(19) United States
(12) Patent Application Publication
(10) Pub. No.: US 2024/0121030 A1
(43) Pub. Date: Apr. 11, 2024

(54) COMMUNICATION METHOD AND COMMUNICATION APPARATUS

(71) Applicant: Huawei Technologies Co., Ltd., Shenzhen (CN)

(72) Inventors: Jian Yu, Shenzhen (CN); Yunbo Li, Shenzhen (CN); Ming Gan, Shenzhen (CN)

(21) Appl. No.: 18/542,274

(22) Filed: Dec. 15, 2023

Related U.S. Application Data
(63) Continuation of application No. PCT/CN2022/098733, filed on Jun. 14, 2022.

(30) Foreign Application Priority Data
Jun. 17, 2021 (CN) 202110675567.9

(51) Int. Cl. H04L 1/00; H04L 5/00

(52) U.S. Cl. CPC H04L 1/0069; H04L 5/0044

(57) ABSTRACT

A communication method and a communication apparatus. The method includes a first device sends a management frame, where the management frame includes a first bitmap, and a first puncturing pattern indicated by the first bitmap is a puncturing pattern not supported by non-orthogonal frequency division multiple access (non-OFDMA) transmission, and the first device sends a physical layer protocol data unit (PPDU) based on a second puncturing pattern corresponding to the first bitmap, where the second puncturing pattern is a puncturing pattern supported by the non-OFDMA transmission.

### CROSS-REFERENCE TO RELATED APPLICATIONS

This application is a continuation of International Application No. PCT/CN2022/098733, filed on Jun. 14, 2022, which claims priority to Chinese Patent Application No. 202110675567.9, filed on Jun. 17, 2021. The disclosures of the aforementioned applications are hereby incorporated by reference in their entireties.

### TECHNICAL FIELD

This application relates to the field of communication technologies, and in particular, to a communication method and a communication apparatus.

### BACKGROUND

A wireless local area network (wireless local area network, WLAN) has undergone a plurality of generations of development, including 802.11a/b/g, 802.11n, 802.11ac, 802.11ax, 802.11be that is currently under discussion, and the like. The 802.11a/b/g standard is referred to as non-high throughput (none-high throughput, non-HT), the 802.11n standard is referred to as high throughput (high throughput, HT), the 802.11ac standard is referred to as very high throughput (very high throughput, VHT), the 802.11ax standard is referred to as high efficiency (high efficiency, HE), and the 802.11be standard is referred to as extremely high throughput (extremely high throughput, EHT).

The 802.11be standard defines two formats of EHT physical layer protocol data unit (physical protocol data unit, PPDU): an extremely high throughput multiple-user physical layer protocol data unit (extremely high throughput multiple-user physical layer protocol data unit, EHT MU PPDU) and an extremely high throughput trigger-based physical layer protocol data unit (extremely high throughput trigger-based physical layer protocol data unit, EHT TB PPDU).

There are two transmission modes for both the EHT MU PPDU and the EHT TB PPDU: non-orthogonal frequency division multiple access (non-orthogonal frequency division multiple access, non-OFDMA) transmission and orthogonal frequency division multiple access (orthogonal frequency division multiple access, OFDMA) transmission.

Currently, it is stipulated in the 802.11be standard that, a manner in which a 16-bit bitmap is carried in a management frame such as a beacon frame can indicate, within a range of a basic service set (basic service set, BSS) bandwidth, 20 MHz sub-channels on which transmission can be performed and 20 MHz sub-channels on which transmission cannot be performed. The 16-bit bitmap is generally referred to as a bitmap of sub-channels on which transmission is not allowed. In the bitmap of the sub-channels on which transmission is not allowed, 0 indicates that transmission is allowed, and 1 indicates that transmission is not allowed. Further, it is further stipulated in the 802.11be standard that, a puncturing pattern indicated by the bitmap of the sub-channels on which transmission is not allowed needs to be a puncturing pattern supported by the non-OFDMA transmission. Therefore, the puncturing pattern indicated by the bitmap of the sub-channels on which transmission is not allowed is very limited, and flexibility is poor.

### SUMMARY

This application provides a communication method and a communication apparatus, which can improve flexibility of indicating a puncturing pattern of a first bitmap (optionally, including a bitmap of sub-channels on which transmission is not allowed), thereby improving applicability.

According to a first aspect, this application provides a communication method. The method includes: A first device sends a management frame, where the management frame includes a first bitmap, and a first puncturing pattern indicated by the first bitmap is a puncturing pattern not supported by non-orthogonal frequency division multiple access non-OFDMA transmission; and the first device sends a physical layer protocol data unit PPDU based on a second puncturing pattern corresponding to the first bitmap, where the second puncturing pattern is a puncturing pattern supported by the non-OFDMA transmission.

In this application, the first device may send the management frame in a manner such as broadcast, so that a second device receiving the management frame may determine, based on the first bitmap included in the management frame, 20 MHz sub-channels on which transmission can be performed and 20 MHz sub-channels on which transmission cannot be performed within a range of a first BSS bandwidth. For downlink transmission, if the first puncturing pattern indicated by the first bitmap is a puncturing pattern not supported by the non-OFDMA transmission, the first device may send the PPDU based on the second puncturing pattern corresponding to the first bitmap. In other words, the first device may determine, based on mapping relationships between the first bitmap and puncturing patterns, a puncturing pattern (namely, the second puncturing pattern) supported by the non-OFDMA transmission, so as to perform the non-OFDMA transmission with the second device based on the second puncturing pattern. Herein, the PPDU may be an EHT MU PPDU, or may be a non-HT duplicate PPDU, or may be an EHT TB PPDU, or the like. This is not limited herein. Compared with a case of a conventional technology in which the first bitmap can be used to indicate only a puncturing pattern supported by the non-OFDMA transmission, in this application, mapping relationships between the first bitmap and puncturing patterns are established, so that an indication of the puncturing pattern by the first bitmap is more flexible, thereby providing higher applicability. Specifically, for the more flexible first bitmap, because the first device may send the PPDU by using the mapped second puncturing pattern, no puncturing pattern for the non-OFDMA transmission is added to the first bitmap, thereby sparing extra implementation complexity. Further, because the first bitmap is more flexible, when the PPDU is sent, a broader BSS bandwidth range can be supported and more 20 MHz channels on which transmission is allowed are supported. In other words, because the first device may further perform OFDMA transmission with the second device by using the first puncturing pattern, in this application, a larger bandwidth and more 20 MHz channels can be used to send data, thereby improving system throughput.

According to a second aspect, this application provides a communication method. The method includes: A second device receives a management frame, where the management frame includes a first bitmap, and a first puncturing pattern indicated by the first bitmap is a puncturing pattern not supported by non-orthogonal frequency division multiple access non-OFDMA transmission; and the second device receives a physical layer protocol data unit PPDU, where transmission of the PPDU is performed by using a second puncturing pattern corresponding to the first bitmap, and the second puncturing pattern is a puncturing pattern supported by the non-OFDMA transmission.

For beneficial effects of the second aspect, refer to the description of the first aspect. Details are not described herein again.

According to a third aspect, this application provides a communication method. The method includes: A first device sends a management frame, where the management frame includes a first bitmap, and a first puncturing pattern indicated by the first bitmap is a puncturing pattern not supported by non-orthogonal frequency division multiple access non-OFDMA transmission; and the first device receives a physical layer protocol data unit PPDU, where transmission of the PPDU is performed by using a second puncturing pattern corresponding to the first bitmap, and the second puncturing pattern is a puncturing pattern supported by the non-OFDMA transmission.

In this application, the first device sends the management frame in a manner such as broadcast, so that a second device receiving the management frame may determine, based on the first bitmap included in the management frame, 20 MHz sub-channels on which transmission can be performed and 20 MHz sub-channels on which transmission cannot be performed within a range of a first BSS bandwidth. For uplink transmission, the second device may further send the PPDU based on the second puncturing pattern corresponding to the first bitmap. In other words, the second device may determine, based on mapping relationships between the first bitmap and puncturing patterns, a puncturing pattern (namely, the second puncturing pattern) supported by the non-OFDMA transmission, so as to send the PPDU based on the second puncturing pattern. Correspondingly, the second device receives the PPDU. Herein, the PPDU may be an EHT TB PPDU, an EHT MU PPDU, a non-HT duplicate PPDU, or the like. This is not limited herein. In this application, for the puncturing pattern indicated by the first bitmap, compared with a case of a conventional technology in which the first bitmap can be used to indicate only a puncturing pattern supported by the non-OFDMA transmission, an indication by the first bitmap is more flexible, thereby providing higher applicability. Specifically, for the more flexible first bitmap, because the first device may send the PPDU by using the mapped second puncturing pattern, no puncturing pattern for the non-OFDMA transmission is added to the first bitmap, thereby sparing extra implementation complexity. Further, because the first bitmap is more flexible, when the PPDU is sent, a broader BSS bandwidth range can be supported and more 20 MHz channels on which transmission is allowed are supported. In other words, because the first device may further perform OFDMA transmission with the second device by using the first puncturing pattern, in this application, a larger bandwidth and more 20 MHz channels can be used to send data, thereby improving system throughput.

According to a fourth aspect, this application provides a communication method. The method includes: A second device receives a management frame, where the management frame includes a first bitmap, and a first puncturing pattern indicated by the first bitmap is a puncturing pattern not supported by non-orthogonal frequency division multiple access non-OFDMA transmission; and the second device sends a physical layer protocol data unit PPDU based on a second puncturing pattern corresponding to the first bitmap, where the second puncturing pattern is a puncturing pattern supported by the non-OFDMA transmission.

For beneficial effects of the third aspect and the fourth aspect, refer to the description of the first aspect. Details are not described herein again.

According to a fifth aspect, a communication apparatus is provided. The apparatus may be a first device, and includes a transceiver unit, configured to send a management frame, where the management frame includes a first bitmap, and a first puncturing pattern indicated by the first bitmap is a puncturing pattern not supported by non-orthogonal frequency division multiple access non-OFDMA transmission, and the transceiver unit is further configured to send a physical layer protocol data unit PPDU based on a second puncturing pattern corresponding to the first bitmap, where the second puncturing pattern is a puncturing pattern supported by the non-OFDMA transmission.

For beneficial effects of the fifth aspect, refer to the description of the first aspect. Details are not described herein again.

According to a sixth aspect, a communication apparatus is provided. The apparatus may be a second device, and includes a transceiver unit, configured to receive a management frame, where the management frame includes a first bitmap, and a first puncturing pattern indicated by the first bitmap is a puncturing pattern not supported by non-orthogonal frequency division multiple access non-OFDMA transmission, and the transceiver unit is further configured to receive a physical layer protocol data unit PPDU, where transmission of the PPDU is performed by using the second puncturing pattern, and the second puncturing pattern is a puncturing pattern supported by the non-OFDMA transmission.

For beneficial effects of the sixth aspect, refer to the description of the second aspect. Details are not described herein again.

According to a seventh aspect, a communication apparatus is provided. The apparatus may be a first device, and includes a transceiver unit, configured to send a management frame, where the management frame includes a first bitmap, and a first puncturing pattern indicated by the first bitmap is a puncturing pattern not supported by non-orthogonal frequency division multiple access non-OFDMA transmission, and the transceiver unit is further configured to receive a physical layer protocol data unit PPDU, where transmission of the PPDU is performed by using the second puncturing pattern, and the second puncturing pattern is a puncturing pattern supported by the non-OFDMA transmission.

For beneficial effects of the seventh aspect, refer to the description of the third aspect. Details are not described herein again.

According to an eighth aspect, a communication apparatus is provided. The apparatus may be a second device, and includes a transceiver unit, configured to receive a management frame, where the management frame includes a first bitmap, and a first puncturing pattern indicated by the first bitmap is a puncturing pattern not supported by non-orthogonal frequency division multiple access non-OFDMA transmission; and the transceiver unit is further configured to send a physical layer protocol data unit PPDU based on a second puncturing pattern corresponding to the first bitmap, where the second puncturing pattern is a puncturing pattern supported by the non-OFDMA transmission.

For beneficial effects of the eighth aspect, refer to the description of the fourth aspect. Details are not described herein again.

With reference to any one of the first aspect to the eighth aspect, in a possible implementation, the management frame further includes a first bandwidth field, the first bandwidth field indicates a first basic service set BSS bandwidth, and the first bit bitmap is a bit bitmap corresponding to the first BSS bandwidth.

With reference to any one of the first aspect to the eighth aspect, in a possible implementation, the first puncturing pattern is a puncturing pattern supported by orthogonal frequency division multiple access OFDMA transmission.

In this application, the first puncturing pattern is a puncturing pattern not supported by the non-OFDMA transmission, and the first puncturing pattern is a puncturing pattern supported by the OFDMA transmission.

With reference to any one of the first aspect to the eighth aspect, in a possible implementation, non-punctured sub-channels in the first puncturing pattern and the second puncturing pattern include a primary 20 MHz channel.

In this application, non-punctured sub-channels in the first puncturing pattern and the second puncturing pattern include a primary 20 MHz channel, so that embodiments of this application comply with a method for channel access based on a primary channel, thereby improving forward compatibility of the methods provided in this application.

With reference to any one of the first aspect to the eighth aspect, in a possible implementation, the second puncturing pattern includes any one of puncturing patterns corresponding to the following resource unit indexes: 242-tone RU 1, 484-tone RU 1, 484+242-tone MRU 1, 484+242-tone MRU 2, 484+242-tone MRU 3, 484+242-tone MRU 4, 996-tone RU 1, 996+484+242-tone MRU 1, 996+484+242-tone MRU 2, 996+484+242-tone MRU 3, 996+484+242-tone MRU 4, 996+484+242-tone MRU 5, 996+484+242-tone MRU 6, 996+484+242-tone MRU 7, 996+484+242-tone MRU 8, 996+484-tone MRU 1, 996+484-tone MRU 2, 996+484-tone MRU 3, 996+484-tone MRU 4, 2*996-tone RU 1, 2*996+484-tone MRU 1, 2*996+484-tone MRU 2, 2*996+484-tone MRU 3, 2*996+484-tone MRU 4, 2*996+484-tone MRU 5, 2*996+484-tone MRU 6, 2*996+484-tone MRU 7, 2*996+484-tone MRU 8, 2*996+484-tone MRU 9, 2*996+484-tone MRU 10, 2*996+484-tone MRU 11, 2*996+484-tone MRU 12, 3*996-tone MRU 1, 3*996-tone MRU 2, 3*996-tone MRU 3, 3*996-tone MRU 4, 3*996+484-tone MRU 1, 3*996+484-tone MRU 2, 3*996+484-tone MRU 3, 3*996+484-tone MRU 4, 3*996+484-tone MRU 5, 3*996+484-tone MRU 6, 3*996+484-tone MRU 7, 3*996+484-tone MRU 8, and 4*996-tone RU 1.

In this application, the second puncturing pattern corresponding to the first bitmap is an allowed puncturing pattern supported by the non-OFDMA transmission in the current 802.11 standard, and no puncturing pattern for the non-OFDMA transmission is added, thereby ensuring same implementation complexity as in a conventional technology and sparing extra complexity.

With reference to any one of the first aspect to the eighth aspect, in a possible implementation, the first BSS bandwidth is 80 MHz; and when the first bitmap is 0110 1111 1111 1111, the first puncturing pattern is 1001 and the second puncturing pattern is a puncturing pattern corresponding to the 242-tone RU 1.

For example, in this application, when the first BSS bandwidth is 80 MHz, mapping relationships between the first bitmap and the first puncturing pattern and between the first bitmap and the second puncturing pattern are established, so that system efficiency is doubled when the first device or the second device performs OFDMA transmission based on the first puncturing pattern. This is because in a conventional technology, to indicate a puncturing pattern supported by non-OFDMA transmission, a BSS bandwidth needs to be reduced (that is, the BSS bandwidth is reduced from 80 MHz to 20 MHz), so that a maximum bandwidth for OFDMA transmission is 20 MHz. In contrast, in this application, mapping relationships between the first bitmap and the first puncturing pattern and between the first bitmap and the second puncturing pattern are established, so that a BSS bandwidth does not need to be reduced (that is, the BSS bandwidth is 80 MHz). In this way, the BSS bandwidth is still 80 MHz, and OFDMA transmission is performed on two 20 MHz channels on which transmission is allowed, that is, an equivalent bandwidth is 40 MHz, thereby doubling system efficiency.

With reference to any one of the first aspect to the eighth aspect, in a possible implementation, if the first BSS bandwidth is 16 0 MHz, and the first BSS bandwidth is divided into a primary 80 MHz channel and a secondary 80 MHz channel in ascending order of frequencies in sequence, when the first bitmap is 0110 y₁y₂y₃y₄ 1111 1111, the first puncturing pattern is 1001 y₁y₂y₃y₄ and the second puncturing pattern is a puncturing pattern corresponding to the 242-tone RU 1, where yᵢ is negation of yᵢ, i includes 1, 2, 3, and 4, and y₁y₂y₃y₄ is any one of 1111, 0111, 1011, 1101, 1110, 1100, 0011, or 1001; or when the first bitmap is 0011 y₁y₂y₃y₄ 1111 1111, the first puncturing pattern is 1100 y₁y₂y₃y₄ and the second puncturing pattern is a puncturing pattern corresponding to the 484-tone RU 1, where yᵢ is negation of yᵢ, i includes 1, 2, 3, and 4, and y₁y₂y₃y₄ is any one of 0111, 1011, 1101, 1110, 1100, 0011, or 1001; or when the first bitmap is 1100 y₁y₂y₃y₄ 1111 1111, the first puncturing pattern is 0011 y₁y₂y₃y₄ and the second puncturing pattern is a puncturing pattern corresponding to the 484-tone RU 1, where yᵢ is negation of yᵢ, i includes 1, 2, 3, and 4, and y₁y₂y₃y₄ is any one of 0111, 1011, 1101, 1110, 1100, 0011, or 1001; or when the first bitmap is 0001 y₁y₂y₃y₄ 1111 1111, the first puncturing pattern is 1110 y₁y₂y₃y₄ and the second puncturing pattern is a puncturing pattern corresponding to the 484+242-tone MRU 4, where yᵢ is negation of yᵢ, i includes 1, 2, 3, and 4, and y₁y₂y₃y₄ is any one of 0111, 1011, 1101, 1110, 1100, 0011, or 1001; or when the first bitmap is 0100 y₁y₂y₃y₄ 1111 1111, the first puncturing pattern is 1011 y₁y₂y₃y₄ and the second puncturing pattern is a puncturing pattern corresponding to the 484+242-tone MRU 2, where yᵢ is negation of yᵢ, i includes 1, 2, 3, and 4, and y₁y₂y₃y₄ is any one of 0111, 1011, 1101, 1110, 1100, 0011, or 1001; or when the first bitmap is 0010 y₁y₂y₃y₄ 1111 1111, the first puncturing pattern is 1101 y₁y₂y₃y₄ and the second puncturing pattern is a puncturing pattern corresponding to the 484+242-tone MRU 3, where yᵢ is negation of yᵢ, i includes 1, 2, 3, and 4, and y₁y₂y₃y₄ is any one of 0111, 1011, 1101, 1110, 1100, 0011, or 1001; or when the first bitmap is 1000 y₁y₂y₃y₄ 1111 1111, the first puncturing pattern is 0111 y₁y₂y₃y₄ and the second puncturing pattern is a puncturing pattern corresponding to the 484+242-tone MRU 1, where yᵢ is negation of yᵢ, i includes 1, 2, 3, and 4, and y₁y₂y₃y₄ is any one of 0111, 1011, 1101, 1110, 1100, 0011, or 1001; or when the first bitmap is 0000 0110 1111 1111, the first puncturing pattern is 1111 1001 and the second puncturing pattern is a puncturing pattern corresponding to the 996-tone RU 1.

In this application, when the first BSS bandwidth is 16 0 MHz and the first BSS bandwidth is divided into a primary 80 MHz channel and a secondary 80 MHz channel in ascending order of frequencies in sequence, mapping relationships between the first bitmap and the first puncturing pattern and between the first bitmap and the second puncturing pattern are established, thereby improving indication flexibility of the first bitmap. Further, in a conventional technology, to indicate a puncturing pattern supported by non-OFDMA transmission, a BSS bandwidth needs to be reduced, and/or to indicate a puncturing pattern supported by OFDMA transmission, a quantity of 20 MHz channels on which OFDMA transmission is allowed needs to be reduced. In this application, after the mapping relationships are established, a BSS bandwidth can be increased to 160 MHz, and/or a quantity of 20 MHz channels on which OFDMA transmission is allowed can be increased, thereby improving throughput.

With reference to any one of the first aspect to the eighth aspect, in a possible implementation, if the first BSS bandwidth is 160 MHz, and the first BSS bandwidth is divided into a secondary 80 MHz channel and a primary 80 MHz channel in ascending order of frequencies in sequence, when the first bitmap is y₁y₂y₃y₄ 0110 1111 1111, the first puncturing pattern is y₁y₂y₃y₄ 1001 and the second puncturing pattern is a puncturing pattern corresponding to the 242-tone RU 1, where yᵢ is negation of yᵢ, i includes 1, 2, 3, and 4, and y₁y₂y₃y₄ is any one of 1111, 0111, 1011, 1101, 1110, 1100, 0011, or 1001; or when the first bitmap is y₁y₂y₃y₄ 0011 1111 1111, the first puncturing pattern is y₁y₂y₃y₄ 1100 and the second puncturing pattern is a puncturing pattern corresponding to the 484-tone RU 1, where yᵢ is negation of yᵢ, i includes 1, 2, 3, and 4, and y₁y₂y₃y₄ is any one of 0111, 1011, 1101, 1110, 1100, 0011, or 1001; or when the first bitmap is y₁y₂y₃y₄ 1100 1111 1111, the first puncturing pattern is y₁y₂y₃y₄ 0011 and the second puncturing pattern is a puncturing pattern corresponding to the 484-tone RU 1, where yᵢ is negation of yᵢ, i includes 1, 2, 3, and 4, and y₁y₂y₃y₄ is any one of 0111, 1011, 1101, 1110, 1100, 0011, or 1001; or when the first bitmap is y₁y₂y₃y₄ 0001 1111 1111, the first puncturing pattern is y₁y₂y₃y₄ 1110 and the second puncturing pattern is a puncturing pattern corresponding to the 484+242-tone MRU 4, where yᵢ is negation of yᵢ, i includes 1, 2, 3, and 4, and y₁y₂y₃y₄ is any one of 0111, 1011, 1101, 1110, 1100, 0011, or 1001; or when the first bitmap is y₁y₂y₃y₄ 0100 1111 1111, the first puncturing pattern is y₁y₂y₃y₄ 1011 and the second puncturing pattern is a puncturing pattern corresponding to the 484+242-tone MRU 2, where yᵢ is negation of yᵢ, i includes 1, 2, 3, and 4, and y₁y₂y₃y₄ is any one of 0111, 1011, 1101, 1110, 1100, 0011, or 1001; or when the first bitmap is y₁y₂y₃y₄ 0010 1111 1111, the first puncturing pattern is y₁y₂y₃y₄ 1101 and the second puncturing pattern is a puncturing pattern corresponding to the 484+242-tone MRU 3, where yᵢ is negation of yᵢ, i includes 1, 2, 3, and 4, and y₁y₂y₃y₄ is any one of 0111, 1011, 1101, 1110, 1100, 0011, or 1001; or when the first bitmap is y₁y₂y₃y₄ 1000 1111 1111, the first puncturing pattern is y₁y₂y₃y₄ 0111 and the second puncturing pattern is a puncturing pattern corresponding to the 484+242-tone MRU 1, where yᵢ is negation of yᵢ, i includes 1, 2, 3, and 4, and y₁y₂y₃y₄ is any one of 0111, 1011, 1101, 1110, 1100, 0011, or 1001; or when the first bitmap is 0110 0000 1111 1111, the first puncturing pattern is 1001 1111 and the second puncturing pattern is a puncturing pattern corresponding to the 996-tone RU 1.

In this application, when the first BSS bandwidth is 16 0 MHz and the first BSS bandwidth is divided into a secondary 80 MHz channel and a primary 80 MHz channel in ascending order of frequencies in sequence, mapping relationships between the first bitmap and the first puncturing pattern and between the first bitmap and the second puncturing pattern are established, thereby improving indication flexibility of the first bitmap. Further, in a conventional technology, to indicate a puncturing pattern supported by non-OFDMA transmission, a BSS bandwidth needs to be reduced, and/or to indicate a puncturing pattern supported by OFDMA transmission, a quantity of 20 MHz channels on which OFDMA transmission is allowed needs to be reduced. In this application, after the mapping relationships are established, a BSS bandwidth can be increased to 16 0 MHz, and/or a quantity of 20 MHz channels on which OFDMA transmission is allowed can be increased, thereby improving throughput.

With reference to any one of the first aspect to the eighth aspect, in a possible implementation, if the first BSS bandwidth is 320 MHz, and the first BSS bandwidth is divided into a primary 80 MHz channel, a secondary 80 MHz channel, and a secondary 160 MHz channel in ascending order of frequencies in sequence when the first bitmap is 0110 y₁y₂y₃y₄ z₁z₂z₃z₄ k₁k₂k₃k₄, the first puncturing pattern is 1001 y₁y₂y₃y₄ z₁z₂z₃z₄ k₁k₂k₃k₄ and the second puncturing pattern is a puncturing pattern corresponding to the 242-tone RU 1, where yᵢ is negation of yᵢ, zᵢ is negation of zᵢ, kᵢ is negation of kᵢ, i includes 1, 2, 3, and 4, y₁y₂y₃y₄ is any one of 1111, 0111, 1011, 1101, 1110, 1100, 0011, 1001, or 0000, z₁z₂z₃z₄ is any one of 1111, 0111, 1011, 1101, 1110, 1100, 0011, 1001, or 0000, k₁k₂k₃k₄ is any one of 1111, 0111, 1011, 1101, 1110, 1100, 0011, 1001, or 0000, and z₁z₂z₃z₄ and k₁k₂k₃k₄ are not both 0000; or when the first bitmap is 0011 y₁y₂y₃y₄ z₁z₂z₃z₄ k₁k₂k₃k₄, the first puncturing pattern is 1100 y₁y₂y₃y₄ z₁z₂z₃z₄ k₁k₂k₃k₄ and the second puncturing pattern is a puncturing pattern corresponding to the 484-tone RU 1, where y is negation of yᵢ, zᵢ is negation of zᵢ, kᵢ is negation of kᵢ, i includes 1, 2, 3, and 4, y₁y₂y₃y₄ is any one of 0111, 1011, 1101, 1110, 1100, 0011, 1001, or 0000, z₁z₂z₃z₄ is any one of 1111, 0111, 1011, 1101, 1110, 1100, 0011, 1001, or 0000, k₁k₂k₃k₄ is any one of 1111, 0111, 1011, 1101, 1110, 1100, 0011, 1001, or 0000, and z₁z₂z₃z₄ and k₁k₂k₃k₄ are not both 0000; or when the first bitmap is 1100 y₁y₂y₃y₄ z₁z₂z₃z₄ k₁k₂k₃k₄, the first puncturing pattern is 0011 y₁y₂y₃y₄ z₁z₂z₃z₄ k₁k₂k₃k₄ and the second puncturing pattern is a puncturing pattern corresponding to the 484-tone RU 1, where yᵢ is negation of yᵢ, i includes 1, 2, 3, and 4, y₁y₂y₃y₄ is any one of 0111, 1011, 1101, 1110, 1100, 0011, 1001, or 0000, z₁z₂z₃z₄ is any one of 1111, 0111, 1011, 1101, 1110, 1100, 0011, 1001, or 0000, k₁k₂k₃k₄ is any one of 1111, 0111, 1011, 1101, 1110, 1100, 0011, 1001, or 0000, and z₁z₂z₃z₄ and k₁k₂k₃k₄ are not both 0000; or when the first bitmap is 0011 0000 z₁z₂z₃z₄ k₁k₂k₃k₄, the first puncturing pattern is 1100 1111 z₁z₂z₃z₄ k₁k₂k₃k₄ and the second puncturing pattern is a puncturing pattern corresponding to the 996+484-tone MRU 2, where zᵢ is negation of zᵢ, kᵢ is negation of kᵢ, i includes 1, 2, 3, and 4, z₁z₂z₃z₄ is any one of 0111, 1011, 1101, 1110, 1100, 0011, 1001, or 0000, k₁k₂k₃k₄ is any one of 1111, 0111, 1011, 1101, 1110, 1100, 0011, 1001, or 0000, and z₁z₂z₃z₄ and k₁k₂k₃k₄ are not both 0000; or when the first bitmap is 1100 0000 z₁z₂z₃z₄ k₁k₂k₃k₄, the first puncturing pattern is 0011 1111 z₁z₂z₃z₄ k₁k₂k₃k₄ and the second puncturing pattern is a puncturing pattern corresponding to the 996+484-tone MRU 1, where zᵢ is negation of zᵢ, k is negation of kᵢ, i includes 1, 2, 3, and 4, z₁z₂z₃z₄ is any one of 0111, 1011, 1101, 1110, 1100, 0011, 1001, or 0000, k₁k₂k₃k₄ is any one of 1111, 0111, 1011, 1101, 1110, 1100, 0011, 1001, or 0000, and z₁z₂z₃z₄ and k₁k₂k₃k₄ are not both 0000; or when the first bitmap is 0011 0000 0000 k₁k₂k₃k₄, the first puncturing pattern is 1100 1111 1111 k₁k₂k₃k₄ and the second puncturing pattern is a puncturing pattern corresponding to the 2*996+484-tone MRU 2, where kᵢ is negation of kᵢ, i includes 1, 2, 3, and 4, and k₁k₂k₃k₄ is any one of 0111, 1011, 1101, 1110, 1100, 0011, 1001, or 0000; or when the first bitmap is 1100 0000 0000 k₁k₂k₃k₄, the first puncturing pattern is 0011 1111 1111 k₁k₂k₃k₄ and the second puncturing pattern is a puncturing pattern corresponding to the 2*996+484-tone MRU 1, where kᵢ is negation of kᵢ, i includes 1, 2, 3, and 4, and k₁k₂k₃k₄ is any one of 0111, 1011, 1101, 1110, 1100, 0011, 1001, or 0000; or when the first bitmap is 0001 y₁y₂y₃y₄ z₁z₂z₃z₄ k₁k₂k₃k₄, the first puncturing pattern is 111 0 y₁y₂y₃y₄ z₁z₂z₃z₄ k₁k₂k₃k₄ and the second puncturing pattern is a puncturing pattern corresponding to the 484+242-tone MRU 4, where yᵢ is negation of yᵢ, zᵢ is negation of zᵢ, kᵢ is negation of kᵢ, i includes 1, 2, 3, and 4, y₁y₂y₃y₄ is any one of 0111, 1011, 1101, 1110, 1100, 0011, 1001, or 0000, z₁z₂z₃z₄ is any one of 1111, 0111, 1011, 1101, 1110, 1100, 0011, 1001, or 0000, k₁k₂k₃k₄ is any one of 1111, 0111, 1011, 1101, 1110, 1100, 0011, 1001, or 0000, and z₁z₂z₃z₄ and k₁k₂k₃k₄ are not both 0000; or when the first bitmap is 0100 y₁y₂y₃y₄ z₁z₂z₃z₄ k₁k₂k₃k₄, the first puncturing pattern is 10n y₁y₂y₃y₄ z₁z₂z₃z₄ k₁k₂k₃k₄ and the second puncturing pattern is a puncturing pattern corresponding to the 484+242-tone MRU 2, where yᵢ is negation of yᵢ, zᵢ is negation of zᵢ, kᵢ is negation of kᵢ, i includes 1, 2, 3, and 4, y₁y₂y₃y₄ is any one of 0111, 1011, 1101, 1110, 1100, 0011, 1001, or 0000, z₁z₂z₃z₄ is any one of 1111, 0111, 1011, 1101, 1110, 1100, 0011, 1001, or 0000, k₁k₂k₃k₄ is any one of 1111, 0111, 1011, 1101, 1110, 1100, 0011, 1001, or 0000, and z₁z₂z₃z₄ and k₁k₂k₃k₄ are not both 0000; or when the first bitmap is 0010 y₁y₂y₃y₄ z₁z₂z₃z₄ k₁k₂k₃k₄, the first puncturing pattern is 1101 y₁y₂y₃y₄ z₁z₂z₃z₄ k₁k₂k₃k₄ and the second puncturing pattern is a puncturing pattern corresponding to the 484+242-tone MRU 3, where yᵢ is negation of yᵢ, zᵢ is negation of zᵢ, kᵢ is negation of kᵢ, i includes 1, 2, 3, and 4, y₁y₂y₃y₄ is any one of 0111, 1011, 1101, 1110, 1100, 0011, 1001, or 0000, z₁z₂z₃z₄ is any one of 1111, 0111, 1011, 1101, 1110, 1100, 0011, 1001, or 0000, k₁k₂k₃k₄ is any one of 1111, 0111, 1011, 1101, 1110, 1100, 0011, 1001, or 0000, and z₁z₂z₃z₄ and k₁k₂k₃k₄ are not both 0000; or when the first bitmap is 1000 y₁y₂y₃y₄ z₁z₂z₃z₄ k₁k₂k₃k₄, the first puncturing pattern is 0111 y₁y₂y₃y₄ z₁z₂z₃z₄ k₁k₂k₃k₄ and the second puncturing pattern is a puncturing pattern corresponding to the 484+242-tone MRU 1, where yᵢ is negation of yᵢ, zᵢ is negation of zᵢ, kᵢ is negation of kᵢ, i includes 1, 2, 3, and 4, y₁y₂y₃y₄ is any one of 0111, 1011, 1101, 1110, 1100, 0011, 1001, or 0000, z₁z₂z₃z₄ is any one of 1111, 0111, 1011, 1101, 1110, 1100, 0011, 1001, or 0000, k₁k₂k₃k₄ is any one of 1111, 0111, 1011, 1101, 1110, 1100, 0011, 1001, or 0000, and z₁z₂z₃z₄ and k₁k₂k₃k₄ are not both 0000; or when the first bitmap is 0001 0000 z₁z₂z₃z₄ k₁k₂k₃k₄, the first puncturing pattern is 1110 1111 z₁z₂z₃z₄ k₁k₂k₃k₄ and the second puncturing pattern is a puncturing pattern corresponding to the 996+484+242-tone MRU 4, where zᵢ is negation of zᵢ, kᵢ is negation of kᵢ, i includes 1, 2, 3, and 4, z₁z₂z₃z₄ is any one of 0111, 1011, 1101, 1110, 1100, 0011, 1001, or 0000, k₁k₂k₃k₄ is any one of 1111, 0111, 1011, 1101, 1110, 1100, 0011, 1001, or 0000, and z₁z₂z₃z₄ and k₁k₂k₃k₄ are not both 0000; or when the first bitmap is 0100 0000 z₁z₂z₃z₄ k₁k₂k₃k₄, the first puncturing pattern is 1011 1111 z₁z₂z₃z₄ k₁k₂k₃k₄ and the second puncturing pattern is a puncturing pattern corresponding to the 996+484+242-tone MRU 2, where zᵢ is negation of zᵢ, kᵢ is negation of kᵢ, i includes 1, 2, 3, and 4, z₁z₂z₃z₄ is any one of 0111, 1011, 1101, 1110, 1100, 0011, 1001, or 0000, k₁k₂k₃k₄ is any one of 1111, 0111, 1011, 1101, 1110, 1100, 0011, 1001, or 0000, and z₁z₂z₃z₄ and k₁k₂k₃k₄ are not both 0000; or when the first bitmap is 0010 0000 z₁z₂z₃z₄ k₁k₂k₃k₄, the first puncturing pattern is 1101 1111 z₁z₂z₃z₄ k₁k₂k₃k₄ and the second puncturing pattern is a puncturing pattern corresponding to the 996+484+242-tone MRU 3, where zᵢ is negation of zᵢ, kᵢ is negation of kᵢ, i includes 1, 2, 3, and 4, z₁z₂z₃z₄ is any one of 0111, 1011, 1101, 1110, 1100, 0011, 1001, or 0000, k₁k₂k₃k₄ is any one of 1111, 0111, 1011, 1101, 1110, 1100, 0011, 1001, or 0000, and z₁z₂z₃z₄ and k₁k₂k₃k₄ are not both 0000; or when the first bitmap is 1000 0000 z₁z₂z₃z₄ k₁k₂k₃k₄, the first puncturing pattern is 0111 1111 z₁z₂z₃z₄ k₁k₂k₃k₄ and the second puncturing pattern is a puncturing pattern corresponding to the 996+484+242-tone MRU 1, where zᵢ is negation of zᵢ, kᵢ is negation of kᵢ, i includes 1, 2, 3, and 4, z₁z₂z₃z₄ is any one of 0111, 1011, 1101, 1110, 1100, 0011, 1001, or 0000, k₁k₂k₃k₄ is any one of 1111, 0111, 1011, 1101, 1110, 1100, 0011, 1001, or 0000, and z₁z₂z₃z₄ and k₁k₂k₃k₄ are not both 0000; or when the first bitmap is 0001 0000 0000 k₁k₂k₃k₄, the first puncturing pattern is 1110 1111 1111 k₁k₂k₃k₄ and the second puncturing pattern is a puncturing pattern corresponding to the 2*996+484-tone MRU 2, where kᵢ is negation of kᵢ, i includes 1, 2, 3, and 4, and k₁k₂k₃k₄ is any one of 0111, 1011, 1101, 1110, 1100, 0011, 1001, or 0000; or when the first bitmap is 0100 0000 0000 k₁k₂k₃k₄, the first puncturing pattern is 1011 1111 1111 k₁k₂k₃k₄ and the second puncturing pattern is a puncturing pattern corresponding to the 2*996+484-tone MRU 1, where kᵢ is negation of kᵢ, i includes 1, 2, 3, and 4, and k₁k₂k₃k₄ is any one of 0111, 1011, 1101, 1110, 1100, 0011, 1001, or 0000; or when the first bitmap is 0010 0000 0000 k₁k₂k₃k₄, the first puncturing pattern is 1101 1111 1111 k₁k₂k₃k₄ and the second puncturing pattern is a puncturing pattern corresponding to the 2*996+484-tone MRU 2, where kᵢ is negation of kᵢ, i includes 1, 2, 3, and 4, and k₁k₂k₃k₄ is any one of 0111, 1011, 1101, 1110, 1100, 0011, 1001, or 0000; or when the first bitmap is 1000 0000 0000 k₁k₂k₃k₄, the first puncturing pattern is 0111 1111 1111 k₁k₂k₃k₄ and the second puncturing pattern is a puncturing pattern corresponding to the 2*996+484-tone MRU 1, where kᵢ is negation of kᵢ, i includes 1, 2, 3, and 4, and k₁k₂k₃k₄ is any one of 0111, 1011, 1101, 1110, 1100, 0011, 1001, or 0000; or when the first bitmap is 0001 0000 0000 0000, the first puncturing pattern is 1110 1111 1111 1111 and the second puncturing pattern is a puncturing pattern corresponding to the 3*996+484-tone MRU 2; or when the first bitmap is 0100 0000 0000 0000, the first puncturing pattern is 10 1111 1111 1111 and the second puncturing pattern is a puncturing pattern corresponding to the 3*996+484-tone MRU 1; or when the first bitmap is 0010 0000 0000 0000, the first puncturing pattern is 1101 1111 1111 1111 and the second puncturing pattern is a puncturing pattern corresponding to the 3*996+484-tone MRU 2; or when the first bitmap is 1000 0000 0000 0000, the first puncturing pattern is 0111 1111 1111 1111 and the second puncturing pattern is a puncturing pattern corresponding to the 3*996+484-tone MRU 1; or when the first bitmap is 0000 0110 z₁z₂z₃z₄ k₁k₂k₃k₄, the first puncturing pattern is 1111 1101 and the second puncturing pattern is a puncturing pattern corresponding to the 996-tone RU 1, where zᵢ is negation of zᵢ, kᵢ is negation of kᵢ, i includes 1, 2, 3, and 4, z₁z₂z₃z₄ is any one of 1111, 0111, 1011, 1101, 1110, 1100, 0011, 1001, or 0000, k₁k₂k₃k₄ is any one of 0111, 1011, 1101, 1110, 1100, 0011, 1001, or 0000, and z₁z₂z₃z₄ and k₁k₂k₃k₄ are not both 0000; or when the first bitmap is 0000 0110 0000 0000, the first puncturing pattern is 1111 1001 1111 1111 and the second puncturing pattern is a puncturing pattern corresponding to the 3*996-tone MRU 2; or when the first bitmap is 0000 0011 z₁z₂z₃z₄ k₁k₂k₃k₄, the first puncturing pattern is 1111 1100 z₁z₂z₃z₄ k₁k₂k₃k₄ and the second puncturing pattern is a puncturing pattern corresponding to the 996+484-tone MRU 4, where zᵢ is negation of zᵢ, kᵢ is negation of kᵢ, i includes 1, 2, 3, and 4, z₁z₂z₃z₄ is any one of 0111, 1011, 1101, 1110, 1100, 0011, 1001, or 0000, k₁k₂k₃k₄ is any one of 1111, 0111, 1011, 1101, 1110, 1100, 0011, 1001, or 0000, and z₁z₂z₃z₄ and k₁k₂k₃k₄ are not both 0000; or when the first bitmap is 0000 1100 z₁z₂z₃z₄ k₁k₂k₃k₄, the first puncturing pattern is 1111 0011 z₁z₂z₃z₄ k₁k₂k₃k₄ and the second puncturing pattern is a puncturing pattern corresponding to the 996+484-tone MRU 3, where zᵢ is negation of zᵢ, kᵢ is negation of kᵢ, i includes 1, 2, 3, and 4, z₁z₂z₃z₄ is any one of 0111, 1011, 1101, 1110, 1100, 0011, 1001, or 0000, k₁k₂k₃k₄ is any one of 1111, 0111, 1011, 1101, 1110, 1100, 0011, 1001, or 0000, and z₁z₂z₃z₄ and k₁k₂k₃k₄ are not both 0000; or when the first bitmap is 0000 0011 0000 k₁k₂k₃k₄, the first puncturing pattern is 1111 1100 1111 k₁k₂k₃k₄ and the second puncturing pattern is a puncturing pattern corresponding to the 2*996+484-tone MRU 4, where kᵢ is negation of kᵢ, i includes 1, 2, 3, and 4, and k₁k₂k₃k₄ is any one of 0111, 1011, 1101, 1110, 1100, 0011, 1001, or 0000; or when the first bitmap is 0000 1100 0000 k₁k₂k₃k₄, the first puncturing pattern is 1111 0011 1111 k₁k₂k₃k₄ and the second puncturing pattern is a puncturing pattern corresponding to the 2*996+484-tone MRU 3, where kᵢ is negation of kᵢ, i includes 1, 2, 3, and 4, and k₁k₂k₃k₄ is any one of 0111, 1011, 1101, 1110, 1100, 0011, 1001, or 0000; or when the first bitmap is 0000 0001 z₁z₂z₃z₄ k₁k₂k₃k₄, the first puncturing pattern is 1111 1110 z₁z₂z₃z₄ k₁k₂k₃k₄ and the second puncturing pattern is a puncturing pattern corresponding to the 996+484+242-tone MRU 8, where zᵢ is negation of zᵢ, kᵢ is negation of kᵢ, i includes 1, 2, 3, and 4, z₁z₂z₃z₄ is any one of 0111, 1011, 1101, 1110, 1100, 0011, 1001, or 0000, k₁k₂k₃k₄ is any one of 1111, 0111, 1011, 1101, 1110, 1100, 0011, 1001, or 0000, and z₁z₂z₃z₄ and k₁k₂k₃k₄ are not both 0000; or when the first bitmap is 0000 0010 z₁z₂z₃z₄ k₁k₂k₃k₄, the first puncturing pattern is 1111 1101 z₁z₂z₃z₄ k₁k₂k₃k₄ and the second puncturing pattern is a puncturing pattern corresponding to the 996+484+242-tone MRU 7, where zᵢ is negation of zᵢ, kᵢ is negation of kᵢ, i includes 1, 2, 3, and 4, z₁z₂z₃z₄ is any one of 0111, 1011, 1101, 1110, 1100, 0011, 1001, or 0000, k₁k₂k₃k₄ is any one of 1111, 0111, 1011, 1101, 1110, 1100, 0011, 1001, or 0000, and z₁z₂z₃z₄ and k₁k₂k₃k₄ are not both 0000; or when the first bitmap is 0000 0100 z₁z₂z₃z₄ k₁k₂k₃k₄, the first puncturing pattern is 1111 1011 z₁z₂z₃z₄ k₁k₂k₃k₄ and the second puncturing pattern is a puncturing pattern corresponding to the 996+484+242-tone MRU 6, where zᵢ is negation of zᵢ, kᵢ is negation of kᵢ, i includes 1, 2, 3, and 4, z₁z₂z₃z₄ is any one of 0111, 1011, 1101, 1110, 1100, 0011, 1001, or 0000, k₁k₂k₃k₄ is any one of 1111, 0111, 1011, 1101, 1110, 1100, 0011, 1001, or 0000, and z₁z₂z₃z₄ and k₁k₂k₃k₄ are not both 0000; or when the first bitmap is 0000 1000 z₁z₂z₃z₄ k₁k₂k₃k₄, the first puncturing pattern is 1111 0111 z₁z₂z₃z₄ k₁k₂k₃k₄ and the second puncturing pattern is a puncturing pattern corresponding to the 996+484+242-tone MRU 5, where zᵢ is negation of zᵢ, kᵢ is negation of kᵢ, i includes 1, 2, 3, and 4, z₁z₂z₃z₄ is any one of 0111, 1011, 1101, 1110, 1100, 0011, 1001, or 0000, k₁k₂k₃k₄ is any one of 1111, 0111, 1011, 1101, 1110, 1100, 0011, 1001, or 0000, and z₁z₂z₃z₄ and k₁k₂k₃k₄ are not both 0000; or when the first bitmap is 0000 0001 0000 k₁k₂k₃k₄, the first puncturing pattern is 1111 1110 1111 k₁k₂k₃k₄ and the second puncturing pattern is a puncturing pattern corresponding to the 2*996+484-tone MRU 4, where kᵢ is negation of kᵢ, i includes 1, 2, 3, and 4, and k₁k₂k₃k₄ is any one of 0111, 1011, 1101, 1110, 1100, 0011, 1001, or 0000; or when the first bitmap is 0000 0010 0000 k₁k₂k₃k₄, the first puncturing pattern is 1111 1101 1111 k₁k₂k₃k₄ and the second puncturing pattern is a puncturing pattern corresponding to the 2*996+484-tone MRU 4, where k is negation of kᵢ, i includes 1, 2, 3, and 4, and k₁k₂k₃k₄ is any one of 1111, 0111, 1011, 1101, 1110, 1100, 0011, 1001, or 0000; or when the first bitmap is 0000 0100 0000 k₁k₂k₃k₄, the first puncturing pattern is 1111 1011 1111 k₁k₂k₃k₄ and the second puncturing pattern is a puncturing pattern corresponding to the 2*996+484-tone MRU 3, where kᵢ is negation of kᵢ, i includes 1, 2, 3, and 4, and k₁k₂k₃k₄ is any one of 1111, 0111, 1011, 1101, 1110, 1100, 0011, 1001, or 0000; or when the first bitmap is 0000 1000 0000 k₁k₂k₃k₄, the first puncturing pattern is 1111 0111 1111 k₁k₂k₃k₄ and the second puncturing pattern is a puncturing pattern corresponding to the 2*996+484-tone MRU 3, where kᵢ is negation of kᵢ, i includes 1, 2, 3, and 4, and k₁k₂k₃k₄ is any one of 1111, 0111, 1011, 1101, 1110, 1100, 0011, 1001, or 0000; or when the first bitmap is 0000 0001 0000 0000, the first puncturing pattern is 1111 1110 1111 1111 and the second puncturing pattern is a puncturing pattern corresponding to the 3*996+484-tone MRU 4; or when the first bitmap is 0000 0010 0000 0000, the first puncturing pattern is 1111 1101 1111 1111 and the second puncturing pattern is a puncturing pattern corresponding to the 3*996+484-tone MRU 4; or when the first bitmap is 0000 0100 0000 0000, the first puncturing pattern is 1111 1011 1111 1111 and the second puncturing pattern is a puncturing pattern corresponding to the 3*996+484-tone MRU 3; or when the first bitmap is 0000 1000 0000 0000, the first puncturing pattern is 1111 0111 1111 1111, and the second puncturing pattern is a puncturing pattern corresponding to the 3*996+484-tone MRU 3; or when the first bitmap is 0000 0000 0110 k₁k₂k₃k₄, the first puncturing pattern is 1111 1111 1001 k₁k₂k₃k₄ and the second puncturing pattern is a puncturing pattern corresponding to the 2*996-tone RU 1, where kᵢ is negation of kᵢ, i includes 1, 2, 3, and 4, and k₁k₂k₃k₄ is any one of 0111, 1011, 1101, 1110, 1100, 0011, 1001, or 0000; or when the first bitmap is 0000 0000 0011 k₁k₂k₃k₄, the first puncturing pattern is 1111 1111 1100 k₁k₂k₃k₄ and the second puncturing pattern is a puncturing pattern corresponding to the 2*996+484-tone MRU 6, where kᵢ is negation of kᵢ, i includes 1, 2, 3, and 4, and k₁k₂k₃k₄ is any one of 0111, 1011, 1101, 1110, 1100, 0011, 1001, or 0000; or when the first bitmap is 0000 0000 1100 k₁k₂k₃k₄, the first puncturing pattern is 1111 1111 0011 k₁k₂k₃k₄ and the second puncturing pattern is a puncturing pattern corresponding to the 2*996+484-tone MRU 5, where kᵢ is negation of kᵢ, i includes 1, 2, 3, and 4, and k₁k₂k₃k₄ is any one of 0111, 1011, 1101, 1110, 1100, 0011, 1001, or 0000; or when the first bitmap is 0000 0000 0001 k₁k₂k₃k₄, the first puncturing pattern is 1111 1111 1110 k₁k₂k₃k₄ and the second puncturing pattern is a puncturing pattern corresponding to the 2*996+484-tone MRU 6, where kᵢ is negation of kᵢ, i includes 1, 2, 3, and 4, and k₁k₂k₃k₄ is any one of 0111, 1011, 1101, 1110, 1100, 0011, 1001, or 0000; or when the first bitmap is 0000 0000 0010 k₁k₂k₃k₄, the first puncturing pattern is 1111 1111 1101 k₁k₂k₃k₄ and the second puncturing pattern is a puncturing pattern corresponding to the 2*996+484-tone MRU 6, where kᵢ is negation of kᵢ, i includes 1, 2, 3, and 4, and k₁k₂k₃k₄ is any one of 0111, 1011, 1101, 1110, 1100, 0011, 1001, or 0000; or when the first bitmap is 0000 0000 0100 k₁k₂k₃k₄, the first puncturing pattern is 1111 1111 1011 k₁k₂k₃k₄ and the second puncturing pattern is a puncturing pattern corresponding to the 2*996+484-tone MRU 5, where kᵢ is negation of kᵢ, i includes 1, 2, 3, and 4, and k₁k₂k₃k₄ is any one of 0111, 1011, 1101, 1110, 1100, 0011, 1001, or 0000; or when the first bitmap is 0000 0000 1000 k₁k₂k₃k₄, the first puncturing pattern is 1111 1111 0111 k₁k₂k₃k₄ and the second puncturing pattern is a puncturing pattern corresponding to the 2*996+484-tone MRU 5, where kᵢ is negation of kᵢ, i includes 1, 2, 3, and 4, and k₁k₂k₃k₄ is any one of 0111, 1011, 1101, 1110, 1100, 0011, 1001, or 0000; or when the first bitmap is 0000 0000 0001 0000, the first puncturing pattern is 1111 1111 1110 1111 and the second puncturing pattern is a puncturing pattern corresponding to the 2*996+484-tone MRU 6; or when the first bitmap is 0000 0000 0010 0000, the first puncturing pattern is 1111 1111 1101 1111 and the second puncturing pattern is a puncturing pattern corresponding to the 3*996+484-tone MRU 6; or when the first bitmap is 0000 0000 0100 0000, the first puncturing pattern is 1111 1111 1011 1111 and the second puncturing pattern is a puncturing pattern corresponding to the 3*996+484-tone MRU 5; or when the first bitmap is 0000 0000 1000 0000, the first puncturing pattern is 1111 1111 0111 1111, and the second puncturing pattern is a puncturing pattern corresponding to the 3*996+484-tone MRU 5; or when the first bitmap is 0000 0000 0000 0110, the first puncturing pattern is 1111 1111 1111 1001 and the second puncturing pattern is a puncturing pattern corresponding to the 3*996-tone MRU 4; or when the first bitmap is 0000 0000 0000 0001, the first puncturing pattern is 1111 1111 1111 1110 and the second puncturing pattern is a puncturing pattern corresponding to the 3*996+484-tone MRU 8; or when the first bitmap is 0000 0000 0000 0010, the first puncturing pattern is 1111 1111 1111 1101 and the second puncturing pattern is a puncturing pattern corresponding to the 3*996+484-tone MRU 8; or when the first bitmap is 0000 0000 0000 0100, the first puncturing pattern is 1111 1111 1111 1011 and the second puncturing pattern is a puncturing pattern corresponding to the 3*996+484-tone MRU 7; or when the first bitmap is 0000 0000 0000 1000, the first puncturing pattern is 1111 1111 1111 0111, and the second puncturing pattern is a puncturing pattern corresponding to the 3*996+484-tone MRU 7.

In this application, when the first BSS bandwidth is 320 MHz and the first BSS bandwidth is divided into a primary 80 MHz channel, a secondary 80 MHz channel, and a secondary 160 MHz channel in ascending order of frequencies in sequence, mapping relationships between the first bitmap and the first puncturing pattern and between the first bitmap and the second puncturing pattern are established, thereby improving indication flexibility of the first bitmap and improving applicability of the solutions. Further, in a conventional technology, to indicate a puncturing pattern supported by non-OFDMA transmission, a BSS bandwidth needs to be reduced, and/or to indicate a puncturing pattern supported by OFDMA transmission, a quantity of 20 MHz channels on which OFDMA transmission is allowed needs to be reduced. In this application, after the mapping relationships are established, a BSS bandwidth can be increased to 320 MHz, and/or a quantity of 20 MHz channels on which OFDMA transmission is allowed can be increased, thereby improving throughput.

With reference to any one of the first aspect to the eighth aspect, in a possible implementation, if the first BSS bandwidth is 320 MHz, and the first BSS bandwidth is divided into a secondary 80 MHz channel, a primary 80 MHz channel, and a secondary 160 MHz channel in ascending order of frequencies in sequence, when the first bitmap is y₁y₂y₃y₄ 0110 z₁z₂z₃z₄ k₁k₂k₃k₄, the first puncturing pattern is y₁y₂y₃y₄ 1001 z₁z₂z₃z₄ k₁k₂k₃k₄ and the second puncturing pattern is a puncturing pattern corresponding to the 242-tone RU 1, where y is negation of yᵢ, zᵢ is negation of zᵢ, kᵢ is negation of kᵢ, i includes 1, 2, 3, and 4, each of y₁y₂y₃y₄, k₁k₂k₃k₄, and z₁z₂z₃z₄ is any one of 1111, 0111, 1011, 1101, 1110, 1100, 0011, 1001, or 0000, and z₁z₂z₃z₄ and k₁k₂k₃k₄ are not both 0000; or when the first bitmap is y₁y₂y₃y₄ z₁z₂z₃z₄ k₁k₂k₃k₄, the first puncturing pattern is y₁y₂y₃y₄ 1100 z₁z₂z₃z₄ k₁k₂k₃k₄ and the second puncturing pattern is a puncturing pattern corresponding to the 484-tone RU 1, where yᵢ is negation of yᵢ, zᵢ is negation of zᵢ, kᵢ is negation of kᵢ, i includes 1, 2, 3, and 4, y₁y₂y₃y₄ is any one of 0111, 1011, 1101, 1110, 1100, 0011, 1001, or 0000, z₁z₂z₃z₄ and k₁k₂k₃k₄ each are any one of 1111, 0111, 1011, 1101, 1110, 1100, 0011, 1001, or 0000, and z₁z₂z₃z₄ and k₁k₂k₃k₄ are not both 1111 or not both 0000; or when the first bitmap is y₁y₂y₃y₄ 1100 z₁z₂z₃z₄ k₁k₂k₃k₄, the first puncturing pattern is y₁y₂y₃y₄ 0011 z₁z₂z₃z₄ k₁k₂k₃k₄ and the second puncturing pattern is a puncturing pattern corresponding to the 484-tone RU 1, where yᵢ is negation of yᵢ, Z, is negation of zᵢ, kᵢ is negation of kᵢ, i includes 1, 2, 3, and 4, y₁y₂y₃y₄ is any one of 0111, 1011, 1101, 1110, 1100, 0011, 1001, or 0000, z₁z₂z₃z₄ and k₁k₂k₃k₄ each are any one of 1111, 0111, 1011, 1101, 1110, 1100, 0011, 1001, or 0000, and z₁z₂z₃z₄ and k₁k₂k₃k₄ are not both 1111 or not both 0000; or when the first bitmap is y₁y₂y₃y₄ 0011 0000 0000, the first puncturing pattern is y₁y₂y₃y₄ 1100 1111 1111 and the second puncturing pattern is a puncturing pattern corresponding to the 2*996+484-tone MRU 8, where yᵢ is negation of yᵢ, i includes 1, 2, 3, and 4, and y₁y₂y₃y₄ is any one of 0111, 1011, 1101, 1110, 1100, 0011, 1001, or 0000; or when the first bitmap is y₁y₂y₃y₄ 1100 0000 0000, the first puncturing pattern is y₁y₂y₃y₄ 0011 1111 1111 and the second puncturing pattern is a puncturing pattern corresponding to the 2*996+484-tone MRU 7, where yᵢ is negation of yᵢ, i includes 1, 2, 3, and 4, and y₁y₂y₃y₄ is any one of 0111, 1011, 1101, 1110, 1100, 0011, 1001, or 0000; or when the first bitmap is 0000 0011 z₁z₂z₃z₄ k₁k₂k₃k₄, the first puncturing pattern is 1111 1100 z₁z₂z₃z₄ k₁k₂k₃k₄ and the second puncturing pattern is a puncturing pattern corresponding to the 996+484-tone MRU 4, where zᵢ is negation of zᵢ, kᵢ is negation of kᵢ, i includes 1, 2, 3, and 4, z₁z₂z₃z₄ is any one of 0111, 1011, 1101, 1110, 1100, 0011, 1001, or 0000, k₁k₂k₃k₄ is any one of 1111, 0111, 1011, 1101, 1110, 1100, 0011, 1001, or 0000, and z₁z₂z₃z₄ and k₁k₂k₃k₄ are not both 0000; or when the first bitmap is 0000 1100 z₁z₂z₃z₄ k₁k₂k₃k₄, the first puncturing pattern is 1111 0011 z₁z₂z₃z₄ k₁k₂k₃k₄ and the second puncturing pattern is a puncturing pattern corresponding to the 996+484-tone MRU 3, where zᵢ is negation of zᵢ, kᵢ is negation of kᵢ, i includes 1, 2, 3, and 4, z₁z₂z₃z₄ is any one of 0111, 1011, 1101, 1110, 1100, 0011, 1001, or 0000, k₁k₂k₃k₄ is any one of 1111, 0111, 1011, 1101, 1110, 1100, 0011, 1001, or 0000, and z₁z₂z₃z₄ and k₁k₂k₃k₄ are not both 0000; or when the first bitmap is 0000 0011 0000 k₁k₂k₃k₄, the first puncturing pattern is 1111 1100 1111 k₁k₂k₃k₄ and the second puncturing pattern is a puncturing pattern corresponding to the 2*996+484-tone MRU 4, where kᵢ is negation of kᵢ, i includes 1, 2, 3, and 4, and k₁k₂k₃k₄ is any one of 0111, 1011, 1101, 1110, 1100, 0011, 1001, or 0000; or when the first bitmap is 0000 1100 0000 k₁k₂k₃k₄, the first puncturing pattern is 1111 0011 1111 k₁k₂k₃k₄ and the second puncturing pattern is a puncturing pattern corresponding to the 2*996+484-tone MRU 3, where kᵢ is negation of kᵢ, i includes 1, 2, 3, and 4, and k₁k₂k₃k₄ is any one of 0111, 1011, 1101, 1110, 1100, 0011, 1001, or 0000; or when the first bitmap is y₁y₂y₃y₄ 0001 z₁z₂z₃z₄ k₁k₂k₃k₄, the first puncturing pattern is y₁y₂y₃y₄ 1110 z₁z₂z₃z₄ k₁k₂k₃k₄ and the second puncturing pattern is a puncturing pattern corresponding to the 484+242-tone MRU 4, where yᵢ is negation of yᵢ, zᵢ is negation of zᵢ, kᵢ is negation of kᵢ, i includes 1, 2, 3, and 4, y₁y₂y₃y₄ is any one of 0111, 1011, 1101, 1110, 1100, 0011, 1001, or 0000, z₁z₂z₃z₄ and k₁k₂k₃k₄ each are any one of 1111, 0111, 1011, 1101, 1110, 1100, 0011, 1001, or 0000, and z₁z₂z₃z₄ and k₁k₂k₃k₄ are not both 1111 or not both 0000; or when the first bitmap is y₁y₂y₃y₄ 0100 z₁z₂z₃z₄ k₁k₂k₃k₄, the first puncturing pattern is y₁y₂y₃y₄ 1011 z₁z₂z₃z₄ k₁k₂k₃k₄ and the second puncturing pattern is a puncturing pattern corresponding to the 484+242-tone MRU 2, where yᵢ is negation of yᵢ, zᵢ is negation of zᵢ, kᵢ is negation of kᵢ, i includes 1, 2, 3, and 4, y₁y₂y₃y₄ is any one of 0111, 1011, 1101, 1110, 1100, 0011, 1001, or 0000, z₁z₂z₃z₄ and k₁k₂k₃k₄ each are any one of 1111, 0111, 1011, 1101, 1110, 1100, 0011, 1001, or 0000, and z₁z₂z₃z₄ and kᵢk₂k₃k₄ are not both 1111 or not both 0000; or when the first bitmap is y₁y₂y₃y₄ 0010 z₁z₂z₃z₄ k₁k₂k₃k₄, the first puncturing pattern is y₁y₂y₃y₄ 1101 z₁z₂z₃z₄ k₁k₂k₃k₄ and the second puncturing pattern is a puncturing pattern corresponding to the 484+242-tone MRU 3, where yᵢ is negation of yᵢ, zᵢ is negation of zᵢ, kᵢ is negation of kᵢ, i includes 1, 2, 3, and 4, y₁y₂y₃y₄ is any one of 0111, 1011, 1101, 1110, 1100, 0011, 1001, or 0000, z₁z₂z₃z₄ and k₁k₂k₃k₄ each are any one of 1111, 0111, 1011, 1101, 1110, 1100, 0011, 1001, or 0000, and z₁z₂z₃z₄ and kᵢk₂k₃k₄ are not both 1111 or not both 0000; or when the first bitmap is y₁y₂y₃y₄ 1000 z₁z₂z₃z₄ k₁k₂k₃k₄, the first puncturing pattern is y₁y₂y₃y₄ 0111 z₁z₂z₃z₄ k₁k₂k₃k₄ and the second puncturing pattern is a puncturing pattern corresponding to the 484+242-tone MRU 1, where yᵢ is negation of yᵢ, zᵢ is negation of zᵢ, kᵢ is negation of kᵢ, i includes 1, 2, 3, and 4, y₁y₂y₃y₄ is any one of 0111, 1011, 1101, 1110, 1100, 0011, 1001, or 0000, z₁z₂z₃z₄ and k₁k₂k₃k₄ each are any one of 1111, 0111, 1011, 1101, 1110, 1100, 0011, 1001, or 0000, and z₁z₂z₃z₄ and kᵢk₂k₃k₄ are not both 1111 or not both 0000; or when the first bitmap is y₁y₂y₃y₄ 0001 0000 0000, the first puncturing pattern is y₁y₂y₃y₄ 1110 1111 1111 and the second puncturing pattern is a puncturing pattern corresponding to the 2*996+484-tone MRU 8, where yᵢ is negation of yᵢ, i includes 1, 2, 3, and 4, and y₁y₂y₃y₄ is any one of 0111, 1011, 1101, 1110, 1100, 0011, 1001, or 0000; or when the first bitmap is y₁y₂y₃y₄ 0100 0000 0000, the first puncturing pattern is y₁y₂y₃y₄ 1011 1111 1111 and the second puncturing pattern is a puncturing pattern corresponding to the 2*996+484-tone MRU 7, where yᵢ is negation of yᵢ, i includes 1, 2, 3, and 4, and y₁y₂y₃y₄ is any one of 0111, 1011, 1101, 1110, 1100, 0011, 1001, or 0000; or when the first bitmap is y₁y₂y₃y₄ 0010 0000 0000, the first puncturing pattern is y₁y₂y₃y₄ 1101 1111 1111 and the second puncturing pattern is a puncturing pattern corresponding to the 2*996+484-tone MRU 8, where yᵢ is negation of yᵢ, i includes 1, 2, 3, and 4, and y₁y₂y₃y₄ is any one of 0111, 1011, 1101, 1110, 1100, 0011, 1001, or 0000; or when the first bitmap is y₁y₂y₃y₄ 1000 0000 0000, the first puncturing pattern is y₁y₂y₃y₄ 0111 1111 1111 and the second puncturing pattern is a puncturing pattern corresponding to the 2*996+484-tone MRU 7, where yᵢ is negation of yᵢ, i includes 1, 2, 3, and 4, and y₁y₂y₃y₄ is any one of 0111, 1011, 1101, 1110, 1100, 0011, 1001, or 0000; or when the first bitmap is 0000 0001 z₁z₂z₃z₄ k₁k₂k₃k₄, the first puncturing pattern is 1111 1110 z₁z₂z₃z₄ k₁k₂k₃k₄ and the second puncturing pattern is a puncturing pattern corresponding to the 996+484+242-tone MRU 8, where zᵢ is negation of zᵢ, kᵢ is negation of kᵢ, i includes 1, 2, 3, and 4, z₁z₂z₃z₄ is any one of 0111, 1011, 1101, 1110, 1100, 0011, 1001, or 0000, and k₁k₂k₃k₄ is any one of 1111, 0111, 1011, 1101, 1110, 1100, 0011, 1001, or 0000; or when the first bitmap is 0000 0100 z₁z₂z₃z₄ k₁k₂k₃k₄, the first puncturing pattern is 1111 1011 z₁z₂z₃z₄ k₁k₂k₃k₄ and the second puncturing pattern is a puncturing pattern corresponding to the 996+484+242-tone MRU 6, where zᵢ is negation of zᵢ, kᵢ is negation of kᵢ, i includes 1, 2, 3, and 4, z₁z₂z₃z₄ is any one of 0111, 1011, 1101, 1110, 1100, 0011, 1001, or 0000, and k₁k₂k₃k₄ is any one of 1111, 0111, 1011, 1101, 1110, 1100, 0011, 1001, or 0000; or when the first bitmap is 0000 0010 z₁z₂z₃z₄ k₁k₂k₃k₄, the first puncturing pattern is 1111 1101 z₁z₂z₃z₄ k₁k₂k₃k₄ and the second puncturing pattern is a puncturing pattern corresponding to the 996+484+242-tone MRU 7, where zᵢ is negation of zᵢ, kᵢ is negation of kᵢ, i includes 1, 2, 3, and 4, z₁z₂z₃z₄ is any one of 0111, 1011, 1101, 1110, 1100, 0011, 1001, or 0000, and k₁k₂k₃k₄ is any one of 1111, 0111, 1011, 1101, 1110, 1100, 0011, 1001, or 0000; or when the first bitmap is 0000 1000 z₁z₂z₃z₄ k₁k₂k₃k₄, the first puncturing pattern is 1111 0111 z₁z₂z₃z₄ k₁k₂k₃k₄ and the second puncturing pattern is a puncturing pattern corresponding to the 996+484+242-tone MRU 5, where zᵢ is negation of zᵢ, kᵢ is negation of kᵢ, i includes 1, 2, 3, and 4, z₁z₂z₃z₄ is any one of 0111, 1011, 1101, 1110, 1100, 0011, 1001, or 0000, and k₁k₂k₃k₄ is any one of 1111, 0111, 1011, 1101, 1110, 1100, 0011, 1001, or 0000; or when the first bitmap is 0000 0001 z₁z₂z₃z₄ k₁k₂k₃k₄, the first puncturing pattern is 1111 1110 1111 k₁k₂k₃k₄ and the second puncturing pattern is a puncturing pattern corresponding to the 2*996+484-tone MRU 4, where kᵢ is negation of kᵢ, i includes 1, 2, 3, and 4, and k₁k₂k₃k₄ is any one of 0111, 1011, 1101, 1110, 1100, 0011, 1001, or 0000; or when the first bitmap is 0000 0100 0000 k₁k₂k₃k₄, the first puncturing pattern is 1111 1011 1111k₁k₂k₃k₄ and the second puncturing pattern is a puncturing pattern corresponding to the 2*996+484-tone MRU 3, where kᵢ is negation of kᵢ, i includes 1, 2, 3, and 4, and k₁k₂k₃k₄ is any one of 0111, 1011, 1101, 1110, 1100, 0011, 1001, or 0000; or when the first bitmap is 0000 0010 0000 k₁k₂k₃k₄, the first puncturing pattern is 1111 1101 1111 k₁k₂k₃k₄ and the second puncturing pattern is a puncturing pattern corresponding to the 2*996+484-tone MRU 4, where kᵢ is negation of kᵢ, i includes 1, 2, 3, and 4, and k₁k₂k₃k₄ is any one of 0111, 1011, 1101, 1110, 1100, 0011, 1001, or 0000; or when the first bitmap is 0000 1000 0000 k₁k₂k₃k₄, the first puncturing pattern is 1111 0111 1111 k₁k₂k₃k₄ and the second puncturing pattern is a puncturing pattern corresponding to the 2*996+484-tone MRU 3, where kᵢ is negation of kᵢ, i includes 1, 2, 3, and 4, and k₁k₂k₃k₄ is any one of 0111, 1011, 1101, 1110, 1100, 0011, 1001, or 0000; or when the first bitmap is 0000 0001 0000 0000, the first puncturing pattern is 1111 1110 1111 1111 and the second puncturing pattern is a puncturing pattern corresponding to the 3*996+484-tone MRU 4; or when the first bitmap is 0000 0100 0000 0000, the first puncturing pattern is 1111 1011 1111 1111 and the second puncturing pattern is a puncturing pattern corresponding to the 3*996+484-tone MRU 3; or when the first bitmap is 0000 0010 0000 0000, the first puncturing pattern is 1111 1101 1111 1111 and the second puncturing pattern is a puncturing pattern corresponding to the 3*996+484-tone MRU 4; or when the first bitmap is 0000 1000 0000 0000, the first puncturing pattern is 1111 0111 1111 1111, and the second puncturing pattern is a puncturing pattern corresponding to the 3*996+484-tone MRU 3; or when the first bitmap is 0110 0000 0110 k₁k₂k₃k₄, the first puncturing pattern is 1001 1111 1001 k₁k₂k₃k₄ and the second puncturing pattern is a puncturing pattern corresponding to the 996-tone RU 1, where kᵢ is negation of kᵢ, i includes 1, 2, 3, and 4, and k₁k₂k₃k₄ is any one of 0111, 1011, 1101, 1110, 1100, 0011, 1001, or 0000; or when the first bitmap is 0110 0000 0110 0000, the first puncturing pattern is 1001 1111 1001 1111 and the second puncturing pattern is a puncturing pattern corresponding to the 996-tone RU 1; or when the first bitmap is 0110 0000 1100 k₁k₂k₃k₄, the first puncturing pattern is 1001 1111 0011 k₁k₂k₃k₄ and the second puncturing pattern is a puncturing pattern corresponding to the 996-tone RU 1, where kᵢ is negation of kᵢ, i includes 1, 2, 3, and 4, and k₁k₂k₃k₄ is any one of 0111, 1011, 1101, 1110, 1100, 0011, 1001, or 0000; or when the first bitmap is 0110 0000 0011 k₁k₂k₃k₄, the first puncturing pattern is 1001 1111 1100 k₁k₂k₃k₄ and the second puncturing pattern is a puncturing pattern corresponding to the 996-tone RU 1, where kᵢ is negation of kᵢ, i includes 1, 2, 3, and 4, and k₁k₂k₃k₄ is any one of 0111, 1011, 1101, 1110, 1100, 0011, 1001, or 0000; or when the first bitmap is 0110 0000 1000 k₁k₂k₃k₄, the first puncturing pattern is 1001 1111 0111 k₁k₂k₃k₄ and the second puncturing pattern is a puncturing pattern corresponding to the 996-tone RU 1, where h is negation of kᵢ, i includes 1, 2, 3, and 4, and k₁k₂k₃k₄ is any one of 0111, 1011, 1101, 1110, 1100, 0011, 1001, or 0000; or when the first bitmap is 0110 0000 0100 k₁k₂k₃k₄, the first puncturing pattern is 1001 1111 1011 k₁k₂k₃k₄ and the second puncturing pattern is a puncturing pattern corresponding to the 996-tone RU 1, where kᵢ is negation of kᵢ, i includes 1, 2, 3, and 4, and k₁k₂k₃k₄ is any one of 0111, 1011, 1101, 1110, 1100, 0011, 1001, or 0000; or when the first bitmap is 0110 0000 0010 k₁k₂k₃k₄, the first puncturing pattern is 1001 1111 1101 k₁k₂k₃k₄ and the second puncturing pattern is a puncturing pattern corresponding to the 996-tone RU 1, where h is negation of kᵢ, i includes 1, 2, 3, and 4, and k₁k₂k₃k₄ is any one of 0111, 1011, 1101, 1110, 1100, 0011, 1001, or 0000; or when the first bitmap is 0110 0000 0100 k₁k₂k₃k₄, the first puncturing pattern is 1001 1111 1110 k₁k₂k₃k₄ and the second puncturing pattern is a puncturing pattern corresponding to the 996-tone RU 1, where kᵢ is negation of kᵢ, i includes 1, 2, 3, and 4, and k₁k₂k₃k₄ is any one of 0111, 1011, 1101, 1110, 1100, 0011, 1001, or 0000; or when the first bitmap is 0110 0000 z₁z₂z₃z₄ 0110, the first puncturing pattern is 1001 1111 z₁z₂z₃z₄ 1001 and the second puncturing pattern is a puncturing pattern corresponding to the 996-tone RU 1, where & is negation of zᵢ, i includes 1, 2, 3, and 4, and z₁z₂z₃z₄ is any one of 0111, 1011, 1101, 1110, 1100, 0011, 1001, or 0000; or when the first bitmap is 0110 0000 z₁z₂z₃z₄ 1100, the first puncturing pattern is 1001 1111 z₁z₂z₃z₄ 0011 and the second puncturing pattern is a puncturing pattern corresponding to the 996-tone RU 1, where zᵢ is negation of zᵢ, i includes 1, 2, 3, and 4, and z₁z₂z₃z₄ is any one of 0111, 1011, 1101, 1110, 1100, 0011, 1001, or 0000; or when the first bitmap is 0110 0000 z₁z₂z₃z₄ 0011, the first puncturing pattern is 1001 1111 z₁z₂z₃z₄ 1100 and the second puncturing pattern is a puncturing pattern corresponding to the 996-tone RU 1, where zᵢ is negation of zᵢ, i includes 1, 2, 3, and 4, and z₁z₂z₃z₄ is any one of 0111, 1011, 1101, 1110, 1100, 0011, 1001, or 0000; or when the first bitmap is 0110 0000 z₁z₂z₃z₄ 1000, the first puncturing pattern is 1001 1111 z₁z₂z₃z₄ 0111 and the second puncturing pattern is a puncturing pattern corresponding to the 996-tone RU 1, where z; is negation of zᵢ, i includes 1, 2, 3, and 4, and z₁z₂z₃z₄ is any one of 0111, 1011, 1101, 1110, 1100, 0011, 1001, or 0000; or when the first bitmap is 0110 0000 z₁z₂z₃z₄ 0100, the first puncturing pattern is 1001 1111 z₁z₂z₃z₄ 1011 and the second puncturing pattern is a puncturing pattern corresponding to the 996-tone RU 1, where & is negation of zᵢ, i includes 1, 2, 3, and 4, and z₁z₂z₃z₄ is any one of 0111, 1011, 1101, 1110, 1100, 0011, 1001, or 0000; or when the first bitmap is 0110 0000 z₁z₂z₃z₄ 0010, the first puncturing pattern is 1001 1111 z₁z₂z₃z₄ 1101, and the second puncturing pattern is a puncturing pattern corresponding to the 996-tone RU 1, where zᵢ is negation of zᵢ, i includes 1, 2, 3, and 4, and z₁z₂z₃z₄ is any one of 0111, 1011, 1101, 1110, 1100, 0011, 1001, or 0000; or when the first bitmap is 0110 0000 z₁z₂z₃z₄ 0001, the first puncturing pattern is 1001 1111 z₁z₂z₃z₄ 1110 and the second puncturing pattern is a puncturing pattern corresponding to the 996-tone RU 1, where zᵢ is negation of zᵢ, i includes 1, 2, 3, and 4, and z₁z₂z₃z₄ is any one of 0111, 1011, 1101, 1110, 1100, 0011, 1001, or 0000; or when the first bitmap is 0110 0000 1100 0000, the first puncturing pattern is 1001 1111 0011 1111 and the second puncturing pattern is a puncturing pattern corresponding to the 2*996+484-tone MRU 9; or when the first bitmap is 0110 0000 0011 0000, the first puncturing pattern is 1001 1111 1100 1111 and the second puncturing pattern is a puncturing pattern corresponding to the 2*996+484-tone MRU 10; or when the first bitmap is 0110 0000 1000 0000, the first puncturing pattern is 1001 1111 0111 1111 and the second puncturing pattern is a puncturing pattern corresponding to the 2*996+484-tone MRU 9; or when the first bitmap is 0110 0000 0100 0000, the first puncturing pattern is 1001 1111 1011 1111 and the second puncturing pattern is a puncturing pattern corresponding to the 2*996+484-tone MRU 9; or when the first bitmap is 0110 0000 0010 0000, the first puncturing pattern is 1001 1111 1101 1111 and the second puncturing pattern is a puncturing pattern corresponding to the 2*996+484-tone MRU 10; or when the first bitmap is 0110 0000 0001 0000, the first puncturing pattern is 1001 1111 1100 1111 and the second puncturing pattern is a puncturing pattern corresponding to the 2*996+484-tone MRU 10; or when the first bitmap is 0110 0000 0000 0011, the first puncturing pattern is 1001 1111 1111 0011 and the second puncturing pattern is a puncturing pattern corresponding to the 2*996+484-tone MRU 11; or when the first bitmap is 0110 0000 0000 1100, the first puncturing pattern is 1001 1111 1111 1100 and the second puncturing pattern is a puncturing pattern corresponding to the 2*996+484-tone MRU 12; or when the first bitmap is 0110 0000 0000 1000, the first puncturing pattern is 1001 1111 1111 0111 and the second puncturing pattern is a puncturing pattern corresponding to the 2*996+484-tone MRU 11; or when the first bitmap is 0110 0000 0000 0100, the first puncturing pattern is 1001 1111 1111 1011 and the second puncturing pattern is a puncturing pattern corresponding to the 2*996+484-tone MRU 11; or when the first bitmap is 0110 0000 0000 0010, the first puncturing pattern is 1001 1111 1111 1101 and the second puncturing pattern is a puncturing pattern corresponding to the 2*996+484-tone MRU 12; or when the first bitmap is 0110 0000 0000 0001, the first puncturing pattern is 1001 1111 1111 1110 and the second puncturing pattern is a puncturing pattern corresponding to the 2*996+484-tone MRU 12; or when the first bitmap is 0110 0000 0000 0000, the first puncturing pattern is 1001 1111 1111 1111 and the second puncturing pattern is a puncturing pattern corresponding to the 3*996-tone MRU 1; or when the first bitmap is 0011 0000 0110 k₁k₂k₃k₄, the first puncturing pattern is 1100 1111 1001 k₁k₂k₃k₄ and the second puncturing pattern is a puncturing pattern corresponding to the 996+484-tone MRU 2, where kᵢ is negation of kᵢ, i includes 1, 2, 3, and 4, and k₁k₂k₃k₄ is any one of 0111, 1011, 1101, 1110, 1100, 0011, 1001, or 0000; or when the first bitmap is 0011 0000 0110 0000, the first puncturing pattern is 1100 1111 1001 1111 and the second puncturing pattern is a puncturing pattern corresponding to the 996+484-tone MRU 2; or when the first bitmap is 0011 0000 1100 k₁k₂k₃k₄, the first puncturing pattern is 1100 1111 0011 k₁k₂k₃k₄ and the second puncturing pattern is a puncturing pattern corresponding to the 996+484-tone MRU 2, where k; is negation of kᵢ, i includes 1, 2, 3, and 4, and k₁k₂k₃k₄ is any one of 0111, 1011, 1101, 1110, 1100, 0011, 1001, or 0000; or when the first bitmap is 0011 0000 0011 k₁k₂k₃k₄, the first puncturing pattern is 1100 1111 1100 k₁k₂k₃k₄ and the second puncturing pattern is a puncturing pattern corresponding to the 996+484-tone MRU 2, where kᵢ is negation of kᵢ, i includes 1, 2, 3, and 4, and k₁k₂k₃k₄ is any one of 0111, 1011, 1101, 1110, 1100, 0011, 1001, or 0000; or when the first bitmap is 0011 0000 1000 k₁k₂k₃k₄, the first puncturing pattern is 1100 1111 0111 k₁k₂k₃k₄ and the second puncturing pattern is a puncturing pattern corresponding to the 996+484-tone MRU 2, where kᵢ is negation of kᵢ, i includes 1, 2, 3, and 4, and k₁k₂k₃k₄ is any one of 0111, 1011, 1101, 1110, 1100, 0011, 1001, or 0000; or when the first bitmap is 0011 0000 0100 k₁k₂k₃k₄, the first puncturing pattern is 1100 1111 1011 k₁k₂k₃k₄ and the second puncturing pattern is a puncturing pattern corresponding to the 996+484-tone MRU 2, where kᵢ is negation of kᵢ, i includes 1, 2, 3, and 4, and k₁k₂k₃k₄ is any one of 0111, 1011, 1101, 1110, 1100, 0011, 1001, or 0000; or when the first bitmap is 0011 0000 0010 k₁k₂k₃k₄, the first puncturing pattern is 1100 1111 1101 k₁k₂k₃k₄ and the second puncturing pattern is a puncturing pattern corresponding to the 996+484-tone MRU 2, where kᵢ is negation of kᵢ, i includes 1, 2, 3, and 4, and k₁k₂k₃k₄ is any one of 0111, 1011, 1101, 1110, 1100, 0011, 1001, or 0000; or when the first bitmap is 0011 0000 0001 k₁k₂k₃k₄, the first puncturing pattern is 1100 1111 1110 k₁k₂k₃k₄ and the second puncturing pattern is a puncturing pattern corresponding to the 996+484-tone MRU 2, where kᵢ is negation of kᵢ, i includes 1, 2, 3, and 4, and k₁k₂k₃k₄ is any one of 0111, 1011, 1101, 1110, 1100, 0011, 1001, or 0000; or when the first bitmap is 0011 0000 z₁z₂z₃z₄ 0110, the first puncturing pattern is 1100 1111 z₁z₂z₃z₄ 1001 and the second puncturing pattern is a puncturing pattern corresponding to the 996+484-tone MRU 2, where zᵢ is negation of zᵢ, i includes 1, 2, 3, and 4, and z₁z₂z₃z₄ is any one of 0111, 1011, 1101, 1110, 1100, 0011, 1001, or 0000; or when the first bitmap is 0011 0000 z₁z₂z₃z₄ 1100, the first puncturing pattern is 1100 1111 z₁z₂z₃z₄ 0011 and the second puncturing pattern is a puncturing pattern corresponding to the 996+484-tone MRU 2, where zᵢ is negation of zᵢ, i includes 1, 2, 3, and 4, and z₁z₂z₃z₄ is any one of 0111, 1011, 1101, 1110, 1100, 0011, 1001, or 0000; or when the first bitmap is 0011 0000 z₁z₂z₃z₄ 0011, the first puncturing pattern is 1100 1111 z₁z₂z₃z₄ 1100 and the second puncturing pattern is a puncturing pattern corresponding to the 996+484-tone MRU 2, where zᵢ is negation of zᵢ, i includes 1, 2, 3, and 4, and z₁z₂z₃z₄ is any one of 0111, 1011, 1101, 1110, 1100, 0011, 1001, or 0000; or when the first bitmap is 0011 0000 z₁z₂z₃z₄ 1000, the first puncturing pattern is 1100 1111 z₁z₂z₃z₄ 0111 and the second puncturing pattern is a puncturing pattern corresponding to the 996+484-tone MRU 2, where zᵢ is negation of zᵢ, i includes 1, 2, 3, and 4, and z₁z₂z₃z₄ is any one of 0111, 1011, 1101, 1110, 1100, 0011, 1001, or 0000; or when the first bitmap is 0011 0000 z₁z₂z₃z₄ 0100, the first puncturing pattern is 1100 1111 z₁z₂z₃z₄ 1011 and the second puncturing pattern is a puncturing pattern corresponding to the 996+484-tone MRU 2, where zᵢ is negation of zᵢ, i includes 1, 2, 3, and 4, and z₁z₂z₃z₄ is any one of 0111, 1011, 1101, 1110, 1100, 0011, 1001, or 0000; or when the first bitmap is 0011 0000 z₁z₂z₃z₄ 0010, the first puncturing pattern is 1100 1111 z₁z₂z₃z₄ 1101 and the second puncturing pattern is a puncturing pattern corresponding to the 996+484-tone MRU 2, where zᵢ is negation of zᵢ, i includes 1, 2, 3, and 4, and z₁z₂z₃z₄ is any one of 0111, 1011, 1101, 1110, 1100, 0011, 1001, or 0000; or when the first bitmap is 0011 0000 z₁z₂z₃z₄ 0001, the first puncturing pattern is 1100 1111 z₁z₂z₃z₄ 1110 and the second puncturing pattern is a puncturing pattern corresponding to the 996+484-tone MRU 2, where zᵢ is negation of zᵢ, i includes 1, 2, 3, and 4, and z₁z₂z₃z₄ is any one of 0111, 1011, 1101, 1110, 1100, 0011, 1001, or 0000; or when the first bitmap is 1100 0000 0110 k₁k₂k₃k₄, the first puncturing pattern is 0011 1111 1001 k₁k₂k₃k₄ and the second puncturing pattern is a puncturing pattern corresponding to the 996+484-tone MRU 1, where kᵢ is negation of kᵢ, i includes 1, 2, 3, and 4, and k₁k₂k₃k₄ is any one of 0111, 1011, 1101, 1110, 1100, 0011, 1001, or 0000; or when the first bitmap is 1100 0000 0110 0000, the first puncturing pattern is 0011 1111 1001 1111 and the second puncturing pattern is a puncturing pattern corresponding to the 996+484-tone MRU 1; or when the first bitmap is 1100 0000 1100 k₁k₂k₃k₄, the first puncturing pattern is 0011 1111 0011 k₁k₂k₃k₄ and the second puncturing pattern is a puncturing pattern corresponding to the 996+484-tone MRU 1, where kᵢ is negation of kᵢ, i includes 1, 2, 3, and 4, and k₁k₂k₃k₄ is any one of 0111, 1011, 1101, 1110, 1100, 0011, 1001, or 0000; or when the first bitmap is 1100 0000 0011 k₁k₂k₃k₄, the first puncturing pattern is 0011 1111 1100 k₁k₂k₃k₄ and the second puncturing pattern is a puncturing pattern corresponding to the 996+484-tone MRU 1, where kᵢ is negation of kᵢ, i includes 1, 2, 3, and 4, and k₁k₂k₃k₄ is any one of 0111, 1011, 1101, 1110, 1100, 0011, 1001, or 0000; or when the first bitmap is 1100 0000 1000 k₁k₂k₃k₄, the first puncturing pattern is 0011 1111 0111 k₁k₂k₃k₄ and the second puncturing pattern is a puncturing pattern corresponding to the 996+484-tone MRU 1, where kᵢ is negation of kᵢ, i includes 1, 2, 3, and 4, and k₁k₂k₃k₄ is any one of 0111, 1011, 1101, 1110, 1100, 0011, 1001, or 0000; or when the first bitmap is 1100 0000 0100 k₁k₂k₃k₄, the first puncturing pattern is 0011 1111 1011 k₁k₂k₃k₄ and the second puncturing pattern is a puncturing pattern corresponding to the 996+484-tone MRU 1, where kᵢ is negation of kᵢ, i includes 1, 2, 3, and 4, and k₁k₂k₃k₄ is any one of 0111, 1011, 1101, 1110, 1100, 0011, 1001, or 0000; or when the first bitmap is 1100 0000 0010 k₁k₂k₃k₄, the first puncturing pattern is 0011 1111 1101 k₁k₂k₃k₄ and the second puncturing pattern is a puncturing pattern corresponding to the 996+484-tone MRU 1, where kᵢ is negation of kᵢ, i includes 1, 2, 3, and 4, and k₁k₂k₃k₄ is any one of 0111, 1011, 1101, 1110, 1100, 0011, 1001, or 0000; or when the first bitmap is 1100 0000 0001 k₁k₂k₃k₄, the first puncturing pattern is 0011 1111 1110 k₁k₂k₃k₄ and the second puncturing pattern is a puncturing pattern corresponding to the 996+484-tone MRU 1, where kᵢ is negation of kᵢ, i includes 1, 2, 3, and 4, and k₁k₂k₃k₄ is any one of 0111, 1011, 1101, 1110, 1100, 0011, 1001, or 0000; or when the first bitmap is 1100 0000 z₁z₂z₃z₄ 0110, the first puncturing pattern is 0011 1111 z₁z₂z₃z₄ 1001 and the second puncturing pattern is a puncturing pattern corresponding to the 996+484-tone MRU 1, where zᵢ is negation of zᵢ, i includes 1, 2, 3, and 4, and z₁z₂z₃z₄ is any one of 0111, 1011, 1101, 1110, 1100, 0011, 1001, or 0000; or when the first bitmap is 1100 0000 z₁z₂z₃z₄ 1100, the first puncturing pattern is 0011 1111 z₁z₂z₃z₄ 0011 and the second puncturing pattern is a puncturing pattern corresponding to the 996+484-tone MRU 1, where zᵢ is negation of zᵢ, i includes 1, 2, 3, and 4, and z₁z₂z₃z₄ is any one of 0111, 1011, 1101, 1110, 1100, 0011, 1001, or 0000; or when the first bitmap is 1100 0000 z₁z₂z₃z₄ 0011, the first puncturing pattern is 0011 1111 z₁z₂z₃z₄ 1100 and the second puncturing pattern is a puncturing pattern corresponding to the 996+484-tone MRU 1, where zᵢ is negation of zᵢ, i includes 1, 2, 3, and 4, and z₁z₂z₃z₄ is any one of 0111, 1011, 1101, 1110, 1100, 0011, 1001, or 0000; or when the first bitmap is 1100 0000 z₁z₂z₃z₄ 1000, the first puncturing pattern is 0011 1111 z₁z₂z₃z₄ 0111 and the second puncturing pattern is a puncturing pattern corresponding to the 996+484-tone MRU 1, where zᵢ is negation of zᵢ, i includes 1, 2, 3, and 4, and z₁z₂z₃z₄ is any one of 0111, 1011, 1101, 1110, 1100, 0011, 1001, or 0000; or when the first bitmap is 1100 0000 z₁z₂z₃z₄ 0100, the first puncturing pattern is 0011 1111 z₁z₂z₃z₄ 1011 and the second puncturing pattern is a puncturing pattern corresponding to the 996+484-tone MRU 1, where zᵢ is negation of zᵢ, i includes 1, 2, 3, and 4, and z₁z₂z₃z₄ is any one of 0111, 1011, 1101, 1110, 1100, 0011, 1001, or 0000; or when the first bitmap is 1100 0000 z₁z₂z₃z₄ 0010, the first puncturing pattern is 0011 1111 z₁z₂z₃z₄ 1101 and the second puncturing pattern is a puncturing pattern corresponding to the 996+484-tone MRU 1, where zᵢ is negation of zᵢ, i includes 1, 2, 3, and 4, and z₁z₂z₃z₄ is any one of 0111, 1011, 1101, 1110, 1100, 0011, 1001, or 0000; or when the first bitmap is 1100 0000 z₁z₂z₃z₄ 0001, the first puncturing pattern is 0011 1111 z₁z₂z₃z₄ 1110 and the second puncturing pattern is a puncturing pattern corresponding to the 996+484-tone MRU 1, where zᵢ is negation of zᵢ, i includes 1, 2, 3, and 4, and z₁z₂z₃z₄ is any one of 0111, 1011, 1101, 1110, 1100, 0011, 1001, or 0000; or when the first bitmap is 0011 0000 1100 0000, the first puncturing pattern is 1100 1111 0011 1111 and the second puncturing pattern is a puncturing pattern corresponding to the 2*996+484-tone MRU 9; or when the first bitmap is 0011 0000 0011 0000, the first puncturing pattern is 1100 1111 1100 1111 and the second puncturing pattern is a puncturing pattern corresponding to the 2*996+484-tone MRU 10; or when the first bitmap is 0011 0000 1000 0000, the first puncturing pattern is 1100 1111 0111 1111 and the second puncturing pattern is a puncturing pattern corresponding to the 2*996+484-tone MRU 9; or when the first bitmap is 0011 0000 0100 0000, the first puncturing pattern is 1100 1111 1011 1111 and the second puncturing pattern is a puncturing pattern corresponding to the 2*996+484-tone MRU 9; or when the first bitmap is 0011 0000 0010 0000, the first puncturing pattern is 1100 1111 1101 1111 and the second puncturing pattern is a puncturing pattern corresponding to the 2*996+484-tone MRU 10; or when the first bitmap is 0011 0000 0001 0000, the first puncturing pattern is 1100 1111 1110 1111 and the second puncturing pattern is a puncturing pattern corresponding to the 2*996+484-tone MRU 10; or when the first bitmap is 0011 0000 0000 k₁k₂k₃k₄, the first puncturing pattern is 1100 1111 1111 k₁k₂k₃k₄, where kᵢ is negation of kᵢ, and i includes 1, 2, 3, and 4; and when k₁k₂k₃k₄ is any one of 0111, 1011, 1101, 1110, 1100, 0011, 1001 or 0000, the second puncturing pattern is the 2*996+484-tone MRU 2; or when k₁k₂k₃k₄ is any one of 0111, 1011, or 0011, the second puncturing pattern is the 2*996+484-tone MRU 11; or when k₁k₂k₃k₄ is any one of 1101, 1110, or 1100, the second puncturing pattern is the 2*996+484-tone MRU 12; or when the first bitmap is 1100 0000 1100 0000, the first puncturing pattern is 0011 1111 0011 1111 and the second puncturing pattern is a puncturing pattern corresponding to the 2*996+484-tone MRU 9; or when the first bitmap is 1100 0000 0011 0000, the first puncturing pattern is 0011 1111 1100 1111 and the second puncturing pattern is a puncturing pattern corresponding to the 2*996+484-tone MRU 10; or when the first bitmap is 1100 0000 1000 0000, the first puncturing pattern is 0011 1111 0111 1111 and the second puncturing pattern is a puncturing pattern corresponding to the 2*996+484-tone MRU 9; or when the first bitmap is 1100 0000 0100 0000, the first puncturing pattern is 0011 1111 1011 1111 and the second puncturing pattern is a puncturing pattern corresponding to the 2*996+484-tone MRU 9; or when the first bitmap is 1100 0000 0010 0000, the first puncturing pattern is 0011 1111 1101 1111 and the second puncturing pattern is a puncturing pattern corresponding to the 2*996+484-tone MRU 10; or when the first bitmap is 1100 0000 0001 0000, the first puncturing pattern is 0011 1111 1110 1111 and the second puncturing pattern is a puncturing pattern corresponding to the 2*996+484-tone MRU 10; or when the first bitmap is 1100 0000 0000 k₁k₂k₃k₄, the first puncturing pattern is 0011 1111 1111 k₁k₂k₃k₄, where kᵢ is negation of kᵢ, and i includes 1, 2, 3, and 4; and when k₁k₂k₃k₄ is any one of 0111, 1011, 1101, 1110, 1100, 0011, 1001 or 0000, the second puncturing pattern is the 2*996+484-tone MRU 1; or when k₁k₂k₃k₄ is any one of 0111, 1011, or 0011, the second puncturing pattern is the 2*996+484-tone MRU 11; or when k₁k₂k₃k₄ is any one of 1101, 1110, or 1100, the second puncturing pattern is the 2*996+484-tone MRU 12; or when the first bitmap is 0001 0000 Z₁Z₂Z₃Z₄ K₁K₂K₂K₄, the first puncturing pattern is 1110 1111 Z₁Z₂Z₃Z₄ K₁K₂K₃K₄ and the second puncturing pattern is a puncturing pattern corresponding to the 996+484+242-tone MRU 4; or when the first bitmap is 0010 0000 Z₁Z₂Z₃Z₄ K₁K₂K₂K₄, the first puncturing pattern is 1101 1111 Z₁Z₂Z₃Z₄ K₁K₂K₃K₄ and the second puncturing pattern is a puncturing pattern corresponding to the 996+484+242-tone MRU 3; or when the first bitmap is 0100 0000 Z₁Z₂Z₃Z₄ K₁K₂K₂K₄, the first puncturing pattern is 1011 1111 Z₁Z₂Z₃Z₄ K₁K₂K₃K₄ and the second puncturing pattern is a puncturing pattern corresponding to the 996+484+242-tone MRU 2; or when the first bitmap is 1000 0000 Z₁Z₂Z₃Z₄ K₁K₂K₂K₄, the first puncturing pattern is 0111 1111 Z₁Z₂Z₃Z₄ K₁K₂K₃K₄ and the second puncturing pattern is a puncturing pattern corresponding to the 996+484+242-tone MRU 1; where when Z₁Z₂Z₃Z₄ and K₁K₂K₂K₄ are 0110 and k₁k₂k₃k₄ respectively, Z₁Z₂Z₃Z₄ and K₁K₂K₃K₄ are 1001 and k₁k₂k₃k₄ respectively; or when Z₁Z₂Z₃Z₄ and K₁K₂K₂K₄ are 0110 and 0000 respectively, Z₁Z₂Z₃Z₄ and K₁K₂K₃K₄ are 1001 and 1111 respectively; or when Z₁Z₂Z₃Z₄ and K₁K₂K₂K₄ are 1100 and k₁k₂k₃k₄ respectively, Z₁Z₂Z₃Z₄ and K₁K₂K₃K₄ are 0011 and k₁k₂k₃k₄ respectively; or when Z₁Z₂Z₃Z₄ and K₁K₂K₂K₄ are 0011 and k₁k₂k₃k₄ respectively, Z₁Z₂Z₃Z₄ and K₁K₂K₃K₄ are 1100 and k₁k₂k₃k₄ respectively; or when Z₁Z₂Z₃Z₄ and K₁K₂K₂K₄ are 1000 and k₁k₂k₃k₄ respectively, Z₁Z₂Z₃Z₄ and K₁K₂K₃K₄ are 0111 and k₁k₂k₃k₄ respectively; or when Z₁Z₂Z₃Z₄ and K₁K₂K₂K₄ are 0100 and k₁k₂k₃k₄ respectively, Z₁Z₂Z₃Z₄ and K₁K₂K₃K₄ are 1011 and k₁k₂k₃k₄ respectively; or when Z₁Z₂Z₃Z₄ and K₁K₂K₃K₄ are 0010 and k₁k₂k₃k₄ respectively, Z₁Z₂Z₃Z₄ and K₁K₂K₃K₄ are 1101 and k₁k₂k₃k₄ respectively; or when Z₁Z₂Z₃Z₄ and K₁K₂K₂K₄ are 0001 and k₁k₂k₃k₄ respectively, Z₁Z₂Z₃Z₄ and K₁K₂K₃K₄ are 1110 and k₁k₂k₃k₄ respectively; or when Z₁Z₂Z₃Z₄ and K₁K₂K₂K₄ are z₁z₂z₃z₄ and 0110 respectively, Z₁Z₂Z₃Z₄ and K₁K₂K₃K₄ are z₁z₂z₃z₄ and 1001 respectively; or when Z₁Z₂Z₃Z₄ and K₁K₂K₂K₄ are z₁z₂z₃z₄ and 1100 respectively, Z₁Z₂Z₃Z₄ and K₁K₂K₃K₄ are z₁z₂z₃z₄ and 0011 respectively; or when Z₁Z₂Z₃Z₄ and K₁K₂K₂K₄ are z₁z₂z₃z₄ and 0011 respectively, Z₁Z₂Z₃Z₄ and K₁K₂K₃K₄ are z₁z₂z₃z₄ and 1100 respectively; or when Z₁Z₂Z₃Z₄ and K₁K₂K₂K₄ are z₁z₂z₃z₄ and 1000 respectively, Z₁Z₂Z₃Z₄ and K₁K₂K₃K₄ are z₁z₂z₃z₄ and 0111 respectively; or when Z₁Z₂Z₃Z₄ and K₁K₂K₂K₄ are z₁z₂z₃z₄ and 0100 respectively, Z₁Z₂Z₃Z₄ and K₁K₂K₃K₄ are z₁z₂z₃z₄ and 1011 respectively; or when Z₁Z₂Z₃Z₄ and K₁K₂K₂K₄ are z₁z₂z₃z₄ and 0010 respectively, Z₁Z₂Z₃Z₄ and K₁K₂K₃K₄ are z₁z₂z₃z₄ and 1101 respectively; or when Z₁Z₂Z₃Z₄ and K₁K₂K₂K₄ are z₁z₂z₃z₄ and 0001 respectively, Z₁Z₂Z₃Z₄ and K₁K₂K₃K₄ are z₁z₂z₃z₄ and 1110 respectively, where kᵢ is negation of kᵢ, zᵢ is negation of zᵢ, i includes 1, 2, 3, and 4, k₁k₂k₃k₄ is any one of 0111, 1011, 1101, 1110, 1100, 0011, 1001 or 0000, and Z₁Z₂Z₃Z₄ is any one of 0111, 1011, 1101, 1110, 1100, 0011, 1001 or 0000; or when the first bitmap is 0001 0000 Z₁Z₂Z₃Z₄ K₁K₂K₃K₄, the first puncturing pattern is 1110 1111 Z₁Z₂Z₃Z₄ K₁K₂K₃K₄, where when Z₁Z₂Z₃Z₄ and K₁K₂K₂K₄ are respectively 1100 and 0000, Z₁Z₂Z₃Z₄ and K₁K₂K₃K₄ are respectively 0011 and 1111, and the second puncturing pattern is a puncturing pattern corresponding to the 2*996+484-tone MRU 9; or when Z₁Z₂Z₃Z₄ and K₁K₂K₂K₄ are respectively 0011 and 0000, Z₁Z₂Z₃Z₄ and K₁K₂K₃K₄ are respectively 1100 and 1111, and the second puncturing pattern is a puncturing pattern corresponding to the 2*996+484-tone MRU 10; or when Z₁Z₂Z₃Z₄ and K₁K₂K₂K₄ are respectively 1000 and 0000, Z₁Z₂Z₃Z₄ and K₁K₂K₃K₄ are respectively 0111 and 1111, and the second puncturing pattern is a puncturing pattern corresponding to the 2*996+484-tone MRU 9; or when Z₁Z₂Z₃Z₄ and K₁K₂K₂K₄ are respectively 0100 and 0000, Z₁Z₂Z₃Z₄ and K₁K₂K₃K₄ are respectively 1011 and 1111, and the second puncturing pattern is a puncturing pattern corresponding to the 2*996+484-tone MRU 9; or when Z₁Z₂Z₃Z₄ and K₁K₂K₂K₄ are respectively 0010 and 0000, Z₁Z₂Z₃Z₄ and K₁K₂K₃K₄ are respectively 1101 and 1111, and the second puncturing pattern is a puncturing pattern corresponding to the 2*996+484-tone MRU 10; or when Z₁Z₂Z₃Z₄ and K₁K₂K₂K₄ are respectively 0001 and 0000, Z₁Z₂Z₃Z₄ and K₁K₂K₃K₄ are respectively 1110 and 1111, and the second puncturing pattern is a puncturing pattern corresponding to the 2*996+484-tone MRU 10; or when Z₁Z₂Z₃Z₄ and K₁K₂K₂K₄ are respectively 0000 and k₁k₂k₃k₄, Z₁Z₂Z₃Z₄ and K₁K₂K₃K₄ are respectively 1111 and k₁k₂k₃k₄, and the second puncturing pattern is a puncturing pattern corresponding to the 2*996+484-tone MRU 2, where kᵢ is negation of kᵢ, i includes 1, 2, 3, and 4, and k₁k₂k₃k₄ is any one of 0111, 1011, 1101, 1110, 1100, 0011, 1001 or 0000; or when the first bitmap is 0010 0000 Z₁Z₂Z₃Z₄ K₁K₂K₂K₄, the first puncturing pattern is 1101 1111 Z₁Z₂Z₃Z₄ K₁K₂K₃K₄, where when Z₁Z₂Z₃Z₄ and K₁K₂K₂K₄ are respectively 1100 and 0000, Z₁Z₂Z₃Z₄ and K₁K₂K₃K₄ are respectively 0011 and 1111, and the second puncturing pattern is a puncturing pattern corresponding to the 2*996+484-tone MRU 9; or when Z₁Z₂Z₃Z₄ and K₁K₂K₂K₄ are respectively 0011 and 0000, Z₁Z₂Z₃Z₄ and K₁K₂K₃K₄ are respectively 1100 and 1111, and the second puncturing pattern is a puncturing pattern corresponding to the 2*996+484-tone MRU 10; or when Z₁Z₂Z₃Z₄ and K₁K₂K₂K₄ are respectively 1000 and 0000, Z₁Z₂Z₃Z₄ and K₁K₂K₃K₄ are respectively 0111 and 1111, and the second puncturing pattern is a puncturing pattern corresponding to the 2*996+484-tone MRU 9; or when Z₁Z₂Z₃Z₄ and K₁K₂K₂K₄ are respectively 0100 and 0000, Z₁Z₂Z₃Z₄ and K₁K₂K₃K₄ are respectively 1011 and 1111, and the second puncturing pattern is a puncturing pattern corresponding to the 2*996+484-tone MRU 9; or when Z₁Z₂Z₃Z₄ and K₁K₂K₂K₄ are respectively 0010 and 0000, Z₁Z₂Z₃Z₄ and K₁K₂K₃K₄ are respectively 1101 and 1111, and the second puncturing pattern is a puncturing pattern corresponding to the 2*996+484-tone MRU 10; or when Z₁Z₂Z₃Z₄ and K₁K₂K₂K₄ are respectively 0001 and 0000, Z₁Z₂Z₃Z₄ and K₁K₂K₃K₄ are respectively 1110 and 1111, and the second puncturing pattern is a puncturing pattern corresponding to the 2*996+484-tone MRU 10; or when Z₁Z₂Z₃Z₄ and K₁K₂K₂K₄ are respectively 0000 and k₁k₂k₃k₄, Z₁Z₂Z₃Z₄ and K₁K₂K₃K₄ are respectively 1111 and k₁k₂k₃k₄, and the second puncturing pattern is a puncturing pattern corresponding to the 2*996+484-tone MRU 2, where kᵢ is negation of kᵢ, i includes 1, 2, 3, and 4, and k₁k₂k₃k₄ is any one of 0111, 1011, 1101, 1110, 1100, 0011, 1001 or 0000; or when the first bitmap is 0100 0000 Z₁Z₂Z₃Z₄ K₁K₂K₂K₄, the first puncturing pattern is 1011 1111 Z₁Z₂Z₃Z₄ K₁K₂K₃K₄, where when Z₁Z₂Z₃Z₄ and K₁K₂K₂K₄ are respectively 1100 and 0000, Z₁Z₂Z₃Z₄ and K₁K₂K₃K₄ are respectively 0011 and 1111, and the second puncturing pattern is a puncturing pattern corresponding to the 2*996+484-tone MRU 9; or when Z₁Z₂Z₃Z₄ and K₁K₂K₂K₄ are respectively 0011 and 0000, Z₁Z₂Z₃Z₄ and K₁K₂K₃K₄ are respectively 1100 and 1111, and the second puncturing pattern is a puncturing pattern corresponding to the 2*996+484-tone MRU 10; or when Z₁Z₂Z₃Z₄ and K₁K₂K₂K₄ are respectively 1000 and 0000, Z₁Z₂Z₃Z₄ and K₁K₂K₃K₄ are respectively 0111 and 1111, and the second puncturing pattern is a puncturing pattern corresponding to the 2*996+484-tone MRU 9; or when Z₁Z₂Z₃Z₄ and K₁K₂K₂K₄ are respectively 0100 and 0000, Z₁Z₂Z₃Z₄ and K₁K₂K₃K₄ are respectively 1011 and 1111, and the second puncturing pattern is a puncturing pattern corresponding to the 2*996+484-tone MRU 9; or when Z₁Z₂Z₃Z₄ and K₁K₂K₂K₄ are respectively 0010 and 0000, Z₁Z₂Z₃Z₄ and K₁K₂K₃K₄ are respectively 1101 and 1111, and the second puncturing pattern is a puncturing pattern corresponding to the 2*996+484-tone MRU 10; or when Z₁Z₂Z₃Z₄ and K₁K₂K₂K₄ are respectively 0001 and 0000, Z₁Z₂Z₃Z₄ and K₁K₂K₃K₄ are respectively 1110 and 1111, and the second puncturing pattern is a puncturing pattern corresponding to the 2*996+484-tone MRU 10; or when Z₁Z₂Z₃Z₄ and K₁K₂K₂K₄ are respectively 0000 and k₁k₂k₃k₄, Z₁Z₂Z₃Z₄ and K₁K₂K₃K₄ are respectively 1111 and k₁k₂k₃k₄, and the second puncturing pattern is a puncturing pattern corresponding to the 2*996+484-tone MRU 1, where kᵢ is negation of kᵢ, i includes 1, 2, 3, and 4, and k₁k₂k₃k₄ is any one of 0111, 1011, 1101, 1110, 1100, 0011, 1001 or 0000; or when the first bitmap is 1000 0000 Z₁Z₂Z₃Z₄ K₁K₂K₂K₄, the first puncturing pattern is 0111 1111 Z₁Z₂Z₃Z₄ K₁K₂K₃K₄, where when Z₁Z₂Z₃Z₄ and K₁K₂K₂K₄ are respectively 1100 and 0000, Z₁Z₂Z₃Z₄ and K₁K₂K₃K₄ are respectively 0011 and 1111, and the second puncturing pattern is a puncturing pattern corresponding to the 2*996+484-tone MRU 9; or when Z₁Z₂Z₃Z₄ and K₁K₂K₂K₄ are respectively 0011 and 0000, Z₁Z₂Z₃Z₄ and K₁K₂K₃K₄ are respectively 1100 and 1111, and the second puncturing pattern is a puncturing pattern corresponding to the 2*996+484-tone MRU 10; or when Z₁Z₂Z₃Z₄ and K₁K₂K₂K₄ are respectively 1000 and 0000, Z₁Z₂Z₃Z₄ and K₁K₂K₃K₄ are respectively 0111 and 1111, and the second puncturing pattern is a puncturing pattern corresponding to the 2*996+484-tone MRU 9; or when Z₁Z₂Z₃Z₄ and K₁K₂K₂K₄ are respectively 0100 and 0000, Z₁Z₂Z₃Z₄ and K₁K₂K₃K₄ are respectively 1011 and 1111, and the second puncturing pattern is a puncturing pattern corresponding to the 2*996+484-tone MRU 9; or when Z₁Z₂Z₃Z₄ and K₁K₂K₂K₄ are respectively 0010 and 0000, Z₁Z₂Z₃Z₄ and K₁K₂K₃K₄ are respectively 1101 and 1111, and the second puncturing pattern is a puncturing pattern corresponding to the 2*996+484-tone MRU 10; or when Z₁Z₂Z₃Z₄ and K₁K₂K₂K₄ are respectively 0001 and 0000, Z₁Z₂Z₃Z₄ and K₁K₂K₃K₄ are respectively 1110 and 1111, and the second puncturing pattern is a puncturing pattern corresponding to the 2*996+484-tone MRU 10; or when Z₁Z₂Z₃Z₄ and K₁K₂K₂K₄ are respectively 0000 and k₁k₂k₃k₄, Z₁Z₂Z₃Z₄ and K₁K₂K₃K₄ are respectively 1111 and k₁k₂k₃k₄, and the second puncturing pattern is a puncturing pattern corresponding to the 2*996+484-tone MRU 1, where kᵢ is negation of kᵢ, i includes 1, 2, 3, and 4, and k₁k₂k₃k₄ is any one of 0111, 1011, 1101, 1110, 1100, 0011, 1001 or 0000; or when the first bitmap is 0001 0000 0000 0000, the first puncturing pattern is 1110 1111 1111 1111 and the second puncturing pattern is a puncturing pattern corresponding to the 3*996+484-tone MRU 2; or when the first bitmap is 0010 0000 0000 0000, the first puncturing pattern is 1101 1111 1111 1111 and the second puncturing pattern is a puncturing pattern corresponding to the 3*996+484-tone MRU 2; or when the first bitmap is 0100 0000 0000 0000, the first puncturing pattern is 1011 1111 1111 1111 and the second puncturing pattern is a puncturing pattern corresponding to the 3*996+484-tone MRU 1; or when the first bitmap is 0100 0000 0000 0000, the first puncturing pattern is 0111 1111 1111 1111 and the second puncturing pattern is a puncturing pattern corresponding to the 3*996+484-tone MRU 1; or when the first bitmap is 0000 0000 0110 k₁k₂k₃k₄, the first puncturing pattern is 1111 1111 1001 k₁k₂k₃k₄ and the second puncturing pattern is a puncturing pattern corresponding to the 2*996-tone RU 1, where kᵢ is negation of kᵢ, i includes 1, 2, 3, and 4, and k₁k₂k₃k₄ is any one of 0111, 1011, 1101, 1110, 1100, 0011, 1001, or 0000; or when the first bitmap is 0000 0000 0011 k₁k₂k₃k₄, the first puncturing pattern is 1111 1111 1100 k₁k₂k₃k₄ and the second puncturing pattern is a puncturing pattern corresponding to the 2*996+484-tone MRU 6, where kᵢ is negation of kᵢ, i includes 1, 2, 3, and 4, and k₁k₂k₃k₄ is any one of 0111, 1011, 1101, 1110, 1100, 0011, 1001, or 0000; or when the first bitmap is 0000 0000 1100 k₁k₂k₃k₄, the first puncturing pattern is 1111 1111 0011 k₁k₂k₃k₄ and the second puncturing pattern is a puncturing pattern corresponding to the 2*996+484-tone MRU 5, where kᵢ is negation of kᵢ, i includes 1, 2, 3, and 4, and k₁k₂k₃k₄ is any one of 0111, 1011, 1101, 1110, 1100, 0011, 1001, or 0000; or when the first bitmap is 0000 0000 0001 k₁k₂k₃k₄, the first puncturing pattern is 1111 1111 1110 k₁k₂k₃k₄ and the second puncturing pattern is a puncturing pattern corresponding to the 2*996+484-tone MRU 6, where kᵢ is negation of kᵢ, i includes 1, 2, 3, and 4, and k₁k₂k₃k₄ is any one of 0111, 1011, 1101, 1110, 1100, 0011, 1001, or 0000; or when the first bitmap is 0000 0000 0010 k₁k₂k₃k₄, the first puncturing pattern is 1111 1111 1101 k₁k₂k₃k₄ and the second puncturing pattern is a puncturing pattern corresponding to the 2*996+484-tone MRU 6, where kᵢ is negation of kᵢ, i includes 1, 2, 3, and 4, and k₁k₂k₃k₄ is any one of 0111, 1011, 1101, 1110, 1100, 0011, 1001, or 0000; or when the first bitmap is 0000 0000 0100 k₁k₂k₃k₄, the first puncturing pattern is 1111 1111 1011 k₁k₂k₃k₄ and the second puncturing pattern is a puncturing pattern corresponding to the 2*996+484-tone MRU 5, where kᵢ is negation of kᵢ, i includes 1, 2, 3, and 4, and k₁k₂k₃k₄ is any one of 0111, 1011, 1101, 1110, 1100, 0011, 1001, or 0000; or when the first bitmap is 0000 0000 1000 k₁k₂k₃k₄, the first puncturing pattern is 1111 1111 0111 k₁k₂k₃k₄ and the second puncturing pattern is a puncturing pattern corresponding to the 2*996+484-tone MRU 5, where kᵢ is negation of kᵢ, i includes 1, 2, 3, and 4, and k₁k₂k₃k₄ is any one of 0111, 1011, 1101, 1110, 1100, 0011, 1001, or 0000; or when the first bitmap is 0000 0000 0001 0000, the first puncturing pattern is 1111 1111 1110 1111 and the second puncturing pattern is a puncturing pattern corresponding to the 3*996+484-tone MRU 6; or when the first bitmap is 0000 0000 0010 0000, the first puncturing pattern is 1111 1111 1101 1111 and the second puncturing pattern is a puncturing pattern corresponding to the 3*996+484-tone MRU 6; or when the first bitmap is 0000 0000 0100 0000, the first puncturing pattern is 1111 1111 1011 1111 and the second puncturing pattern is a puncturing pattern corresponding to the 3*996+484-tone MRU 5; or when the first bitmap is 0000 0000 1000 0000, the first puncturing pattern is 1111 1111 0111 1111, and the second puncturing pattern is a puncturing pattern corresponding to the 3*996+484-tone MRU 5; or when the first bitmap is 0000 0000 0000 0110, the first puncturing pattern is 1111 1111 1111 1001 and the second puncturing pattern is a puncturing pattern corresponding to the 3*996-tone MRU 4; or when the first bitmap is 0000 0000 0000 0001, the first puncturing pattern is 1111 1111 1111 1110 and the second puncturing pattern is a puncturing pattern corresponding to the 3*996+484-tone MRU 8; or when the first bitmap is 0000 0000 0000 0010, the first puncturing pattern is 1111 1111 1111 1101 and the second puncturing pattern is a puncturing pattern corresponding to the 3*996+484-tone MRU 8; or when the first bitmap is 0000 0000 0000 0100, the first puncturing pattern is 1111 1111 1111 1011 and the second puncturing pattern is a puncturing pattern corresponding to the 3*996+484-tone MRU 7; or when the first bitmap is 0000 0000 0000 1000, the first puncturing pattern is 1111 1111 1111 0111, and the second puncturing pattern is a puncturing pattern corresponding to the 3*996+484-tone MRU 7.

In this application, when the first BSS bandwidth is 320 MHz and the first BSS bandwidth is divided into a secondary 80 MHz channel, a primary 80 MHz channel, and a secondary 160 MHz channel in ascending order of frequencies in sequence, mapping relationships between the first bitmap and the first puncturing pattern and between the first bitmap and the second puncturing pattern are established, thereby improving indication flexibility of the first bitmap. Further, in a conventional technology, to indicate a puncturing pattern supported by non-OFDMA transmission, a BSS bandwidth needs to be reduced, and/or to indicate a puncturing pattern supported by OFDMA transmission, a quantity of 20 MHz channels on which OFDMA transmission is allowed needs to be reduced. In this application, after the mapping relationships are established, a BSS bandwidth can be increased to 320 MHz, and/or a quantity of 20 MHz channels on which OFDMA transmission is allowed can be increased, thereby improving throughput.

With reference to any one of the first aspect to the eighth aspect, in a possible implementation, the PPDU includes any one of an extremely high throughput multiple-user physical layer protocol data unit EHT MU PPDU, a non-high throughput duplicate physical layer protocol data unit non-HT duplicate PPDU, and an EHT TB PPDU.

In this application, for downlink transmission, the PPDU may be an EHT TB PPDU, an EHT MU PPDU, or a non-HT duplicate PPDU. For uplink transmission, the PPDU may also be an EHT TB PPDU, an EHT MU PPDU, or a non-HT duplicate PPDU.

Optionally, in a possible implementation, because selection of the primary 20 MHz channel has great impact on non-OFDMA modes allowed to be supported, in embodiments of this application, a position of a preferential primary 80 MHz may be alternatively used for non-OFDMA transmission.

According to a ninth aspect, this application provides a communication method. The method includes: A first device generates a first frame, where the first frame includes a first indication field, and the first indication field indicates a puncturing mode supported by orthogonal frequency division multiple access OFDMA transmission; and the first device sends the first frame to a second device.

In this application, the first device sends the first frame including the first indication field to the second device, so that the second device may perform OFDMA transmission based on a puncturing pattern (which may be described as a first puncturing pattern) indicated in the first indication field; or may perform mapping or derivation, based on a first bitmap included in the first indication field, to obtain a corresponding second puncturing pattern, so as to perform non-OFDMA transmission based on the second puncturing pattern. In this way, an indication of the puncturing pattern is more flexible, thereby providing higher applicability.

According to a tenth aspect, a communication apparatus is provided. The apparatus may be a first device, and includes a processing unit, configured to generate a first frame, where the first frame includes a first indication field, and the first indication field indicates a puncturing pattern supported by orthogonal frequency division multiple access OFDMA transmission; and a transceiver unit, configured to send the first frame to a second device.

With reference to the ninth aspect or the tenth aspect, in a possible implementation, the first frame includes a management frame.

With reference to the ninth aspect or the tenth aspect, in a possible implementation, the first indication field carries a first bitmap.

With reference to the ninth aspect or the tenth aspect, in a possible implementation, the first frame further includes a second indication field, and the second indication field indicates a puncturing pattern supported by non-orthogonal frequency division multiple access non-OFDMA transmission.

With reference to the ninth aspect or the tenth aspect, in a possible implementation, the second indication field carries a second bitmap.

In this application, the first frame may further include the second indication field, where the second indication field carries the second bitmap, which is used to indicate a bitmap of puncturing patterns supported by non-OFDMA transmission. For a device with a relatively weak capability, the device may read information in the second indication field only, to perform OFDMA transmission or non-OFDMA transmission based on the puncturing pattern that is indicated in the second indication field. Therefore, implementation of the device with a relatively weak capability is not affected. For a device with a relatively strong capability, the device may read both information in the first indication field and information in the second indication field, to perform OFDMA transmission based on the puncturing pattern that is indicated in the first indication field and perform non-OFDMA transmission based on the puncturing pattern that is indicated in the second indication field. In this way, on a premise of implementing more flexible bitmap indication, throughput can be improved without increasing implementation complexity.

With reference to the ninth aspect or the tenth aspect, in a possible implementation, the first frame further includes a third indication field, and the third indication field indicates whether the first indication field exists.

With reference to the ninth aspect or the tenth aspect, in a possible implementation, the first frame further includes a first bandwidth field, the first bandwidth field indicates a first basic service set BSS bandwidth, and the first BSS bandwidth is a BSS bandwidth corresponding to the first bitmap.

With reference to the ninth aspect or the tenth aspect, in a possible implementation, the first frame further includes a second bandwidth field, the second bandwidth field indicates a second BSS bandwidth, and the second BSS bandwidth is a BSS bandwidth corresponding to the second bitmap.

For beneficial effects of the ninth aspect or the tenth aspect, refer to the description of the first aspect. Details are not described herein again.

According to an eleventh aspect, a communication apparatus is provided. The apparatus may be the first device, or may be an apparatus in the first device, or an apparatus that can be used together with the first device. The communication apparatus may be alternatively a chip system. The communication apparatus may perform the method according to the first aspect, the third aspect, or the ninth aspect. Functions of the communication apparatus may be implemented by hardware, or may be implemented by hardware by executing corresponding software. The hardware or the software includes one or more units corresponding to the functions. The unit may be software and/or hardware. For operations performed by the communication apparatus and beneficial effects thereof, refer to the method and beneficial effects described in the first aspect, the third aspect, or the ninth aspect. Details are not described herein again.

According to a twelfth aspect, a communication apparatus is provided. The apparatus may be the second device, or may be an apparatus in the second device, or an apparatus that can be used together with the second device. The communication apparatus may be alternatively a chip system. The communication apparatus may perform the method according to the second aspect or the fourth aspect. Functions of the communication apparatus may be implemented by hardware, or may be implemented by hardware by executing corresponding software. The hardware or the software includes one or more units corresponding to the functions. The unit may be software and/or hardware. For operations performed by the communication apparatus and beneficial effects thereof, refer to the method and beneficial effects described in the second aspect or the fourth aspect. Details are not described herein again.

According to a thirteenth aspect, this application provides a communication apparatus, where the communication apparatus includes at least one processor and a transceiver. The processor and the transceiver enable the method performed by the first device in the method according to the first aspect, the third aspect, or the ninth aspect to be performed.

Optionally, with reference to the thirteenth aspect, in a possible implementation, the communication apparatus further includes a memory, where the memory is configured to store a computer program or instructions for implementing the method performed by the first device in the method according to the first aspect, the third aspect, or the ninth aspect.

According to a fourteenth aspect, this application provides a communication apparatus, where the communication apparatus includes at least one processor and a transceiver. The processor and the transceiver enable the method performed by the second device in the method according to the second aspect or the fourth aspect to be performed.

Optionally, with reference to the fourteenth aspect, in a possible implementation, the communication apparatus further includes a memory, where the memory is configured to store a computer program or instructions for implementing the method performed by the second device in the method according to the second aspect or the fourth aspect.

According to a fifteenth aspect, this application provides a communication apparatus, where the communication apparatus includes a processor and a memory. The memory is configured to store a computer program, and the processor is configured to perform the computer program stored in the memory, so that the communication apparatus performs the method performed by the first device in the method according to the first aspect, the third aspect, or the ninth aspect.

According to a sixteenth aspect, this application provides a communication apparatus, where the communication apparatus includes a processor and a memory. The memory is configured to store a computer program, and the processor is configured to perform the computer program stored in the memory, so that the communication apparatus performs the method performed by the second device in the method according to the second aspect or the fourth aspect.

According to a seventeenth aspect, this application provides a communication apparatus, where the communication apparatus includes a processor, a memory, and a transceiver. The transceiver is configured to receive a signal or send a signal. The memory is configured to store a computer program. The processor is configured to invoke the computer program from the memory, to perform the method performed by the first device in the method according to the first aspect, the third aspect, or the ninth aspect.

According to an eighteenth aspect, this application provides a communication apparatus, where the communication apparatus includes a processor, a memory, and a transceiver. The transceiver is configured to receive a signal or send a signal. The memory is configured to store a computer program. The processor is configured to invoke the computer program from the memory, to perform the method performed by the second device in the method according to the second aspect or the fourth aspect.

According to a nineteenth aspect, this application provides a communication apparatus, where the communication apparatus includes at least one processor and a communication interface. The communication interface is configured to receive a computer program and transmit the computer program to the processor. The processor runs the computer program to perform the method performed by the first device in the method according to the first aspect, the third aspect, or the ninth aspect.

According to a twentieth aspect, this application provides a communication apparatus, where the communication apparatus includes at least one processor and a communication interface. The processor runs a computer program to perform the method performed by the second device in the method according to the second aspect or the fourth aspect.

According to a twenty-first aspect, this application provides a computer-readable storage medium, where the computer-readable storage medium is configured to store instructions. When the instructions are executed, the method performed by the first device in the method according to the first aspect, the third aspect, or the ninth aspect is implemented.

According to a twenty-second aspect, this application provides a computer-readable storage medium, where the computer-readable storage medium is configured to store instructions. When the instructions are executed, the method performed by the second device according to the second aspect or the fourth aspect is implemented.

According to a twenty-third aspect, this application provides a computer program product including instructions. When the instructions are executed, the method performed by the first device in the method according to the first aspect, the third aspect, or the ninth aspect is implemented.

According to a twenty-fourth aspect, this application provides a computer program product including instructions. When the instructions are executed, the method performed by the second device in the second aspect or the fourth aspect is implemented.

According to a twenty-fifth aspect, this application provides an apparatus. The apparatus is implemented in a product form of a chip, and includes an input/output interface and a processing circuit. The apparatus is a chip in the first device according to the first aspect, the third aspect, or the ninth aspect. The input/output interface is configured to input data or a signal (for example, a PPDU) that is received by using an antenna and a radio frequency circuit. The input/output interface is further configured to output data or a signal (for example, a management frame), process the data or signal by using the radio frequency circuit, and send the data or signal by using the antenna. The processing circuit is configured to generate a management frame or the like.

According to a twenty-sixth aspect, this application provides an apparatus. The apparatus is implemented in a product form of a chip, and includes an input/output interface and a processing circuit. The apparatus is a chip in the second device according to the second aspect or the fourth aspect. The input/output interface is configured to input data or a signal (for example, a management frame) that is received by using an antenna and a radio frequency circuit. The input/output interface is further configured to output data or a signal (for example, a PPDU), process the data or signal by using the radio frequency circuit, and send the data or signal by using the antenna. The processing circuit is configured to generate a PPDU or the like.

### BRIEF DESCRIPTION OF THE DRAWINGS

FIG. 1 is a schematic diagram of a frame structure of an EHT MU PPDU according to an embodiment of this application;

FIG. 2 is a schematic diagram of a scenario in which a STA is scheduled, based on a trigger frame, to send an EHT TB PPDU according to an embodiment of this application;

FIG. 3A and FIG. 3B are a schematic diagram of a frame structure of a trigger frame according to an embodiment of this application;

FIG. 4 is a schematic diagram of a frame structure of an EHT TB PPDU according to an embodiment of this application;

FIG. 5 is a schematic diagram of channel allocation for a bandwidth of 320 MHz according to an embodiment of this application;

FIG. 6 is a schematic diagram of non-OFDMA punctured transmission of an EHT MU PPDU according to an embodiment of this application;

FIG. 7 is a schematic diagram of OFDMA punctured transmission of an EHT MU PPDU according to an embodiment of this application;

FIG. 8 is a schematic diagram of division of channels with a bandwidth of 80/160/320 MHz in a 6 GHz frequency band according to an embodiment of this application;

FIG. 9 is a schematic diagram of non-OFDMA punctured transmission of an EHT TB PPDU according to an embodiment of this application;

FIG. 10 is a schematic diagram of OFDMA punctured transmission of an EHT TB PPDU according to an embodiment of this application;

FIG. 11 is a schematic diagram of a system architecture according to an embodiment of this application;

FIG. 12 is a schematic flowchart of a communication method according to an embodiment of this application;

FIG. 13 is a schematic diagram of a primary 80 MHz channel according to an embodiment of this application;

FIG. 14 is another schematic diagram of a primary 80 MHz channel according to an embodiment of this application;

FIG. 15 is still another schematic diagram of a primary 80 MHz channel according to an embodiment of this application;

FIG. 16 is yet another schematic diagram of a primary 80 MHz channel according to an embodiment of this application;

FIG. 17 is still yet another schematic diagram of a primary 80 MHz channel according to an embodiment of this application;

FIG. 18 is a further schematic diagram of a primary 80 MHz channel according to an embodiment of this application;

FIG. 19 is a schematic diagram of a primary 20 MHz channel according to an embodiment of this application;

FIG. 20 is another schematic flowchart of a communication method according to an embodiment of this application;

FIG. 21 is still another schematic flowchart of a communication method according to an embodiment of this application;

FIG. 22 is a schematic diagram of a structure of a first frame according to an embodiment of this application;

FIG. 23 is a schematic diagram of a structure of a communication apparatus according to an embodiment of this application; and

FIG. 24 is a schematic diagram of a structure of another communication apparatus according to an embodiment of this application.

### DETAILED DESCRIPTION OF ILLUSTRATIVE EMBODIMENTS

The following clearly and completely describes the technical solutions in embodiments of this application with reference to the accompanying drawings in embodiments of this application.

In descriptions of this application, unless otherwise specified, “/” means “or”. For example, A/B may represent A or B. The term “and/or” in embodiments of this application describes only an association relationship for describing associated objects and represents that three relationships may exist. For example, A and/or B may represent the following three cases: Only A exists, both A and B exist, and only B exists. In addition, “at least one” means one or more, and “a plurality of” means two or more. Terms such as “first” and “second” do not limit a quantity and an execution sequence, and the terms such as “first” and “second” do not indicate a definite difference.

In this application, the word such as “example” or “for example” is used to represent giving an example, an illustration, or a description. Any embodiment or design scheme described as “an example” or “for example” in this application should not be construed as being more preferable or advantageous than other embodiments or design schemes. Exactly, use of the word “example”, “for example”, or the like is intended to present a related concept in a specific manner.

For ease of understanding related content of embodiments of this application, the following describes some knowledge required in the solutions of this application.

1. Extremely High Throughput Multiple-User Physical Layer Protocol Data Unit (Extremely High Throughput Multiple-User Physical Layer Protocol Data Unit, EHT MU PPDU)

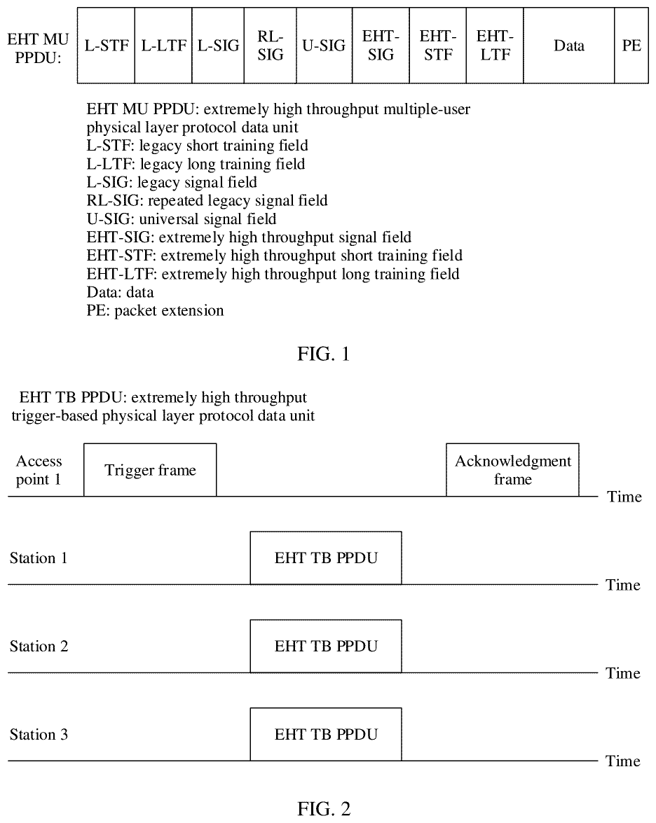

A wireless local area network (Wireless Local Area Network, WLAN) starts from 802.11a/b/g, and has undergone 802.11n, 802.11ac, 802.11ax, and 802.11be that is currently under discussion. The 802.11be standard defines two EHT PPDU formats: EHT MU PPDU and EHT TB PPDU, where EHT is a standard name of 802.11be, MU indicates multiple users, and the EHT MU PPDU can support data transmission for a single user (in the downlink or uplink) and for multiple users (in the downlink). For example, refer to FIG. 1. FIG. 1 is a schematic diagram of a frame structure of an EHT MU PPDU according to an embodiment of this application. As shown in FIG. 1, the EHT MU PPDU includes a legacy short training field (legacy short training field, L-STF), a legacy long training field (legacy long training field, L-LTF), a legacy signal field (legacy signal field, L-SIG), a repeated legacy signal field (repeated L-SIG, RL-SIG), a universal signal field (universal SIG, U-SIG), an extremely high throughput signal field (extremely high throughput signal field, EHT-SIG), an extremely high throughput short training field (extremely high throughput short training field, EHT-STF), an extremely high throughput long training field (extremely high throughput long training field, EHT-LTF), a data (Data) field, and a packet extension (packet extension, PE) field. For meanings and functions of the fields, refer to Table 1 below.

TABLE 1
Meanings of fields in the EHT MU PPDU

| Acronyms or | | | |
|---|---|---|---|
| abbreviations | Full name | Description | Function |
| L-STF | Legacy Short Training | Legacy short | This field is used to perform |
| | Field | training field | PPDU discovery, coarse |
| | | | synchronization, and |
| | | | automatic gain control. |
| L-LTF | Legacy Long Training | Legacy long training | This field is used to perform |
| | Field | field | fine synchronization and |
| | | | channel estimation. |
| L-SIG | Legacy Signal Field | Legacy signal field | This field is used to carry |
| | | | signaling information |
| | | | related to a PPDU length, so |
| | | | as to ensure coexistence. |
| RL-SIG | Repeated L-SIG | Repeated legacy | This field is used to carry |
| | | signal field | signaling information |
| | | | related to a PPDU length, so |
| | | | as to ensure coexistence. |
| U-SIG | Universal SIG | Universal signal | This field is similar to HE- |
| | | field | SIG-A. A difference is that a |
| | | | universal signal field is used |
| | | | in an EHT PPDU and |
| | | | subsequent standards. |
| | | | Therefore, this field is |
| | | | referred to as a universal |
| | | | signal field. |
| EHT-SIG | Extremely High | Extremely high | This field is used to carry |
| | Throughput Signal | throughput signal | signaling used to |
| | Field | field | demodulate subsequent |
| | | | data, and mainly includes |
| | | | resource unit indication |
| | | | information of one or more |
| | | | target users. |
| EHT-STF | Extremely High | Extremely high | This field is used to perform |
| | Throughput Short | throughput short | automatic gain control of a |
| | Training Field | training field | subsequent field. |
| EHT-LTF | Extremely High | Extremely high | This field is used to perform |
| | Throughput Long | throughput long | channel estimation. |
| | Training Field | training field | |
| Data | | Data | This field is used to carry |
| | | | data information. |
| PE | Packet Extension | Packet extension | This field is used to increase |
| | | | the processing time of a |
| | | | receiver. |

In this application, “field (field)” may also be referred to as “field”, “information”, or the like, and “subfield (subfield)” may be referred to as “subfield”, “information”, or the like. This is not limited herein.

2. Extremely High Throughput Trigger-Based Physical Layer Protocol Data Unit (Extremely High Throughput Trigger-Based Physical Layer Protocol Data Unit, EHT TB PPDU)

An EHT TB PPDU is another format of an EHT PPDU sent, by one or more stations (station, STA), based on triggering by a trigger frame (trigger frame, TF) that is sent by an access point (access point, AP).

Refer to FIG. 2. FIG. 2 is a schematic diagram of a scenario in which a STA is scheduled, based on a trigger frame, to send an EHT TB PPDU according to an embodiment of this application. As shown in FIG. 2, the communication system includes an access point 1, a station 1, a station 2, and a station 3. A procedure in which the access point 1 schedules, based on the trigger frame, the station 1, the station 2, and the station 3 to send the EHT TB PPDU is as follows.

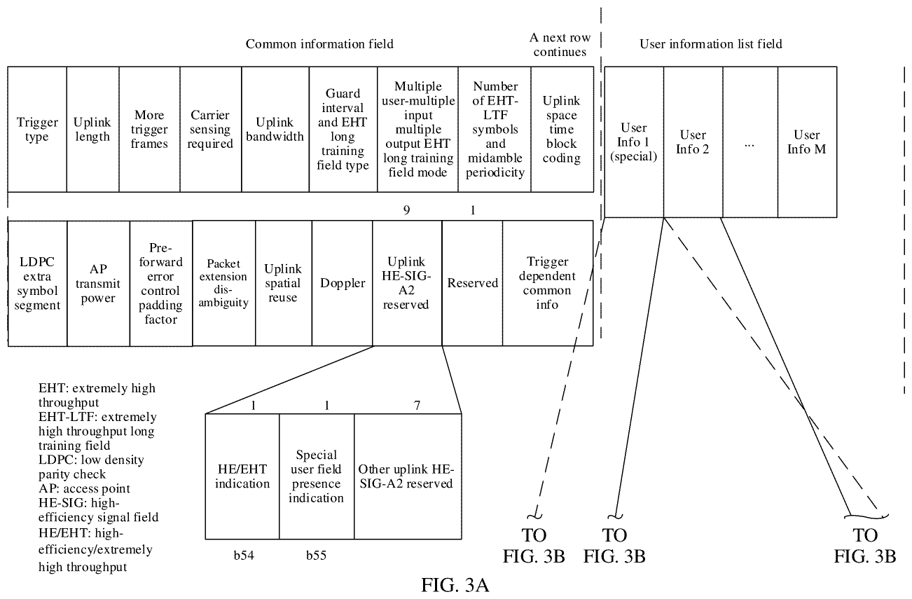

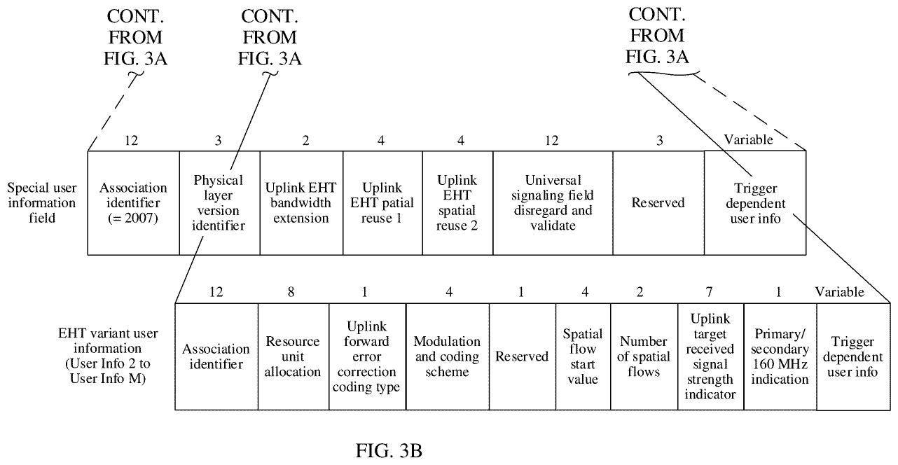

Step 1: The access point 1 first sends a trigger frame, where the trigger frame includes resource unit allocation information and another parameter that are used by one or more STAs (the station 1, the station 2, and the station 3 shown in FIG. 2) to send an EHT TB PPDU. For example, refer to FIG. 3A and FIG. 3B. FIG. 3A and FIG. 3B show a schematic diagram of a frame structure of a trigger frame according to an embodiment of this application. As shown in FIG. 3A and FIG. 3B, the trigger frame includes a common information field and a user information list field. The common information field includes a trigger frame type (trigger type) subfield, an uplink length (uplink length, UL length) subfield, a more trigger frames (more TF) subfield, a carrier sensing required (carrier sensing required, CS required) subfield, an uplink bandwidth (UL (HE) bandwidth) subfield, a guard interval and EHT-LTF long training field type (guard interval and EHT-LTF type) subfield, a multiple user-multiple input multiple output EHT long training field mode (multiple user-multiple input multiple output EHT-LTF mode, MU-MIMOEHT-LTF mode) subfield, a Number of EHT-LTF symbols and midamble periodicity (number of EHT-LTF symbols and midamble periodicity) subfield, an uplink space time block coding (uplink space time block coding, UL STBC) subfield, a low density parity check extra symbol segment (low density parity check extra symbol segment, LDPC extra symbol segment) subfield, an access point transmit power (access point transmit power, AP Tx power) subfield, a pre-forward error control padding factor (pre-forward error control padding factor) subfield, a packet extension disambiguity (PE disambiguity) subfield, an uplink spatial reuse (UL spatial reuse) subfield, a Doppler (Doppler) subfield, an uplink he-sig-a2 reserved (UL-HE-SIG-A2 reserved) subfield, a reserved (reserved) subfield, and a trigger dependent common information (trigger dependent common info) subfield. The uplink HE-SIG-A2 reserved subfield includes an HE/EHT indication subfield, a special user field presence indication subfield, and an Other uplink HE-SIG-A2 reserved (Other UL HE-SIG-A2 Reserved) subfield. The user information list field includes a special user information (User Info (special)) field (for example, user information related to a STA 1 may be carried in the special user information field) and an EHT variant user information (namely, user information User Info 2 to User Info M) field. For example, user information related to a STA M may be carried in a User Info M field. The special user information field includes an association identifier (AID12) subfield, a physical layer version identifier (PHY Version ID) subfield, an uplink EHT bandwidth extension (UL EHT BW Extension) subfield, an uplink EHT Spatial Reuse 1 (UL EHT Spatial Reuse 1) subfield, an uplink EHT Spatial Reuse 2 (UL EHT Spatial Reuse 2) subfield, a universal signal field Disregard and Validate (U-SIG Disregard and Validate) subfield, a reserved (reserved) subfield, and a trigger dependent user information (trigger dependent user info) subfield. The EHT variant user information field includes an association identifier (AID12) subfield, a resource unit allocation (RU allocation) subfield, an uplink forward error correction coding type (UL FEC Coding Type) subfield, a modulation and coding scheme (UL EHT-MCS) subfield, a reserved (reserved) subfield, a spatial flow start value subfield, a Number of spatial flows subfield, an uplink target received signal strength indicator (UL Target RSSI) subfield, a primary/secondary 160 MHz indication (PS160) subfield, and a trigger dependent user information (trigger dependent user info) subfield.

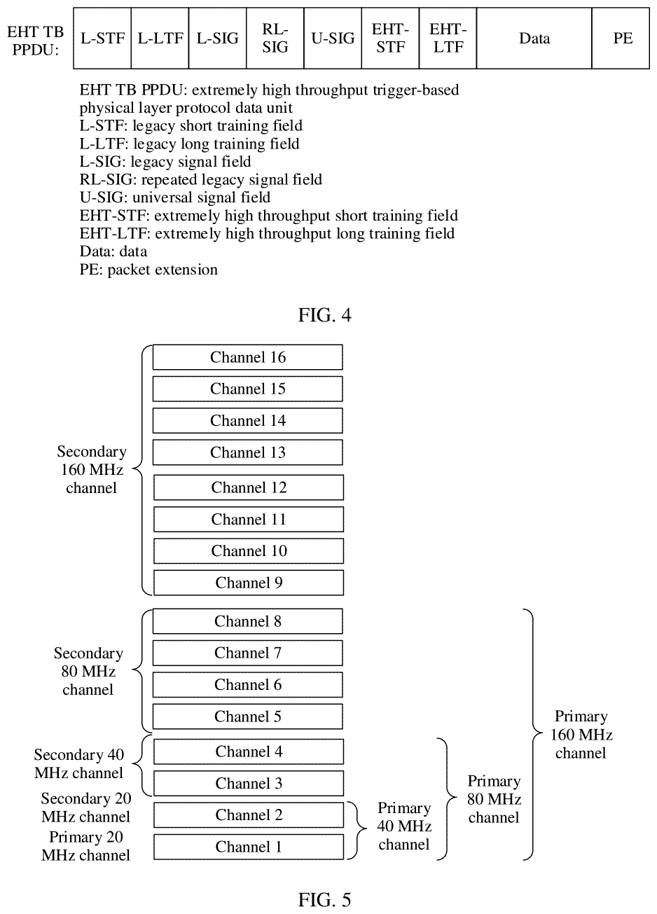

Step 2: After receiving the trigger frame, a station (the station 1, the station 2, or the station 3 shown in FIG. 2, each of which is described as a station below for ease of description) parses the trigger frame to obtain a user information field that matches an association identifier of the station, and then sends an EHT TB PPDU on a resource unit that is indicated by a resource unit allocation subfield in the user information field. For example, refer to FIG. 4. FIG. 4 is a schematic diagram of a frame structure of an EHT TB PPDU according to an embodiment of this application. As shown in FIG. 4, the EHT TB PPDU includes a legacy short training field (legacy short training field, L-STF), a legacy long training field (legacy long training field, L-LTF), a legacy signal field (legacy signal field, L-SIG), a repeated legacy signal field (repeated L-SIG, RL-SIG), a universal signal field (universal SIG, U-SIG), an extremely high throughput short training field (extremely high throughput short training field, EHT-STF), an extremely high throughput long training field (extremely high throughput long training field, EHT-LTF), a data (Data) field, and a packet extension (packet extension, PE) field. The EHT TB PPDU does not include an EHT-SIG field. This is because scheduling information of the EHT TB PPDU is sent by the access point 1 to the station. Therefore, the station does not need to add the scheduling information to the EHT TB PPDU to notify the access point 1.

Step 3: After receiving the EHT TB PPDU sent by the station, the access point 1 sends an acknowledgment frame to the station.

3. WLAN Bandwidth Configuration

The 802.11 standard usually uses 20 MHz as a basic bandwidth, and each supported bandwidth is an exponential integer multiple (for example, 20 MHz, 40 MHz, 80 MHz, 160 MHz, or 320 MHz) of 20 MHz. For channel allocation, refer to FIG. 5. FIG. 5 is a schematic diagram of channel allocation for a bandwidth of 320 MHz according to an embodiment of this application. As shown in FIG. 5, channels may be numbered in ascending order of absolute frequencies as a channel 1 to a channel 16. An entire channel is divided into a primary 20 MHz channel (Primary 20 MHz, P20), a secondary 20 MHz channel (Secondary 20 MHz, S20), a secondary 40 MHz channel (Secondary 40 MHz, S40), a secondary 80 MHz (Secondary 80 MHz, S80) channel, and a secondary 160 MHz channel (Secondary 160 MHz, S160). In this application, the primary 20 MHz channel may also be referred to as a primary channel for short. The primary channel is determined by an AP on its own, and may be any 20 MHz sub-channel. A 40 MHz channel that includes a P20 channel is referred to as a P40 channel. An 80 MHz channel that includes a P20 channel is referred to as a P80 channel. A 160 MHz channel that includes a P20 channel is referred to as a P160 channel. In embodiments of this application, alternatively, a primary 20 MHz channel may be described as primary 20 MHz, a primary 40 MHz channel may be described as primary 40 MHz, a primary 80 MHz channel may be described as primary 80 MHz, a primary 160 MHz channel may be described as primary 160 MHz, a secondary 80 MHz channel may be described as secondary 80 MHz, and a secondary 160 MHz channel may be described as secondary 160 MHz.

4. Resource Unit (Resource Unit, RU) and Multiple Resource Unit (Multiple Resource Unit, MRU)

User frequency band resources are not allocated in a unit of a 20 MHz channel, but in a unit of a resource unit (resource unit, RU) or a multiple resource unit (multiple resource unit, MRU). The RU may be in a form of a 26-tone RU, 52-tone RU, 106-tone RU, 242-tone RU, 484-tone RU, 996-tone RU, or the like, where the tone represents a subcarrier. The MRU may be in a form of a 484+242-tone MRU, 996+484+242-tone MRU, 996+484-tone MRU, 3*996+484-tone MRU, 2*996+484-tone MRU, or the like.

5. Non-Orthogonal Frequency Division Multiple Access (None-Orthogonal Frequency Division Multiple Access, Non-OFDMA) Transmission and Orthogonal Frequency Division Multiple Access (Orthogonal Frequency Division Multiple Access, OFDMA) Transmission

There are two transmission modes for both an EHT MU PPDU and an EHT TB PPDU: non-orthogonal frequency division multiple access non-OFDMA (none-orthogonal frequency division multiple access, non-OFDMA) transmission and orthogonal frequency division multiple access (orthogonal frequency division multiple access, OFDMA) transmission. The OFDMA transmission is a multiple-user communication mechanism, and is applicable to data frame exchange between an access point (access point, AP) and a non-access point station (non-access point station, non-AP STA, which is usually described as a STA) in the 802.11ax standard and a later standard, where an entire transmission bandwidth is divided into a plurality of RUs or MRUs, and the RUs or MRUs are separately allocated to different users. In the non-OFDMA transmission (which may be alternatively described as non-OFDMA transmission), an entire transmission bandwidth includes only one RU or MRU, which is used as a whole for single-user (single user, SU) or multiple user-multiple input multiple output (multiple user-multiple input multiple output, MU-MIMO) transmission. For the non-OFDMA transmission, after preamble puncturing is performed, a remaining non-punctured part forms an MRU.

The following separately describes non-OFDMA transmission and OFDMA transmission of an EHT MU PPDU, and non-OFDMA transmission and OFDMA transmission of an EHT TB PPDU.

6. Non-OFDMA Transmission of an EHT MU PPDU

When transmission cannot be performed on some 20 MHz sub-channels, if an AP or a STA performs transmission by using an EHT MU PPDU, the transmission is performed by using preamble puncturing (preamble puncture) and no any signal is transmitted on these 20 MHz sub-channels. There are two transmission modes for an EHT MU PPDU: non-OFDMA transmission and OFDMA transmission. For non-OFDMA transmission, there is only one resource unit (resource unit, RU) or one multiple resource unit (multiple resource unit, MRU) within a non-puncturing range of an entire PPDU bandwidth; and the RU or MRU is allocated as a whole to one user or to a group of users. Puncturing patterns for non-OFDMA transmission of an EHT MU PPDU are shown in Table 2 below. A puncturing pattern may be indicated based on a punctured channel information field (bits B3 to B7) of a second symbol in a U-SIG field, and a PPDU bandwidth may be indicated based on a PPDU bandwidth indication field (bits B3 to B5) of a first symbol in the U-SIG field. Generally, the puncturing pattern varies according to different PPDU bandwidths.

TABLE 2
5-bit punctured channel indication in an EHT MU PPDU in a case of
non-OFDMA transmission

| | | Puncturing pattern | |
|---|---|---|---|
| | | Puncturing pattern | |
| PPDU bandwidth | Case | (RU or MRU index) | Field value |
| PPDU bandwidth | Cases | (RU or MRU index) | Field value |
| 20 MHz | No puncturing | [1 1 1 1] | 0 |
| | | (242-tone RU 1) | |
| 40 MHZ | No puncturing | [1 1 1 1] | 0 |
| | | (484-tone RU 1) | |
| 80 MHz | No puncturing | [1 1 1 1] | 0 |
| | | (996-tone RU 1) | |
| | 20 MHz puncturing | [x 1 1 1] | 1 |
| | | (484 + 242-tone MRU 1) | |
| | | [1 x 1 1] | 2 |
| | | (484 + 242-tone MRU 2) | |
| | | [1 1 x 1] | 3 |
| | | (484 + 242-tone MRU 3) | |
| | | [1 1 1 x] | 4 |
| | | (484 + 242-tone MRU 4) | |
| 160 MHz | No puncturing | [1 1 1 1 1 1 1 1] | 0 |
| | | (2 * 996-tone RU 1) | |
| | 20 MHz puncturing | [x 1 1 1 1 1 1 1] | 1 |
| | | (996 + 484 + 242-tone MRU 1) | |
| | | [1 x 1 1 1 1 1 1] | 2 |
| | | (996 + 484 + 242-tone MRU 2) | |
| | | [1 1 x 1 1 1 1 1] | 3 |
| | | (996 + 484 + 242-tone MRU 3) | |
| | | [1 1 1 x 1 1 1 1] | 4 |
| | | (996 + 484 + 242-tone MRU 4) | |
| | | [1 1 1 1 x 1 1 1] | 5 |
| | | (996 + 484 + 242-tone MRU 5) | |
| | | [1 1 1 1 1 x 1 1] | 6 |
| | | (996 + 484 + 242-tone MRU 6) | |
| | | [1 1 1 1 1 1 x 1] | 7 |
| | | (996 + 484 + 242-tone MRU 7) | |
| | | [1 1 1 1 1 1 1 x] | 8 |
| | | (996 + 484 + 242-tone MRU 8) | |
| | 40 MHz puncturing | [x x 1 1 1 1 1 1] | 9 |
| | | (996 + 484-tone MRU 1) | |
| | | [1 1 x x 1 1 1 1] | 10 |
| | | (996 + 484-tone MRU 2) | |
| | | [1 1 1 1 x x 1 1] | 11 |
| | | (996 + 484-tone MRU 3) | |
| | | [1 1 1 1 1 1 x x] | 12 |
| | | (996 + 484-tone MRU 4) | |
| 320 MHz | No puncturing | [1 1 1 1 1 1 1 1] | 0 |
| | | (4 * 996-tone RU 1) | |
| | 40 MHz puncturing | [x 1 1 1 1 1 1 1] | 1 |
| | | (3 × 996 + 484-tone MRU 1) | |
| | | [1 x 1 1 1 1 1 1] | 2 |
| | | (3 * 996 + 484-tone MRU 2) | |
| | | [1 1 x 1 1 1 1 1] | 3 |
| | | (3 * 996 + 484-tone MRU 3) | |
| | | [1 1 1 x 1 1 1 1] | 4 |
| | | (3 * 996 + 484-tone MRU 4) | |
| | | [1 1 1 1 x 1 1 1] | 5 |
| | | (3 * 996 + 484-tone MRU 5) | |
| | | [1 1 1 1 1 x 1 1] | 6 |
| | | (3 * 996 + 484-tone MRU 6) | |
| | | [1 1 1 1 1 1 x 1] | 7 |
| | | (3 * 996 + 484-tone MRU 7) | |
| | | [1 1 1 1 1 1 1 x] | 8 |
| | | (3 * 996 + 484-tone MRU 8) | |
| | 80 MHz puncturing | [x x 1 1 1 1 1 1] | 9 |
| | | (3 * 996-tone MRU 1) | |
| | | [1 1 x x 1 1 1 1] | 10 |
| | | (3 * 996-tone MRU 2) | |
| | | [1 1 1 1 x x 1 1] | 11 |
| | | (3 * 996-tone MRU 3) | |
| | | [1 1 1 1 1 1 x x] | 12 |
| | | (3 * 996-tone MRU 4) | |
| | 320-80-40 | [x x x 1 1 1 1 1] | 13 |
| | | (2 * 996 + 484-tone MRU 7) | |
| | | [x x 1 x 1 1 1 1] | 14 |
| | | (2 * 996 + 484-tone MRU 8) | |
| | | [x x 1 1 x 1 1 1] | 15 |
| | | (2 * 996 + 484-tone MRU 9) | |
| | | [x x 1 1 1 x 1 1] | 16 |
| | | (2 * 996 + 484-tone MRU 10) | |
| | | [x x 1 1 1 1 x 1] | 17 |
| | | (2 * 996 + 484-tone MRU 11) | |
| | | [x x 1 1 1 1 1 x] | 18 |
| | | (2 * 996 + 484-tone MRU 12) | |
| | | [x 1 1 1 1 1 x x] | 19 |
| | | (2 * 996 + 484-tone MRU 1) | |
| | | [1 x 1 1 1 1 x x] | 20 |
| | | (2 * 996 + 484-tone MRU 2) | |
| | | [1 1 x 1 1 1 x x] | 21 |
| | | (2 * 996 + 484-tone MRU 3) | |
| | | [1 1 1 x 1 1 x x] | 22 |
| | | (2 * 996 + 484-tone MRU 4) | |
| | | [1 1 1 1 x 1 x x] | 23 |
| | | (2 * 996 + 484-tone MRU 5) | |
| | | [1 1 1 1 1 x x x] | 24 |
| | | (2 * 996 + 484-tone MRU 6) | |

In Table 2, one “i” in the third column (namely, a puncturing pattern) represents one non-punctured sub-channel, and one “x” represents one punctured sub-channel. It can be understood that, in Table 2, “x” in a puncturing pattern in the third column may be alternatively represented as “0”, that is, one “0” represents one punctured sub-channel. For an 80 MHz PPDU and a 160 MHz PPDU, a puncturing granularity is 20 MHz (that is, each “i” or “x” (or 0) represents a 20 MHz sub-channel). For a 320 MHz PPDU, a puncturing granularity is 40 MHz (that is, each “i” or “x” (or 0) represents a 40 MHz sub-channel). In Table 2, frequencies are in ascending order from left to right.

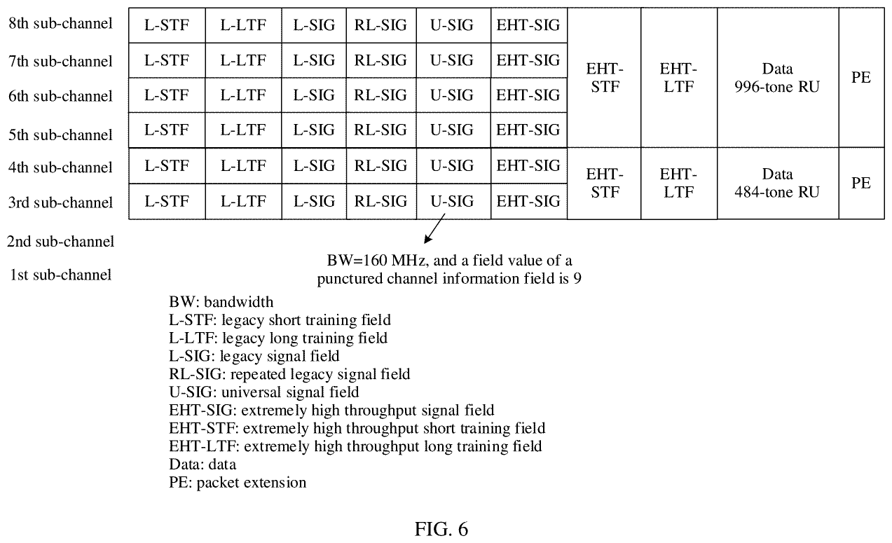

For example, refer to FIG. 6. FIG. 6 is a schematic diagram of non-OFDMA punctured transmission of an EHT MU PPDU according to an embodiment of this application. As shown in FIG. 6, when non-OFDMA transmission is used for an EHT MU PPDU with a bandwidth of 160 MHz in which a 40 MHz channel with a lowest frequency is punctured, a value of a PPDU bandwidth indication field in a U-SIG field of the EHT MU PPDU is 160 MHz, and a field value of a punctured channel information field is 9 (where the field value 9 corresponds to the puncturing pattern [x x 1 1 1 1 1 1] in Table 2). Fields from L-STF to EHT-SIG are referred to as a non-EHT modulation preamble, and are transmitted in a unit of 20 MHz. Fields EHT-STF, EHT-LTF, Data, and PE are transmitted in a unit of an RU or an MRU. In FIG. 6, a 996+484-tone MRU (which is an MRU formed by a 484-tone RU and a 996-tone RU) is allocated to one user for non-MU-MIMO transmission, or to a plurality of users for MU-MIMO transmission.

7. OFDMA Transmission of an EHT MU PPDU

For OFDMA transmission, more than one RU or MRU exists in a non-punctured part of an entire bandwidth, and the more than one RU or MRU is allocated to different users. When a PPDU bandwidth is greater than or equal to 80 MHz, for downlink OFDMA transmission, first four bits (bits B3 to B6 of a second symbol in a U-SIG field) in a 5-bit punctured channel indication field indicate which 20 MHz sub-channels are punctured in an 80 MHz sub-block (Subblock) that is associated with the PPDU bandwidth. Bits B3 to B6 correspond to frequencies from a lowest frequency to a highest frequency, where 0 indicates that a corresponding 20 MHz sub-channel is punctured, and 1 indicates that a corresponding 20 MHz sub-channel is not punctured. For OFDMA transmission of an EHT MU PPDU, puncturing patterns supported by an 80 MHz sub-block include 0000, 1111, 0111, 1011, 1101, 1110, 0011, 1100 and 1001, where 0000 indicates that an 80 MHz sub-block is totally punctured, there is no U-SIG field in the 80 MHz sub-block, and there is no corresponding puncturing indication; and 1111 indicates that an 80 MHz sub-block is not punctured. In addition, if the PPDU bandwidth is 20 MHz or 40 MHz, values of B3 to B6 are all 1, indicating that there is no puncturing.

When the PPDU bandwidth is greater than 80 MHz, one PPDU bandwidth includes more than one 80 MHz sub-block. Content of a U-SIG field in each 80 MHz sub-block may be different. For example, B3 to B6 of a second symbol in the U-SIG field in each 80 MHz sub-block indicate a puncturing status corresponding to the 80 MHz sub-block. Then a puncturing status of each 80 MHz sub-block may vary.

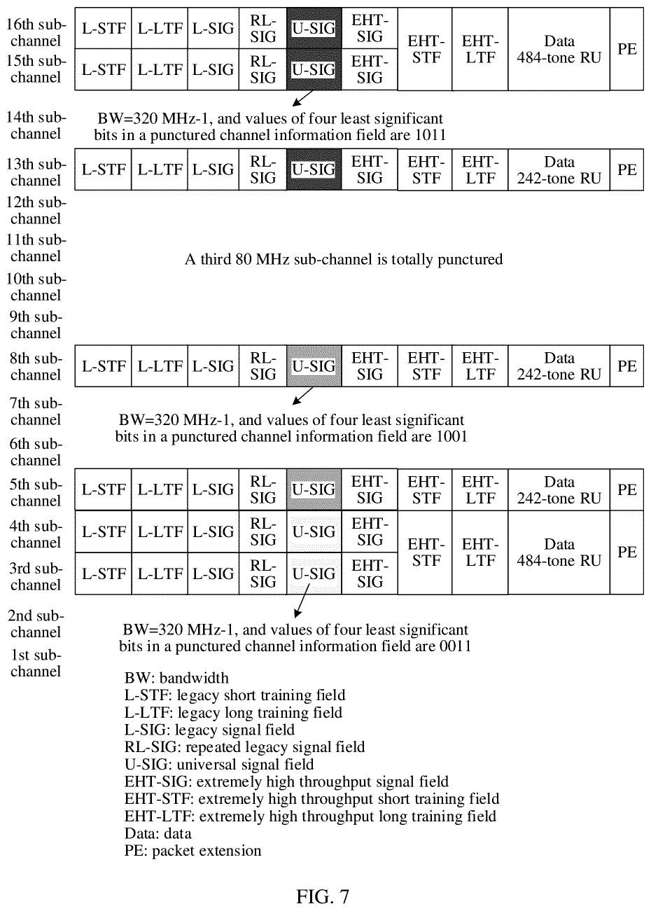

For example, refer to FIG. 7. FIG. 7 is a schematic diagram of OFDMA punctured transmission of an EHT MU PPDU according to an embodiment of this application. As shown in FIG. 7, when OFDMA transmission is used for an EHT MU PPDU with a bandwidth of 320 MHz in which 1^{st}, 2^{nd}, 6^{th}, 7^{th}, 9^{th}, 10^{th}, 11^{th}, 12^{th} and 14^{th} 20 MHz sub-channels in ascending order of frequencies are punctured, values of PPDU bandwidth indication fields in U-SIG fields included in EHT MU PPDUs that are carried on non-punctured 20 MHz sub-channels are all 320 MHz-1; and, in ascending order of frequencies, values of four least significant bits in punctured channel information fields of non-punctured 20 MHz sub-channels in a first 80 MHz sub-block (namely, 80 MHz corresponding to a channel 1 to a channel 4 in FIG. 7) are all 0011, and values of four least significant bits in punctured channel information fields of non-punctured 20 MHz sub-channels in a second 80 MHz sub-block (namely, 80 MHz corresponding to a channel 5 to a channel 8 in FIG. 7) are all 1001. A third 80 MHz sub-block (namely, 80 MHz corresponding to a channel 9 to a channel 12 in FIG. 7) is totally punctured. Therefore, there is no U-SIG field in the third 80 MHz sub-block. Values of four least significant bits in punctured channel information fields of non-punctured 20 MHz sub-channels in a fourth 80 MHz sub-block (namely, 80 MHz corresponding to a channel 13 to a channel 16 in FIG. 7) are all 1011. It is easy to learn that content of U-SIG fields may vary according to different 80 MHz sub-blocks; and U-SIG fields of different 20 MHz sub-channels in an 80 MHz sub-block have same content. In FIG. 7, in ascending order of frequencies, a first 484-tone RU is allocated to a user 1, next two 242-tone RUs are respectively allocated to a user 2 and a user 3, and a last 484+242-tone MRU (which is an MRU formed by a 242-tone RU and a 484-tone RU) is allocated to a user 4.

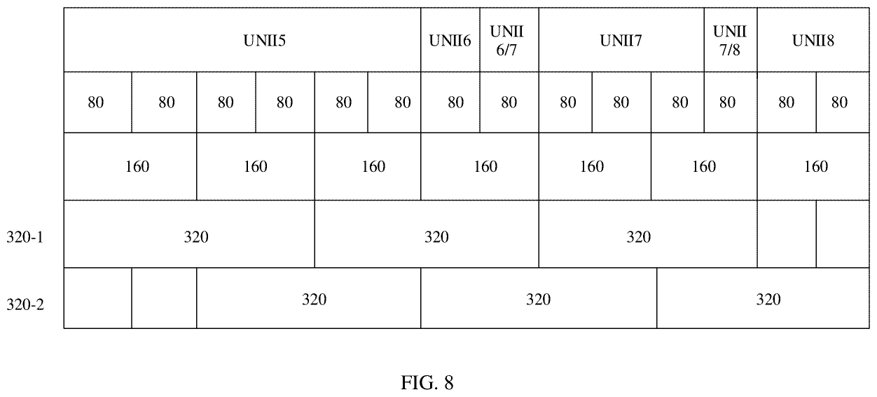

It can be understood that two types of 320 MHz channels have been designed for effective channel utilization, and are respectively: 320 MHz-1 whose center frequency is 31/95/159 MHz and 320 MHz-2 whose center frequency is 63/127/191 MHz. For example, refer to FIG. 8. FIG. 8 is a schematic diagram of division of channels with a bandwidth of 80/160/320 MHz in a frequency band of 6 GHz according to an embodiment of this application. As shown in FIG. 8, when a 320 MHz channel division manner is 320-1, a first 320 MHz channel includes a first 160 MHz channel and a second 160 MHz channel; a second 320 MHz channel includes a third 160 MHz channel and a fourth 160 MHz channel; and a third 320 MHz channel includes a fifth 160 MHz channel and a sixth 160 MHz channel; or when the 320 MHz channel division manner is 320-2, a first 320 MHz channel includes a second 160 MHz channel and a third 160 MHz channel; a second 320 MHz channel includes a fourth 160 MHz channel and a fifth 160 MHz channel; and a third 320 MHz channel includes a sixth 160 MHz channel and a seventh 160 MHz channel. In FIG. 8, UNII represents the Unlicensed National Information Infrastructure radio band (the Unlicensed National Information Infrastructure radio band).

8. Non-OFDMA Transmission of an EHT TB PPDU

When a STA performs, based on a resource unit allocation sub-field in a trigger frame, transmission on a corresponding resource unit, the STA sends a preamble only on a 20 MHz sub-channel on which the resource unit of the STA is located. If an AP does not schedule any STA to transmit an EHT TB PPDU on a sub-channel that needs to be punctured, the corresponding 20 MHz sub-channel is punctured by default.

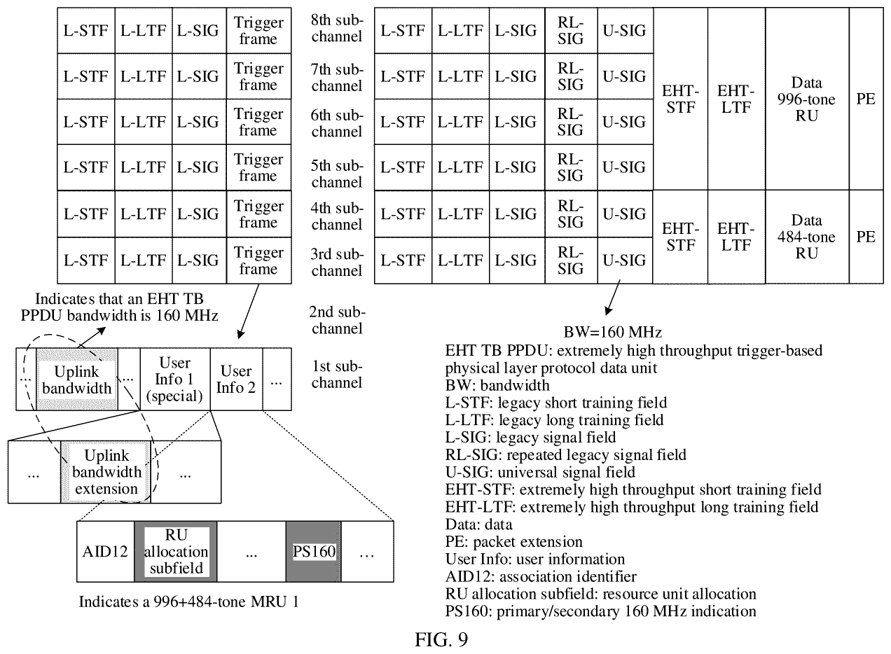

For example, refer to FIG. 9. FIG. 9 is a schematic diagram of non-OFDMA punctured transmission of an EHT TB PPDU according to an embodiment of this application. As shown in FIG. 9, an AP uses an uplink bandwidth field and an uplink bandwidth extension field together in a trigger frame, to indicate that a scheduled EHT TB PPDU bandwidth is 160 MHz. An RU allocation subfield and PS160 in a user information field 2 (namely, User Info 2) are used together to indicate that a resource unit allocated to a user 1 is a 996+484-tone MRU 1 (where the last “i” is an index of a plurality of RUs or MRUs having a same size, and uniquely corresponds to a specific type of RUs or MRUs), and then the user 1 performs transmission of an EHT TB PPDU on the 996+484-tone MRU 1. Preamble puncturing information does not need to be separately indicated in the trigger frame. Correspondingly, a puncturing information indication is not needed in a U-SIG field. Transmission of the trigger frame in FIG. 9 is performed by using a non-high throughput duplicate physical layer protocol data unit (non-HT duplicate PPDU), where the trigger frame is located in a Data field of the non-HT duplicate PPDU, and is transmitted in a duplicated (repetitive) manner in a unit of 20 MHz on a non-punctured 20 MHz sub-channel. Optionally, the transmission of the trigger frame may be alternatively performed by using another PPDU format. This is not limited in this application.

9. OFDMA Transmission of an EHT TB PPDU

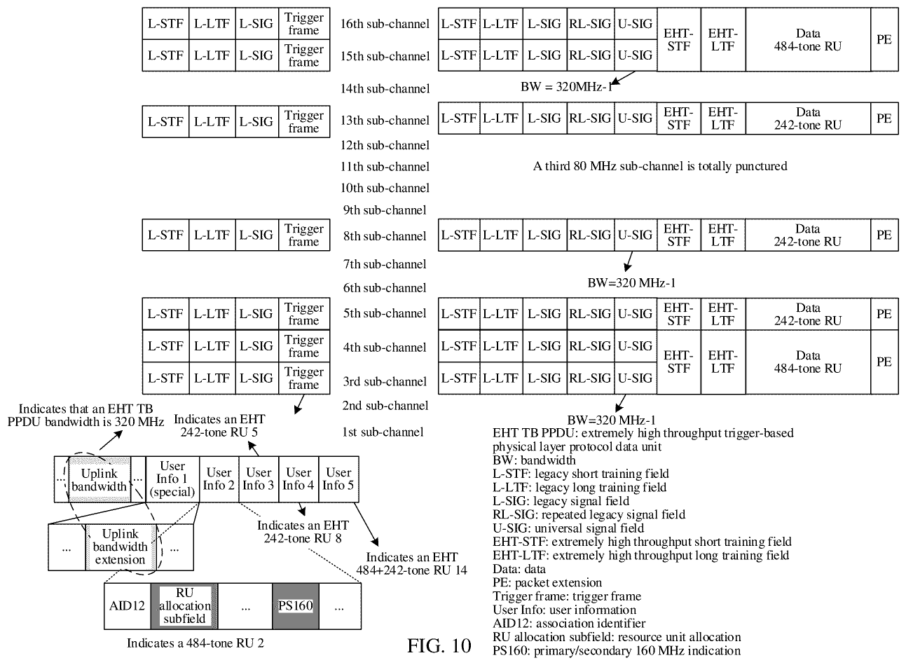

For OFDMA transmission, for example, refer to FIG. 10. FIG. 10 is a schematic diagram of OFDMA punctured transmission of an EHT TB PPDU according to an embodiment of this application. As shown in FIG. 10, an AP uses an uplink bandwidth field and an uplink bandwidth extension field together in a trigger frame, to indicate that a scheduled EHT TB PPDU bandwidth is 320 MHz (320 MHz-1 or 320 MHz-2). An RU allocation subfield and PS160 in a user information field 2 (namely, User Info 2) are used together to indicate that a resource unit allocated to a user 1 is a 484-tone RU 2, and then the user 1 performs transmission of an EHT TB PPDU on the 484-tone RU 2. An RU allocation subfield and PS160 in a user information field 3 (namely, User Info 3) are used together to indicate that a resource unit allocated to a user 2 is a 242-tone RU 5, and then the user 2 performs transmission of an EHT TB PPDU on the 242-tone RU 5. An RU allocation subfield and PS160 in a user information field 4 (namely, User Info 4) are used together to indicate that a resource unit allocated to a user 3 is a 242-tone RU 8, and then the user 3 performs transmission of an EHT TB PPDU on the 242-tone RU 8. An RU allocation subfield and PS160 in a user information field 5 (namely, User Info 5) are used together to indicate that a resource unit allocated to a user 4 is a 484+242-tone RU 14, and then the user 4 performs transmission of an EHT TB PPDU on the 484+242-tone RU 14. In FIG. 10, U-SIG fields of the EHT TB PPDUs in different 80 MHz sub-blocks have same content.

10. Bitmap of Sub-Channels on which Transmission is not Allowed

An AP may indicate, in a manner in which a 16-bit bitmap is carried in a management frame such as a beacon frame, 20 MHz sub-channels on which transmission can be performed and 20 MHz sub-channels on which transmission cannot be performed within a range of a basic service set (basic service set, BSS) bandwidth. The 16-bit bitmap is generally referred to as a bitmap (which may also be referred to as a bitmap for short for ease of description) of sub-channels on which transmission is not allowed. In the bitmap of the sub-channels on which transmission is not allowed, 0 indicates that transmission is allowed (or described as that transmission can be performed), and 1 indicates that transmission is not allowed (or described as that transmission cannot be performed). When the BSS bandwidth is less than 320 MHz, the 20 MHz sub-channels on which transmission can be performed and the 20 MHz sub-channels on which transmission cannot be performed within the BSS bandwidth may be indicated, by using N least significant bits in 16 bits. The other (16-N) bits are set to 1 by default, indicating that transmission is not allowed, where N=BSS bandwidth/20 MHz. In other words, all APs and all STAs in a BSS, in which the AP is located, need to perform punctured transmission based on the bitmap of the sub-channels on which transmission is not allowed. In consideration of complexity of STA implementation (generally, an AP has a relatively strong capability), currently, it is further stipulated in the 802.11be standard that: A puncturing pattern indicated by the bitmap of the sub-channels on which transmission is not allowed needs to be a puncturing pattern supported by non-OFDMA transmission, that is, the APs and the STAs in the BSS can perform punctured transmission (OFDMA transmission or non-OFDMA transmission) based on only the puncturing patterns shown in Table 2. Therefore, the puncturing pattern indicated by the bitmap of the sub-channels on which transmission is not allowed is very limited, causing poor flexibility. In other words, because it is stipulated in the current 802.11be standard that, a puncturing pattern indicated by the bitmap of the sub-channels on which transmission is not allowed needs to be a puncturing pattern supported by non-OFDMA transmission, for a puncturing pattern that cannot be supported by the non-OFDMA transmission, an AP cannot but reduce a BSS bandwidth corresponding to the bitmap of the sub-channels on which transmission is not allowed, so that the bitmap of the sub-channels on which transmission is not allowed meets the condition of indicating a puncturing pattern supported by the non-OFDMA transmission. However, this manner of reducing a maximum PPDU bandwidth (namely, the BSS bandwidth) allowed for transmission reduces both system throughput and transmission efficiency. Therefore, applicability is low.

Therefore, this application provides a communication method and a communication apparatus, which can improve flexibility of indicating a puncturing pattern of a first bitmap (namely, a bitmap of sub-channels on which transmission is not allowed), thereby improving applicability.

For ease of understanding the solutions described in embodiments of this application, the following first describes a system architecture according to an embodiment of this application.

It needs to be noted that the technical solutions in embodiments of this application can be applied to a wireless local area network WLAN that uses 802.11be or a standard later than 802.11be, or can be applied to another communication system that supports large-bandwidth OFDM transmission. Generally, EHT+ can be used to represent a standard later than 802.11be.

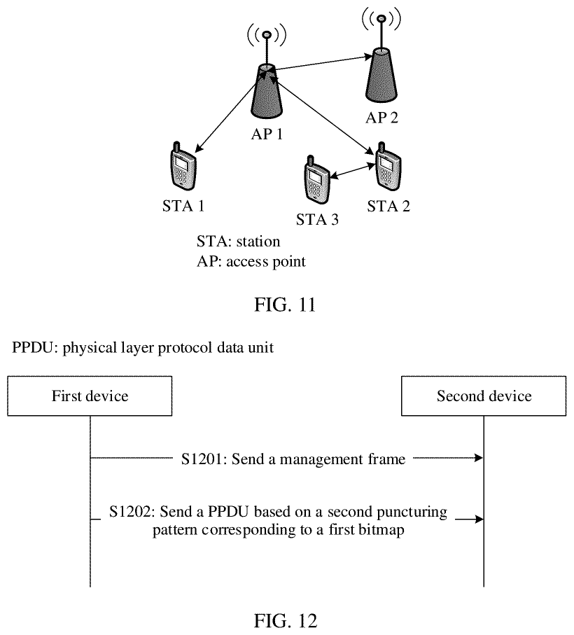

Refer to FIG. 11. FIG. 11 is a schematic diagram of a system architecture according to an embodiment of this application. As shown in FIG. 11, the system architecture may include an access point (access point, AP) station and a non-access point station (non-access point station, non-AP STA). For ease of description, in this specification, an access point station is referred to as an access point (AP), and a non-access point station is referred to as a station (STA). The system architecture may include one or more access points and one or more stations. FIG. 11 uses an example in which two access points and three stations are included.

The access point may be an access point used by a terminal device (such as a mobile phone) to access a wired (or wireless) network, and is mainly deployed at home, in a building, or in a campus. A typical coverage radius is tens of meters to a hundred meters. Certainly, the access point may be alternatively deployed outdoors. The access point is equivalent to a bridge that connects the wired network and the wireless network. A main function of the access point is to connect various wireless network clients together and then connect the wireless network to an Ethernet. Specifically, the access point may be a terminal device (such as a mobile phone) or a network device (such as a router) having a wireless fidelity (wireless fidelity, Wi-Fi) chip. The access point may be a device that supports the 802.11be standard. Alternatively, the access point may be a device that supports a plurality of wireless local area network (wireless local area network, WLAN) standards of the 802.11 family, such as 802.11be, 802.11ax, 802.11ac, 802.11n, 802.11g, 802.11b, and 802.11a. The access point in this application may be a high-efficiency (high-efficiency, HE) AP, an extremely high throughput (extremely high throughput, EHT) AP, or an access point applicable to a future-generation Wi-Fi standard.

A device having wireless receiving and sending functions includes an access point in a non-Wi-Fi system, and may also include but is not limited to: a home gateway, a router, a server, a switch, a bridge, an evolved NodeB (evolved NodeB, eNB), a radio network controller (radio network controller, RNC), a NodeB (NodeB, NB), a base station controller (base station controller, BSC), a base transceiver station (base transceiver station, BTS), a home NodeB (for example, a home evolved NodeB, or a home NodeB, HNB), a baseband unit (baseband unit, BBU), a wireless relay node, a wireless backhaul node, a transmission point (transmission and reception point, TRP, or transmission point, TP), or the like; or may be a gNB or a transmission point (TRP or TP) in a 5G system such as a new radio (new radio, NR) system, or one antenna panel or a group of antenna panels (including a plurality of antenna panels) of a base station in a 5G system; or may be a network node that forms a gNB or a transmission point, for example, a baseband unit (BBU), or a distributed unit (distributed unit, DU), a roadside unit (roadside unit, RSU) having functions of a base station, or the like.

The station may be a wireless communication chip, a wireless sensor, a wireless communication terminal, or the like, and may also be referred to as a user. For example, the station may be a mobile phone (mobile phone), a wireless data card, a personal digital assistant (personal digital assistant, PDA) computer, a laptop computer (laptop computer), a pad computer (Pad), an ultra-mobile personal computer (ultra-mobile personal computer, UMPC), a netbook computer, a computer having wireless receiving and sending functions, a machine type communication (machine type communication, MTC) terminal, a virtual reality (virtual reality, VR) terminal device, an augmented reality (augmented reality, AR) terminal device, an Internet of Things (Internet of Things, IoT) terminal device, a wireless terminal in industrial control (industrial control), a wireless terminal in self-driving (self-driving), a wireless terminal in remote medicine (remote medical), a wireless terminal in a smart grid (smart grid), a wireless terminal in transportation safety (transportation safety), a wireless terminal (for example, a smart water meter, a smart ammeter, or a smart air detection node) in a smart city (smart city), a wireless terminal (for example, a game console, a projector, a smart camera, a smart television, a smart sound box, a smart refrigerator, or fitness equipment) in smart home (smart home), a vehicle-mounted terminal, or an RSU having functions of a terminal. The access terminal may be: a cellular phone (cellular phone), a cordless phone, a Session Initiation Protocol (session initiation protocol, SIP) phone, a wireless local loop (wireless local loop, WLL) station, a personal digital assistant (personal digital assistant, PDA), a handset (handset) having a wireless communication function, a computing device, another processing device connected to a wireless modem, a wearable device, or the like; and includes: a mobile phone supporting a Wi-Fi communication function, a pad computer supporting the Wi-Fi communication function, a set-top box supporting the Wi-Fi communication function, a smart television supporting the Wi-Fi communication function, an intelligent wearable device supporting the Wi-Fi communication function, an in-vehicle communication device supporting the Wi-Fi communication function, a computer supporting the Wi-Fi communication function, and the like. Optionally, the station may support the 802.11be standard. Alternatively, the station may support a plurality of wireless local area network (wireless local area network, WLAN) standards of the 802.11 family, such as 802.11be, 802.11ax, 802.11ac, 802.11n, 802.11g, 802.11b, and 802.11a.

For example, the access point and the station may be: devices used in the Internet of Vehicles; Internet of Things nodes, sensors, or the like in the Internet of Things (Internet of Things, IoT); smart cameras, smart remote controllers, smart water meters or ammeters, or the like in smart home; or sensors in a smart city, or the like.

It can be understood that the technical solutions of this application are applicable to data communication between one or more access points and one or more stations, communication between access points, and communication between stations. This is not limited herein. For ease of understanding, in the following embodiments in this application, the technical solutions of this application are described by using data communication between an access point and a station as an example. In other words, the first device in this application may be understood as an access point, and the second device may be understood as a station.

Refer to FIG. 12. FIG. 12 is a schematic flowchart of a communication method according to an embodiment of this application. As shown in FIG. 12, the communication method includes the following steps S1201 and S1202. The method shown in FIG. 12 may be performed by an access point (hereinafter described as a first device), or the method shown in FIG. 12 may be performed by a chip in the first device. For ease of description, the following description is provided by using the first device as an example.

S1201: The first device sends a management frame to a second device.

In some feasible implementations, the first device may send, in a manner such as broadcast, the management frame to all stations included in a BSS in which the first device is located (for ease of description, only one station (namely, the second device) is used as an example below for description in this embodiment of this application). The management frame includes a first bitmap (or described as a bitmap of sub-channels on which transmission is not allowed), and a first puncturing pattern indicated by the first bitmap is a puncturing pattern not supported by non-OFDMA transmission. It can be understood that the first puncturing pattern may be alternatively a puncturing pattern supported by OFDMA transmission. In other words, the first puncturing pattern in this embodiment of this application may be understood as a puncturing pattern not supported by non-OFDMA transmission but supported by OFDMA transmission. Generally, the management frame may be a beacon frame or the like, which is not limited herein. Optionally, the management frame may further include a first bandwidth field. The first bandwidth field indicates a first BSS bandwidth, and the first bitmap is a bitmap corresponding to the first BSS bandwidth. Correspondingly, the second device receives the management frame from the first device, and then may determine, based on information such as the first bitmap and the BSS bandwidth in the management frame, 20 MHz sub-channels on which transmission can be performed and 20 MHz sub-channels on which transmission cannot be performed within the BSS bandwidth.

S1202: The first device sends a PPDU to the second device based on a second puncturing pattern corresponding to the first bitmap.

In some feasible implementations, the first device may send the PPDU to the second device based on the second puncturing pattern corresponding to the first bitmap. In other words, when the first device determines that the first puncturing pattern indicated by the first bitmap is a puncturing pattern not supported by the non-OFDMA transmission, the first device may further determine the second puncturing pattern corresponding to the first bitmap, where the second puncturing pattern is a puncturing pattern supported by the non-OFDMA transmission, so that the first device may send the PPDU based on the second puncturing pattern. In other words, the first device may perform non-OFDMA transmission based on the second puncturing pattern. The PPDU may be an EHT MU PPDU, or may be a non-HT duplicate PPDU, or may be an EHT TB PPDU, or may be another PPDU, which is not limited herein. A Data field in a non-HT duplicate PPDU may include/carry a trigger frame, where the trigger frame is used to trigger the second device to send an EHT TB PPDU, that is, a trigger frame may be carried in a Data field of a non-HT duplicate PPDU, or in other words, transmission of a trigger frame may be performed by using a non-HT duplicate PPDU. Optionally, the non-HT duplicate PPDU may be further used to carry a frame of another type, in addition to the trigger frame. This is specifically determined based on an actual scenario, and is not limited herein. Correspondingly, in addition to using a non-HT duplicate PPDU for transmission, the trigger frame may be alternatively carried in another PPDU for transmission. This is specifically determined based on an actual application scenario, and is not limited herein. For ease of understanding, in this embodiment of this application, description may be provided below by using an example in which a non-HT duplicate PPDU includes/carries a trigger frame.

Optionally, in some feasible implementations, if the first device needs to perform OFDMA transmission, the first device may send the PPDU based on the first puncturing pattern, that is, the first device may perform the OFDMA transmission based on the first puncturing pattern. In other words, in this embodiment of this application, the first device may perform non-OFDMA transmission based on the second puncturing pattern, or may perform OFDMA transmission based on the first puncturing pattern. This is specifically determined based on an actual application scenario and is not limited herein. Optionally, during actual implementation, the first device may further puncture a 20 MHz channel that corresponds to the first puncturing pattern and allows for transmission, so as to perform OFDMA transmission; or the first device may further puncture a 20 MHz channel that corresponds to the second puncturing pattern and allows for transmission, so as to perform non-OFDMA transmission. This is specifically determined based on an actual scenario, and is not limited herein.

For example, the first BSS bandwidth is 160 MHz, and the first bitmap is 0011 y₁y₂y₃y₄ 1111 1111. When y₁y₂y₃y₄=0100, the first bitmap is 0011 0100 1111 1111, the first puncturing pattern is 1100 1011, and the second puncturing pattern is a puncturing pattern corresponding to a 484-tone RU 1. (1) It is assumed that the first device needs to perform non-OFDMA transmission, and the first device may send the PPDU based on the puncturing pattern corresponding to the 484-tone RU 1 (that is, send the PPDU on the 484-tone RU 1 in the 160 MHz bandwidth). Optionally, the first device may alternatively perform the non-OFDMA transmission by using a supported non-OFDMA puncturing pattern with a smaller size (that is, further puncture a 20 MHz channel that corresponds to the second puncturing pattern and allows for transmission, so as to perform the non-OFDMA transmission). For example, the first device may alternatively perform the non-OFDMA transmission based on a puncturing pattern corresponding to a 242-tone RU 1 (that is, send the PPDU on the 242-tone RU 1 in the 160 MHz bandwidth). (2) It is assumed that the first device needs to perform OFDMA transmission, and the first device may perform the OFDMA transmission by using the first puncturing pattern 1100 1011. Optionally, the first device may alternatively perform the OFDMA transmission by using a supported OFDMA puncturing pattern with a smaller size (that is, further puncture a 20 MHz channel that corresponds to the first puncturing pattern and allows for transmission, so as to perform the OFDMA transmission). For example, the first device may alternatively perform the OFDMA transmission by using a puncturing pattern 1100 1001.

Correspondingly, for the second device, the second device may receive the PPDU from the first device, and decode the received PPDU. Specifically: (1) When the PPDU is an EHT MU PPDU, because a U-SIG field in the EHT MU PPDU includes a punctured channel information field used to indicate a puncturing pattern and includes a PPDU bandwidth indication field used to indicate a PPDU bandwidth, the second device may determine, based on the PPDU bandwidth indicated in the PPDU bandwidth indication field and a field value indicated in the punctured channel information field, which second puncturing pattern has been specifically used for the transmission of the PPDU, and then receives the EHT MU PPDU based on the determined second puncturing pattern; or (2) when the PPDU is a non-HT duplicate PPDU, because the non-HT duplicate PPDU includes only PPDU bandwidth indication information used to indicate a PPDU bandwidth and does not include puncturing pattern indication information used to indicate a puncturing pattern, the second device may determine, based on the first bitmap included in the received management frame, the second puncturing pattern corresponding to the first bitmap, and then receives the non-HT duplicate PPDU based on the determined second puncturing pattern. For example, if the non-HT duplicate PPDU includes/carries a trigger frame, after the second device receives the non-HT duplicate PPDU, the second device may perform parsing to obtain a user information field that matches an association identifier of the second device in the trigger frame included in the non-HT duplicate PPDU, and then sends an EHT TB PPDU on a resource unit that is indicated in a resource unit allocation subfield in the user information field. Optionally, the trigger frame in this embodiment of this application may be alternatively transmitted by using another PPDU format than the non-HT duplicate PPDU. In other words, (3) when the PPDU is another PPDU that carries a trigger frame, after receiving the another PPDU, the second device may perform parsing to obtain a user information field that matches an association identifier of the second device in the trigger frame included in the another PPDU, and then sends an EHT TB PPDU on a resource unit that is indicated in a resource unit allocation subfield in the user information field. Specifically, if the resource unit indicated in the resource unit allocation sub-field in the trigger frame is a resource unit used to schedule the second device to perform non-OFDMA transmission, the first device may allocate, to the second device based on the second puncturing pattern, one RU or MRU used for transmission of the EHT TB PPDU, so as to schedule the second device to send the EHT TB PPDU in a non-OFDMA transmission manner. If the resource unit indicated in the resource unit allocation sub-field in the trigger frame is a resource unit used to schedule the second device to perform OFDMA transmission, the first device may allocate, based on the first puncturing pattern, more than one (namely, two or more) RU or MRU to the second device, so as to schedule the second device to send the EHT TB PPDU in an OFDMA transmission manner.

It can be understood that, in this embodiment of this application, the first puncturing pattern indicated by the first bitmap may be a combination of any N puncturing patterns in the following nine puncturing patterns: 0000, 1111, 0111, 1011, 1101, 1110, 0011, 1100, and 1001, where 1 indicates that a corresponding 20 MHz sub-channel is not punctured, and 0 indicates that a corresponding 20 MHz sub-channel is punctured, only a non-punctured 20 MHz sub-channel can be used for transmission of the PPDU, and N=First BSS bandwidth/80 MHz. It needs to be noted that the first puncturing pattern cannot be all 0s. For example, when the first BSS bandwidth is 160 MHz, the first bitmap may be 1000 0011 1111 1111 and the first puncturing pattern indicated by the first bitmap is 0111 1100.

Optionally, in some feasible implementations, if it is specified that transmission can be further performed on another channel only when the transmission is performed on a primary 20 MHz channel (that is, to comply with a method for channel access based on a primary channel), a primary 20 MHz channel in this embodiment of this application cannot be punctured, that is, non-punctured sub-channels in the first puncturing pattern need to include the primary 20 MHz channel.

The second puncturing pattern corresponding to the first bitmap includes any one of puncturing patterns corresponding to the following resource unit indexes: 242-tone RU 1, 484-tone RU 1, 484+242-tone MRU 1, 484+242-tone MRU 2, 484+242-tone MRU 3, 484+242-tone MRU 4, 996-tone RU 1, 996+484+242-tone MRU 1, 996+484+242-tone MRU 2, 996+484+242-tone MRU 3, 996+484+242-tone MRU 4, 996+484+242-tone MRU 5, 996+484+242-tone MRU 6, 996+484+242-tone MRU 7, 996+484+242-tone MRU 8, 996+484-tone MRU 1, 996+484-tone MRU 2, 996+484-tone MRU 3, 996+484-tone MRU 4, 2*996-tone RU 1, 2*996+484-tone MRU 1, 2*996+484-tone MRU 2, 2*996+484-tone MRU 3, 2*996+484-tone MRU 4, 2*996+484-tone MRU 5, 2*996+484-tone MRU 6, 2*996+484-tone MRU 7, 2*996+484-tone MRU 8, 2*996+484-tone MRU 9, 2*996+484-tone MRU 10, 2*996+484-tone MRU 11, 2*996+484-tone MRU 12, 3*996-tone MRU 1, 3*996-tone MRU 2, 3*996-tone MRU 3, 3*996-tone MRU 4, 3*996+484-tone MRU 1, 3*996+484-tone MRU 2, 3*996+484-tone MRU 3, 3*996+484-tone MRU 4, 3*996+484-tone MRU 5, 3*996+484-tone MRU 6, 3*996+484-tone MRU 7, 3*996+484-tone MRU 8, and 4*996-tone RU 1.

Optionally, in some feasible implementations, if it is specified that transmission can be further performed on another channel only when the transmission is performed on a primary 20 MHz channel (that is, to comply with a method for channel access based on a primary channel), non-punctured sub-channels included in the second puncturing pattern in this embodiment of this application also need to include a primary 20 MHz channel.

Specifically, when the first BSS bandwidth is 80 MHz and the primary 20 MHz channel is located in an 80 MHz channel with a lowest frequency, mapping relationships between the first bitmap and the first puncturing pattern and between the first bitmap and the second puncturing pattern are as follows: When the first bitmap is 0110 1111 1111 1111, the first puncturing pattern is 1001 and the second puncturing pattern is a puncturing pattern corresponding to the 242-tone RU 1, where the puncturing pattern corresponding to the 242-tone RU 1 is the puncturing pattern 1111 corresponding to 20 MHz in Table 2. The primary 20 MHz channel is located at a first 20 MHz channel or a fourth 20 MHz channel in a primary 80 MHz channel, that is, the primary 20 MHz channel is located at a 20 MHz sub-channel corresponding to “i” in the first puncturing pattern. For a clearer description of the mapping relationships between the first bitmap and the first puncturing pattern and between the first bitmap and the second puncturing pattern when the first BSS bandwidth is 80 MHz, the mapping relationships can be converted into a mapping table shown in Table 3 below.

TABLE 3
A table of mapping of the 80 MHz bandwidth

| First bitmap (0 | First | Second | |
|---|---|---|---|
| indicates that | puncturing | puncturing | |
| transmission is | pattern (0 | pattern | |
| allowed, and 1 | indicates | (0 indicates | |
| indicates that | puncturing, | puncturing, and | |
| transmission is not | and 1 indicates | 1 indicates no | |
| allowed) | no puncturing) | puncturing) | Condition |
| 0110 1111 1111 1111 | 1001 | 20 MHz PPDU: | The primary 20 MHz channel is |
| | | 1111 | located at a first or fourth 20 |
| | | (namely, 242-tone | MHz channel from left to right |
| | | RU 1) | in the primary 80 MHz channel. |

For Table 3, when the first BSS bandwidth is 8 0 MHz, mapping relationships between the first bitmap and the first puncturing pattern and between the first bitmap and the second puncturing pattern are established, so that system efficiency is doubled when the first device or the second device performs OFDMA transmission based on the first puncturing pattern. This is because in a conventional technology, to indicate a puncturing pattern supported by non-OFDMA transmission, a BSS bandwidth needs to be reduced (that is, the BSS bandwidth is reduced from 80 MHz to 20 MHz), so that a maximum bandwidth for OFDMA transmission is 20 MHz. In contrast, in this application, mapping relationships between the first bitmap and the first puncturing pattern and between the first bitmap and the second puncturing pattern are established, so that a BSS bandwidth does not need to be reduced (that is, the BSS bandwidth is 8 0 MHz). In this way, the BSS bandwidth is still 80 MHz, and OFDMA transmission is performed on two 20 MHz channels on which transmission is allowed, that is, an equivalent bandwidth is 40 MHz, thereby doubling system efficiency. It can be understood that, when the first puncturing pattern corresponding to the first bitmap is another puncturing pattern used for OFDMA transmission, system efficiency determined based on an equivalent bandwidth corresponding to the first puncturing pattern and an equivalent bandwidth (for example, 20 MHz) in the conventional technology is adaptively adjusted. This is not limited herein.

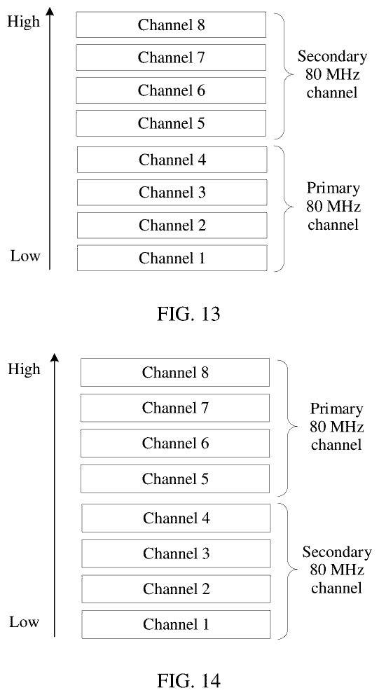

Optionally, in some feasible implementations, when the first BSS bandwidth is 160 MHz and the first BSS bandwidth is divided into a primary 80 MHz channel and a secondary 80 MHz channel in ascending order of frequencies in sequence (as shown in FIG. 13, the primary 20 MHz channel is located in a lower 80 MHz channel in the 160 MHz bandwidth), mapping relationships between the first bitmap and the first puncturing pattern and between the first bitmap and the second puncturing pattern are as follows when the first bitmap is 0110 y₁y₂y₃y₄ 1111 1111, the first puncturing pattern is 1001 y₁y₂y₃y₄ and the second puncturing pattern is a puncturing pattern corresponding to the 242-tone RU 1, where yᵢ is negation of yᵢ, i includes 1, 2, 3, and 4, and y₁y₂y₃y₄ is any one of 1111, 0111, 1011, 1101, 1110, 1100, 0011, or 1001; or when the first bitmap is 0011 y₁y₂y₃y₄ 1111 1111, the first puncturing pattern is 1100 y₁y₂y₃y₄ and the second puncturing pattern is a puncturing pattern corresponding to the 484-tone RU 1, where yᵢ is negation of yᵢ, i includes 1, 2, 3, and 4, and y₁y₂y₃y₄ is any one of 0111, 1011, 1101, 1110, 1100, 0011, or 1001; or when the first bitmap is 1100 y₁y₂y₃y₄ 1111 1111, the first puncturing pattern is 0011 y₁y₂y₃y₄ and the second puncturing pattern is a puncturing pattern corresponding to the 484-tone RU 1, where yᵢ is negation of yᵢ, i includes 1, 2, 3, and 4, and y₁y₂y₃y₄ is any one of 0111, 1011, 1101, 1110, 1100, 0011, or 1001; or when the first bitmap is 0001 y₁y₂y₃y₄ 1111 1111, the first puncturing pattern is 1110 y₁y₂y₃y₄ and the second puncturing pattern is a puncturing pattern corresponding to the 484+242-tone MRU 4, where yᵢ is negation of yᵢ, i includes 1, 2, 3, and 4, and y₁y₂y₃y₄ is any one of 0111, 1011, 1101, 1110, 1100, 0011, or 1001; or when the first bitmap is 0100 y₁y₂y₃y₄ 1111 1111, the first puncturing pattern is 1011 y₁y₂y₃y₄ and the second puncturing pattern is a puncturing pattern corresponding to the 484+242-tone MRU 2, where yᵢ is negation of yᵢ, i includes 1, 2, 3, and 4, and y₁y₂y₃y₄ is any one of 0111, 1011, 1101, 1110, 1100, 0011, or 1001; or when the first bitmap is 0010 y₁y₂y₃y₄ 1111 1111, the first puncturing pattern is 1101 y₁y₂y₃y₄ and the second puncturing pattern is a puncturing pattern corresponding to the 484+242-tone MRU 3, where yᵢ is negation of yᵢ, i includes 1, 2, 3, and 4, and y₁y₂y₃y₄ is any one of 0111, 1011, 1101, 1110, 1100, 0011, or 1001; or when the first bitmap is 1000 y₁y₂y₃y₄ 1111 1111, the first puncturing pattern is 0111 y₁y₂y₃y₄ and the second puncturing pattern is a puncturing pattern corresponding to the 484+242-tone MRU 1, where yᵢ is negation of yᵢ, i includes 1, 2, 3, and 4, and y₁y₂y₃y₄ is any one of 0111, 1011, 1101, 1110, 1100, 0011, or 1001; or when the first bitmap is 0000 0110 1111 1111, the first puncturing pattern is 1111 1001 and the second puncturing pattern is a puncturing pattern corresponding to the 996-tone RU 1

It can be understood that, when the first BSS bandwidth is 16 0 MHz, the first puncturing pattern is a puncturing pattern with a maximum size that corresponds to the first bitmap and is supported by OFDMA transmission but not supported by non-OFDMA transmission, and the second puncturing pattern is a puncturing pattern with a maximum size that corresponds to the first bitmap and is supported by the non-OFDMA transmission. Generally, when sending a PPDU, the first device or the second device may preferably use the second puncturing pattern (namely, the non-OFDMA puncturing pattern with the maximum size) to perform non-OFDMA transmission, or preferentially use the first puncturing pattern (namely, the OFDMA puncturing pattern with the maximum size) to perform OFDMA transmission. Certainly, the non-OFDMA transmission may be alternatively performed by using a supported non-OFDMA puncturing pattern with a smaller size, or the OFDMA transmission may be performed by using a supported OFDMA puncturing pattern with a smaller size. Sizes are sorted according to a quantity of included subcarriers. A larger size indicates a larger quantity of subcarriers, and a smaller size indicates a smaller quantity of subcarriers.

For example, the first BSS bandwidth is 160 MHz, and the first bitmap is 0011 y₁y₂y₃y₄ 1111 1111. When y₁y₂y₃y₄=0100, the first bitmap is 0011 0100 1111 1111. In this case, the first puncturing pattern is 1100 1011, and the second puncturing pattern is a puncturing pattern corresponding to the 484-tone RU 1. It is assumed that the first device needs to perform non-OFDMA transmission, and the first device may send a PPDU based on a puncturing pattern corresponding to the 484-tone RU 1 (that is, send the PPDU on the 484-tone RU 1 in the 160 MHz bandwidth). Optionally, the first device may alternatively perform the non-OFDMA transmission by using a supported non-OFDMA puncturing pattern with a smaller size. For example, the first device may alternatively send the PPDU based on a puncturing pattern corresponding to the 242-tone RU 1 (that is, send the PPDU on the 242-tone RU 1 in the 160 MHz bandwidth). It is assumed that the first device needs to perform OFDMA transmission, and the first device may send a PPDU by using the first puncturing pattern 1100 1011. Optionally, the first device may alternatively perform the OFDMA transmission by using a supported OFDMA puncturing pattern with a smaller size (that is, further puncture a 20 MHz channel that corresponds to the first puncturing pattern and allows for transmission, so as to perform the OFDMA transmission). For example, the first device may alternatively perform the OFDMA transmission by using a puncturing pattern 1100 1001. For another example, the first device may alternatively perform the OFDMA transmission by using a puncturing pattern 1100 0011.

For a clearer description of the mapping relationships between the first bitmap and the first puncturing pattern and between the first bitmap and the second puncturing pattern when the first BSS bandwidth is 160 MHz and the first BSS bandwidth is divided into a primary 80 MHz channel and a secondary 80 MHz channel in ascending order of frequencies in sequence, the mapping relationships can be converted into a mapping table shown in Table 4 below.

TABLE 4
A table of mapping of the 160 MHz bandwidth (primary 80 MHz
channel-secondary 80 MHz channel)

| First bitmap (0 | | | |
|---|---|---|---|
| indicates that | First puncturing | Second puncturing | Other conditions |
| transmission is allowed, | pattern (0 indicates | pattern (0 indicates | (than the conditions |
| and 1 indicates that | puncturing, and 1 | puncturing, and 1 | in Note 3 to Note 5 |
| transmission is not | indicates no | indicates no | at the bottom of this |
| allowed) | puncturing) | puncturing) | table) |
| 0110 y₁y₂y₃y₄ 1111 | 1001 y₁y₂y₃y₄ | 20 MHz PPDU: | None |
| 1111 | | 1111 (namely, 242-tone | |
| | | RU 1) | |
| 0011 y₁y₂y₃y₄ 1111 | 1100 y₁y₂y₃y₄ | 40 MHz PPDU: | y₁y₂y₃y₄ is not equal |
| 1111 | | 1111 (namely, 484-tone | to 1111. |
| | | RU 1) | |
| 1100 y₁y₂y₃y₄ 1111 | 0011 y₁y₂y₃y₄ | 40 MHz PPDU: | y₁y₂y₃y₄ is not equal |
| 1111 | | 1111 (namely, 484-tone | to 1111. |
| | | RU 1) | |
| 0001 y₁y₂y₃y₄ 1111 | 1110 y₁y₂y₃y₄ | 484 + 242-tone MRU of | y₁y₂y₃y₄ is not equal |
| 1111 | | 80 MHz PPDU: | to 1111. |
| | | 1110 (namely, | |
| | | 484 + 242-tone MRU 4) | |
| 0100 y₁y₂y₃y₄ 1111 | 1011 y₁y₂y₃y₄ | 484 + 242-tone MRU of | y₁y₂y₃y₄ is not equal |
| 1111 | | 80 MHz PPDU: | to 1111. |
| | | 1011 (namely, | |
| | | 484 + 242-tone MRU 2) | |
| 0010 y₁y₂y₃y₄ 1111 | 1101 y₁y₂y₃y₄ | 484 + 242-tone MRU of | y₁y₂y₃y₄ is not equal |
| 1111 | | 80 MHz PPDU: | to 1111. |
| | | 1101 (namely, | |
| | | 484 + 242-tone MRU 3) | |
| 1000 y₁y₂y₃y₄ 1111 | 0111 y₁y₂y₃y₄ | 484 + 242-tone MRU of | y₁y₂y₃y₄ is not equal |
| 1111 | | 80 MHz PPDU: | to 1111. |
| | | 0111 (namely, | |
| | | 484 + 242-tone MRU 1) | |
| 0000 0110 1111 1111 | 1111 1001 | 80 MHz PPDU: | None |
| | | 1111 (namely, 996-tone | |
| | | RU 1) | |

Note 1:
yᵢ indicates that the value may be 1 or 0.
Note 2:
yᵢ indicates negation of yᵢ; and when yᵢ is 0, yᵢ is 1; or when yᵢ is 1, yᵢ is 0, where i = 1, 2, 3, or 4.
Note 3:
y₁y₂y₃y₄ may not be 0000 (the secondary 80 MHz channel cannot be simultaneously punctured; otherwise, the BSS bandwidth is reduced to 80 MHz).
Note 4:
In this table, the primary 20 MHz channel is located at a non-punctured position in the primary 80 MHz channel.
Note 5:
y₁y₂y₃y₄ may be 1111, 0111, 1011, 1101, 1110, 1100, 0011 or 1001.
Note 6:
The second puncturing pattern (namely, the non-OFDMA puncturing pattern with the maximum size) is preferably used to perform non-OFDMA transmission, or the first puncturing pattern (namely, the OFDMA puncturing pattern with the maximum size) is preferably used to perform OFDMA transmission. Certainly, the non-OFDMA transmission may be alternatively performed by using a supported non-OFDMA puncturing pattern with a smaller size, or the OFDMA transmission may be performed by using a supported OFDMA puncturing pattern with a smaller size. Sizes are sorted according to a quantity of included subcarriers. A larger size indicates a larger quantity of subcarriers, and a smaller size indicates a smaller quantity of subcarriers.

Optionally, in some feasible implementations, when the first BSS bandwidth is 160 MHz and the first BSS bandwidth is divided into a secondary 80 MHz channel and a primary 80 MHz channel in ascending order of frequencies in sequence (as shown in FIG. 14, the primary 20 MHz channel is located in a higher 80 MHz channel in the 160 MHz bandwidth), mapping relationships between the first bitmap and the first puncturing pattern and between the first bitmap and the second puncturing pattern are as follows when the first bitmap is y₁y₂y₃y₄ 0110 1111 1111, the first puncturing pattern is y₁y₂y₃y₄ 1001 and the second puncturing pattern is a puncturing pattern corresponding to the 242-tone RU 1, where yᵢ is negation of yᵢ, i includes 1, 2, 3, and 4, and y₁y₂y₃y₄ is any one of 1111, 0111, 1011, 1101, 1110, 1100, 0011, or 1001; or when the first bitmap is y₁y₂y₃y₄ 0011 1111 1111, the first puncturing pattern is y₁y₂y₃y₄ 1100 and the second puncturing pattern is a puncturing pattern corresponding to the 484-tone RU 1, where yᵢ is negation of yᵢ, i includes 1, 2, 3, and 4, and y₁y₂y₃y₄ is any one of 0111, 1011, 1101, 1110, 1100, 0011, or 1001; or when the first bitmap is y₁y₂y₃y₄ 1100 1111 1111, the first puncturing pattern is y₁y₂y₃y₄ 0011 and the second puncturing pattern is a puncturing pattern corresponding to the 484-tone RU 1, where yᵢ is negation of yᵢ, i includes 1, 2, 3, and 4, and y₁y₂y₃y₄ is any one of 0111, 1011, 1101, 1110, 1100, 0011, or 1001; or when the first bitmap is y₁y₂y₃y₄ 0001 1111 1111, the first puncturing pattern is y₁y₂y₃y₄ 1110 and the second puncturing pattern is a puncturing pattern corresponding to the 484+242-tone MRU 4, where yᵢ is negation of yᵢ, i includes 1, 2, 3, and 4, and y₁y₂y₃y₄ is any one of 0111, 1011, 1101, 1110, 1100, 0011, or 1001; or when the first bitmap is y₁y₂y₃y₄ 0100 1111 1111, the first puncturing pattern is y₁y₂y₃y₄ 1011 and the second puncturing pattern is a puncturing pattern corresponding to the 484+242-tone MRU 2, where yᵢ is negation of yᵢ, i includes 1, 2, 3, and 4, and y₁y₂y₃y₄ is any one of 0111, 1011, 1101, 1110, 1100, 0011, or 1001; or when the first bitmap is y₁y₂y₃y₄ 0010 1111 1111, the first puncturing pattern is y₁y₂y₃y₄ 1101 and the second puncturing pattern is a puncturing pattern corresponding to the 484+242-tone MRU 3, where yᵢ is negation of yᵢ, i includes 1, 2, 3, and 4, and y₁y₂y₃y₄ is any one of 0111, 1011, 1101, 1110, 1100, 0011, or 1001; or when the first bitmap is y₁y₂y₃y₄ 1000 1111 1111, the first puncturing pattern is y₁y₂y₃y₄ 0111 and the second puncturing pattern is a puncturing pattern corresponding to the 484+242-tone MRU 1, where yᵢ is negation of yᵢ, i includes 1, 2, 3, and 4, and y₁y₂y₃y₄ is any one of 0111, 1011, 1101, 1110, 1100, 0011, or 1001; or when the first bitmap is 0110 0000 1111 1111, the first puncturing pattern is 1001 1111 and the second puncturing pattern is a puncturing pattern corresponding to the 996-tone RU.

In other words, the sequences of the four bits respectively corresponding to the primary 8 MHz channel and the secondary 80 MHz channel in Table 4 can be swapped, to obtain mapping relationships between the first bitmap and the first puncturing pattern and between the first bitmap and the second puncturing pattern when the first BSS bandwidth is 160 MHz and the first BSS bandwidth is divided into a secondary 80 MHz channel and a primary 80 MHz channel in ascending order of frequencies in sequence, as shown in Table 5 below.

TABLE 5
A table of mapping of the 160 MHz bandwidth (secondary 80 MHz
channel-primary 80 MHz channel)

| | | | Other conditions |
|---|---|---|---|
| First bitmap (0 indicates | First puncturing | Second puncturing | (than the |
| that transmission is | pattern (0 indicates | pattern (0 indicates | conditions in |
| allowed, and 1 indicates | puncturing, and 1 | puncturing, and 1 | Note 3 to Note 5 |
| that transmission is not | indicates no | indicates no | at the bottom of |
| allowed) | puncturing) | puncturing) | this table) |
| y₁y₂y₃y₄ 0110 1111 1111 | y₁y₂y₃y₄ 1001 | 20 MHz PPDU: | None |
| | | 1111 (242-tone RU 1) | |
| y₁y₂y₃y₄ 0011 1111 1111 | y₁y₂y₃y₄ 1100 | 40 MHz PPDU: | y₁y₂y₃y₄ is not |
| | | 1111 (484-tone RU 1) | equal to 1111. |
| y₁y₂y₃y₄ 1100 1111 1111 | y₁y₂y₃y₄ 0011 | 40 MHz PPDU: | y₁y₂y₃y₄ is not |
| | | 1111 (484-tone RU 1) | equal to 1111. |
| y₁y₂y₃y₄ 0001 1111 1111 | y₁y₂y₃y₄ 1110 | 484 + 242-tone MRU of | y₁y₂y₃y₄ is not |
| | | 80 MHz PPDU: | equal to 1111. |
| | | 1110 (484 + 242-tone | |
| | | MRU 4) | |
| y₁y₂y₃y₄ 0100 1111 1111 | y₁y₂y₃y₄ 1011 | 484 + 242-tone MRU of | y₁y₂y₃y₄ is not |
| | | 80 MHz PPDU: | equal to 1111. |
| | | 1011 (484 + 242-tone | |
| | | MRU 2) | |
| y₁y₂y₃y₄ 0010 1111 1111 | y₁y₂y₃y₄ 1101 | 484 + 242-tone MRU of | y₁y₂y₃y₄ is not |
| | | 80 MHz PPDU: | equal to 1111. |
| | | 1101 (484 + 242-tone | |
| | | MRU 3) | |
| y₁y₂y₃y₄ 1000 1111 1111 | y₁y₂y₃y₄ 0111 | 484 + 242-tone MRU of | y₁y₂y₃y₄ is not |
| | | 80 MHz PPDU: | equal to 1111. |
| | | 0111 (484 + 242-tone | |
| | | MRU 1) | |
| 0110 0000 1111 1111 | 1001 1111 | 80 MHz PPDU: | None |
| | | 1111 (996-tone RU 1) | |

Note 1:
yᵢ indicates that the value may be 1 or 0.
Note 2:
yᵢ indicates negation of yᵢ; when yᵢ is 0, yᵢ is 1, or when yᵢ is 1, yᵢ is 0; and zᵢ indicates negation of zᵢ, and kᵢ indicates negation of kᵢ, where i = 1, 2, 3, or 4.
Note 3:
y₁y₂y₃y₄ may not be 0000 (the secondary 80 MHz channel cannot be simultaneously punctured; otherwise, the BSS bandwidth is reduced to 80 MHz).
Note 4:
In this table, the primary 20 MHz channel is located at a non-punctured position in the primary 80 MHz channel.
Note 5:
y₁y₂y₃y₄ may be 1111, 0111, 101 1, 1101, 1110, 1100, 0011 or 1001.
Note 6:
The second puncturing pattern (namely, the non-OFDMA puncturing pattern with the maximum size) is preferably used to perform non-OFDMA transmission, or the first puncturing pattern (namely, the OFDMA puncturing pattern with the maximum size) is preferably used to perform OFDMA transmission. Certainly, the non-OFDMA transmission may be alternatively performed by using a supported non-OFDMA puncturing pattern with a smaller size, or the OFDMA transmission may be performed by using a supported OFDMA puncturing pattern with a smaller size. Sizes are sorted according to a quantity of includedsubcarriers. A larger size indicates a larger quantity of subcarriers, and a smaller size indicates a smaller quantity of subcarriers.

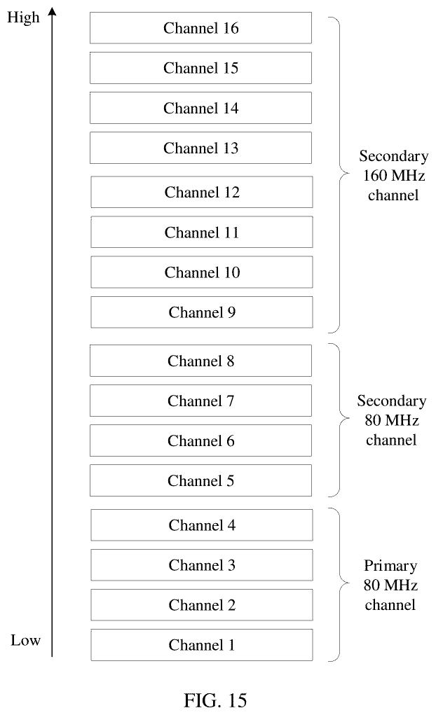

Optionally, in some feasible implementations, when the first BSS bandwidth is 320 MHz and the first BSS bandwidth is divided into a primary 80 MHz channel, a secondary 80 MHz channel, and a secondary 160 MHz channel in ascending order of frequencies in sequence (as shown in FIG. 15, the primary 20 MHz channel is located in a lowest 80 MHz channel in the 320 MHz bandwidth), mapping relationships between the first bitmap and the first puncturing pattern and between the first bitmap and the second puncturing pattern are as follows when the first bitmap is 0110 y₁y₂y₃y₄ z₁z₂z₃z₄ k₁k₂k₃k₄, the first puncturing pattern is 1001 y₁y₂y₃y₄ z₁z₂z₃z₄ k₁k₂k₃k₄ and the second puncturing pattern is a puncturing pattern corresponding to the 242-tone RU 1, where yᵢ is negation of yᵢ, zᵢ is negation of zᵢ, kᵢ is negation of kᵢ, i includes 1, 2, 3, and 4, y₁y₂y₃y₄ is any one of 1111, 0111, 1011, 1101, 1110, 1100, 0011, 1001, or 0000, z₁z₂z₃z₄ is any one of 1111, 0111, 1011, 1101, 1110, 1100, 0011, 1001, or 0000, k₁k₂k₃k₄ is any one of 1111, 0111, 1011, 1101, 1110, 1100, 0011, 1001, or 0000, and z₁z₂z₃z₄ and k₁k₂k₃k₄ are not both 0000; or when the first bitmap is 0011 y₁y₂y₃y₄ z₁z₂z₃z₄ k₁k₂k₃k₄, the first puncturing pattern is 1100 y₁y₂y₃y₄ z₁z₂z₃z₄ k₁k₂k₃k₄ and the second puncturing pattern is a puncturing pattern corresponding to the 484-tone RU 1, where yᵢ is negation of yᵢ, zᵢ is negation of zᵢ, kᵢ is negation of kᵢ includes 1, 2, 3, and 4, y₁y₂y₃y₄ is any one of 0111, 1011, 1101, 1110, 1100, 0011, 1001, or 0000, z₁z₂z₃z₄ is any one of 1111, 0111, 1011, 1101, 1110, 1100, 0011, 1001, or 0000, k₁k₂k₃k₄ is any one of 1111, 0111, 1011, 1101, 1110, 1100, 0011, 1001, or 0000, and z₁z₂z₃z₄ and k₁k₂k₃k₄ are not both 0000; or when the first bitmap is 1100 y₁y₂y₃y₄ z₁z₂z₃z₄ k₁k₂k₃k₄, the first puncturing pattern is 0011 y₁y₂y₃y₄ z₁z₂z₃z₄ k₁k₂k₃k₄ and the second puncturing pattern is a puncturing pattern corresponding to the 484-tone RU 1, where yᵢ is negation of yᵢ, i includes 1, 2, 3, and 4, y₁y₂y₃y₄ is any one of 0111, 1011, 1101, 1110, 1100, 0011, 1001, or 0000, z₁z₂z₃z₄ is any one of 1111, 0111, 1011, 1101, 1110, 1100, 0011, 1001, or 0000, k₁k₂k₃k₄ is any one of 1111, 0111, 1011, 1101, 1110, 1100, 0011, 1001, or 0000, and z₁z₂z₃z₄ and k₁k₂k₃k₄ are not both 0000; or when the first bitmap is 0011 0000 z₁z₂z₃z₄ k₁k₂k₃k₄, the first puncturing pattern is 1100 1111 z₁z₂z₃z₄ k₁k₂k₃k₄ and the second puncturing pattern is a puncturing pattern corresponding to the 996+484-tone MRU 2, where zᵢ is negation of zᵢ, kᵢ is negation of kᵢ, i includes 1, 2, 3, and 4, z₁z₂z₃z₄ is any one of 0111, 1011, 1101, 1110, 1100, 0011, 1001, or 0000, k₁k₂k₃k₄ is any one of 1111, 0111, 1011, 1101, 1110, 1100, 0011, 1001, or 0000, and z₁z₂z₃z₄ and k₁k₂k₃k₄ are not both 0000; or when the first bitmap is 1100 0000 z₁z₂z₃z₄ k₁k₂k₃k₄, the first puncturing pattern is 0011 1111 z₁z₂z₃z₄ k₁k₂k₃k₄ and the second puncturing pattern is a puncturing pattern corresponding to the 996+484-tone MRU 1, where zᵢ is negation of zᵢ, kᵢ is negation of kᵢ, i includes 1, 2, 3, and 4, z₁z₂z₃z₄ is any one of 0111, 1011, 1101, 1110, 1100, 0011, 1001, or 0000, k₁k₂k₃k₄ is any one of 1111, 0111, 1011, 1101, 1110, 1100, 0011, 1001, or 0000, and z₁z₂z₃z₄ and k₁k₂k₃k₄ are not both 0000; or when the first bitmap is 0011 0000 0000 k₁k₂k₃k₄, the first puncturing pattern is 1100 1111 1111 k₁k₂k₃k₄ and the second puncturing pattern is a puncturing pattern corresponding to the 2*996+484-tone MRU 2, where k₁ is negation of kᵢ, i includes 1, 2, 3, and 4, and k₁k₂k₃k₄ is any one of 0111, 1011, 1101, 1110, 1100, 0011, 1001, or 0000; or when the first bitmap is 1100 0000 0000 k₁k₂k₃k₄, the first puncturing pattern is 0011 1111 1111 k₁k₂k₃k₄ and the second puncturing pattern is a puncturing pattern corresponding to the 2*996+484-tone MRU 1, where kᵢ is negation of kᵢ, i includes 1, 2, 3, and 4, and k₁k₂k₃k₄ is any one of 0111, 1011, 1101, 1110, 1100, 0011, 1001, or 0000; or when the first bitmap is 0001 y₁y₂y₃y₄ z₁z₂z₃z₄ k₁k₂k₃k₄, the first puncturing pattern is 1110 y₁y₂y₃y₄ z₁z₂z₃z₄ k₁k₂k₃k₄ and the second puncturing pattern is a puncturing pattern corresponding to the 484+242-tone MRU 4, where yᵢ is negation of yᵢ, zᵢ is negation of zᵢ, k₁ is negation of kᵢ, i includes 1, 2, 3, and 4, y₁y₂y₃y₄ is any one of 0111, 1011, 1101, 1110, 1100, 0011, 1001, or 0000, z₁z₂z₃z₄ is any one of 1111, 0111, 1011, 1101, 1110, 1100, 0011, 1001, or 0000, k₁k₂k₃k₄ is any one of 1111, 0111, 1011, 1101, 1110, 1100, 0011, 1001, or 0000, and z₁z₂z₃z₄ and k₁k₂k₃k₄ are not both 0000; or when the first bitmap is 0100 y₁y₂y₃y₄ z₁z₂z₃z₄ k₁k₂k₃k₄, the first puncturing pattern is 1011 y₁y₂y₃y₄ z₁z₂z₃z₄ k₁k₂k₃k₄ and the second puncturing pattern is a puncturing pattern corresponding to the 484+242-tone MRU 2, where yᵢ is negation of yᵢ, zᵢ is negation of zᵢ, kᵢ is negation of kᵢ, i includes 1, 2, 3, and 4, y₁y₂y₃y₄ is any one of 0111, 1011, 1101, 1110, 1100, 0011, 1001, or 0000, z₁z₂z₃z₄ is any one of 1111, 0111, 1011, 1101, 1110, 1100, 0011, 1001, or 0000, k₁k₂k₃k₄ is any one of 1111, 0111, 1011, 1101, 1110, 1100, 0011, 1001, or 0000, and z₁z₂z₃z₄ and k₁k₂k₃k₄ are not both 0000; or when the first bitmap is 0010 y₁y₂y₃y₄ z₁z₂z₃z₄ k₁k₂k₃k₄, the first puncturing pattern is 1101 y₁y₂y₃y₄ z₁z₂z₃z₄ k₁k₂k₃k₄ and the second puncturing pattern is a puncturing pattern corresponding to the 484+242-tone MRU 3, where yᵢ is negation of yᵢ, zᵢ is negation of zᵢ, kᵢ is negation of kᵢ, i includes 1, 2, 3, and 4, y₁y₂y₃y₄ is any one of 0111, 1011, 1101, 1110, 1100, 0011, 1001, or 0000, z₁z₂z₃z₄ is any one of 1111, 0111, 1011, 1101, 1110, 1100, 0011, 1001, or 0000, k₁k₂k₃k₄ is any one of 1111, 0111, 1011, 1101, 1110, 1100, 0011, 1001, or 0000, and z₁z₂z₃z₄ and k₁k₂k₃k₄ are not both 0000; or when the first bitmap is 1000 y₁y₂y₃y₄ z₁z₂z₃z₄ k₁k₂k₃k₄, the first puncturing pattern is 0111 y₁y₂y₃y₄ z₁z₂z₃z₄ k₁k₂k₃k₄ and the second puncturing pattern is a puncturing pattern corresponding to the 484+242-tone MRU 1, where yᵢ is negation of yᵢ, zᵢ is negation of zᵢ, kᵢ is negation of kᵢ, i includes 1, 2, 3, and 4, y₁y₂y₃y₄ is any one of 0111, 1011, 1101, 1110, 1100, 0011, 1001, or 0000, z₁z₂z₃z₄ is any one of 1111, 0111, 1011, 1101, 1110, 1100, 0011, 1001, or 0000, k₁k₂k₃k₄ is any one of 1111, 0111, 1011, 1101, 1110, 1100, 0011, 1001, or 0000, and z₁z₂z₃z₄ and k₁k₂k₃k₄ are not both 0000; or when the first bitmap is 0001 0000 z₁z₂z₃z₄ k₁k₂k₃k₄, the first puncturing pattern is 1110 1111 z₁z₂z₃z₄ k₁k₂k₃k₄ and the second puncturing pattern is a puncturing pattern corresponding to the 996+484+242-tone MRU 4, where zᵢ is negation of zᵢ, kᵢ is negation of kᵢ, i includes 1, 2, 3, and 4, z₁z₂z₃z₄ is any one of 0111, 1011, 1101, 1110, 1100, 0011, 1001, or 0000, k₁k₂k₃k₄ is any one of 1111, 0111, 1011, 1101, 1110, 1100, 0011, 1001, or 0000, and z₁z₂z₃z₄ and k₁k₂k₃k₄ are not both 0000; or when the first bitmap is 0100 0000 z₁z₂z₃z₄ k₁k₂k₃k₄, the first puncturing pattern is 1011 1111 z₁z₂z₃z₄ k₁k₂k₃k₄ and the second puncturing pattern is a puncturing pattern corresponding to the 996+484+242-tone MRU 2, where zᵢ is negation of zᵢ, kᵢ is negation of kᵢ, i includes 1, 2, 3, and 4, z₁z₂z₃z₄ is any one of 0111, 1011, 1101, 1110, 1100, 0011, 1001, or 0000, k₁k₂k₃k₄ is any one of 1111, 0111, 1011, 1101, 1110, 1100, 0011, 1001, or 0000, and z₁z₂z₃z₄ and k₁k₂k₃k₄ are not both 0000; or when the first bitmap is 0010 0000 z₁z₂z₃z₄ k₁k₂k₃k₄, the first puncturing pattern is 1101 1111 z₁z₂z₃z₄ k₁k₂k₃k₄ and the second puncturing pattern is a puncturing pattern corresponding to the 996+484+242-tone MRU 3, where zᵢ is negation of zᵢ, kᵢ is negation of kᵢ, i includes 1, 2, 3, and 4, z₁z₂z₃z₄ is any one of 0111, 1011, 1101, 1110, 1100, 0011, 1001, or 0000, k₁k₂k₃k₄ is any one of 1111, 0111, 1011, 1101, 1110, 1100, 0011, 1001, or 0000, and z₁z₂z₃z₄ and k₁k₂k₃k₄ are not both 0000; or when the first bitmap is 1000 0000 z₁z₂z₃z₄ k₁k₂k₃k₄, the first puncturing pattern is 0111 1111 z₁z₂z₃z₄ k₁k₂k₃k₄ and the second puncturing pattern is a puncturing pattern corresponding to the 996+484+242-tone MRU 1, where zᵢ is negation of zᵢ, hi is negation of kᵢ, i includes 1, 2, 3, and 4, z₁z₂z₃z₄ is any one of 0111, 1011, 1101, 1110, 1100, 0011, 1001, or 0000, k₁k₂k₃k₄ is any one of 1111, 0111, 1011, 1101, 1110, 1100, 0011, 1001, or 0000, and z₁z₂z₃z₄ and k₁k₂k₃k₄ are not both 0000; or when the first bitmap is 0001 0000 0000 k₁k₂k₃k₄, the first puncturing pattern is 1110 1111 1111 k₁k₂k₃k₄ and the second puncturing pattern is a puncturing pattern corresponding to the 2*996+484-tone MRU 2, where kᵢ is negation of kᵢ, i includes 1, 2, 3, and 4, and k₁k₂k₃k₄ is any one of 0111, 1011, 1101, 1110, 1100, 0011, 1001, or 0000; or when the first bitmap is 0100 0000 0000 k₁k₂k₃k₄, the first puncturing pattern is 1011 1111 1111 k₁k₂k₃k₄ and the second puncturing pattern is a puncturing pattern corresponding to the 2*996+484-tone MRU 1, where kᵢ is negation of kᵢ, i includes 1, 2, 3, and 4, and k₁k₂k₃k₄ is any one of 0111, 1011, 1101, 1110, 1100, 0011, 1001, or 0000; or when the first bitmap is 0010 0000 0000 k₁k₂k₃k₄, the first puncturing pattern is 1101 1111 1111 k₁k₂k₃k₄ and the second puncturing pattern is a puncturing pattern corresponding to the 2*996+484-tone MRU 2, where kᵢ is negation of kᵢ, i includes 1, 2, 3, and 4, and k₁k₂k₃k₄ is any one of 0111, 1011, 1101, 1110, 1100, 0011, 1001, or 0000; or when the first bitmap is 1000 0000 0000 k₁k₂k₃k₄, the first puncturing pattern is 0111 1111 1111 k₁k₂k₃k₄ and the second puncturing pattern is a puncturing pattern corresponding to the 2*996+484-tone MRU 1, where kᵢ is negation of kᵢ, i includes 1, 2, 3, and 4, and k₁k₂k₃k₄ is any one of 0111, 1011, 1101, 1110, 1100, 0011, 1001, or 0000; or when the first bitmap is 0001 0000 0000 0000, the first puncturing pattern is 1110 1111 1111 1111 and the second puncturing pattern is a puncturing pattern corresponding to the 3*996+484-tone MRU 2; or when the first bitmap is 0100 0000 0000 0000, the first puncturing pattern is 10 1111 1111 1111 and the second puncturing pattern is a puncturing pattern corresponding to the 3*996+484-tone MRU 1; or when the first bitmap is 0010 0000 0000 0000, the first puncturing pattern is 1101 1111 1111 1111 and the second puncturing pattern is a puncturing pattern corresponding to the 3*996+484-tone MRU 2; Or when the first bitmap is 1000 0000 0000 0000, the first puncturing pattern is 0111 1111 1111 1111 and the second puncturing pattern is a puncturing pattern corresponding to the 3*996+484-tone MRU 1; or when the first bitmap is 0000 0110 z₁z₂z₃z₄ k₁k₂k₃k₄, the first puncturing pattern is 1111 1101 and the second puncturing pattern is a puncturing pattern corresponding to the 996-tone RU 1, where zᵢ is negation of zᵢ, kᵢ is negation of kᵢ, i includes 1, 2, 3, and 4, z₁z₂z₃z₄ is any one of 1111, 0111, 1011, 1101, 1110, 1100, 0011, 1001, or 0000, k₁k₂k₃k₄ is any one of 0111, 1011, 1101, 1110, 1100, 0011, 1001, or 0000, and z₁z₂z₃z₄ and k₁k₂k₃k₄ are not both 0000; or when the first bitmap is 0000 0110 0000 0000, the first puncturing pattern is 1111 1001 1111 1111 and the second puncturing pattern is a puncturing pattern corresponding to the 3*996-tone MRU 2; or when the first bitmap is 0000 0011 z₁z₂z₃z₄ k₁k₂k₃k₄, the first puncturing pattern is 1111 1100 z₁z₂z₃z₄ k₁k₂k₃k₄ and the second puncturing pattern is a puncturing pattern corresponding to the 996+484-tone MRU 4, where zᵢ is negation of zᵢ, kᵢ is negation of kᵢ, i includes 1, 2, 3, and 4, z₁z₂z₃z₄ is any one of 0111, 1011, 1101, 1110, 1100, 0011, 1001, or 0000, k₁k₂k₃k₄ is any one of 1111, 0111, 1011, 1101, 1110, 1100, 0011, 1001, or 0000, and z₁z₂z₃z₄ and k₁k₂k₃k₄ are not both 0000; or when the first bitmap is 0000 1100 z₁z₂z₃z₄ k₁k₂k₃k₄, the first puncturing pattern is 1111 0011 z₁z₂z₃z₄ k₁k₂k₃k₄ and the second puncturing pattern is a puncturing pattern corresponding to the 996+484-tone MRU 3, where zᵢ is negation of zᵢ, kᵢ is negation of kᵢ, i includes 1, 2, 3, and 4, z₁z₂z₃z₄ is any one of 0111, 1011, 1101, 1110, 1100, 0011, 1001, or 0000, k₁k₂k₃k₄ is any one of 1111, 0111, 1011, 1101, 1110, 1100, 0011, 1001, or 0000, and z₁z₂z₃z₄ and k₁k₂k₃k₄ are not both 0000; or when the first bitmap is 0000 0011 0000 k₁k₂k₃k₄, the first puncturing pattern is 1111 1100 1111 k₁k₂k₃k₄ and the second puncturing pattern is a puncturing pattern corresponding to the 2*996+484-tone MRU 4, where kᵢ is negation of kᵢ, i includes 1, 2, 3, and 4, and k₁k₂k₃k₄ is any one of 0111, 1011, 1101, 1110, 1100, 0011, 1001, or 0000; or when the first bitmap is 0000 1100 0000 k₁k₂k₃k₄, the first puncturing pattern is 1111 0011 1111 k₁k₂k₃k₄ and the second puncturing pattern is a puncturing pattern corresponding to the 2*996+484-tone MRU 3, where kᵢ is negation of kᵢ, i includes 1, 2, 3, and 4, and k₁k₂k₃k₄ is any one of 0111, 1011, 1101, 1110, 1100, 0011, 1001, or 0000; or when the first bitmap is 0000 0001 z₁z₂z₃z₄ k₁k₂k₃k₄, the first puncturing pattern is 1111 1110 z₁z₂z₃z₄ k₁k₂k₃k₄ and the second puncturing pattern is a puncturing pattern corresponding to the 996+484+242-tone MRU 8, where zᵢ is negation of zᵢ, kᵢ is negation of kᵢ, i includes 1, 2, 3, and 4, z₁z₂z₃z₄ is any one of 0111, 1011, 1101, 1110, 1100, 0011, 1001, or 0000, k₁k₂k₃k₄ is any one of 1111, 0111, 1011, 1101, 1110, 1100, 0011, 1001, or 0000, and z₁z₂z₃z₄ and k₁k₂k₃k₄ are not both 0000; or when the first bitmap is 0000 0010 z₁z₂z₃z₄ k₁k₂k₃k₄, the first puncturing pattern is 1111 1101 z₁z₂z₃z₄ k₁k₂k₃k₄ and the second puncturing pattern is a puncturing pattern corresponding to the 996+484+242-tone MRU 7, where zᵢ is negation of zᵢ, kᵢ is negation of kᵢ, i includes 1, 2, 3, and 4, z₁z₂z₃z₄ is any one of 0111, 1011, 1101, 1110, 1100, 0011, 1001, or 0000, k₁k₂k₃k₄ is any one of 1111, 0111, 1011, 1101, 1110, 1100, 0011, 1001, or 0000, and z₁z₂z₃z₄ and k₁k₂k₃k₄ are not both 0000; or when the first bitmap is 0000 0100 z₁z₂z₃z₄ k₁k₂k₃k₄, the first puncturing pattern is 1111 1011 z₁z₂z₃z₄ k₁k₂k₃k₄ and the second puncturing pattern is a puncturing pattern corresponding to the 996+484+242-tone MRU 6, where zᵢ is negation of zᵢ, kᵢ is negation of kᵢ, i includes 1, 2, 3, and 4, z₁z₂z₃z₄ is any one of 0111, 1011, 1101, 1110, 1100, 0011, 1001, or 0000, k₁k₂k₃k₄ is any one of 1111, 0111, 1011, 1101, 1110, 1100, 0011, 1001, or 0000, and z₁z₂z₃z₄ and k₁k₂k₃k₄ are not both 0000; or when the first bitmap is 0000 1000 z₁z₂z₃z₄ k₁k₂k₃k₄, the first puncturing pattern is 1111 0111 z₁z₂z₃z₄ k₁k₂k₃k₄ and the second puncturing pattern is a puncturing pattern corresponding to the 996+484+242-tone MRU 5, where zᵢ is negation of zᵢ, kᵢ is negation of kᵢ, i includes 1, 2, 3, and 4, z₁z₂z₃z₄ is any one of 0111, 1011, 1101, 1110, 1100, 0011, 1001, or 0000, k₁k₂k₃k₄ is any one of 1111, 0111, 1011, 1101, 1110, 1100, 0011, 1001, or 0000, and z₁z₂z₃z₄ and k₁k₂k₃k₄ are not both 0000; or when the first bitmap is 0000 0001 0000 k₁k₂k₃k₄, the first puncturing pattern is 1111 1110 1111 k₁k₂k₃k₄ and the second puncturing pattern is a puncturing pattern corresponding to the 2*996+484-tone MRU 4, where kᵢ is negation of kᵢ, i includes 1, 2, 3, and 4, and k₁k₂k₃k₄ is any one of 0111, 1011, 1101, 1110, 1100, 0011, 1001, or 0000; or when the first bitmap is 0000 0010 0000 k₁k₂k₃k₄, the first puncturing pattern is 1111 1101 1111 k₁k₂k₃k₄ and the second puncturing pattern is a puncturing pattern corresponding to the 2*996+484-tone MRU 4, where k is negation of kᵢ, i includes 1, 2, 3, and 4, and k₁k₂k₃k₄ is any one of 1111, 0111, 1011, 1101, 1110, 1100, 0011, 1001, or 0000; or when the first bitmap is 0000 0100 0000 k₁k₂k₃k₄, the first puncturing pattern is 1111 1011 1111 k₁k₂k₃k₄ and the second puncturing pattern is a puncturing pattern corresponding to the 2*996+484-tone MRU 3, where kᵢ is negation of kᵢ, i includes 1, 2, 3, and 4, and k₁k₂k₃k₄ is any one of 1111, 0111, 1011, 1101, 1110, 1100, 0011, 1001, or 0000; or when the first bitmap is 0000 1000 0000 k₁k₂k₃k₄, the first puncturing pattern is 1111 0111 1111 k₁k₂k₃k₄ and the second puncturing pattern is a puncturing pattern corresponding to the 2*996+484-tone MRU 3, where kᵢ is negation of kᵢ, i includes 1, 2, 3, and 4, and k₁k₂k₃k₄ is any one of 1111, 0111, 1011, 1101, 1110, 1100, 0011, 1001, or 0000; or when the first bitmap is 0000 0001 0000 0000, the first puncturing pattern is 1111 1110 1111 1111 and the second puncturing pattern is a puncturing pattern corresponding to the 3*996+484-tone MRU 4; or when the first bitmap is 0000 0010 0000 0000, the first puncturing pattern is 1111 1101 1111 1111 and the second puncturing pattern is a puncturing pattern corresponding to the 3*996+484-tone MRU 4; or when the first bitmap is 0000 0100 0000 0000, the first puncturing pattern is 1111 1011 1111 1111 and the second puncturing pattern is a puncturing pattern corresponding to the 3*996+484-tone MRU 3; or when the first bitmap is 0000 1000 0000 0000, the first puncturing pattern is 1111 0111 1111 1111, and the second puncturing pattern is a puncturing pattern corresponding to the 3*996+484-tone MRU 3; or when the first bitmap is 0000 0000 0110 k₁k₂k₃k₄, the first puncturing pattern is 1111 1111 1001 k₁k₂k₃k₄ and the second puncturing pattern is a puncturing pattern corresponding to the 2*996-tone RU 1, where kᵢ is negation of kᵢ, i includes 1, 2, 3, and 4, and k₁k₂k₃k₄ is any one of 0111, 1011, 1101, 1110, 1100, 0011, 1001, or 0000; or when the first bitmap is 0000 0000 0011 k₁k₂k₃k₄, the first puncturing pattern is 1111 1111 1100 k₁k₂k₃k₄ and the second puncturing pattern is a puncturing pattern corresponding to the 2*996+484-tone MRU 6, where kᵢ is negation of kᵢ, i includes 1, 2, 3, and 4, and k₁k₂k₃k₄ is any one of 0111, 1011, 1101, 1110, 1100, 0011, 1001, or 0000; or when the first bitmap is 0000 0000 1100 k₁k₂k₃k₄, the first puncturing pattern is 1111 1111 0011 k₁k₂k₃k₄ and the second puncturing pattern is a puncturing pattern corresponding to the 2*996+484-tone MRU 5, where kᵢ is negation of kᵢ, i includes 1, 2, 3, and 4, and k₁k₂k₃k₄ is any one of 0111, 1011, 1101, 1110, 1100, 0011, 1001, or 0000; or when the first bitmap is 0000 0000 0001 k₁k₂k₃k₄, the first puncturing pattern is 1111 1111 1110 k₁k₂k₃k₄ and the second puncturing pattern is a puncturing pattern corresponding to the 2*996+484-tone MRU 6, where kᵢ is negation of kᵢ, i includes 1, 2, 3, and 4, and k₁k₂k₃k₄ is any one of 0111, 1011, 1101, 1110, 1100, 0011, 1001, or 0000; or when the first bitmap is 0000 0000 0010 k₁k₂k₃k₄, the first puncturing pattern is 1111 1111 1101 k₁k₂k₃k₄ and the second puncturing pattern is a puncturing pattern corresponding to the 2*996+484-tone MRU 6, where kᵢ is negation of kᵢ, i includes 1, 2, 3, and 4, and k₁k₂k₃k₄ is any one of 0111, 1011, 1101, 1110, 1100, 0011, 1001, or 0000; or when the first bitmap is 0000 0000 0100 k₁k₂k₃k₄, the first puncturing pattern is 1111 1111 1011 k₁k₂k₃k₄ and the second puncturing pattern is a puncturing pattern corresponding to the 2*996+484-tone MRU 5, where kᵢ is negation of kᵢ, i includes 1, 2, 3, and 4, and k₁k₂k₃k₄ is any one of 0111, 1011, 1101, 1110, 1100, 0011, 1001, or 0000; or when the first bitmap is 0000 0000 1000 k₁k₂k₃k₄, the first puncturing pattern is 1111 1111 0111 k₁k₂k₃k₄ and the second puncturing pattern is a puncturing pattern corresponding to the 2*996+484-tone MRU 5, where kᵢ is negation of kᵢ, i includes 1, 2, 3, and 4, and k₁k₂k₃k₄ is any one of 0111, 1011, 1101, 1110, 1100, 0011, 1001, or 0000; or when the first bitmap is 0000 0000 0001 0000, the first puncturing pattern is 1111 1111 1110 1111 and the second puncturing pattern is a puncturing pattern corresponding to the 2*996+484-tone MRU 6; or when the first bitmap is 0000 0000 0010 0000, the first puncturing pattern is 1111 1111 1101 1111 and the second puncturing pattern is a puncturing pattern corresponding to the 3*996+484-tone MRU 6; or when the first bitmap is 0000 0000 0100 0000, the first puncturing pattern is 1111 1111 1011 1111 and the second puncturing pattern is a puncturing pattern corresponding to the 3*996+484-tone MRU 5; or when the first bitmap is 0000 0000 1000 0000, the first puncturing pattern is 1111 1111 0111 1111, and the second puncturing pattern is a puncturing pattern corresponding to the 3*996+484-tone MRU 5; or when the first bitmap is 0000 0000 0000 0110, the first puncturing pattern is 1111 1111 1111 1001 and the second puncturing pattern is a puncturing pattern corresponding to the 3*996-tone MRU 4; or when the first bitmap is 0000 0000 0000 0001, the first puncturing pattern is 1111 1111 1111 1110 and the second puncturing pattern is a puncturing pattern corresponding to the 3*996+484-tone MRU 8; or when the first bitmap is 0000 0000 0000 0010, the first puncturing pattern is 1111 1111 1111 1101 and the second puncturing pattern is a puncturing pattern corresponding to the 3*996+484-tone MRU 8; or when the first bitmap is 0000 0000 0000 0100, the first puncturing pattern is 1111 1111 1111 1011 and the second puncturing pattern is a puncturing pattern corresponding to the 3*996+484-tone MRU 7; or when the first bitmap is 0000 0000 0000 1000, the first puncturing pattern is 1111 1111 1111 0111 and the second puncturing pattern is a puncturing pattern corresponding to the 3*996+484-tone MRU 7.

It can be understood that, when the first BSS bandwidth is 320 MHz, the first puncturing pattern is a puncturing pattern with a maximum size that corresponds to the first bitmap and is supported by OFDMA transmission but not supported by non-OFDMA transmission, and the second puncturing pattern is a puncturing pattern with a maximum size that corresponds to the first bitmap and is supported by the non-OFDMA transmission. Generally, when sending a PPDU, the first device or the second device may preferably use the second puncturing pattern (namely, the non-OFDMA puncturing pattern with the maximum size) to perform non-OFDMA transmission, or preferentially use the first puncturing pattern (namely, the OFDMA puncturing pattern with the maximum size) to perform OFDMA transmission. Certainly, the non-OFDMA transmission may be alternatively performed by using a supported non-OFDMA puncturing pattern with a smaller size, or the OFDMA transmission may be performed by using a supported OFDMA puncturing pattern with a smaller size. Sizes are sorted according to a quantity of included subcarriers. A larger size indicates a larger quantity of subcarriers, and a smaller size indicates a smaller quantity of subcarriers.

For example, an illustrative description is provided herein by using an example in which the first bitmap is 0000 0000 0000 1000, the first puncturing pattern is 1111 1111 1111 0111, and the second puncturing pattern is a puncturing pattern corresponding to the 3*996+484-tone MRU 7. It is assumed that the first device needs to perform non-OFDMA transmission, and the first device may send a PPDU based on the puncturing pattern corresponding to the 3*996+484-tone MRU 7 (that is, send the PPDU on the 3*996+484-tone MRU 7 in the 320 MHz bandwidth). Optionally, the first device may alternatively perform the non-OFDMA transmission by using a supported non-OFDMA puncturing pattern with a smaller size. For example, the first device may alternatively send the PPDU based on a puncturing pattern corresponding to the 242-tone RU 1 (that is, send the PPDU on the 242-tone RU 1 in the 320 MHz bandwidth). For another example, the first device may alternatively send the PPDU on the 484-tone RU 1 in the 320 MHz bandwidth. For still another example, the first device may alternatively send the PPDU on the 484+242-tone MRU 1 to the 484+242-tone MRU 4 in the 320 MHz bandwidth. This is not limited herein.

For a clearer description of the mapping relationships between the first bitmap and the first puncturing pattern and between the first bitmap and the second puncturing pattern when the first BSS bandwidth is 320 MHz and the first BSS bandwidth is divided into a primary 80 MHz channel, a secondary 80 MHz channel, and a secondary 160 MHz channel in ascending order of frequencies in sequence, the mapping relationships can be converted into a mapping table shown in Table 6 below.

TABLE 6
A table of mapping of the 320 MHz bandwidth (primary 80 MHz
channel-secondary 80 MHz channel-secondary 160 MHz channel)

| First bitmap (0 | First puncturing | | Other conditions |
|---|---|---|---|
| indicates that | pattern (0 | | (than the |
| transmission is allowed, | indicates | | conditions in |
| and 1 indicates that | puncturing, and 1 | Second puncturing pattern (0 | Note 3 to Note 5 |
| transmission is not | indicates no | indicates puncturing, and 1 | at the bottom of |
| allowed) | puncturing) | indicates no puncturing) | this table) |
| 0110 y₁y₂y₃ y₄z₁z₂z₃z₄ | 1001 y₁y₂y₃y₄ | 20 MHz PPDU: | None |
| k₁k₂k₃k₄ | z₁z₂z₃z₄ k₁k₂k₃k₄ | 1111 (namely, 242-tone RU 1) | |
| 0011 y₁y₂y₃y₄ z₁z₂z₃z₄ | 1100 y₁y₂y₃y₄ | 40 MHz PPDU: | y₁y₂y₃y₄ is not |
| k₁k₂k₃k₄ | z₁z₂z₃z₄ k₁k₂k₃k₄ | 1111 (namely, 484-tone RU 1) | equal to 1111. |
| 1100 y₁y₂y₃ y₄z₁z₂z₃z₄ | 0011 y₁y₂y₃y₄ | 40 MHz PPDU: | y₁y₂y₃y₄ is not |
| k₁k₂k₃k₄ | z₁z₂z₃z₄ k₁k₂k₃k₄ | 1111 (namely, 484-tone RU 1) | equal to 1111. |
| 0011 0000 z₁z₂z₃z₄ | 1100 1111 | 996 + 484-tone MRU of 160 | z₁z₂z₃z₄ is not |
| k₁k₂k₃k₄ | z₁z₂z₃z₄ k₁k₂k₃k₄ | MHz PPDU: | equal to 1111. |
| | | 1100 1111 (namely, | |
| | | 996 + 484-tone MRU 2) | |
| 1100 0000 z₁z₂z₃z₄ | 0011 1111 | 996 + 484-tone MRU of 160 | z₁z₂z₃z₄ is not |
| k₁k₂k₃k₄ | z₁z₂z₃z₄ k₁k₂k₃k₄ | MHz PPDU: | equal to 1111. |
| | | 0011 1111 (namely, | |
| | | 996 + 484-tone MRU 1) | |
| 0011 0000 0000 | 1100 1111 1111 | 2 * 996 + 484-tone MRU of | k₁k₂k₃k₄ is not |
| k₁k₂k₃k₄ | k₁k₂k₃k₄ | 320 MHz PPDU: | equal to 1111. |
| | | 1100 1111 1111 0000 | |
| | | (namely, 2 * 996 + 484-tone | |
| | | MRU 2) | |
| 1100 0000 0000 | 0011 1111 1111 | 2 * 996 + 484-tone MRU of | k₁k₂k₃k₄ is not |
| k₁k₂k₃k₄ | k₁k₂k₃k₄ | 320 MHz PPDU: | equal to 1111. |
| | | 0011 1111 1111 0000 | |
| | | (namely, 2 * 996 + 484-tone | |
| | | MRU 1) | |
| 0001 y₁y₂y₃y₄ z₁z₂z₃z₄ | 1110 y₁y₂y₃y₄ | 484 + 242-tone MRU of 80 | y₁y₂y₃y₄ is not |
| k₁k₂k₃k₄ | z₁z₂z₃z₄ k₁k₂k₃k₄ | MHz PPDU: | equal to 1111. |
| | | 1110 (namely, 484 + 242-tone | |
| | | MRU 4) | |
| 0100 y₁y₂y₃y₄ z₁z₂z₃z₄ | 1011 y₁y₂y₃y₄ | 484 + 242-tone MRU of 80 | y₁y₂y₃y₄ is not |
| k₁k₂k₃k₄ | z₁z₂z₃z₄ k₁k₂k₃k₄ | MHz PPDU: | equal to 1111. |
| | | 1011 (namely, 484 + 242-tone | |
| | | MRU 2) | |
| 0010 y₁y₂y₃y₄ z₁z₂z₃z₄ | 1101 y₁y₂y₃y₄ | 484 + 242-tone MRU of 80 | y₁y₂y₃y₄ is not |
| k₁k₂k₃k₄ | z₁z₂z₃z₄ k₁k₂k₃k₄ | MHz PPDU: | equal to 1111. |
| | | 1101 (namely, 484 + 242-tone | |
| | | MRU 3) | |
| 1000 y₁y₂y₃y₄ z₁z₂z₃z₄ | 0111 y₁y₂y₃y₄ | 484 + 242-tone MRU of 80 | y₁y₂y₃y₄ is not |
| k₁k₂k₃k₄ | z₁z₂z₃z₄ k₁k₂k₃k₄ | MHz PPDU: | equal to 1111. |
| | | 0111 (namely, 484 + 242-tone | |
| | | MRU 1) | |
| 0001 0000 z₁z₂z₃z₄ | 1110 1111 | 996 + 484 + 242-tone MRU of | z₁z₂z₃z₄ is not |
| k₁k₂k₃k₄ | z₁z₂z₃z₄ k₁k₂k₃k₄ | 160 MHz PPDU: | equal to 1111. |
| | | 1110 1111 (namely, | |
| | | 996 + 484 + 242-tone MRU 4) | |
| 0100 0000 z₁z₂z₃z₄ | 1011 1111 | 996 + 484 + 242-tone MRU of | z₁z₂z₃z₄ is not |
| k₁k₂k₃k₄ | z₁z₂z₃z₄ k₁k₂k₃k₄ | 160 MHz PPDU: | equal to 1111. |
| | | 1011 1111 (namely, | |
| | | 996 + 484 + 242-tone MRU 2) | |
| 0010 0000 z₁z₂z₃z₄ | 1101 1111 | 996 + 484 + 242-tone MRU of | z₁z₂z₃z₄ is not |
| k₁k₂k₃k₄ | z₁z₂z₃z₄ k₁k₂k₃k₄ | 160M Hz PPDU: | equal to 1111. |
| | | 1101 1111 (namely, | |
| | | 996 + 484 + 242-tone MRU 3) | |
| 1000 0000 z₁z₂z₃z₄ | 0111 1111 | 996 + 484 + 242-tone MRU of | z₁z₂z₃z₄ is not |
| k₁k₂k₃k₄ | z₁z₂z₃z₄ k₁k₂k₃k₄ | 160 MHz PPDU: | equal to 1111. |
| | | 0111 1111 (namely, | |
| | | 996 + 484 + 242-tone MRU 1) | |
| 0001 0000 0000 | 1110 1111 1111 | 2 * 996 + 484-tone MRU of | k₁k₂k₃k₄ is not |
| k₁k₂k₃k₄ | k₁k₂k₃k₄ | 320 MHz PPDU: | equal to 1111. |
| | | 1100 1111 1111 0000 | |
| | | (namely, 2 * 996 + 484-tone | |
| | | MRU 2) | |
| 0100 0000 0000 | 1011 1111 1111 | 2 * 996 + 484-tone MRU of | k₁k₂k₃k₄ is not |
| k₁k₂k₃k₄ | k₁k₂k₃k₄ | 320 MHz PPDU: | equal to 1111. |
| | | 0011 1111 1111 0000 | |
| | | (namely, 2 * 996 + 484-tone | |
| | | MRU 1) | |
| 0010 0000 0000 | 1101 1111 1111 | 2 * 996 + 484-tone MRU of | k₁k₂k₃k₄ is not |
| k₁k₂k₃k₄ | k₁k₂k₃k₄ | 320 MHz PPDU: | equal to 1111. |
| | | 1100 1111 1111 0000 | |
| | | (namely, 2 * 996 + 484-tone | |
| | | MRU 2) | |
| 1000 0000 0000 | 0111 1111 1111 | 2 * 996 + 484-tone MRU of | k₁k₂k₃k₄ is not |
| k₁k₂k₃k₄ | k₁k₂k₃k₄ | 320 MHz PPDU: | equal to 1111. |
| | | 0011 1111 1111 0000 | |
| | | (namely, 2 * 996 + 484-tone | |
| | | MRU 1) | |
| 0001 0000 0000 0000 | 1110 1111 1111 | 3 * 996 + 484-tone MRU of | None |
| | 1111 | 320 MHz PPDU: | |
| | | 1100 1111 1111 1111 | |
| | | (namely, 3 * 996 + 484-tone | |
| | | MRU 2) | |
| 0100 0000 0000 0000 | 1011 1111 1111 | MRU of 320 MHz PPDU: | None |
| | 1111 | 0011 1111 1111 1111 | |
| | | (namely, 3 * 996 + 484-tone | |
| | | MRU 1) | |
| 0010 0000 0000 0000 | 1101 1111 1111 | MRU of 320 MHz PPDU: | None |
| | 1111 | 1100 1111 1111 1111 | |
| | | (namely, 3 * 996 + 484-tone | |
| | | MRU 2) | |
| 1000 0000 0000 0000 | 0111 1111 1111 | MRU of 320 MHz PPDU: | None |
| | 1111 | 0011 1111 1111 1111 | |
| | | (namely, 3 * 996 + 484-tone | |
| | | MRU 1) | |
| 0000 0110 z₁z₂z₃z₄ | 1111 1001 | 80 MHz PPDU: | k₁k₂k₃k₄ is not |
| k₁k₂k₃k₄ | z₁z₂z₃z₄ k₁k₂k₃k₄ | 1111 (namely, 996-tone RU 1) | equal to 1111. |
| 0000 0110 0000 0000 | 1111 1001 1111 | 3 * 996-tone MRU of 320 | None |
| | 1111 | MHz PPDU: | |
| | | 1111 0000 1111 1111 | |
| | | (namely, 3 * 996-tone MRU 2) | |
| 0000 0011 z₁z₂z₃z₄ | 1111 1100 | 996 + 484-tone MRU of 160 | z₁z₂z₃z₄ is not |
| k₁k₂k₃k₄ | z₁z₂z₃z₄ k₁k₂k₃k₄ | MHz PPDU: | equal to 1111. |
| | | 1111 1100 (namely, | |
| | | 996 + 484-tone MRU 4) | |
| 0000 1100 z₁z₂z₃z₄ | 1111 0011 | 996 + 484-tone MRU of 160 | z₁z₂z₃z₄ is not |
| k₁k₂k₃k₄ | z₁z₂z₃z₄ k₁k₂k₃k₄ | MHz PPDU | equal to 1111. |
| | | 1111 0011 (namely, | |
| | | 996 + 484-tone MRU 3) | |
| 0000 0011 0000 | 1111 1100 1111 | 2 * 996 + 484-tone MRU of | k₁k₂k₃k₄ is not |
| k₁k₂k₃k₄ | k₁k₂k₃k₄ | 320 MHz PPDU: | equal to 1111. |
| | | 1111 1100 1111 0000 | |
| | | (namely, 2 * 996 + 484-tone | |
| | | MRU 4) | |
| 0000 1100 0000 | 1111 0011 1111 | 2 * 996 + 484-tone MRU of | k₁k₂k₃k₄ is not |
| k₁k₂k₃k₄ | k₁k₂k₃k₄ | 320 MHz PPDU: | equal to 1111. |
| | | 1111 0011 1111 0000 | |
| | | (namely, 2 * 996 + 484-tone | |
| | | MRU 3) | |
| 0000 0001 z₁z₂z₃z₄ | 1111 1110 | 996 + 484 + 242-tone MRU of | z₁z₂z₃z₄ is not |
| k₁k₂k₃k₄ | z₁z₂z₃z₄ k₁k₂k₃k₄ | 160 MHz PPDU: | equal to 1111. |
| | | 1111 1110 (namely, | |
| | | 996 + 484 + 242-tone MRU 8) | |
| 0000 0010 z₁z₂z₃z₄ | 1111 1101 | 996 + 484 + 242-tone MRU of | z₁z₂z₃z₄ is not |
| k₁k₂k₃k₄ | z₁z₂z₃z₄ k₁k₂k₃k₄ | 160 MHz PPDU: | equal to 1111. |
| | | 1111 1101 (namely, | |
| | | 996 + 484 + 242-tone MRU 7) | |
| 0000 0100 z₁z₂z₃z₄ | 1111 1011 | 996 + 484 + 242-tone MRU of | z₁z₂z₃z₄ is not |
| k₁k₂k₃k₄ | z₁z₂z₃z₄ k₁k₂k₃k₄ | 160 MHz PPDU: | equal to 1111. |
| | | 1111 1011 (namely, | |
| | | 996 + 484 + 242-tone MRU 6) | |
| 0000 1000 z₁z₂z₃z₄ | 1111 0111 | 996 + 484 + 242-tone MRU of | z₁z₂z₃z₄ is not |
| k₁k₂k₃k₄ | z₁z₂z₃z₄ k₁k₂k₃k₄ | 160 MHz PPDU: | equal to 1111. |
| | | 1111 0111 (namely, | |
| | | 996 + 484 + 242-tone MRU 5) | |
| 0000 0001 0000 | 1111 1110 1111 | 2 * 996 + 484-tone MRU of | k₁k₂k₃k₄ is not |
| k₁k₂k₃k₄ | k₁k₂k₃k₄ | 320 MHz PPDU: | equal to 1111. |
| | | 1111 1100 1111 0000 | |
| | | (namely, 2 * 996 + 484-tone | |
| | | MRU 4) | |
| 0000 0010 0000 | 1111 1101 1111 | 2 * 996 + 484-tone MRU of | k₁k₂k₃k₄ is not |
| k₁k₂k₃k₄ | k₁k₂k₃k₄ | 320 MHz PPDU: | equal to 1111. |
| | | 1111 1100 1111 0000 | |
| | | (namely, 2 * 996 + 484-tone | |
| | | MRU 4) | |
| 0000 0100 0000 | 1111 1011 1111 | 2 * 996 + 484-tone MRU of | k₁k₂k₃k₄ is not |
| k₁k₂k₃k₄ | k₁k₂k₃k₄ | 320 MHz PPDU: | equal to 1111. |
| | | 1111 0011 1111 0000 | |
| | | (namely, 2 * 996 + 484-tone | |
| | | MRU 3) | |
| 0000 1000 0000 | 1111 0111 1111 | 2 * 996 + 484-tone MRU of | k₁k₂k₃k₄ is not |
| k₁k₂k₃k₄ | k₁k₂k₃k₄ | 320 MHz PPDU: | equal to 1111. |
| | | 1111 0011 1111 0000 | |
| | | (namely, 2 * 996 + 484-tone | |
| | | MRU 3) | |
| 0000 0001 0000 0000 | 1111 1110 1111 | 3 * 996 + 484-tone MRU of | None |
| | 1111 | 320 MHz PPDU: | |
| | | 1111 1100 1111 1111 | |
| | | (namely, 3 * 996 + 484-tone | |
| | | MRU 4) | |
| 0000 0010 0000 0000 | 1111 1101 1111 | 3 * 996 + 484-tone MRU of | None |
| | 1111 | 320 MHz PPDU: | |
| | | 1111 1100 1111 1111 | |
| | | (namely, 3 * 996 + 484-tone | |
| | | MRU 4) | |
| 0000 0100 0000 0000 | 1111 1011 1111 | 3 * 996 + 484-tone MRU of | None |
| | 1111 | 320 MHz PPDU: | |
| | | 1111 0011 1111 1111 | |
| | | (namely, 3 * 996 + 484-tone | |
| | | MRU 3) | |
| 0000 1000 0000 0000 | 1111 0111 1111 | 3 * 996 + 484-tone MRU of | None |
| | 1111 | 320 MHz PPDU: | |
| | | 1111 0011 1111 1111 | |
| | | (namely, 3 * 996 + 484-tone | |
| | | MRU 3) | |
| 0000 0000 0110 | 1111 1111 1001 | 160 MHz PPDU: | k₁k₂k₃k₄ is not |
| k₁k₂k₃k₄ | k₁k₂k₃k₄ | 11111111 (namely, 2 * 996- | equal to 1111. |
| | | tone RU 1) | |
| 0000 0000 0011 | 1111 1111 1100 | 2 * 996 + 484-tone MRU of | k₁k₂k₃k₄ is not |
| k₁k₂k₃k₄ | k₁k₂k₃k₄ | 320 MHz PPDU: | equal to 1111. |
| | | 1111 1111 1100 0000 | |
| | | (namely, 2 * 996 + 484-tone | |
| | | MRU 6) | |
| 0000 0000 1100 | 1111 1111 0011 | 2 * 996 + 484-tone MRU of | k₁k₂k₃k₄ is not |
| k₁k₂k₃k₄ | k₁k₂k₃k₄ | 320 MHz PPDU: | equal to 1111. |
| | | 1111 1111 0011 0000 | |
| | | (namely, 2 * 996 + 484-tone | |
| | | MRU 5) | |
| 0000 0000 0001 | 1111 1111 1110 | 2 * 996 + 484-tone MRU of | k₁k₂k₃k₄ is not |
| k₁k₂k₃k₄ | k₁k₂k₃k₄ | 320 MHz PPDU: | equal to 1111. |
| | | 1111 1111 1100 0000 | |
| | | (namely, 2 * 996 + 484-tone | |
| | | MRU 6) | |
| 0000 0000 0010 | 1111 1111 1101 | 2 * 996 + 484-tone MRU of | k₁k₂k₃k₄ is not |
| k₁k₂k₃k₄ | k₁k₂k₃k₄ | 320 MHz PPDU: | equal to 1111. |
| | | 1111 1111 1100 0000 | |
| | | (namely, 2 * 996 + 484-tone | |
| | | MRU 6) | |
| 0000 0000 0100 | 1111 1111 1011 | 2 * 996 + 484-tone MRU of | k₁k₂k₃k₄ is not |
| k₁k₂k₃k₄ | k₁k₂k₃k₄ | 320 MHz PPDU: | equal to 1111. |
| | | 1111 1111 0011 0000 | |
| | | (namely, 2 * 996 + 484-tone | |
| | | MRU 5) | |
| 0000 0000 1000 | 1111 1111 0111 | 2 * 996 + 484-tone MRU of | k₁k₂k₃k₄ is not |
| k₁k₂k₃k₄ | k₁k₂k₃k₄ | 320 MHz PPDU: | equal to 1111. |
| | | 1111 1111 0011 0000 | |
| | | (namely, 2 * 996 + 484-tone | |
| | | MRU 5) | |
| 0000 0000 0001 0000 | 1111 1111 1110 | 3 * 996 + 484-tone MRU of | None |
| | 1111 | 320 MHz PPDU: | |
| | | 1111 1111 1100 1111 | |
| | | (namely, 3 * 996 + 484-tone | |
| | | MRU 6) | |
| 0000 0000 0010 0000 | 1111 1111 1101 | 3 * 996 + 484-tone MRU of | None |
| | 1111 | 320 MHz PPDU: | |
| | | 1111 1111 1100 1111 | |
| | | (namely, 3 * 996 + 484-tone | |
| | | MRU 6) | |
| 0000 0000 0100 0000 | 1111 1111 1011 | 3 * 996 + 484-tone MRU of | None |
| | 1111 | 320 MHz PPDU: | |
| | | 1111 1111 0011 1111 | |
| | | (namely, 3 * 996 + 484-tone | |
| | | MRU 5) | |
| 0000 0000 1000 0000 | 1111 1111 0111 | 3 * 996 + 484-tone MRU of | None |
| | 1111 | 320 MHz PPDU: | |
| | | 1111 1111 0011 1111 | |
| | | (namely, 3 * 996 + 484-tone | |
| | | MRU 5) | |
| 0000 0000 0000 0110 | 1111 1111 1111 | 3 * 996-tone MRU of 320 | None |
| | 1001 | MHz PPDU: | |
| | | 1111 1111 1111 0000 | |
| | | (namely, 3 * 996-tone MRU 4) | |
| 0000 0000 0000 0001 | 1111 1111 1111 | 3 * 996 + 484-tone MRU of | None |
| | 1110 | 320 MHz PPDU: | |
| | | 1111 1111 1111 1100 | |
| | | (namely, 3 * 996 + 484-tone | |
| | | MRU 8) | |
| 0000 0000 0000 0010 | 1111 1111 1111 | 3 * 996 + 484-tone MRU of | None |
| | 1101 | 320 MHz PPDU: | |
| | | 1111 1111 1111 1100 | |
| | | (namely, 3 * 996 + 484-tone | |
| | | MRU 8) | |
| 0000 0000 0000 0100 | 1111 1111 1111 | 3 * 996 + 484-tone MRU of | None |
| | 1011 | 320 MHz PPDU: | |
| | | 1111 1111 1111 0011 | |
| | | (namely, 3 * 996 + 484-tone | |
| | | MRU 7) | |
| 0000 0000 0000 1000 | 1111 1111 1111 | 3 * 996 + 484-tone MRU of | None |
| | 0111 | 320 MHz PPDU: | |
| | | 1111 1111 1111 0011 | |
| | | (namely, 3 * 996 + 484-tone | |
| | | MRU 7) | |

Note 1:
yᵢ, zᵢ, and kᵢ each indicate that the value may be 1 or 0.
Note 2:
yᵢ indicates negation of yᵢ; when yᵢ is 0, yᵢ is 1, or when yᵢ is 1, yᵢ is 0; and zᵢ indicates negation of zᵢ, and kᵢ indicates negation of kᵢ, where i = 1, 2, 3, or 4.
Note 3:
z₁z₂z₃z₄ k₁k₂k₃k₄ may not be 0000 0000 (Otherwise, the BSS bandwidth is reduced to 160 MHz)
Note 4:
In this table, the primary 20 MHz channel is located at a non-punctured position in the primary 80 MHz channel.
Note 5:
y₁y₂y₃y₄, z₁z₂z₃z₄, and k₁k₂k₃k₄ each may be 1111, 0111, 101 1, 1101, 1110, 1100, 0011, 1001 or 0000.
Note 6:
The second puncturing pattern (namely, the non-OFDMA puncturing pattern with the maximum size) is preferably used to perform non-OFDMA transmission, or the first puncturing pattern (namely, the OFDMA puncturing pattern with the maximum size) is preferably used to perform OFDMA transmission. Certainly, the non-OFDMA transmission may be alternatively performed by using a supported non-OFDMA puncturing pattern with a smaller size, or the OFDMA transmission may be performed by using a supported OFDMA puncturing pattern with a smaller size. Sizes are sorted according to a quantity of included subcarriers. A larger size indicates a larger quantity of subcarriers, and a smaller size indicates a smaller quantity of subcarriers.

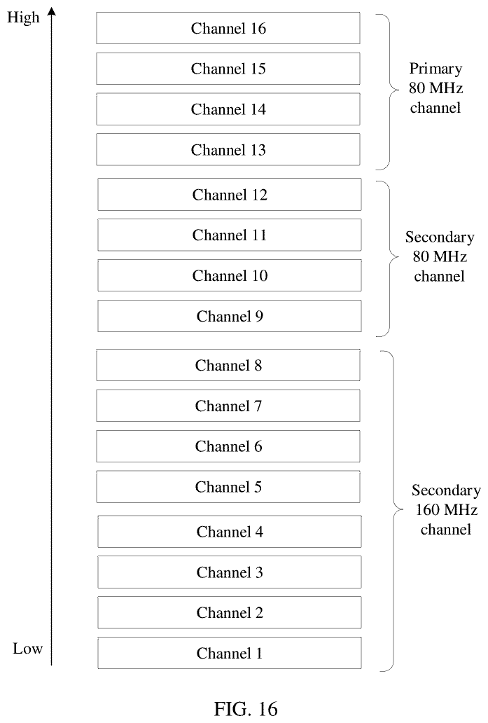

Optionally, in some feasible implementations, when the first BSS bandwidth is 320 MHz and the first BSS bandwidth is divided into a secondary 160 MHz channel, a secondary 80 MHz channel, and a primary 80 MHz channel in ascending order of frequencies in sequence (as shown in FIG. 16, the primary 20 MHz channel is located in a highest 80 MHz channel in the 320 MHz bandwidth): For mapping relationships between the first bitmap and the first puncturing pattern and between the first bitmap and the second puncturing pattern, the four bits corresponding to the primary 80 MHz channel, the four bits corresponding to the secondary 80 MHz channel, and the eight bits corresponding to the secondary 160 MHz channel in Table 6 need to be adjusted according to a sequence of the secondary 160 MHz channel, the secondary 80 MHz channel, and the primary 80 MHz channel respectively, to obtain the mapping relationships when the first BSS bandwidth is 320 MHz and the first BSS bandwidth is divided into the secondary 160 MHz channel, the secondary 80 MHz channel, and the primary 80 MHz channel in ascending order of frequencies in sequence. It can be understood that, after the four bits corresponding to the corresponding primary 80 MHz channel, the four bits corresponding to the corresponding secondary 80 MHz channel, and the eight bits corresponding to the corresponding secondary 160 MHz channel are swapped according to the different division of the first BSS bandwidth, an index value of a resource unit corresponding to the second puncturing pattern also needs to be adaptively adjusted. This is specifically determined based on an actual scenario, and is not limited herein.

For example, in Table 6, the first bitmap is 0011 0000 z₁z₂z₃z₄k₁k₂k₃k₄, the first puncturing pattern is 1100 1111 z₁z₂z₃z₄ k₁k₂k₃k₄, and the second puncturing pattern is 1100 1111 (namely, a puncturing pattern corresponding to the 996+484-tone MRU 2). When the first BSS bandwidth is 320 MHz and the first BSS bandwidth is divided into a secondary 160 MHz channel, a secondary 80 MHz channel, and a primary 80 MHz channel in ascending order of frequencies in sequence, the four bits corresponding to the primary 80 MHz channel, the four bits corresponding to the secondary 80 MHz channel, and the eight bits corresponding to the secondary 160 MHz channel in Table 6 are adjusted according to a sequence of the secondary 160 MHz channel, the secondary 80 MHz channel, and the primary 80 MHz channel, to obtain mapping relationships between the first bitmap and the first puncturing pattern and between the first bitmap and the second puncturing pattern when the first BSS bandwidth is 320 MHz and the first BSS bandwidth is divided into the secondary 160 MHz channel, the secondary 80 MHz channel, and the primary 80 MHz channel in ascending order of frequencies in sequence as follows: The first bitmap is z₁z₂z₃z₄k₁k₂k₃k₄ 0000 0011, the first puncturing pattern is z₁z₂z₃z₄ k₁k₂k₃k₄ 1111 1100, and the second puncturing pattern is 1111 1100 (namely, a puncturing pattern corresponding to the 996+484-tone MRU 4).

For another example, in Table 6, the first bitmap is 0000 0000 0000 0110, the first puncturing pattern is 1111 1111 1111 1001, and the second puncturing pattern is 1111 1111 1111 0000 (namely, a puncturing pattern corresponding to the 3*996-tone MRU 4). When the first BSS bandwidth is 320 MHz and the first BSS bandwidth is divided into a secondary 160 MHz channel, a secondary 80 MHz channel, and a primary 80 MHz channel in ascending order of frequencies in sequence, mapping relationships between the first bitmap and the first puncturing pattern and between the first bitmap and the second puncturing pattern are as follows: The first bitmap is 0000 0110 0000 0000, the first puncturing pattern is 1111 1001 1111 1111, and the second puncturing pattern is 1111 0000 1111 1111 (namely, a puncturing pattern corresponding to the 3*996-tone MRU 2).

For still another example, in Table 6, the first bitmap is 0000 0000 0000 0001, the first puncturing pattern is 1111 1111 1111 1110, and the second puncturing pattern is 1111 1111 1111 1100 (namely, a puncturing pattern corresponding to the 3*996+484-tone MRU 8). When the first BSS bandwidth is 320 MHz and the first BSS bandwidth is divided into a secondary 160 MHz channel, a secondary 80 MHz channel, and a primary 80 MHz channel in ascending order of frequencies in sequence, mapping relationships between the first bitmap and the first puncturing pattern and between the first bitmap and the second puncturing pattern are as follows: The first bitmap is 0000 0001 0000 0000, the first puncturing pattern is 1111 1110 1111 1111, and the second puncturing pattern is 1111 1100 1111 1111 (namely, a puncturing pattern corresponding to the 3*996+484-tone MRU 4).

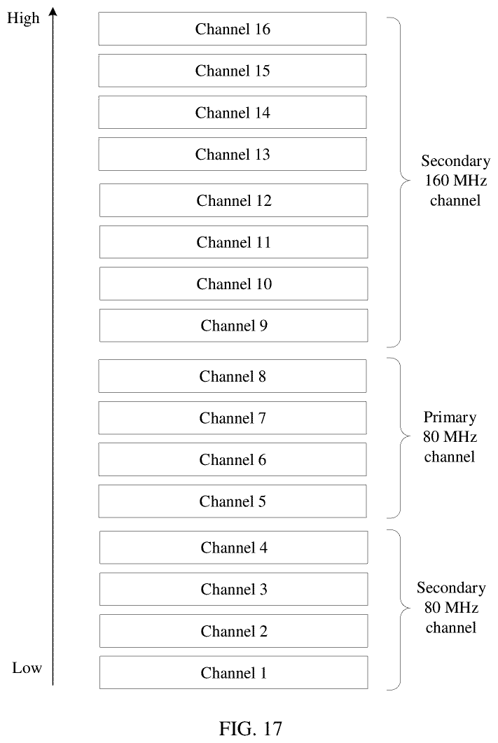

Optionally, in some feasible implementations, when the first BSS bandwidth is 320 MHz and the first BSS bandwidth is divided into a secondary 80 MHz channel, a primary 80 MHz channel, and a secondary 160 MHz channel in ascending order of frequencies in sequence (as shown in FIG. 17, the primary 20 MHz channel is located in an 80 MHz channel corresponding to a channel 5 to a channel 8 in the 320 MHz bandwidth), mapping relationships between the first bitmap and the first puncturing pattern and between the first bitmap and the second puncturing pattern are as follows when the first bitmap is y₁y₂y₃y₄ 0110 z₁z₂z₃z₄ k₁k₂k₃k₄, the first puncturing pattern is y₁y₂y₃y₄ 1001 z₁z₂z₃z₄ k₁k₂k₃k₄ and the second puncturing pattern is a puncturing pattern corresponding to the 242-tone RU 1, where yᵢ is negation of yᵢ, & is negation of zᵢ, kᵢ is negation of kᵢ, i includes 1, 2, 3, and 4, each of y₁y₂y₃y₄, k₁k₂k₃k₄, and z₁z₂z₃z₄ is any one of 1111, 0111, 1011, 1101, 1110, 1100, 0011, 1001, or 0000, and z₁z₂z₃z₄ and k₁k₂k₃k₄ are not both 0000; or when the first bitmap is y₁y₂y₃y₄ 0011 z₁z₂z₃z₄ k₁k₂k₃k₄, the first puncturing pattern is y₁y₂y₃y₄ 1100 z₁z₂z₃z₄ k₁k₂k₃k₄ and the second puncturing pattern is a puncturing pattern corresponding to the 484-tone RU 1, where yᵢ is negation of yᵢ, zᵢ is negation of zᵢ, kᵢ is negation of kᵢ, i includes 1, 2, 3, and 4, y₁y₂y₃y₄ is any one of 0111, 1011, 1101, 1110, 1100, 0011, 1001, or 0000, z₁z₂z₃z₄ and k₁k₂k₃k₄ each are any one of 1111, 0111, 1011, 1101, 1110, 1100, 0011, 1001, or 0000, and z₁z₂z₃z₄ and k₁k₂k₃k₄ are not both 1111 or not both 0000; or when the first bitmap is y₁y₂y₃y₄ 1100 z₁z₂z₃z₄ k₁k₂k₃k₄, the first puncturing pattern is y₁y₂y₃y₄ 0011 z₁z₂z₃z₄ k₁k₂k₃k₄ and the second puncturing pattern is a puncturing pattern corresponding to the 484-tone RU 1, where yᵢ is negation of yᵢ, zᵢ is negation of zᵢ, kᵢ is negation of kᵢ, i includes 1, 2, 3, and 4, y₁y₂y₃y₄ is any one of 0111, 1011, 1101, 1110, 1100, 0011, 1001, or 0000, z₁z₂z₃z₄ and k₁k₂k₃k₄ each are any one of 1111, 0111, 1011, 1101, 1110, 1100, 0011, 1001, or 0000, and z₁z₂z₃z₄ and k₁k₂k₃k₄ are not both 1111 or not both 0000; or when the first bitmap is y₁y₂y₃y₄ 0011 0000 0000, the first puncturing pattern is y₁y₂y₃y₄ 1100 1111 1111 and the second puncturing pattern is a puncturing pattern corresponding to the 2*996+484-tone MRU 8, where yᵢ is negation of yᵢ, i includes 1, 2, 3, and 4, and y₁y₂y₃y₄ is any one of 0111, 1011, 1101, 1110, 1100, 0011, 1001, or 0000; or when the first bitmap is y₁y₂y₃y₄ 1100 0000 0000, the first puncturing pattern is y₁y₂y₃y₄ 0011 1111 1111 and the second puncturing pattern is a puncturing pattern corresponding to the 2*996+484-tone MRU 7, where yᵢ is negation of yᵢ, i includes 1, 2, 3, and 4, and y₁y₂y₃y₄ is any one of 0111, 1011, 1101, 1110, 1100, 0011, 1001, or 0000; or when the first bitmap is 0000 0011 z₁z₂z₃z₄ k₁k₂k₃k₄, the first puncturing pattern is 1111 1100 z₁z₂z₃z₄ k₁k₂k₃k₄ and the second puncturing pattern is a puncturing pattern corresponding to the 996+484-tone MRU 4, where z; is negation of zᵢ, kᵢ is negation of kᵢ, i includes 1, 2, 3, and 4, z₁z₂z₃z₄ is any one of 0111, 1011, 1101, 1110, 1100, 0011, 1001, or 0000, k₁k₂k₃k₄ is any one of 1111, 0111, 1011, 1101, 1110, 1100, 0011, 1001, or 0000, and z₁z₂z₃z₄ and kᵢk₂k₃k₄ are not both 0000; or when the first bitmap is 0000 1100 z₁z₂z₃z₄ k₁k₂k₃k₄, the first puncturing pattern is 1111 0011 z₁z₂z₃z₄ k₁k₂k₃k₄ and the second puncturing pattern is a puncturing pattern corresponding to the 996+484-tone MRU 3, where Z; is negation of zᵢ, kᵢ is negation of kᵢ, i includes 1, 2, 3, and 4, z₁z₂z₃z₄ is any one of 0111, 1011, 1101, 1110, 1100, 0011, 1001, or 0000, k₁k₂k₃k₄ is any one of 1111, 0111, 1011, 1101, 1110, 1100, 0011, 1001, or 0000, and z₁z₂z₃z₄ and kᵢk₂k₃k₄ are not both 0000; or when the first bitmap is 0000 0011 0000 k₁k₂k₃k₄, the first puncturing pattern is 1111 1100 1111 k₁k₂k₃k₄ and the second puncturing pattern is a puncturing pattern corresponding to the 2*996+484-tone MRU 4, where kᵢ is negation of kᵢ, i includes 1, 2, 3, and 4, and k₁k₂k₃k₄ is any one of 0111, 1011, 1101, 1110, 1100, 0011, 1001, or 0000; or when the first bitmap is 0000 1100 0000 k₁k₂k₃k₄, the first puncturing pattern is 1111 0011 1111 k₁k₂k₃k₄ and the second puncturing pattern is a puncturing pattern corresponding to the 2*996+484-tone MRU 3, where kᵢ is negation of kᵢ, i includes 1, 2, 3, and 4, and k₁k₂k₃k₄ is any one of 0111, 1011, 1101, 1110, 1100, 0011, 1001, or 0000; or when the first bitmap is y₁y₂y₃y₄ 0001 z₁z₂z₃z₄ k₁k₂k₃k₄, the first puncturing pattern is y₁y₂y₃y₄ 1110 z₁z₂z₃z₄ k₁k₂k₃k₄ and the second puncturing pattern is a puncturing pattern corresponding to the 484+242-tone MRU 4, where yᵢ is negation of yᵢ, & is negation of zᵢ, kᵢ is negation of kᵢ, i includes 1, 2, 3, and 4, y₁y₂y₃y₄ is any one of 0111, 1011, 1101, 1110, 1100, 0011, 1001, or 0000, z₁z₂z₃z₄ and k₁k₂k₃k₄ each are any one of 1111, 0111, 1011, 1101, 1110, 1100, 0011, 1001, or 0000, and z₁z₂z₃z₄ and kᵢk₂k₃k₄ are not both 1111 or not both 0000; or when the first bitmap is y₁y₂y₃y₄ 0100 z₁z₂z₃z₄ k₁k₂k₃k₄, the first puncturing pattern is y₁y₂y₃y₄ 1011 z₁z₂z₃z₄ k₁k₂k₃k₄ and the second puncturing pattern is a puncturing pattern corresponding to the 484+242-tone MRU 2, where yᵢ is negation of yᵢ, zᵢ is negation of zᵢ, kᵢ is negation of kᵢ, i includes 1, 2, 3, and 4, y₁y₂y₃y₄ is any one of 0111, 1011, 1101, 1110, 1100, 0011, 1001, or 0000, z₁z₂z₃z₄ and k₁k₂k₃k₄ each are any one of 1111, 0111, 1011, 1101, 1110, 1100, 0011, 1001, or 0000, and z₁z₂z₃z₄ and k₁k₂k₃k₄ are not both 1111 or not both 0000; or when the first bitmap is y₁y₂y₃y₄ 0010 z₁z₂z₃z₄ k₁k₂k₃k₄, the first puncturing pattern is y₁y₂y₃y₄ 1101 z₁z₂z₃z₄ k₁k₂k₃k₄ and the second puncturing pattern is a puncturing pattern corresponding to the 484+242-tone MRU 3, where yᵢ is negation of yᵢ, zᵢ is negation of zᵢ, kᵢ is negation of kᵢ, i includes 1, 2, 3, and 4, y₁y₂y₃y₄ is any one of 0111, 1011, 1101, 1110, 1100, 0011, 1001, or 0000, z₁z₂z₃z₄ and k₁k₂k₃k₄ each are any one of 1111, 0111, 1011, 1101, 1110, 1100, 0011, 1001, or 0000, and z₁z₂z₃z₄ and k₁k₂k₃k₄ are not both 1111 or not both 0000; or when the first bitmap is y₁y₂y₃y₄ 1000 z₁z₂z₃z₄ k₁k₂k₃k₄, the first puncturing pattern is y₁y₂y₃y₄ 0111 z₁z₂z₃z₄ k₁k₂k₃k₄ and the second puncturing pattern is a puncturing pattern corresponding to the 484+242-tone MRU 1, where yᵢ is negation of yᵢ, zᵢ is negation of zᵢ, kᵢ is negation of kᵢ, i includes 1, 2, 3, and 4, y₁y₂y₃y₄ is any one of 0111, 1011, 1101, 1110, 1100, 0011, 1001, or 0000, z₁z₂z₃z₄ and k₁k₂k₃k₄ each are any one of 1111, 0111, 1011, 1101, 1110, 1100, 0011, 1001, or 0000, and z₁z₂z₃z₄ and k₁k₂k₃k₄ are not both 1111 or not both 0000; or when the first bitmap is y₁y₂y₃y₄ 0001 0000 0000, the first puncturing pattern is y₁y₂y₃y₄ 1110 1111 1111 and the second puncturing pattern is a puncturing pattern corresponding to the 2*996+484-tone MRU 8, where yᵢ is negation of yᵢ, i includes 1, 2, 3, and 4, and y₁y₂y₃y₄ is any one of 0111, 1011, 1101, 1110, 1100, 0011, 1001, or 0000; or when the first bitmap is y₁y₂y₃y₄ 0100 0000 0000, the first puncturing pattern is y₁y₂y₃y₄ 1011 1111 1111 and the second puncturing pattern is a puncturing pattern corresponding to the 2*996+484-tone MRU 7, where yᵢ is negation of yᵢ, i includes 1, 2, 3, and 4, and y₁y₂y₃y₄ is any one of 0111, 1011, 1101, 1110, 1100, 0011, 1001, or 0000; or when the first bitmap is y₁y₂y₃y₄ 0010 0000 0000, the first puncturing pattern is y₁y₂y₃y₄ 1101 1111 1111 and the second puncturing pattern is a puncturing pattern corresponding to the 2*996+484-tone MRU 8, where yᵢ is negation of yᵢ, i includes 1, 2, 3, and 4, and y₁y₂y₃y₄ is any one of 0111, 1011, 1101, 1110, 1100, 0011, 1001, or 0000; or when the first bitmap is y₁y₂y₃y₄ 1000 0000 0000, the first puncturing pattern is y₁y₂y₃y₄ 0111 1111 1111 and the second puncturing pattern is a puncturing pattern corresponding to the 2*996+484-tone MRU 7, where yᵢ is negation of yᵢ, i includes 1, 2, 3, and 4, and y₁y₂y₃y₄ is any one of 0111, 1011, 1101, 1110, 1100, 0011, 1001, or 0000; or when the first bitmap is 0000 0001 z₁z₂z₃z₄ k₁k₂k₃k₄, the first puncturing pattern is 1111 1110 z₁z₂z₃z₄ k₁k₂k₃k₄ and the second puncturing pattern is a puncturing pattern corresponding to the 996+484+242-tone MRU 8, where zᵢ is negation of zᵢ, kᵢ is negation of kᵢ, i includes 1, 2, 3, and 4, z₁z₂z₃z₄ is any one of 0111, 1011, 1101, 1110, 1100, 0011, 1001, or 0000, and k₁k₂k₃k₄ is any one of 1111, 0111, 1011, 1101, 1110, 1100, 0011, 1001, or 0000; or when the first bitmap is 0000 0100 z₁z₂z₃z₄ k₁k₂k₃k₄, the first puncturing pattern is 1111 1011 z₁z₂z₃z₄ k₁k₂k₃k₄ and the second puncturing pattern is a puncturing pattern corresponding to the 996+484+242-tone MRU 6, where zᵢ is negation of zᵢ, j is negation of kᵢ, i includes 1, 2, 3, and 4, z₁z₂z₃z₄ is any one of 0111, 1011, 1101, 1110, 1100, 0011, 1001, or 0000, and k₁k₂k₃k₄ is any one of 1111, 0111, 1011, 1101, 1110, 1100, 0011, 1001, or 0000; or when the first bitmap is 0000 0010 z₁z₂z₃z₄ k₁k₂k₃k₄, the first puncturing pattern is 1111 1101 z₁z₂z₃z₄ k₁k₂k₃k₄ and the second puncturing pattern is a puncturing pattern corresponding to the 996+484+242-tone MRU 7, where zᵢ is negation of zᵢ, kᵢ is negation of kᵢ, i includes 1, 2, 3, and 4, z₁z₂z₃z₄ is any one of 0111, 1011, 1101, 1110, 1100, 0011, 1001, or 0000, and k₁k₂k₃k₄ is any one of 1111, 0111, 1011, 1101, 1110, 1100, 0011, 1001, or 0000; or when the first bitmap is 0000 1000 z₁z₂z₃z₄ k₁k₂k₃k₄, the first puncturing pattern is 1111 0111 z₁z₂z₃z₄ k₁k₂k₃k₄ and the second puncturing pattern is a puncturing pattern corresponding to the 996+484+242-tone MRU 5, where zᵢ is negation of zᵢ, kᵢ is negation of kᵢ, i includes 1, 2, 3, and 4, z₁z₂z₃z₄ is any one of 0111, 1011, 1101, 1110, 1100, 0011, 1001, or 0000, and k₁k₂k₃k₄ is any one of 1111, 0111, 1011, 1101, 1110, 1100, 0011, 1001, or 0000; or when the first bitmap is 0000 0001 z₁z₂z₃z₄ k₁k₂k₃k₄, the first puncturing pattern is 1111 1110 1111 k₁k₂k₃k₄ and the second puncturing pattern is a puncturing pattern corresponding to the 2*996+484-tone MRU 4, where kᵢ is negation of kᵢ, i includes 1, 2, 3, and 4, and k₁k₂k₃k₄ is any one of 0111, 1011, 1101, 1110, 1100, 0011, 1001, or 0000; or when the first bitmap is 0000 0100 0000 k₁k₂k₃k₄, the first puncturing pattern is 1111 1011 1111k₁k₂k₃k₄ and the second puncturing pattern is a puncturing pattern corresponding to the 2*996+484-tone MRU 3, where kᵢ is negation of kᵢ, i includes 1, 2, 3, and 4, and k₁k₂k₃k₄ is any one of 0111, 1011, 1101, 1110, 1100, 0011, 1001, or 0000; or when the first bitmap is 0000 0010 0000 k₁k₂k₃k₄, the first puncturing pattern is 1111 1101 1111 k₁k₂k₃k₄ and the second puncturing pattern is a puncturing pattern corresponding to the 2*996+484-tone MRU 4, where kᵢ is negation of kᵢ, i includes 1, 2, 3, and 4, and k₁k₂k₃k₄ is any one of 0111, 1011, 1101, 1110, 1100, 0011, 1001, or 0000; or when the first bitmap is 0000 1000 0000 k₁k₂k₃k₄, the first puncturing pattern is 1111 0111 1111 k₁k₂k₃k₄ and the second puncturing pattern is a puncturing pattern corresponding to the 2*996+484-tone MRU 3, where kᵢ is negation of kᵢ, i includes 1, 2, 3, and 4, and k₁k₂k₃k₄ is any one of 0111, 1011, 1101, 1110, 1100, 0011, 1001, or 0000; or when the first bitmap is 0000 0001 0000 0000, the first puncturing pattern is 1111 1110 1111 1111 and the second puncturing pattern is a puncturing pattern corresponding to the 3*996+484-tone MRU 4; or when the first bitmap is 0000 0100 0000 0000, the first puncturing pattern is 1111 1011 1111 1111 and the second puncturing pattern is a puncturing pattern corresponding to the 3*996+484-tone MRU 3; or when the first bitmap is 0000 0010 0000 0000, the first puncturing pattern is 1111 1101 1111 1111 and the second puncturing pattern is a puncturing pattern corresponding to the 3*996+484-tone MRU 4; or when the first bitmap is 0000 1000 0000 0000, the first puncturing pattern is 1111 0111 1111 1111 and the second puncturing pattern is a puncturing pattern corresponding to the 3*996+484-tone MRU 3; or when the first bitmap is 0110 0000 0110 k₁k₂k₃k₄, the first puncturing pattern is 1001 1111 1001 k₁k₂k₃k₄ and the second puncturing pattern is a puncturing pattern corresponding to the 996-tone RU 1, where k is negation of kᵢ, i includes 1, 2, 3, and 4, and k₁k₂k₃k₄ is any one of 0111, 1011, 1101, 1110, 1100, 0011, 1001, or 0000; or when the first bitmap is 0110 0000 0110 0000, the first puncturing pattern is 1001 1111 1001 1111 and the second puncturing pattern is a puncturing pattern corresponding to the 996-tone RU 1; or when the first bitmap is 0110 0000 1100 k₁k₂k₃k₄, the first puncturing pattern is 1001 1111 0011 k₁k₂k₃k₄ and the second puncturing pattern is a puncturing pattern corresponding to the 996-tone RU 1, where kᵢ is negation of kᵢ, i includes 1, 2, 3, and 4, and k₁k₂k₃k₄ is any one of 0111, 1011, 1101, 1110, 1100, 0011, 1001, or 0000; or when the first bitmap is 0110 0000 0011 k₁k₂k₃k₄, the first puncturing pattern is 1001 1111 1100 k₁k₂k₃k₄ and the second puncturing pattern is a puncturing pattern corresponding to the 996-tone RU 1, where kᵢ is negation of kᵢ, i includes 1, 2, 3, and 4, and k₁k₂k₃k₄ is any one of 0111, 1011, 1101, 1110, 1100, 0011, 1001, or 0000; or when the first bitmap is 0110 0000 1000 k₁k₂k₃k₄, the first puncturing pattern is 1001 1111 0111 k₁k₂k₃k₄ and the second puncturing pattern is a puncturing pattern corresponding to the 996-tone RU 1, where kᵢ is negation of kᵢ, i includes 1, 2, 3, and 4, and k₁k₂k₃k₄ is any one of 0111, 1011, 1101, 1110, 1100, 0011, 1001, or 0000; or when the first bitmap is 0110 0000 0100 k₁k₂k₃k₄, the first puncturing pattern is 1001 1111 1011 k₁k₂k₃k₄ and the second puncturing pattern is a puncturing pattern corresponding to the 996-tone RU 1, where kᵢ is negation of kᵢ, i includes 1, 2, 3, and 4, and k₁k₂k₃k₄ is any one of 0111, 1011, 1101, 1110, 1100, 0011, 1001, or 0000; or when the first bitmap is 0110 0000 0010 k₁k₂k₃k₄, the first puncturing pattern is 1001 1111 1101 k₁k₂k₃k₄ and the second puncturing pattern is a puncturing pattern corresponding to the 996-tone RU 1, where kᵢ is negation of kᵢ, i includes 1, 2, 3, and 4, and k₁k₂k₃k₄ is any one of 0111, 1011, 1101, 1110, 1100, 0011, 1001, or 0000; or when the first bitmap is 0110 0000 0001 k₁k₂k₃k₄, the first puncturing pattern is 1001 1111 1110 k₁k₂k₃k₄ and the second puncturing pattern is a puncturing pattern corresponding to the 996-tone RU 1, where kᵢ is negation of kᵢ, i includes 1, 2, 3, and 4, and k₁k₂k₃k₄ is any one of 0111, 1011, 1101, 1110, 1100, 0011, 1001, or 0000; or when the first bitmap is 0110 0000 z₁z₂z₃z₄ 0110, the first puncturing pattern is 1001 1111 z₁z₂z₃z₄ 1001 and the second puncturing pattern is a puncturing pattern corresponding to the 996-tone RU 1, where zᵢ is negation of zᵢ, i includes 1, 2, 3, and 4, and z₁z₂z₃z₄ is any one of 0111, 1011, 1101, 1110, 1100, 0011, 1001, or 0000; or when the first bitmap is 0110 0000 z₁z₂z₃z₄ 1100, the first puncturing pattern is 1001 1111 z₁z₂z₃z₄ 0011 and the second puncturing pattern is a puncturing pattern corresponding to the 996-tone RU 1, where z; is negation of zᵢ, i includes 1, 2, 3, and 4, and z₁z₂z₃z₄ is any one of 0111, 1011, 1101, 1110, 1100, 0011, 1001, or 0000; or when the first bitmap is 0110 0000 z₁z₂z₃z₄ 0011, the first puncturing pattern is 1001 1111 z₁z₂z₃z₄ 1100 and the second puncturing pattern is a puncturing pattern corresponding to the 996-tone RU 1, where zᵢ is negation of zᵢ, i includes 1, 2, 3, and 4, and z₁z₂z₃z₄ is any one of 0111, 1011, 1101, 1110, 1100, 0011, 1001, or 0000; or when the first bitmap is 0110 0000 z₁z₂z₃z₄ 1000, the first puncturing pattern is 1001 1111 z₁z₂z₃z₄ 0111 and the second puncturing pattern is a puncturing pattern corresponding to the 996-tone RU 1, where zᵢ is negation of zᵢ, i includes 1, 2, 3, and 4, and z₁z₂z₃z₄ is any one of 0111, 1011, 1101, 1110, 1100, 0011, 1001, or 0000; or when the first bitmap is 0110 0000 z₁z₂z₃z₄ 0100, the first puncturing pattern is 1001 1111 z₁z₂z₃z₄ 1011 and the second puncturing pattern is a puncturing pattern corresponding to the 996-tone RU 1, where zᵢ is negation of zᵢ, i includes 1, 2, 3, and 4, and z₁z₂z₃z₄ is any one of 0111, 1011, 1101, 1110, 1100, 0011, 1001, or 0000; or when the first bitmap is 0110 0000 z₁z₂z₃z₄ 0010, the first puncturing pattern is 1001 1111 z₁z₂z₃z₄ 1101 and the second puncturing pattern is a puncturing pattern corresponding to the 996-tone RU 1, where zᵢ is negation of zᵢ, i includes 1, 2, 3, and 4, and z₁z₂z₃z₄ is any one of 0111, 1011, 1101, 1110, 1100, 0011, 1001, or 0000; or when the first bitmap is 0110 0000 z₁z₂z₃z₄ 0001, the first puncturing pattern is 1001 1111 z₁z₂z₃z₄ 1110 and the second puncturing pattern is a puncturing pattern corresponding to the 996-tone RU 1, where zᵢ is negation of zᵢ, i includes 1, 2, 3, and 4, and z₁z₂z₃z₄ is any one of 0111, 1011, 1101, 1110, 1100, 0011, 1001, or 0000; or when the first bitmap is 0110 0000 1100 0000, the first puncturing pattern is 1001 1111 0011 1111 and the second puncturing pattern is a puncturing pattern corresponding to the 2*996+484-tone MRU 9; or when the first bitmap is 0110 0000 0011 0000, the first puncturing pattern is 1001 1111 1100 1111 and the second puncturing pattern is a puncturing pattern corresponding to the 2*996+484-tone MRU 10; or when the first bitmap is 0110 0000 1000 0000, the first puncturing pattern is 1001 1111 0111 1111 and the second puncturing pattern is a puncturing pattern corresponding to the 2*996+484-tone MRU 9; or when the first bitmap is 0110 0000 0100 0000, the first puncturing pattern is 1001 1111 1011 1111 and the second puncturing pattern is a puncturing pattern corresponding to the 2*996+484-tone MRU 9; or when the first bitmap is 0110 0000 0010 0000, the first puncturing pattern is 1001 1111 1101 1111 and the second puncturing pattern is a puncturing pattern corresponding to the 2*996+484-tone MRU 10; or when the first bitmap is 0110 0000 0001 0000, the first puncturing pattern is 1001 1111 1110 1111 and the second puncturing pattern is a puncturing pattern corresponding to the 2*996+484-tone MRU 10; or when the first bitmap is 0110 0000 0000 0011, the first puncturing pattern is 1001 1111 1111 0011 and the second puncturing pattern is a puncturing pattern corresponding to the 2*996+484-tone MRU 11; or when the first bitmap is 0110 0000 0000 1100, the first puncturing pattern is 1001 1111 1111 1100 and the second puncturing pattern is a puncturing pattern corresponding to the 2*996+484-tone MRU 12; or when the first bitmap is 0110 0000 0000 1000, the first puncturing pattern is 1001 1111 1111 0111 and the second puncturing pattern is a puncturing pattern corresponding to the 2*996+484-tone MRU 11; or when the first bitmap is 0110 0000 0000 0100, the first puncturing pattern is 1001 1111 1111 1011 and the second puncturing pattern is a puncturing pattern corresponding to the 2*996+484-tone MRU 11; or when the first bitmap is 0110 0000 0000 0010, the first puncturing pattern is 1001 1111 1111 1101 and the second puncturing pattern is a puncturing pattern corresponding to the 2*996+484-tone MRU 12; or when the first bitmap is 0110 0000 0000 0001, the first puncturing pattern is 1001 1111 1111 1110 and the second puncturing pattern is a puncturing pattern corresponding to the 2*996+484-tone MRU 12; or when the first bitmap is 0110 0000 0000 0000, the first puncturing pattern is 1001 1111 1111 1111 and the second puncturing pattern is a puncturing pattern corresponding to the 3*996-tone MRU 1; or when the first bitmap is 0011 0000 0110 k₁k₂k₃k₄, the first puncturing pattern is 1100 1111 1001 k₁k₂k₃k₄ and the second puncturing pattern is a puncturing pattern corresponding to the 996+484-tone MRU 2, where kᵢ is negation of kᵢ, i includes 1, 2, 3, and 4, and k₁k₂k₃k₄ is any one of 0111, 1011, 1101, 1110, 1100, 0011, 1001, or 0000; or when the first bitmap is 0011 0000 0110 0000, the first puncturing pattern is 1100 1111 1001 1111 and the second puncturing pattern is a puncturing pattern corresponding to the 996+484-tone MRU 2; or when the first bitmap is 0011 0000 1100 k₁k₂k₃k₄, the first puncturing pattern is 1100 1111 0011 k₁k₂k₃k₄ and the second puncturing pattern is a puncturing pattern corresponding to the 996+484-tone MRU 2, where k; is negation of kᵢ, i includes 1, 2, 3, and 4, and k₁k₂k₃k₄ is any one of 0111, 1011, 1101, 1110, 1100, 0011, 1001, or 0000; or when the first bitmap is 0011 0000 0011 k₁k₂k₃k₄, the first puncturing pattern is 1100 1111 1100 k₁k₂k₃k₄ and the second puncturing pattern is a puncturing pattern corresponding to the 996+484-tone MRU 2, where kᵢ is negation of kᵢ, i includes 1, 2, 3, and 4, and k₁k₂k₃k₄ is any one of 0111, 1011, 1101, 1110, 1100, 0011, 1001, or 0000; or when the first bitmap is 0011 0000 1000 k₁k₂k₃k₄, the first puncturing pattern is 1100 1111 0111 k₁k₂k₃k₄ and the second puncturing pattern is a puncturing pattern corresponding to the 996+484-tone MRU 2, where kᵢ is negation of kᵢ, i includes 1, 2, 3, and 4, and k₁k₂k₃k₄ is any one of 0111, 1011, 1101, 1110, 1100, 0011, 1001, or 0000; or when the first bitmap is 0011 0000 0100 k₁k₂k₃k₄, the first puncturing pattern is 1100 1111 1011 k₁k₂k₃k₄ and the second puncturing pattern is a puncturing pattern corresponding to the 996+484-tone MRU 2, where kᵢ is negation of kᵢ, i includes 1, 2, 3, and 4, and k₁k₂k₃k₄ is any one of 0111, 1011, 1101, 1110, 1100, 0011, 1001, or 0000; or when the first bitmap is 0011 0000 0010 k₁k₂k₃k₄, the first puncturing pattern is 1100 1111 1101 k₁k₂k₃k₄ and the second puncturing pattern is a puncturing pattern corresponding to the 996+484-tone MRU 2, where kᵢ is negation of kᵢ, i includes 1, 2, 3, and 4, and k₁k₂k₃k₄ is any one of 0111, 1011, 1101, 1110, 1100, 0011, 1001, or 0000; or when the first bitmap is 0011 0000 0001 k₁k₂k₃k₄, the first puncturing pattern is 1100 1111 1110 k₁k₂k₃k₄ and the second puncturing pattern is a puncturing pattern corresponding to the 996+484-tone MRU 2, where kᵢ is negation of kᵢ, i includes 1, 2, 3, and 4, and k₁k₂k₃k₄ is any one of 0111, 1011, 1101, 1110, 1100, 0011, 1001, or 0000; or when the first bitmap is 0011 0000 z₁z₂z₃z₄ 0110, the first puncturing pattern is 1100 1111 z₁z₂z₃z₄ 1001 and the second puncturing pattern is a puncturing pattern corresponding to the 996+484-tone MRU 2, where zᵢ is negation of zᵢ, i includes 1, 2, 3, and 4, and z₁z₂z₃z₄ is any one of 0111, 1011, 1101, 1110, 1100, 0011, 1001, or 0000; or when the first bitmap is 0011 0000 z₁z₂z₃z₄ 1100, the first puncturing pattern is 1100 1111 z₁z₂z₃z₄ 0011 and the second puncturing pattern is a puncturing pattern corresponding to the 996+484-tone MRU 2, where zᵢ is negation of zᵢ, i includes 1, 2, 3, and 4, and z₁z₂z₃z₄ is any one of 0111, 1011, 1101, 1110, 1100, 0011, 1001, or 0000; or when the first bitmap is 0011 0000 z₁z₂z₃z₄ 0011, the first puncturing pattern is 1100 1111 z₁z₂z₃z₄ 1100 and the second puncturing pattern is a puncturing pattern corresponding to the 996+484-tone MRU 2, where zᵢ is negation of zᵢ, i includes 1, 2, 3, and 4, and z₁z₂z₃z₄ is any one of 0111, 1011, 1101, 1110, 1100, 0011, 1001, or 0000; or when the first bitmap is 0011 0000 z₁z₂z₃z₄ 1000, the first puncturing pattern is 1100 1111 z₁z₂z₃z₄ 0111 and the second puncturing pattern is a puncturing pattern corresponding to the 996+484-tone MRU 2, where zᵢ is negation of zᵢ, i includes 1, 2, 3, and 4, and z₁z₂z₃z₄ is any one of 0111, 1011, 1101, 1110, 1100, 0011, 1001, or 0000; or when the first bitmap is 0011 0000 z₁z₂z₃z₄ 0100, the first puncturing pattern is 1100 1111 z₁z₂z₃z₄ 1011 and the second puncturing pattern is a puncturing pattern corresponding to the 996+484-tone MRU 2, where zᵢ is negation of zᵢ, i includes 1, 2, 3, and 4, and z₁z₂z₃z₄ is any one of 0111, 1011, 1101, 1110, 1100, 0011, 1001, or 0000; or when the first bitmap is 0011 0000 z₁z₂z₃z₄ 0010, the first puncturing pattern is 1100 1111 z₁z₂z₃z₄ 1101 and the second puncturing pattern is a puncturing pattern corresponding to the 996+484-tone MRU 2, where zᵢ is negation of zᵢ, i includes 1, 2, 3, and 4, and z₁z₂z₃z₄ is any one of 0111, 1011, 1101, 1110, 1100, 0011, 1001, or 0000; or when the first bitmap is 0011 0000 z₁z₂z₃z₄ 0001, the first puncturing pattern is 1100 1111 z₁z₂z₃z₄ 1110 and the second puncturing pattern is a puncturing pattern corresponding to the 996+484-tone MRU 2, where zᵢ is negation of zᵢ, i includes 1, 2, 3, and 4, and z₁z₂z₃z₄ is any one of 0111, 1011, 1101, 1110, 1100, 0011, 1001, or 0000; or when the first bitmap is 1100 0000 0110 k₁k₂k₃k₄, the first puncturing pattern is 0011 1111 1001 k₁k₂k₃k₄ and the second puncturing pattern is a puncturing pattern corresponding to the 996+484-tone MRU 1, where kᵢ is negation of kᵢ, i includes 1, 2, 3, and 4, and k₁k₂k₃k₄ is any one of 0111, 1011, 1101, 1110, 1100, 0011, 1001, or 0000; or when the first bitmap is 1100 0000 0110 0000, the first puncturing pattern is 0011 1111 1001 1111 and the second puncturing pattern is a puncturing pattern corresponding to the 996+484-tone MRU 1; or when the first bitmap is 1100 0000 1100 k₁k₂k₃k₄, the first puncturing pattern is 0011 1111 0011 k₁k₂k₃k₄ and the second puncturing pattern is a puncturing pattern corresponding to the 996+484-tone MRU 1, where kᵢ is negation of kᵢ, i includes 1, 2, 3, and 4, and k₁k₂k₃k₄ is any one of 0111, 1011, 1101, 1110, 1100, 0011, 1001, or 0000; or when the first bitmap is 1100 0000 0011 k₁k₂k₃k₄, the first puncturing pattern is 0011 1111 1100 k₁k₂k₃k₄ and the second puncturing pattern is a puncturing pattern corresponding to the 996+484-tone MRU 1, where kᵢ is negation of kᵢ, i includes 1, 2, 3, and 4, and k₁k₂k₃k₄ is any one of 0111, 1011, 1101, 1110, 1100, 0011, 1001, or 0000; or when the first bitmap is 1100 0000 1000 k₁k₂k₃k₄, the first puncturing pattern is 0011 1111 0111 k₁k₂k₃k₄ and the second puncturing pattern is a puncturing pattern corresponding to the 996+484-tone MRU 1, where kᵢ is negation of kᵢ, i includes 1, 2, 3, and 4, and k₁k₂k₃k₄ is any one of 0111, 1011, 1101, 1110, 1100, 0011, 1001, or 0000; or when the first bitmap is 1100 0000 0100 k₁k₂k₃k₄, the first puncturing pattern is 0011 1111 1011 k₁k₂k₃k₄ and the second puncturing pattern is a puncturing pattern corresponding to the 996+484-tone MRU 1, where kᵢ is negation of kᵢ, i includes 1, 2, 3, and 4, and k₁k₂k₃k₄ is any one of 0111, 1011, 1101, 1110, 1100, 0011, 1001, or 0000; or when the first bitmap is 1100 0000 0010 k₁k₂k₃k₄, the first puncturing pattern is 0011 1111 1101 k₁k₂k₃k₄ and the second puncturing pattern is a puncturing pattern corresponding to the 996+484-tone MRU 1, where kᵢ is negation of kᵢ, i includes 1, 2, 3, and 4, and k₁k₂k₃k₄ is any one of 0111, 1011, 1101, 1110, 1100, 0011, 1001, or 0000; or when the first bitmap is 1100 0000 0001 k₁k₂k₃k₄, the first puncturing pattern is 0011 1111 1110 k₁k₂k₃k₄ and the second puncturing pattern is a puncturing pattern corresponding to the 996+484-tone MRU 1, where kᵢ is negation of kᵢ, i includes 1, 2, 3, and 4, and k₁k₂k₃k₄ is any one of 0111, 1011, 1101, 1110, 1100, 0011, 1001, or 0000; or when the first bitmap is 1100 0000 z₁z₂z₃z₄ 0110, the first puncturing pattern is 0011 1111 z₁z₂z₃z₄ 1001 and the second puncturing pattern is a puncturing pattern corresponding to the 996+484-tone MRU 1, where zᵢ is negation of zᵢ, i includes 1, 2, 3, and 4, and z₁z₂z₃z₄ is any one of 0111, 1011, 1101, 1110, 1100, 0011, 1001, or 0000; or when the first bitmap is 1100 0000 z₁z₂z₃z₄, the first puncturing pattern is 0011 1111 z₁z₂z₃z₄ 0011 and the second puncturing pattern is a puncturing pattern corresponding to the 996+484-tone MRU 1, where zᵢ is negation of zᵢ, i includes 1, 2, 3, and 4, and z₁z₂z₃z₄ is any one of 0111, 1011, 1101, 1110, 1100, 0011, 1001, or 0000; or when the first bitmap is 1100 0000 z₁z₂z₃z₄ 0011, the first puncturing pattern is 0011 1111 z₁z₂z₃z₄ 1100 and the second puncturing pattern is a puncturing pattern corresponding to the 996+484-tone MRU 1, where zᵢ is negation of zᵢ, i includes 1, 2, 3, and 4, and z₁z₂z₃z₄ is any one of 0111, 1011, 1101, 1110, 1100, 0011, 1001, or 0000; or when the first bitmap is 1100 0000 z₁z₂z₃z₄ 1000, the first puncturing pattern is 0011 1111 z₁z₂z₃z₄ 0111 and the second puncturing pattern is a puncturing pattern corresponding to the 996+484-tone MRU 1, where zᵢ is negation of zᵢ, i includes 1, 2, 3, and 4, and z₁z₂z₃z₄ is any one of 0111, 1011, 1101, 1110, 1100, 0011, 1001, or 0000; or when the first bitmap is 1100 0000 z₁z₂z₃z₄ 0100, the first puncturing pattern is 0011 1111 z₁z₂z₃z₄ 1011 and the second puncturing pattern is a puncturing pattern corresponding to the 996+484-tone MRU 1, where zᵢ is negation of zᵢ, i includes 1, 2, 3, and 4, and z₁z₂z₃z₄ is any one of 0111, 1011, 1101, 1110, 1100, 0011, 1001, or 0000; or when the first bitmap is 1100 0000 z₁z₂z₃z₄ 0010, the first puncturing pattern is 0011 1111 z₁z₂z₃z₄ 1101 and the second puncturing pattern is a puncturing pattern corresponding to the 996+484-tone MRU 1, where zᵢ is negation of zᵢ, i includes 1, 2, 3, and 4, and z₁z₂z₃z₄ is any one of 0111, 1011, 1101, 1110, 1100, 0011, 1001, or 0000; or when the first bitmap is 1100 0000 z₁z₂z₃z₄ 0001, the first puncturing pattern is 0011 1111 z₁z₂z₃z₄ 1110 and the second puncturing pattern is a puncturing pattern corresponding to the 996+484-tone MRU 1, where zᵢ is negation of zᵢ, i includes 1, 2, 3, and 4, and z₁z₂z₃z₄ is any one of 0111, 1011, 1101, 1110, 1100, 0011, 1001, or 0000; or when the first bitmap is 0011 0000 1100 0000, the first puncturing pattern is 1100 1111 0011 1111 and the second puncturing pattern is a puncturing pattern corresponding to the 2*996+484-tone MRU 9; or when the first bitmap is 0011 0000 0011 0000, the first puncturing pattern is 1100 1111 1100 1111 and the second puncturing pattern is a puncturing pattern corresponding to the 2*996+484-tone MRU 10; or when the first bitmap is 0011 0000 1000 0000, the first puncturing pattern is 1100 1111 0111 1111 and the second puncturing pattern is a puncturing pattern corresponding to the 2*996+484-tone MRU 9; or when the first bitmap is 0011 0000 0100 0000, the first puncturing pattern is 1100 1111 1011 1111 and the second puncturing pattern is a puncturing pattern corresponding to the 2*996+484-tone MRU 9; or when the first bitmap is 0011 0000 0010 0000, the first puncturing pattern is 1100 1111 1101 1111 and the second puncturing pattern is a puncturing pattern corresponding to the 2*996+484-tone MRU 10; or when the first bitmap is 0011 0000 0001 0000, the first puncturing pattern is 1100 1111 1110 1111 and the second puncturing pattern is a puncturing pattern corresponding to the 2*996+484-tone MRU 10; or when the first bitmap is 0011 0000 0000 k₁k₂k₃k₄, the first puncturing pattern is 1100 1111 1111 k₁k₂k₃k₄, where kᵢ is negation of kᵢ, and i includes 1, 2, 3, and 4; and when k₁k₂k₃k₄ is any one of 0111, 1011, 1101, 1110, 1100, 0011, 1001 or 0000, the second puncturing pattern is the 2*996+484-tone MRU 2; or when k₁k₂k₃k₄ is any one of 0111, 1011, or 0011, the second puncturing pattern is the 2*996+484-tone MRU 11; or when k₁k₂k₃k₄ is any one of 1101, 1110, or 1100, the second puncturing pattern is the 2*996+484-tone MRU 12; or when the first bitmap is 1100 0000 1100 0000, the first puncturing pattern is 0011 1111 0011 1111 and the second puncturing pattern is a puncturing pattern corresponding to the 2*996+484-tone MRU 9; or when the first bitmap is 1100 0000 0011 0000, the first puncturing pattern is 0011 1111 1100 1111 and the second puncturing pattern is a puncturing pattern corresponding to the 2*996+484-tone MRU 10; or when the first bitmap is 1100 0000 1000 0000, the first puncturing pattern is 0011 1111 0111 1111 and the second puncturing pattern is a puncturing pattern corresponding to the 2*996+484-tone MRU 9; or when the first bitmap is 1100 0000 0100 0000, the first puncturing pattern is 0011 1111 1011 1111 and the second puncturing pattern is a puncturing pattern corresponding to the 2*996+484-tone MRU 9; or when the first bitmap is 1100 0000 0010 0000, the first puncturing pattern is 0011 1111 1101 1111 and the second puncturing pattern is a puncturing pattern corresponding to the 2*996+484-tone MRU 10; or when the first bitmap is 1100 0000 0001 0000, the first puncturing pattern is 0011 1111 1110 1111 and the second puncturing pattern is a puncturing pattern corresponding to the 2*996+484-tone MRU 10; or when the first bitmap is 1100 0000 0000 k₁k₂k₃k₄, the first puncturing pattern is 0011 1111 1111 k₁k₂k₃k₄, where kᵢ is negation of kᵢ, and i includes 1, 2, 3, and 4; and when k₁k₂k₃k₄ is any one of 0111, 1011, 1101, 1110, 1100, 0011, 1001 or 0000, the second puncturing pattern is the 2*996+484-tone MRU 1; or when k₁k₂k₃k₄ is any one of 0111, 1011, or 0011, the second puncturing pattern is the 2*996+484-tone MRU 11; or when k₁k₂k₃k₄ is any one of 1101, 1110, or 1100, the second puncturing pattern is the 2*996+484-tone MRU 12; or when the first bitmap is 0001 0000 Z₁Z₂Z₃Z₄ K₁K₂K₂K₄, the first puncturing pattern is 1110 1111 Z₁Z₂Z₃Z₄ K₁K₂K₃K₄ and the second puncturing pattern is a puncturing pattern corresponding to the 996+484+242-tone MRU 4; or when the first bitmap is 0010 0000 Z₁Z₂Z₃Z₄ K₁K₂K₂K₄, the first puncturing pattern is 1101 1111 Z₁Z₂Z₃Z₄ K₁K₂K₃K₄ and the second puncturing pattern is a puncturing pattern corresponding to the 996+484+242-tone MRU 3; or when the first bitmap is 0100 0000 Z₁Z₂Z₃Z₄ K₁K₂K₂K₄, the first puncturing pattern is 1011 1111 Z₁Z₂Z₃Z₄ K₁K₂K₃K₄ and the second puncturing pattern is a puncturing pattern corresponding to the 996+484+242-tone MRU 2; or when the first bitmap is 1000 0000 Z₁Z₂Z₃Z₄ K₁K₂K₂K₄, the first puncturing pattern is 0111 1111 Z₁Z₂Z₃Z₄ K₁K₂K₃K₄ and the second puncturing pattern is a puncturing pattern corresponding to the 996+484+242-tone MRU 1; or where when Z₁Z₂Z₃Z₄ and K₁K₂K₂K₄ are 0110 and k₁k₂k₃k₄ respectively, Z₁Z₂Z₃Z₄ and K₁K₂K₃K₄ are 1001 and k₁k₂k₃k₄ respectively; or when Z₁Z₂Z₃Z₄ and K₁K₂K₂K₄ are 0110 and 0000 respectively, Z₁Z₂Z₃Z₄ and K₁K₂K₃K₄ are 1001 and 1111 respectively; or when Z₁Z₂Z₃Z₄ and K₁K₂K₂K₄ are 1100 and k₁k₂k₃k₄ respectively, Z₁Z₂Z₃Z₄ and K₁K₂K₃K₄ are 0011 and k₁k₂k₃k₄ respectively; or when Z₁Z₂Z₃Z₄ and K₁K₂K₂K₄ are 0011 and k₁k₂k₃k₄ respectively, Z₁Z₂Z₃Z₄ and K₁K₂K₃K₄ are 1100 and k₁k₂k₃k₄ respectively; or when Z₁Z₂Z₃Z₄ and K₁K₂K₂K₄ are 1000 and k₁k₂k₃k₄ respectively, Z₁Z₂Z₃Z₄ and K₁K₂K₃K₄ are 0111 and k₁k₂k₃k₄ respectively; or when Z₁Z₂Z₃Z₄ and K₁K₂K₂K₄ are 0100 and k₁k₂k₃k₄ respectively, Z₁Z₂Z₃Z₄ and K₁K₂K₃K₄ are 1011 and k₁k₂k₃k₄ respectively; or when Z₁Z₂Z₃Z₄ and K₁K₂K₂K₄ are 0010 and k₁k₂k₃k₄ respectively, Z₁Z₂Z₃Z₄ and K₁K₂K₃K₄ are 1101 and k₁k₂k₃k₄ respectively; or when Z₁Z₂Z₃Z₄ and K₁K₂K₂K₄ are 0001 and k₁k₂k₃k₄ respectively, Z₁Z₂Z₃Z₄ and K₁K₂K₃K₄ are 1110 and k₁k₂k₃k₄ respectively; or when Z₁Z₂Z₃Z₄ and K₁K₂K₂K₄ are z₁z₂z₃z₄ and 0110 respectively, Z₁Z₂Z₃Z₄ and K₁K₂K₃K₄ are z₁z₂z₃z₄ and 1001 respectively; or when Z₁Z₂Z₃Z₄ and K₁K₂K₂K₄ are z₁z₂z₃z₄ and 1100 respectively, Z₁Z₂Z₃Z₄ and K₁K₂K₃K₄ are z₁z₂z₃z₄ and 0011 respectively; or when Z₁Z₂Z₃Z₄ and K₁K₂K₂K₄ are z₁z₂z₃z₄ and 0011 respectively, Z₁Z₂Z₃Z₄ and K₁K₂K₃K₄ are z₁z₂z₃z₄ and 1100 respectively; or when Z₁Z₂Z₃Z₄ and K₁K₂K₂K₄ are z₁z₂z₃z₄ and 1000 respectively, Z₁Z₂Z₃Z₄ and K₁K₂K₃K₄ are z₁z₂z₃z₄ and 0111 respectively; or when Z₁Z₂Z₃Z₄ and K₁K₂K₂K₄ are z₁z₂z₃z₄ and 0100 respectively, Z₁Z₂Z₃Z₄ and K₁K₂K₃K₄ are z₁z₂z₃z₄ and 1011 respectively; or when Z₁Z₂Z₃Z₄ and K₁K₂K₂K₄ are z₁z₂z₃z₄ and 0010 respectively, Z₁Z₂Z₃Z₄ and K₁K₂K₃K₄ are z₁z₂z₃z₄ and 1101 respectively; or when Z₁Z₂Z₃Z₄ and K₁K₂K₂K₄ are z₁z₂z₃z₄ and 0001 respectively, Z₁Z₂Z₃Z₄ and K₁K₂K₃K₄ are z₁z₂z₃z₄ and 1110 respectively, where kᵢ is negation of kᵢ, zᵢ is negation of zᵢ, i includes 1, 2, 3, and 4, k₁k₂k₃k₄ is any one of 0111, 1011, 1101, 1110, 1100, 0011, 1001 or 0000, and z₁z₂z₃z₄ is any one of 0111, 1011, 1101, 1110, 1100, 0011, 1001 or 0000; or when the first bitmap is 0001 0000 Z₁Z₂Z₃Z₄ K₁K₂K₂K₄, the first puncturing pattern is 1110 1111 Z₁Z₂Z₃Z₄ K₁K₂K₃K₄, where when Z₁Z₂Z₃Z₄ and K₁K₂K₂K₄ are respectively 1100 and 0000, Z₁Z₂Z₃Z₄ and K₁K₂K₃K₄ are respectively 0011 and 1111, and the second puncturing pattern is a puncturing pattern corresponding to the 2*996+484-tone MRU 9; or when Z₁Z₂Z₃Z₄ and K₁K₂K₂K₄ are respectively 0011 and 0000, Z₁Z₂Z₃Z₄ and K₁K₂K₃K₄ are respectively 1100 and 1111, and the second puncturing pattern is a puncturing pattern corresponding to the 2*996+484-tone MRU 10; or when Z₁Z₂Z₃Z₄ and K₁K₂K₂K₄ are respectively 1000 and 0000, Z₁Z₂Z₃Z₄ and K₁K₂K₃K₄ are respectively 0111 and 1111, and the second puncturing pattern is a puncturing pattern corresponding to the 2*996+484-tone MRU 9; or when Z₁Z₂Z₃Z₄ and K₁K₂K₂K₄ are respectively 0100 and 0000, Z₁Z₂Z₃Z₄ and K₁K₂K₃K₄ are respectively 1011 and 1111, and the second puncturing pattern is a puncturing pattern corresponding to the 2*996+484-tone MRU 9; or when Z₁Z₂Z₃Z₄ and K₁K₂K are respectively 0010 and 0000, Z₁Z₂Z₃Z₄ and K₁K₂K₃K₄ are respectively 1101 and 1111, and the second puncturing pattern is a puncturing pattern corresponding to the 2*996+484-tone MRU 10; or when Z₁Z₂Z₃Z₄ and K₁K₂K₂K₄ are respectively 0001 and 0000, Z₁Z₂Z₃Z₄ and K₁K₂K₃K₄ are respectively 1110 and 1111, and the second puncturing pattern is a puncturing pattern corresponding to the 2*996+484-tone MRU 10; or when Z₁Z₂Z₃Z₄ and K₁K₂K₂K₄ are respectively 0000 and k₁k₂k₃k₄, Z₁Z₂Z₃Z₄ and K₁K₂K₃K₄ are respectively 1111 and k₁k₂k₃k₄, and the second puncturing pattern is a puncturing pattern corresponding to the 2*996+484-tone MRU 2, where kᵢ is negation of kᵢ, i includes 1, 2, 3, and 4, and k₁k₂k₃k₄ is any one of 0111, 1011, 1101, 1110, 1100, 0011, 1001 or 0000; or when the first bitmap is 0010 0000 Z₁Z₂Z₃Z₄ and K₁K₂K₂K₄, the first puncturing pattern is 1101 1111 Z₁Z₂Z₃Z₄ K₁K₂K₃K₄, where when Z₁Z₂Z₃Z₄ and K₁K₂K₂K₄ are respectively 1100 and 0000, Z₁Z₂Z₃Z₄ and K₁K₂K₃K₄ are respectively 0011 and 1111, and the second puncturing pattern is a puncturing pattern corresponding to the 2*996+484-tone MRU 9; or when Z₁Z₂Z₃Z₄ and K₁K₂K₂K₄ are respectively 0011 and 0000, Z₁Z₂Z₃Z₄ and K₁K₂K₃K₄ are respectively 1100 and 1111, and the second puncturing pattern is a puncturing pattern corresponding to the 2*996+484-tone MRU 10; or when Z₁Z₂Z₃Z₄ and K₁K₂K₂K₄ are respectively 1000 and 0000, Z₁Z₂Z₃Z₄ and K₁K₂K₃K₄ are respectively 0111 and 1111, and the second puncturing pattern is a puncturing pattern corresponding to the 2*996+484-tone MRU 9; or when Z₁Z₂Z₃Z₄ and K₁K₂K₂K₄ are respectively 0100 and 0000, Z₁Z₂Z₃Z₄ and K₁K₂K₃K₄ are respectively 1011 and 1111, and the second puncturing pattern is a puncturing pattern corresponding to the 2*996+484-tone MRU 9; or when Z₁Z₂Z₃Z₄ and K₁K₂K₂K₄ are respectively 0010 and 0000, Z₁Z₂Z₃Z₄ and K₁K₂K₃K₄ are respectively 1101 and 1111, and the second puncturing pattern is a puncturing pattern corresponding to the 2*996+484-tone MRU 10; or when Z₁Z₂Z₃Z₄ and K₁K₂K₂K₄ are respectively 0001 and 0000, Z₁Z₂Z₃Z₄ and K₁K₂K₃K₄ are respectively 1110 and 1111, and the second puncturing pattern is a puncturing pattern corresponding to the 2*996+484-tone MRU 10; or when Z₁Z₂Z₃Z₄ and K₁K₂K₂K₄ are respectively 0000 and k₁k₂k₃k₄, Z₁Z₂Z₃Z₄ and K₁K₂K₃K₄ are respectively 1111 and k₁k₂k₃k₄, and the second puncturing pattern is a puncturing pattern corresponding to the 2*996+484-tone MRU 2, where kᵢ is negation of kᵢ, i includes 1, 2, 3, and 4, and k₁k₂k₃k₄ is any one of 0111, 1011, 1101, 1110, 1100, 0011, 1001 or 0000; or when the first bitmap is 0100 0000 Z₁Z₂Z₃Z₄ and K₁K₂K₂K₄, the first puncturing pattern is 1011 1111 Z₁Z₂Z₃Z₄ K₁K₂K₃K₄, where when Z₁Z₂Z₃Z₄ and K₁K₂K₂K₄ are respectively 1100 and 0000, Z₁Z₂Z₃Z₄ and K₁K₂K₃K₄ are respectively 0011 and 1111, and the second puncturing pattern is a puncturing pattern corresponding to the 2*996+484-tone MRU 9; or when Z₁Z₂Z₃Z₄ and K₁K₂K₂K₄ are respectively 0011 and 0000, Z₁Z₂Z₃Z₄ and K₁K₂K₃K₄ are respectively 1100 and 1111, and the second puncturing pattern is a puncturing pattern corresponding to the 2*996+484-tone MRU 10; or when Z₁Z₂Z₃Z₄ and K₁K₂K₂K₄ are respectively 1000 and 0000, Z₁Z₂Z₃Z₄ and K₁K₂K₃K₄ are respectively 0111 and 1111, and the second puncturing pattern is a puncturing pattern corresponding to the 2*996+484-tone MRU 9; or when Z₁Z₂Z₃Z₄ and K₁K₂K₂K₄ are respectively 0100 and 0000, Z₁Z₂Z₃Z₄ and K₁K₂K₃K₄ are respectively 1011 and 1111, and the second puncturing pattern is a puncturing pattern corresponding to the 2*996+484-tone MRU 9; or when Z₁Z₂Z₃Z₄ and K₁K₂K₂K₄ are respectively 0010 and 0000, Z₁Z₂Z₃Z₄ and K₁K₂K₃K₄ are respectively 1101 and 1111, and the second puncturing pattern is a puncturing pattern corresponding to the 2*996+484-tone MRU 10; or when Z₁Z₂Z₃Z₄ and K₁K₂K₂K₄ are respectively 0001 and 0000, Z₁Z₂Z₃Z₄ and K₁K₂K₃K₄ are respectively 1110 and 1111, and the second puncturing pattern is a puncturing pattern corresponding to the 2*996+484-tone MRU 10; or when Z₁Z₂Z₃Z₄ and K₁K₂K₂K₄ are respectively 0000 and k₁k₂k₃k₄, Z₁Z₂Z₃Z₄ and K₁K₂K₃K₄ are respectively 1111 and k₁k₂k₃k₄, and the second puncturing pattern is a puncturing pattern corresponding to the 2*996+484-tone MRU 1, where kᵢ is negation of kᵢ, i includes 1, 2, 3, and 4, and k₁k₂k₃k₄ is any one of 0111, 1011, 1101, 1110, 1100, 0011, 1001 or 0000; or when the first bitmap is 1000 0000 Z₁Z₂Z₃Z₄ K₁K₂K₂K₄, the first puncturing pattern is 0111 1111 Z₁Z₂Z₃Z₄ K₁K₂K₃K₄, where when Z₁Z₂Z₃Z₄ and K₁K₂K₂K₄ are respectively 1100 and 0000, Z₁Z₂Z₃Z₄ and K₁K₂K₃K₄ are respectively 0011 and 1111, and the second puncturing pattern is a puncturing pattern corresponding to the 2*996+484-tone MRU 9; or when Z₁Z₂Z₃Z₄ and K₁K₂K₂K₄ are respectively 0011 and 0000, Z₁Z₂Z₃Z₄ and K₁K₂K₃K₄ are respectively 1100 and 1111, and the second puncturing pattern is a puncturing pattern corresponding to the 2*996+484-tone MRU 10; or when Z₁Z₂Z₃Z₄ and K₁K₂K₂K₄ are respectively 1000 and 0000, Z₁Z₂Z₃Z₄ and K₁K₂K₃K₄ are respectively 0111 and 1111, and the second puncturing pattern is a puncturing pattern corresponding to the 2*996+484-tone MRU 9; or when Z₁Z₂Z₃Z₄ and K₁K₂K₂K₄ are respectively 0100 and 0000, Z₁Z₂Z₃Z₄ and K₁K₂K₃K₄ are respectively 1011 and 1111, and the second puncturing pattern is a puncturing pattern corresponding to the 2*996+484-tone MRU 9; or when Z₁Z₂Z₃Z₄ and K₁K₂K₂K₄ are respectively 0010 and 0000, Z₁Z₂Z₃Z₄ and K₁K₂K₃K₄ are respectively 1101 and 1111, and the second puncturing pattern is a puncturing pattern corresponding to the 2*996+484-tone MRU 10; or when Z₁Z₂Z₃Z₄ and K₁K₂K₂K₄ are respectively 0001 and 0000, Z₁Z₂Z₃Z₄ and K₁K₂K₃K₄ are respectively 1110 and 1111, and the second puncturing pattern is a puncturing pattern corresponding to the 2*996+484-tone MRU 10; or when Z₁Z₂Z₃Z₄ and K₁K₂K₂K₄ are respectively 0000 and k₁k₂k₃k₄, Z₁Z₂Z₃Z₄ and K₁K₂K₃K₄ are respectively 1111 and k₁k₂k₃k₄, and the second puncturing pattern is a puncturing pattern corresponding to the 2*996+484-tone MRU 1, where kᵢ is negation of kᵢ, i includes 1, 2, 3, and 4, and k₁k₂k₃k₄ is any one of 0111, 1011, 1101, 1110, 1100, 0011, 1001 or 0000; or when the first bitmap is 0001 0000 0000 0000, the first puncturing pattern is 1110 1111 1111 1111, and the second puncturing pattern is a puncturing pattern corresponding to the 3*996+484-tone MRU 2; or when the first bitmap is 0010 0000 0000 0000, the first puncturing pattern is 1101 1111 1111 1111 and the second puncturing pattern is a puncturing pattern corresponding to the 3*996+484-tone MRU 2; or when the first bitmap is 0100 0000 0000 0000, the first puncturing pattern is 1011 1111 1111 1111 and the second puncturing pattern is a puncturing pattern corresponding to the 3*996+484-tone MRU 1; or when the first bitmap is 0100 0000 0000 0000, the first puncturing pattern is 0111 1111 1111 1111 and the second puncturing pattern is a puncturing pattern corresponding to the 3*996+484-tone MRU 1; or when the first bitmap is 0000 0000 0110 k₁k₂k₃k₄, the first puncturing pattern is 1111 1111 1001 k₁k₂k₃k₄ and the second puncturing pattern is a puncturing pattern corresponding to the 2*996-tone RU 1, where kᵢ is negation of kᵢ, i includes 1, 2, 3, and 4, and k₁k₂k₃k₄ is any one of 0111, 1011, 1101, 1110, 1100, 0011, 1001, or 0000; or when the first bitmap is 0000 0000 0011 k₁k₂k₃k₄, the first puncturing pattern is 1111 1111 1100 k₁k₂k₃k₄ and the second puncturing pattern is a puncturing pattern corresponding to the 2*996+484-tone MRU 6, where kᵢ is negation of kᵢ, i includes 1, 2, 3, and 4, and k₁k₂k₃k₄ is any one of 0111, 1011, 1101, 1110, 1100, 0011, 1001, or 0000; or when the first bitmap is 0000 0000 1100 k₁k₂k₃k₄, the first puncturing pattern is 1111 1111 0011 k₁k₂k₃k₄ and the second puncturing pattern is a puncturing pattern corresponding to the 2*996+484-tone MRU 5, where kᵢ is negation of kᵢ, i includes 1, 2, 3, and 4, and k₁k₂k₃k₄ is any one of 0111, 1011, 1101, 1110, 1100, 0011, 1001, or 0000; or when the first bitmap is 0000 0000 0001 k₁k₂k₃k₄, the first puncturing pattern is 1111 1111 1110 k₁k₂k₃k₄ and the second puncturing pattern is a puncturing pattern corresponding to the 2*996+484-tone MRU 6, where kᵢ is negation of kᵢ, i includes 1, 2, 3, and 4, and k₁k₂k₃k₄ is any one of 0111, 1011, 1101, 1110, 1100, 0011, 1001, or 0000; or when the first bitmap is 0000 0000 0010 k₁?k&, the first puncturing pattern is 1111 1111 1101 k₁k₂k₃k₄ and the second puncturing pattern is a puncturing pattern corresponding to the 2*996+484-tone MRU 6, where kᵢ is negation of kᵢ, i includes 1, 2, 3, and 4, and k₁k₂k₃k₄ is any one of 0111, 1011, 1101, 1110, 1100, 0011, 1001, or 0000; or when the first bitmap is 0000 0000 0100 k₁k₂k₃k₄, the first puncturing pattern is 1111 1111 1011 k₁k₂k₃k₄ and the second puncturing pattern is a puncturing pattern corresponding to the 2*996+484-tone MRU 5, where kᵢ is negation of kᵢ, i includes 1, 2, 3, and 4, and k₁k₂k₃k₄ is any one of 0111, 1011, 1101, 1110, 1100, 0011, 1001, or 0000; or when the first bitmap is 0000 0000 1000 k₁k₂k₃k₄, the first puncturing pattern is 1111 1111 0111 k₁k₂k₃k₄ and the second puncturing pattern is a puncturing pattern corresponding to the 2*996+484-tone MRU 5, where kᵢ is negation of kᵢ, i includes 1, 2, 3, and 4, and k₁k₂k₃k₄ is any one of 0111, 1011, 1101, 1110, 1100, 0011, 1001, or 0000; or when the first bitmap is 0000 0000 0001 0000, the first puncturing pattern is 1111 1111 1110 1111 and the second puncturing pattern is a puncturing pattern corresponding to the 3*996+484-tone MRU 6; or when the first bitmap is 0000 0000 0010 0000, the first puncturing pattern is 1111 1111 1101 1111 and the second puncturing pattern is a puncturing pattern corresponding to the 3*996+484-tone MRU 6; or when the first bitmap is 0000 0000 0100 0000, the first puncturing pattern is 1111 1111 1011 1111 and the second puncturing pattern is a puncturing pattern corresponding to the 3*996+484-tone MRU 5; or when the first bitmap is 0000 0000 1000 0000, the first puncturing pattern is 1111 1111 0111 1111, and the second puncturing pattern is a puncturing pattern corresponding to the 3*996+484-tone MRU 5; or when the first bitmap is 0000 0000 0000 0110, the first puncturing pattern is 1111 1111 1111 1001 and the second puncturing pattern is a puncturing pattern corresponding to the 3*996-tone MRU 4; or when the first bitmap is 0000 0000 0000 0001, the first puncturing pattern is 1111 1111 1111 1110 and the second puncturing pattern is a puncturing pattern corresponding to the 3*996+484-tone MRU 8; or when the first bitmap is 0000 0000 0000 0010, the first puncturing pattern is 1111 1111 1111 1101 and the second puncturing pattern is a puncturing pattern corresponding to the 3*996+484-tone MRU 8; or when the first bitmap is 0000 0000 0000 0100, the first puncturing pattern is 1111 1111 1111 1011 and the second puncturing pattern is a puncturing pattern corresponding to the 3*996+484-tone MRU 7; or when the first bitmap is 0000 0000 0000 1000, the first puncturing pattern is 1111 1111 1111 0111 and the second puncturing pattern is a puncturing pattern corresponding to the 3*996+484-tone MRU 7.

For a clearer description of the mapping relationships between the first bitmap and the first puncturing pattern and between the first bitmap and the second puncturing pattern when the first BSS bandwidth is 320 MHz and the first BSS bandwidth is divided into a secondary 80 MHz channel, a primary 80 MHz channel, and a secondary 160 MHz channel in ascending order of frequencies in sequence, the mapping relationships can be converted into a mapping table shown in Table 7 below.

TABLE 7
A table of mapping of the 320 MHz bandwidth (secondary 80 MHz
channel-primary 80 MHz channel-secondary 160 MHz channel)

| First bitmap (0 | | | Other conditions |
|---|---|---|---|
| indicates that | First puncturing | | (than the |
| transmission is allowed, | pattern (0 indicates | Second puncturing | conditions in |
| and 1 indicates that | puncturing, and 1 | pattern (0 indicates | Note 3 to Note 5 |
| transmission is not | indicates no | puncturing, and 1 | at the bottom of |
| allowed) | puncturing) | indicates no puncturing) | this table) |
| y₁y₂y₃y₄ 0110 z₁z₂z₃z₄ | y₁y₂y₃y₄ 1001 | 20 MHz PPDU: | None |
| k₁k₂k₃k₄ | z₁z₂z₃z₄ k₁k₂k₃k₄ | 1111 (namely, 242-tone | |
| | | RU 1) | |
| y₁y₂y₃y₄ 0011 | y₁y₂y₃y₄ 1100 | 40 MHz PPDU: | y₁y₂y₃y₄ is not |
| z₁z₂z₃z₄k₁k₂k₃k₄ | z₁z₂z₃z₄ k₁k₂k₃k₄ | 1111 (namely, 484-tone | equal to 1111. |
| | | RU 1) | z₁z₂z₃z₄ and |
| | | | k₁k₂k₃k₄ are not |
| | | | both equal to |
| | | | 1111 1111. |
| y₁y₂y₃y₄ 1100 z₁z₂z₃z₄ | y₁y₂y₃y₄ 0011 | 40 MHz PPDU: | y₁y₂y₃y₄ is not |
| k₁k₂k₃k₄ | z₁z₂z₃z₄ k₁k₂k₃k₄ | 1111 (namely, 484-tone | equal to 1111. |
| | | RU 1) | z₁z₂z₃z₄ and |
| | | | k₁k₂k₃k₄ are not |
| | | | both equal to |
| | | | 1111 1111. |
| y₁y₂y₃y₄ 0011 | y₁y₂y₃y₄ 1100 | 2 * 996 + 484-tone MRU of | y₁y₂y₃y₄ is not |
| 0000 0000 | 1111 1111 | 320 MHz PPDU: | equal to 1111. |
| | | 0000 1100 1111 1111 | |
| | | (namely, 2 * 996 + 484-tone | |
| | | MRU 8) | |
| y₁y₂y₃y₄ 1100 | y₁y₂y₃y₄ 0011 | 2 * 996 + 484-tone MRU of | y₁y₂y₃y₄ is not |
| 0000 0000 | 1111 1111 | 320 MHz PPDU: | equal to 1111. |
| | | 0000 0011 1111 1111 | |
| | | (namely, 2 * 996 + 484-tone | |
| | | MRU 7) | |
| 0000 0011 z₁z₂z₃z₄ | 1111 1100 | 996 + 484-tone MRU of | z₁z₂z₃z₄ is not |
| k₁k₂k₃k₄ | z₁z₂z₃z₄ k₁k₂k₃k₄ | 160 MHz PPDU: | equal to 1111. |
| | | 1111 1100 (namely, | |
| | | 996 + 484-tone MRU 4) | |
| 0000 1100 z₁z₂z₃z₄ | 1111 0011 | 996 + 484-tone MRU of | z₁z₂z₃z₄ is not |
| k₁k₂k₃k₄ | z₁z₂z₃z₄ k₁k₂k₃k₄ | 160 MHz PPDU: | equal to 1111. |
| | | 1111 0011 (namely, | |
| | | 996 + 484-tone MRU 3) | |
| 0000 0011 0000 | 1111 1100 1111 | 2 * 996 + 484-tone MRU of | k₁k₂k₃k₄ is not |
| k₁k₂k₃k₄ | k₁k₂k₃k₄ | 320 MHz PPDU: | equal to 1111. |
| | | 1111 1100 1111 0000 | |
| | | (namely, 2 * 996 + 484-tone | |
| | | MRU 4) | |
| 0000 1100 0000 | 1111 0011 1111 | 2 * 996 + 484-tone MRU of | k₁k₂k₃k₄ is not |
| k₁k₂k₃k₄ | k₁k₂k₃k₄ | 320 MHz PPDU: | equal to 1111. |
| | | 1111 0011 1111 0000 | |
| | | (namely, 2 * 996 + 484-tone | |
| | | MRU 3) | |
| y₁y₂y₃y₄ 0001 z₁z₂z₃z₄ | y₁y₂y₃y₄ 1110 | 484 + 242-tone MRU of | y₁y₂y₃y₄ is not |
| k₁k₂k₃k₄ | z₁z₂z₃z₄ k₁k₂k₃k₄ | 80 MHz PPDU: | equal to 1111. |
| | | 1110 (namely, 484 + 242- | z₁z₂z₃z₄ and |
| | | tone MRU 4) | k₁k₂k₃k₄ are not |
| | | | both equal to |
| | | | 1111 1111. |
| y₁y₂y₃y₄ 0100 z₁z₂z₃z₄ | y₁y₂y₃y₄ 1011 | 484 + 242-tone MRU of | y₁y₂y₃y₄ is not |
| k₁k₂k₃k₄ | z₁z₂z₃z₄ k₁k₂k₃k₄ | 80 MHz PPDU: | equal to 1111. |
| | | 1011 (namely, 484 + 242- | z₁z₂z₃z₄ and |
| | | tone MRU 2) | k₁k₂k₃k₄ are not |
| | | | both equal to |
| | | | 1111 1111. |
| y₁y₂y₃y₄ 0010 z₁z₂z₃z₄ | y₁y₂y₃y₄ 1101 | 484 + 242-tone MRU of | y₁y₂y₃y₄ is not |
| k₁k₂k₃k₄ | z₁z₂z₃z₄ k₁k₂k₃k₄ | 80 MHz PPDU: | equal to 1111. |
| | | 1101 (namely, 484 + 242- | z₁z₂z₃z₄ and |
| | | tone MRU 3) | k₁k₂k₃k₄ are not |
| | | | both equal to |
| | | | 1111 1111. |
| y₁y₂y₃y₄ 1000 z₁z₂z₃z₄ | y₁y₂y₃y₄ 0111 | 484 + 242-tone MRU of | y₁y₂y₃y₄ is not |
| k₁k₂k₃k₄ | z₁z₂z₃z₄ k₁k₂k₃k₄ | 80 MHz PPDU: | equal to 1111. |
| | | 0111 (namely, 484 + 242- | z₁z₂z₃z₄ and |
| | | tone MRU 1) | k₁k₂k₃k₄ are not |
| | | | both equal to |
| | | | 1111 1111. |
| y₁y₂y₃y₄ 0001 0000 | y₁y₂y₃y₄ 1110 | 2 * 996 + 484-tone MRU of | y₁y₂y₃y₄ is not |
| 0000 | 1111 1111 | 320 MHz PPDU: | equal to 1111. |
| | | 0000 1100 1111 1111 | |
| | | (namely, 2 * 996 + 484-tone | |
| | | MRU 8) | |
| y₁y₂y₃y₄ 0100 0000 | y₁y₂y₃y₄ 1011 | 2 * 996 + 484-tone MRU of | y₁y₂y₃y₄ is not |
| 0000 | 1111 1111 | 320 MHz PPDU: | equal to 1111. |
| | | 0000 0011 1111 1111 | |
| | | (namely, 2 * 996 + 484-tone | |
| | | MRU 7) | |
| y₁y₂y₃y₄ 0010 0000 | y₁y₂y₃y₄ 1101 | 2 * 996 + 484-tone MRU of | y₁y₂y₃y₄ is not |
| 0000 | 1111 1111 | 320 MHz PPDU: | equal to 1111. |
| | | 0000 1100 1111 1111 | |
| | | (namely, 2 * 996 + 484-tone | |
| | | MRU 8) | |
| y₁y₂y₃y₄ 1000 0000 | y₁y₂y₃y₄ 0111 | 2 * 996 + 484-tone MRU of | y₁y₂y₃y₄ is not |
| 0000 | 1111 1111 | 320 MHz PPDU: | equal to 1111. |
| | | 0000 0011 1111 1111 | |
| | | (namely, 2 * 996 + 484-tone | |
| | | MRU 7) | |
| 0000 0001 z₁z₂z₃z₄ | 1111 1110 | 996 + 484 + 242-tone MRU | z₁z₂z₃z₄ is not |
| k₁k₂k₃k₄ | z₁z₂z₃z₄k₁k₂k₃k₄ | of 160 MHz PPDU: | equal to 1111. |
| | | 1111 1110 (namely, | |
| | | 996 + 484 + 242-tone MRU | |
| | | 8) | |
| 0000 0100 z₁z₂z₃z₄ | 1111 1011 | 996 + 484 + 242-tone MRU | z₁z₂z₃z₄ is not |
| k₁k₂k₃k₄ | z₁z₂z₃z₄ k₁k₂k₃k₄ | of 160 MHz PPDU: | equal to 1111. |
| | | 1111 1011 (namely, | |
| | | 996 + 484 + 242-tone MRU | |
| | | 6) | |
| 0000 0010 | 1111 1101 | 996 + 484 + 242-tone MRU | z₁z₂z₃z₄ is not |
| z₁z₂z₃z₄ k₁k₂k₃k₄ | z₁z₂z₃z₄ k₁k₂k₃k₄ | of 160 MHz PPDU: | equal to 1111. |
| | | 1111 1101 (namely, | |
| | | 996 + 484 + 242-tone MRU | |
| | | 7) | |
| 0000 1000 z₁z₂z₃z₄ | 1111 0111 | 996 + 484 + 242-tone MRU | z₁z₂z₃z₄ is not |
| k₁k₂k₃k₄ | z₁z₂z₃z₄ k₁k₂k₃k₄ | of 160 MHz PPDU: | equal to 1111. |
| | | 1111 0111 (namely, | |
| | | 996 + 484 + 242-tone MRU | |
| | | 5) | |
| 0000 0001 z₁z₂z₃z₄ | 1111 1110 1111 | 2 * 996 + 484-tone MRU of | k₁k₂k₃k₄ is not |
| k₁k₂k₃k₄ | k₁k₂k₃k₄ | 320 MHz PPDU: | equal to 1111. |
| | | 1111 1100 1111 0000 | |
| | | (namely, 2 * 996 + 484-tone | |
| | | MRU 4) | |
| 0000 0100 0000 | 1111 1011 1111 | 2 * 996 + 484-tone MRU of | k₁k₂k₃k₄ is not |
| k₁k₂k₃k₄ | k₁k₂k₃k₄ | 320 MHz PPDU: | equal to 1111. |
| | | 1111 0011 1111 0000 | |
| | | (namely, 2 * 996 + 484-tone | |
| | | MRU 3) | |
| 0000 0010 0000 | 1111 1101 1111 | 2 * 996 + 484-tone MRU of | k₁k₂k₃k₄ is not |
| k₁k₂k₃k₄ | k₁k₂k₃k₄ | 320 MHz PPDU: | equal to 1111. |
| | | 1111 1100 1111 0000 | |
| | | (namely, 2 * 996 + 484-tone | |
| | | MRU 4) | |
| 0000 1000 0000 | 1111 0111 1111 | 2 * 996 + 484-tone MRU of | k₁k₂k₃k₄ is not |
| k₁k₂k₃k₄ | k₁k₂k₃k₄ | 320 MHz PPDU: | equal to 1111. |
| | | 1111 0011 1111 0000 | |
| | | (namely, 2 * 996 + 484-tone | |
| | | MRU 3) | |
| 0000 0001 0000 0000 | 1111 1110 1111 | 3 * 996 + 484-tone MRU of | None |
| | 1111 | 320 MHz PPDU: | |
| | | 1111 1100 1111 1111 | |
| | | (namely, 3 * 996 + 484-tone | |
| | | MRU 4) | |
| 0000 0100 0000 0000 | 1111 1011 1111 | 3 * 996 + 484-tone MRU of | None |
| | 1111 | 320 MHz PPDU: | |
| | | 1111 0011 1111 1111 | |
| | | (namely, 3 * 996 + 484-tone | |
| | | MRU 3) | |
| 0000 0010 0000 0000 | 1111 1101 1111 | 3 * 996 + 484-tone MRU of | None |
| | 1111 | 320 MHz PPDU: | |
| | | 1111 1100 1111 1111 | |
| | | (namely, 3 * 996 + 484-tone | |
| | | MRU 4) | |
| 0000 1000 0000 0000 | 1111 0111 1111 | 3 * 996 + 484-tone MRU of | None |
| | 1111 | 320 MHz PPDU: | |
| | | 1111 0011 1111 1111 | |
| | | (namely, 3 * 996 + 484-tone | |
| | | MRU 3) | |
| 0110 0000 0110 | 1001 1111 1001 | 80 MHz PPDU: | z₁z₂z₃z₄ is not |
| k₁k₂k₃k₄ | k₁k₂k₃k₄ | 1111 (namely, 996-tone | equal to 1111. |
| or 0110 0000 0110 | or 1001 1111 1001 | RU 1) | k₁k₂k₃k₄ is not |
| 0000 | 1111 | | equal to 1111. |
| or 0110 0000 1100 | or 1001 1111 0011 | | |
| k₁k₂k₃k₄ | k₁k₂k₃k₄ | | |
| or 0110 0000 0011 | or 1001 1111 1100 | | |
| k₁k₂k₃k₄ | k₁k₂k₃k₄ | | |
| or 0110 0000 1000 | or 1001 1111 0111 | | |
| k₁k₂k₃k₄ | k₁k₂k₃k₄ | | |
| or 0110 0000 0100 | or 1001 1111 1011 | | |
| k₁k₂k₃k₄ | k₁k₂k₃k₄ | | |
| or 0110 0000 0010 | or 1001 1111 1101 | | |
| k₁k₂k₃k₄ | k₁k₂k₃k₄ | | |
| or 0110 0000 0001 | or 1001 1111 1110 | | |
| k₁k₂k₃k₄ | k₁k₂k₃k₄ | | |
| or 0110 0000 z₁z₂z₃z₄ | or 1001 1111 | | |
| 0110 | z₁z₂z₃z₄ 1001 | | |
| or 0110 0000 z₁z₂z₃z₄ | or 1001 1111 | | |
| 1100 | z₁z₂z₃z₄ 0011 | | |
| or 0110 0000 z₁z₂z₃z₄ | or 1001 1111 | | |
| 0011 | z₁z₂z₃z₄ 1100 | | |
| or 0110 0000 z₁z₂z₃z₄ | or 1001 1111 | | |
| 1000 | z₁z₂z₃z₄ 0111 | | |
| or 0110 0000 z₁z₂z₃z₄ | or 1001 1111 | | |
| 0100 | z₁z₂z₃z₄ 101 1 | | |
| or 0110 0000 z₁z₂z₃z₄ | or 1001 1111 | | |
| 0010 | z₁z₂z₃z₄ 1101 | | |
| or 0110 0000 z₁z₂z₃z₄ | or 1001 1111 | | |
| 0001 | z₁z₂z₃z₄ 1110 | | |
| 0110 0000 1100 0000 | 1001 1111 0011 | 2 * 996 + 484-tone MRU of | |
| | 1111 | 320 MHz PPDU: | |
| | | 0000 1111 0011 1111 | |
| | | (namely, 2 * 996 + 484-tone | |
| | | MRU 9) | |
| 0110 0000 0011 0000 | 1001 1111 1100 | 2 * 996 + 484-tone MRU of | |
| | 1111 | 320 MHz PPDU: | |
| | | 0000 1111 1100 1111 | |
| | | (namely, 2 * 996 + 484-tone | |
| | | MRU 10) | |
| 0110 0000 1000 0000 | 1001 1111 0111 | 2 * 996 + 484-tone MRU of | |
| | 1111 | 320 MHz PPDU: | |
| | | 0000 1111 0011 1111 | |
| | | (namely, 2 * 996 + 484-tone | |
| | | MRU 9) | |
| 0110 0000 0100 0000 | 1001 1111 1011 | 2 * 996 + 484-tone MRU of | |
| | 1111 | 320 MHz PPDU: | |
| | | 0000 1111 0011 1111 | |
| | | (namely, 2 * 996 + 484-tone | |
| | | MRU 9) | |
| 0110 0000 0010 0000 | 1001 1111 1101 | 2 * 996 + 484-tone MRU of | |
| | 1111 | 320 MHz PPDU: | |
| | | 0000 1111 1100 1111 | |
| | | (namely, 2 * 996 + 484-tone | |
| | | MRU 10) | |
| 0110 0000 0001 0000 | 1001 1111 1110 | 2 * 996 + 484-tone MRU of | |
| | 1111 | 320 MHz PPDU: | |
| | | 0000 1111 1100 1111 | |
| | | (namely, 2 * 996 + 484-tone | |
| | | MRU 10) | |
| 0110 0000 0000 0011 | 1001 1111 1111 | 2 * 996 + 484-tone MRU of | |
| | 0011 | 320 MHz PPDU: | |
| | | 0000 1111 1111 0011 | |
| | | (namely, 2 * 996 + 484-tone | |
| | | MRU 11) | |
| 0110 0000 0000 1100 | 1001 1111 1111 | 2 * 996 + 484-tone MRU of | |
| | 1100 | 320 MHz PPDU: | |
| | | 0000 1111 1111 1100 | |
| | | (namely, 2 * 996 + 484-tone | |
| | | MRU 12) | |
| 0110 0000 0000 1000 | 1001 1111 1111 | 2 * 996 + 484-tone MRU of | |
| | 0111 | 320 MHz PPDU: | |
| | | 0000 1111 1111 0011 | |
| | | (namely, 2 * 996 + 484-tone | |
| | | MRU 11) | |
| 0110 0000 0000 0100 | 1001 1111 1111 | 2 * 996 + 484-tone MRU of | |
| | 1011 | 320 MHz PPDU: | |
| | | 0000 1111 1111 0011 | |
| | | (namely, 2 * 996 + 484-tone | |
| | | MRU 11) | |
| 0110 0000 0000 0010 | 1001 1111 1111 | 2 * 996 + 484-tone MRU of | |
| | 1101 | 320 MHz PPDU: | |
| | | 0000 1111 1111 1100 | |
| | | (namely, 2 * 996 + 484-tone | |
| | | MRU 12) | |
| 0110 0000 0000 0001 | 1001 1111 1111 | 2 * 996 + 484-tone MRU of | |
| | 1110 | 320 MHz PPDU: | |
| | | 0000 1111 1111 1100 | |
| | | (namely, 2 * 996 + 484-tone | |
| | | MRU 12) | |
| 0110 0000 0000 0000 | 1001 1111 1111 | 3 * 996-tone MRU of 320 | None |
| | 1111 | MHz PPDU | |
| | | 0000 1111 1111 1111 | |
| | | (namely, 3 * 996-tone | |
| | | MRU 1) | |
| 0011 0000 0110 | 1100 1111 1001 | 996 + 484-tone MRU of | z₁z₂z₃z₄ is not |
| k₁k₂k₃k₄ | k₁k₂k₃k₄ | 160 MHz PPDU | equal to 1111. |
| or 0011 0000 0110 | or 1100 1111 1001 | 1100 1111 (namely, | k₁k₂k₃k₄ is not |
| 0000 | 1111 | 996 + 484-tone MRU 2) | equal to 1111. |
| or 0011 0000 1100 | or 1100 1111 0011 | | |
| k₁k₂k₃k₄ | k₁k₂k₃k₄ | | |
| or 0011 0000 0011 | or 1100 1111 1100 | | |
| k₁k₂k₃k₄ | k₁k₂k₃k₄ | | |
| or 0011 0000 1000 | or 1100 1111 0111 | | |
| k₁k₂k₃k₄ | k₁k₂k₃k₄ | | |
| or 0011 0000 0100 | or 1100 1111 1011 | | |
| k₁k₂k₃k₄ | k₁k₂k₃k₄ | | |
| or 0011 0000 0010 | or 1100 1111 1101 | | |
| k₁k₂k₃k₄ | k₁k₂k₃k₄ | | |
| or 0011 0000 0001 | or 1100 1111 1110 | | |
| k₁k₂k₃k₄ | k₁k₂k₃k₄ | | |
| or 0011 0000 z₁z₂z₃z₄ | or 1100 1111 | | |
| 0110 | z₁z₂z₃z₄ 1001 | | |
| or 0011 0000 z₁z₂z₃z₄ | or 1100 1111 | | |
| 1100 | z₁z₂z₃z₄ 0011 | | |
| or 0011 0000 z₁z₂z₃z₄ | or 1100 1111 | | |
| 0011 | z₁z₂z₃z₄ 1100 | | |
| or 0011 0000 z₁z₂z₃z₄ | or 1100 1111 | | |
| 1000 | z₁z₂z₃z₄ 0111 | | |
| or 0011 0000 z₁z₂z₃z₄ | or 1100 1111 | | |
| 0100 | z₁z₂z₃z₄ 1011 | | |
| or 0011 0000 z₁z₂z₃z₄ | or 1100 1111 | | |
| 0010 | z₁z₂z₃z₄ 1101 | | |
| or 0011 0000 z₁z₂z₃z₄ | or 1100 1111 | | |
| 0001 | z₁z₂z₃z₄ 1110 | | |
| 1100 0000 0110 | 0011 1111 1001 | 996 + 484-tone MRU of | z₁z₂z₃z₄ is not |
| k₁k₂k₃k₄ | k₁k₂k₃k₄ | 160 MHz PPDU | equal to 1111. |
| or 1100 0000 0110 | or 0011 1111 1001 | 0011 1111 (namely, | k₁k₂k₃k₄ is not |
| 0000 | 1111 | 996 + 484-tone MRU 1) | equal to 1111. |
| or 1100 0000 1100 | or 0011 1111 0011 | | |
| k₁k₂k₃k₄ | k₁k₂k₃k₄ | | |
| or 1100 0000 0011 | or 0011 1111 1100 | | |
| k₁k₂k₃k₄ | k₁k₂k₃k₄ | | |
| or 1100 0000 1000 | or 0011 1111 0111 | | |
| k₁k₂k₃k₄ | k₁k₂k₃k₄ | | |
| or 1100 0000 0100 | or 0011 1111 1011 | | |
| k₁k₂k₃k₄ | k₁k₂k₃k₄ | | |
| or 1100 0000 0010 | or 0011 1111 1101 | | |
| k₁k₂k₃k₄ | k₁k₂k₃k₄ | | |
| or 1100 0000 0001 | or 0011 1111 1110 | | |
| k₁k₂k₃k₄ | k₁k₂k₃k₄ | | |
| or 1100 0000 z₁z₂z₃z₄ | or 0011 1111 | | |
| 0110 | z₁z₂z₃z₄ 1001 | | |
| or 1100 0000 z₁z₂z₃z₄ | or 0011 1111 | | |
| 1100 | z₁z₂z₃z₄ 0011 | | |
| or 1100 0000 | or 0011 1111 | | |
| z₁z₂z₃z₄0011 | z₁z₂z₃z₄ 1100 | | |
| or 1100 0000 z₁z₂z₃z₄ | or 0011 1111 | | |
| 1000 | z₁z₂z₃z₄ 0111 | | |
| or 1100 0000 z₁z₂z₃z₄ | or 0011 1111 | | |
| 0100 | z₁z₂z₃z₄ 1011 | | |
| or 1100 0000 z₁z₂z₃z₄ | or 0011 1111 | | |
| 0010 | z₁z₂z₃z₄ 1101 | | |
| or 1100 0000 z₁z₂z₃z₄ | or 0011 1111 | | |
| 0001 | z₁z₂z₃z₄ 1110 | | |
| 0011 0000 1100 0000 | 1100 1111 0011 | 2 * 996 + 484-tone MRU of | |
| or 0011 0000 1000 | 1111 | 320 MHz PPDU: | |
| 0000 | or 1100 1111 0111 | 0000 1111 0011 1111 | |
| or 0011 0000 0100 | 1111 | (namely, 2 * 996 + 484-tone | |
| 0000 | or 1100 1111 1011 | MRU 9) | |
| or 1100 0000 1100 | 1111 | | |
| 0000 | or 0011 1111 0011 | | |
| or 1100 0000 1000 | 1111 | | |
| 0000 | or 0011 1111 0111 | | |
| or 1100 0000 0100 | 1111 | | |
| 0000 | or 0011 1111 1011 | | |
| | 1111 | | |
| 0011 0000 0011 0000 | 1100 1111 1100 | 2 * 996 + 484-tone MRU of | |
| or 0011 0000 0010 | 1111 | 320 MHz PPDU: | |
| 0000 | or 1100 1111 1101 | 0000 1111 1100 1111 | |
| or 0011 0000 0001 | 1111 | (namely, 2 * 996 + 484-tone | |
| 0000 | or 1100 1111 1110 | MRU 10) | |
| or 1100 0000 0011 | 1111 | | |
| 0000 | or 0011 1111 1100 | | |
| or 1100 0000 0010 | 1111 | | |
| 0000 | or 0011 1111 1101 | | |
| or 1100 0000 0001 | 1111 | | |
| 0000 | or 0011 1111 1110 | | |
| | 1111 | | |
| 0011 0000 0000 | 1100 1111 1111 | 2 * 996 + 484-tone MRU of | k₁k₂k₃k₄ is not |
| k₁k₂k₃k₄ | k₁k₂k₃k₄ | 320 MHz PPDU: | equal to 1111. |
| | | 1100 1111 1111 0000 | |
| | | (namely, 2 * 996 + 484-tone | |
| | | MRU 2) | |
| 1100 0000 0000 | 0011 1111 1111 | 2 * 996 + 484-tone MRU of | k₁k₂k₃k₄ is not |
| k₁k₂k₃k₄ | k₁k₂k₃k₄ | 320 MHz PPDU: 0011 | equal to 1111. |
| | | 1111 1111 0000 (namely, | |
| | | 2 * 996 + 484-tone MRU 1) | |
| 0011 0000 0000 | 1100 1111 1111 | 2 * 996 + 484-tone MRU of | k₁k₂k₃k₄ is not |
| k₁k₂k₃k₄ | k₁k₂k₃k₄ | 320 MHz PPDU: | equal to 1111, |
| or 1100 0000 0000 | or 0011 1111 1111 | 0000 1111 1111 0011 | 1101, 1110, 1100, |
| k₁k₂k₃k₄ | k₁k₂k₃k₄ | (namely, 2 * 996 + 484-tone | 1001, or 0000. |
| | | MRU 11) | |
| 0011 0000 0000 | 1100 1111 1111 | 2 * 996 + 484-tone MRU of | k₁k₂k₃k₄ is not |
| k₁k₂k₃k₄ | k₁k₂k₃k₄ | 320 MHz PPDU: | equal to 1111, |
| or 1100 0000 0000 | or 0011 1111 1111 | 0000 1111 1111 1100 | 0111, 101 1, 0011, |
| k₁k₂k₃k₄ | k₁k₂k₃k₄ | (namely, 2 * 996 + 484-tone | 1001, or 0000. |
| | | MRU 12) | |
| 0001 0000 | 1110 1111 | 996 + 484 + 242-tone MRU | z₁z₂z₃z₄ is not |
| Z₁Z₂Z₃Z₄K₁K₂K₃K₄ | Z₁Z₂Z₃Z₄ | of 160 MHz PPDU: | equal to 1111. |
| where | K₁K₂K₃K₄ | 1110 1111 | k₁k₂k₃k₄ is not |
| Z₁Z₂Z₃Z₄K₁K₂K₃K₄ is | where Z₁Z₂Z₃Z₄ | (996 + 484 + 242-tone | equal to 1111. |
| equal to: | K₁K₂K₃K₄ is equal | MRU 4) | |
| 0110 k₁k₂k₃k₄ | to: | | |
| or 0110 0000 | 1001 k₁k₂k₃k₄ | | |
| or 1100 k₁k₂k₃k₄ | or 1001 1111 | | |
| or 0011 k₁k₂k₃k₄ | or 0011 k₁k₂k₃k₄ | | |
| or 1000 k₁k₂k₃k₄ | or 1100 k₁k₂k₃k₄ | | |
| or 0100 k₁k₂k₃k₄ | or 0111 k₁k₂k₃k₄ | | |
| or 0010 k₁k₂k₃k₄ | or 1011 k₁k₂k₃k₄ | | |
| or 0001 k₁k₂k₃k₄ | or 1101 k₁k₂k₃k₄ | | |
| or z₁z₂z₃z₄ 0110 | or 1110 k₁k₂k₃k₄ | | |
| or z₁z₂z₃z₄ 1100 | or z₁z₂z₃z₄ 1001 | | |
| or z₁z₂z₃z₄ 0011 | or z₁z₂z₃z₄ 0011 | | |
| or z₁z₂z₃z₄ 1000 | or z₁z₂z₃z₄ 1100 | | |
| or z₁z₂z₃z₄ 0100 | or z₁z₂z₃z₄ 0111 | | |
| or z₁z₂z₃z₄ 0010 | or z₁z₂z₃z₄ 1011 | | |
| or z₁z₂z₃z₄ 0001 | or z₁z₂z₃z₄ 1101 | | |
| | or z₁z₂z₃z₄ 1110 | | |
| 0010 0000 | 1101 1111 | 996 + 484 + 242-tone MRU | z₁z₂z₃z₄ is not |
| Z₁Z₂Z₃Z₄K₁K₂K₃K₄ | Z₁Z₂Z₃Z₄ | of 160 MHz PPDU: | equal to 1111. |
| where | K₁K₂K₃K₄ | 1101 1111 (namely, | k₁k₂k₃k₄ is not |
| Z₁Z₂Z₃Z₄K₁K₂K₃K₄ | where | 996 + 484 + 242-tone | equal to 1111. |
| is equal to: | Z₁Z₂Z₃Z₄ K₁K₂K₃K₄ | MRU 3) | |
| 0110 k₁k₂k₃k₄ | is equal to: | | |
| or 0110 0000 | 1001 k₁k₂k₃k₄ | | |
| or 1100 k₁k₂k₃k₄ | or 1001 1111 | | |
| or 0011 k₁k₂k₃k₄ | or 0011 k₁k₂k₃k₄ | | |
| or 1000 k₁k₂k₃k₄ | or 1100 k₁k₂k₃k₄ | | |
| or 0100 k₁k₂k₃k₄ | or 0111 k₁k₂k₃k₄ | | |
| or 0010 k₁k₂k₃k₄ | or 1011 k₁k₂k₃k₄ | | |
| or 0001 k₁k₂k₃k₄ | or 1101 k₁k₂k₃k₄ | | |
| or z₁z₂z₃z₄ 0110 | or 1110 k₁k₂k₃k₄ | | |
| or z₁z₂z₃z₄ 1100 | or z₁z₂z₃z₄ 1001 | | |
| or z₁z₂z₃z₄ 0011 | or z₁z₂z₃z₄ 0011 | | |
| or z₁z₂z₃z₄ 1000 | or z₁z₂z₃z₄ 1100 | | |
| or z₁z₂z₃z₄ 0100 | or z₁z₂z₃z₄ 0111 | | |
| or z₁z₂z₃z₄ 0010 | or z₁z₂z₃z₄ 1011 | | |
| or z₁z₂z₃z₄ 0001 | or z₁z₂z₃z₄ 1101 | | |
| | or z₁z₂z₃z₄ 1110 | | |
| 0100 0000 | 1011 1111 | 996 + 484 + 242-tone MRU | z₁z₂z₃z₄ is not |
| Z₁Z₂Z₃Z₄K₁K₂K₃K₄ | Z₁Z₂Z₃Z₄ | of 160 MHz PPDU: | equal to 1111. |
| where | K₁K₂K₃K₄ | 1011 1111 (namely, | k₁k₂k₃k₄ is not |
| Z₁Z₂Z₃Z₄K₁K₂K₃K₄ | where Z₁Z₂Z₃Z₄ | 996 + 484 + 242-tone | equal to 1111. |
| is equal to: | K₁K₂K₃K₄ is | MRU 2) | |
| 0110 k₁k₂k₃k₄ | equal to: | | |
| or 0110 0000 | 1001 k₁k₂k₃k₄ | | |
| or 1100 k₁k₂k₃k₄ | or 1001 1111 | | |
| or 0011 k₁k₂k₃k₄ | or 0011 k₁k₂k₃k₄ | | |
| or 1000 k₁k₂k₃k₄ | or 1100 k₁k₂k₃k₄ | | |
| or 0100 k₁k₂k₃k₄ | or 0111 k₁k₂k₃k₄ | | |
| or 0010 k₁k₂k₃k₄ | or 1011 k₁k₂k₃k₄ | | |
| or 0001 k₁k₂k₃k₄ | or 1101 k₁k₂k₃k₄ | | |
| or z₁z₂z₃z₄ 0110 | or 1110 k₁k₂k₃k₄ | | |
| or z₁z₂z₃z₄ 1100 | or z₁z₂z₃z₄ 1001 | | |
| or z₁z₂z₃z₄ 0011 | or z₁z₂z₃z₄ 0011 | | |
| or z₁z₂z₃z₄ 1000 | or z₁z₂z₃z₄ 1100 | | |
| or z₁z₂z₃z₄ 0100 | or z₁z₂z₃z₄ 0111 | | |
| or z₁z₂z₃z₄ 0010 | or z₁z₂z₃z₄ 1011 | | |
| or z₁z₂z₃z₄ 0001 | or z₁z₂z₃z₄ 1101 | | |
| | or z₁z₂z₃z₄ 1110 | | |
| 1000 0000 | 0111 1111 | 996 + 484 + 242-tone MRU | z₁z₂z₃z₄ is not |
| Z₁Z₂Z₃Z₄K₁K₂K₃K₄ | Z₁Z₂Z₃Z₄ K₁K₂K₃K₄ | of 160 MHz PPDU: | equal to 1111. |
| where | where Z₁Z₂Z₃Z₄ | 0111 1111 (namely, | k₁k₂k₃k₄ is not |
| Z₁Z₂Z₃Z₄K₁K₂K₃K₄ | K₁K₂K₃K₄ is equal | 996 + 484 + 242-tone | equal to 1111. |
| is equal to: | to: | MRU 1) | |
| 0110 k₁k₂k₃k₄ | 1001 k₁k₂k₃k₄ | | |
| or 0110 0000 | or 1001 1111 | | |
| or 1100 k₁k₂k₃k₄ | or 0011 k₁k₂k₃k₄ | | |
| or 0011 k₁k₂k₃k₄ | or 1100 k₁k₂k₃k₄ | | |
| or 1000 k₁k₂k₃k₄ | or 0111 k₁k₂k₃k₄ | | |
| or 0100 k₁k₂k₃k₄ | or 1011 k₁k₂k₃k₄ | | |
| or 0010 k₁k₂k₃k₄ | or 1101 k₁k₂k₃k₄ | | |
| or 0001 k₁k₂k₃k₄ | or 1110 k₁k₂k₃k₄ | | |
| or z₁z₂z₃z₄ 0110 | or z₁z₂z₃z₄ 1001 | | |
| or z₁z₂z₃z₄ 1100 | or z₁z₂z₃z₄ 0011 | | |
| or z₁z₂z₃z₄ 0011 | or z₁z₂z₃z₄ 1100 | | |
| or z₁z₂z₃z₄ 1000 | or z₁z₂z₃z₄ 0111 | | |
| or z₁z₂z₃z₄ 0100 | or z₁z₂z₃z₄ 1011 | | |
| or z₁z₂z₃z₄ 0010 | or z₁z₂z₃z₄ 1101 | | |
| or z₁z₂z₃z₄ 0001 | or z₁z₂z₃z₄ 1110 | | |
| 0001 0000 | 1110 1111 | 2 * 996 + 484-tone MRU of | |
| Z₁Z₂Z₃Z₄K₁K₂K₃K₄ | Z₁Z₂Z₃Z₄ | 320 MHz PPDU: | |
| or 0010 0000 | K₁K₂K₃K₄ | 0000 1111 0011 1111 | |
| Z₁Z₂Z₃Z₄K₁K₂K₃K₄ | 1101 1111 | (namely, 2 * 996 + 484-tone | |
| or 0100 0000 | Z₁Z₂Z₃Z₄ | MRU 9) | |
| Z₁Z₂Z₃Z₄K₁K₂K₃K₄ | K₁K₂K₃K₄ | | |
| or 1000 0000 | 1011 1111 | | |
| Z₁Z₂Z₃Z₄K₁K₂K₃K₄ | Z₁Z₂Z₃Z₄ | | |
| where | K₁K₂K₃K₄ | | |
| Z₁Z₂Z₃Z₄K₁K₂K₃K₄ | 0111 1111 | | |
| is equal to: | Z₁Z₂Z₃Z₄K₁K₂K₃K₄ | | |
| 1100 0000 | where Z₁Z₂Z₃Z₄ | | |
| or 1000 0000 | K₁K₂K₃K₄ is equal | | |
| or 0100 0000 | to: | | |
| or 0000 k₁k₂k₃k₄ | 0011 1111 | | |
| | or 0111 1111 | | |
| | or 1011 1111 | | |
| | or 1111 k₁k₂k₃k₄ | | |
| 0001 0000 | 1110 1111 | 2 * 996 + 484-tone MRU of | |
| Z₁Z₂Z₃Z₄K₁K₂K₃K₄ | Z₁Z₂Z₃Z₄ | 320 MHz PPDU: | |
| or 0010 0000 | K₁K₂K₃K₄ | 0000 1111 1100 1111 | |
| Z₁Z₂Z₃Z₄K₁K₂K₃K₄ | 1101 1111 | (namely, 2 * 996 + 484-tone | |
| or 0100 0000 | Z₁Z₂Z₃Z₄ | MRU 10) | |
| Z₁Z₂Z₃Z₄K₁K₂K₃K₄ | K₁K₂K₃K₄ | | |
| or 1000 0000 | 1011 1111 | | |
| Z₁Z₂Z₃Z₄K₁K₂K₃K₄ | Z₁Z₂Z₃Z₄ | | |
| where | K₁K₂K₃K₄ | | |
| Z₁Z₂Z₃Z₄K₁K₂K₃K₄ | 0111 1111 | | |
| is equal to: | Z₁Z₂Z₃Z₄ | | |
| 0011 0000 | K₁K₂K₃K₄ | | |
| or 0010 0000 | where Z₁Z₂Z₃Z₄ | | |
| or 0001 0000 | K₁K₂K₃K₄ is equal | | |
| | to: | | |
| | 1100 1111 | | |
| | or 1101 1111 | | |
| | or 1110 1111 | | |
| 0001 0000 | | 2 * 996 + 484-tone MRU of | k₁k₂k₃k₄ is not |
| Z₁Z₂Z₃Z₄K₁K₂K₃K₄ | | 320 MHz PPDU: | equal to 1111. |
| where | | 1100 1111 1111 0000 | |
| Z₁Z₂Z₃Z₄K₁K₂K₃K₄ | | (namely, 2 * 996 + 484-tone | |
| is equal to: | | MRU 2) | |
| 0000 k₁k₂k₃k₄ | | | |
| 0010 0000 | | 2 * 996 + 484-tone MRU of | k₁k₂k₃k₄ is not |
| Z₁Z₂Z₃Z₄K₁K₂K₃K₄ | | 320 MHz PPDU: | equal to 1111. |
| where | | 1100 1111 1111 0000 | |
| Z₁Z₂Z₃Z₄K₁K₂K₃K₄ | | (namely, 2 * 996 + 484-tone | |
| is equal to: | | MRU 2) | |
| 0000 k₁k₂k₃k₄ | | | |
| 0100 0000 | | 2 * 996 + 484-tone MRU of | k₁k₂k₃k₄ is not |
| Z₁Z₂Z₃Z₄K₁K₂K₃K₄ | | 320 MHz PPDU: | equal to 1111. |
| where | | 0011 1111 1111 0000 | |
| Z₁Z₂Z₃Z₄K₁K₂K₃K₄ | | (namely, 2 * 996 + 484-tone | |
| is equal to: | | MRU 1) | |
| 0000 k₁k₂k₃k₄ | | | |
| 1000 0000 | | 2 * 996 + 484-tone MRU of | k₁k₂k₃k₄ is not |
| Z₁Z₂Z₃Z₄K₁K₂K₃K₄ | | 320 MHz PPDU: | equal to 1111. |
| where | | 0011 1111 1111 0000 | |
| Z₁Z₂Z₃Z₄K₁K₂K₃K₄ | | (namely, 2 * 996 + 484-tone | |
| is equal to: | | MRU 1) | |
| 0000 k₁k₂k₃k₄ | | | |
| 0001 0000 0000 0000 | 1110 1111 1111 | 3 * 996 + 484-tone MRU of | None |
| | 1111 | 320 MHz PPDU: | |
| | | 1100 1111 1111 1111 | |
| | | (namely, 3 * 996 + 484-tone | |
| | | MRU 2) | |
| 0010 0000 0000 0000 | 1101 1111 1111 | 3 * 996 + 484-tone MRU of | None |
| | 1111 | 320 MHz PPDU: | |
| | | 1100 1111 1111 1111 | |
| | | (namely, 3 * 996 + 484-tone | |
| | | MRU 2) | |
| 0100 0000 0000 0000 | 1011111 1111 | 3 * 996 + 484-tone MRU of | None |
| | 1111 | 320 MHz PPDU: | |
| | | 0011 1111 1111 1111 | |
| | | (namely, 3 * 996 + 484-tone | |
| | | MRU 1) | |
| 0100 0000 0000 0000 | 0111 1111 1111 | 3 * 996 + 484-tone MRU of | None |
| | 1111 | 320 MHz PPDU: | |
| | | 0011 1111 1111 1111 | |
| | | (namely, 3 * 996 + 484-tone | |
| | | MRU 1) | |
| 0000 0000 0110 | 1111 1111 1001 | 160 MHz PPDU: | k₁k₂k₃k₄ is not |
| k₁k₂k₃k₄ | k₁k₂k₃k₄ | 1111 1111 (namely, | equal to 1111. |
| | | 2 * 996-tone RU 1) | |
| 0000 0000 0011 | 1111 1111 1100 | 2 * 996 + 484-tone MRU of | k₁k₂k₃k₄ is not |
| k₁k₂k₃k₄ | k₁k₂k₃k₄ | 320 MHz PPDU: | equal to 1111. |
| | | 1111 1111 1100 0000 | |
| | | (namely, 2 * 996 + 484-tone | |
| | | MRU 6) | |
| 0000 0000 1100 | 1111 1111 0011 | 2 * 996 + 484-tone MRU of | k₁k₂k₃k₄ is not |
| k₁k₂k₃k₄ | k₁k₂k₃k₄ | 320 MHz PPDU: | equal to 1111. |
| | | 1111 1111 0011 0000 | |
| | | (namely, 2 * 996 + 484-tone | |
| | | MRU 5) | |
| 0000 0000 0001 | 1111 1111 1110 | 2 * 996 + 484-tone MRU of | k₁k₂k₃k₄ is not |
| k₁k₂k₃k₄ | k₁k₂k₃k₄ | 320 MHz PPDU: | equal to 1111. |
| | | 1111 1111 1100 0000 | |
| | | (namely, 2 * 996 + 484-tone | |
| | | MRU 6) | |
| 0000 0000 0010 | 1111 1111 1101 | 2 * 996 + 484-tone MRU of | k₁k₂k₃k₄ is not |
| k₁k₂k₃k₄ | k₁k₂k₃k₄ | 320 MHz PPDU: | equal to 1111. |
| | | 1111 1111 1100 0000 | |
| | | (namely, 2 * 996 + 484-tone | |
| | | MRU 6) | |
| 0000 0000 0100 | 1111 1111 1011 | 2 * 996 + 484-tone MRU of | k₁k₂k₃k₄ is not |
| k₁k₂k₃k₄ | k₁k₂k₃k₄ | 320 MHz PPDU: | equal to 1111. |
| | | 1111 1111 0011 0000 | |
| | | (namely, 2 * 996 + 484-tone | |
| | | MRU 5) | |
| 0000 0000 1000 | 1111 1111 0111 | 2 * 996 + 484-tone MRU of | k₁k₂k₃k₄ is not |
| k₁k₂k₃k₄ | k₁k₂k₃k₄ | 320 MHz PPDU: | equal to 1111. |
| | | 1111 1111 0011 0000 | |
| | | (namely, 2 * 996 + 484-tone | |
| | | MRU 5) | |
| 0000 0000 0001 0000 | 1111 1111 1110 | 3 * 996 + 484-tone MRU of | |
| | 1111 | 320 MHz PPDU: | |
| | | 1111 1111 1100 1111 | |
| | | (namely, 3 * 996 + 484-tone | |
| | | MRU 6) | |
| 0000 0000 0010 0000 | 1111 1111 1101 | 3 * 996 + 484-tone MRU of | |
| | 1111 | 320 MHz PPDU: | |
| | | 1111 1111 1100 1111 | |
| | | (namely, 3 * 996 + 484-tone | |
| | | MRU 6) | |
| 0000 0000 0100 0000 | 1111 1111 1011 | 3 * 996 + 484-tone MRU of | |
| | 1111 | 320 MHz PPDU: | |
| | | 1111 1111 0011 1111 | |
| | | (namely, 3 * 996 + 484-tone | |
| | | MRU 5) | |
| 0000 0000 1000 0000 | 1111 1111 0111 | 3 * 996 + 484-tone MRU of | |
| | 1111 | 320 MHz PPDU: | |
| | | 1111 1111 0011 1111 | |
| | | (namely, 3 * 996 + 484-tone | |
| | | MRU 5) | |
| 0000 0000 0000 0110 | 1111 1111 1111 | 3 * 996-tone MRU of 320 | |
| | 1001 | MHz PPDU: | |
| | | 1111 1111 1111 0000 | |
| | | (namely, 3 * 996-tone | |
| | | MRU 4) | |
| 0000 0000 0000 0001 | 1111 1111 1111 | 3 * 996 + 484-tone MRU of | |
| | 1110 | 320 MHz PPDU: | |
| | | 1111 1111 1111 1100 | |
| | | (namely, 3 * 996 + 484-tone | |
| | | MRU 8) | |
| 0000 0000 0000 0010 | 1111 1111 1111 | 3 * 996 + 484-tone MRU of | |
| | 1101 | 320 MHz PPDU: | |
| | | 1111 1111 1111 1100 | |
| | | (namely, 3 * 996 + 484-tone | |
| | | MRU 8) | |
| 0000 0000 0000 0100 | 1111 1111 1111 | 3 * 996 + 484-tone MRU of | |
| | 1011 | 320 MHz PPDU: | |
| | | 1111 1111 1111 0011 | |
| | | (namely, 3 * 996 + 484-tone | |
| | | MRU 7) | |
| 0000 0000 0000 1000 | 1111 1111 1111 | 3 * 996 + 484-tone MRU of | |
| | 0111 | 320 MHz PPDU: | |
| | | 1111 1111 1111 0011 | |
| | | (namely, 3 * 996 + 484-tone | |
| | | MRU 7) | |

Note 1:
yᵢ, zᵢ, and kᵢ each indicate that the value may be 1 or 0.
Note 2:
yᵢ indicates negation of yᵢ; when yᵢ is 0, yᵢ is 1, or when yᵢ is 1, yᵢ is 0; and zᵢ indicates negation of zᵢ, and kᵢ indicates negation of kᵢ, where i = 1, 2, 3, or 4.
Note 3:
z₁z₂z₃z₄ and k₁k₂k₃k₄ may not be both 0000 0000 (Otherwise, the BSS bandwidth is reduced to 160 MHz).
Note 4:
In this table, the primary 20 MHz channel is located at a non-punctured position in the primary 80 MHz channel.
Note 5:
y₁y₂y₃y₄, z₁z₂z₃z₄, and k₁k₂k₃k₄ each may be 1111, 0111, 1011 , 1101, 1110, 1100, 0011, 1001 or 0000.
Note 6:
The second puncturing pattern (namely, the non-OFDMA puncturing pattern with the maximum size) is preferably used to perform non-OFDMA transmission, or the first puncturing pattern (namely, the OFDMA puncturing pattern with the maximum size) is preferably used to perform OFDMA transmission. Certainly, the non-OFDMA transmissionmay be alternatively performed by using a supported non-OFDMA puncturing pattern with a smaller size, or the OFDMA transmission may be performed by using a supported OFDMA puncturing pattern with a smaller size. Sizes are sorted according to a quantity of included subcarriers. A larger size indicates a larger quantity of subcarriers, and a smaller size indicates a smaller quantity of subcarriers.

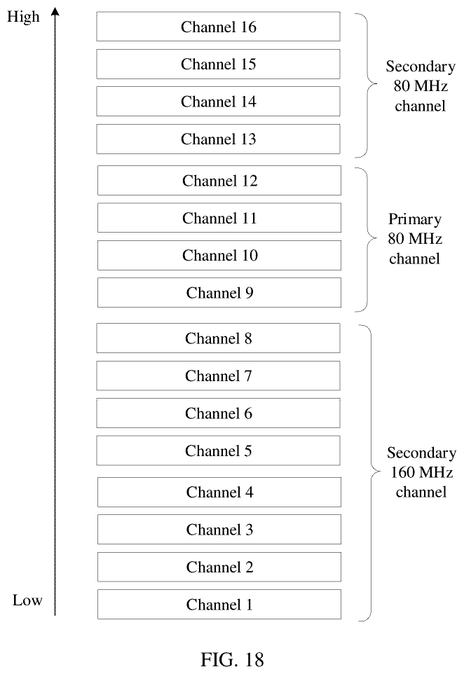

Optionally, in some feasible implementations, when the first BSS bandwidth is 320 MHz and the first BSS bandwidth is divided into a secondary 160 MHz channel, a primary 80 MHz channel, and a secondary 80 MHz channel in ascending order of frequencies in sequence (as shown in FIG. 18, the primary 20 MHz channel is located in an 80 MHz channel corresponding to a channel 9 to a channel 12 in the 320 MHz bandwidth): For mapping relationships between the first bitmap and the first puncturing pattern and between the first bitmap and the second puncturing pattern, the four bits corresponding to the secondary 80 MHz channel, the four bits corresponding to the primary 80 MHz channel, and the eight bits corresponding to the secondary 160 MHz channel in Table 7 need to be adjusted according to a sequence of the secondary 160 MHz channel, the primary 80 MHz channel, and the secondary 80 MHz channel respectively, to obtain the mapping relationships when the first BSS bandwidth is 320 MHz and the first BSS bandwidth is divided into the secondary 160 MHz channel, the primary 80 MHz channel, and the secondary 80 MHz channel in ascending order of frequencies in sequence. It can be understood that, after the four bits corresponding to the corresponding primary 80 MHz channel, the four bits corresponding to the corresponding secondary 80 MHz channel, and the eight bits corresponding to the corresponding secondary 160 MHz channel are swapped according to the different division of the first BSS bandwidth, an index value of a resource unit corresponding to the second puncturing pattern also needs to be adaptively adjusted. This is specifically determined based on an actual scenario, and is not limited herein.

For example, in Table 7, the first bitmap is y₁y₂y₃y₄ 0011 0000 0000, the first puncturing pattern is y₁y₂y₃y₄ 1100 1111 1111, and the second puncturing pattern is 0000 1100 1111 1111 (namely, a puncturing pattern corresponding to the 2*996+484-tone MRU 8). When the first BSS bandwidth is 320 MHz and the first BSS bandwidth is divided into a secondary 160 MHz channel, a primary 80 MHz channel, and a secondary 80 MHz channel in ascending order of frequencies in sequence, the four bits corresponding to the secondary 80 MHz channel, the four bits corresponding to the primary 80 MHz channel, and the eight bits corresponding to the secondary 160 MHz channel in Table 7 are adjusted according to a sequence of the secondary 160 MHz channel, the primary 80 MHz channel, and the secondary 80 MHz channel, to obtain mapping relationships between the first bitmap and the first puncturing pattern and between the first bitmap and the second puncturing pattern when the first BSS bandwidth is 320 MHz and the first BSS bandwidth is divided into the secondary 160 MHz channel, the primary 80 MHz channel, and the secondary 80 MHz channel in ascending order of frequencies in sequence as follows: The first bitmap is 0000 0000 0011 y₁y₂y₃y₄, the first puncturing pattern is 1111 1111 1100 y₁y₂y₃y₄, and the second puncturing pattern is 1111 1111 1100 0000 (namely, a puncturing pattern corresponding to the 2*996+484-tone MRU 6).

For another example, in Table 7, the first bitmap is 0000 0000 0000 0110, the first puncturing pattern is 1111 1111 1111 1001, and the second puncturing pattern is 1111 1111 1111 0000 (namely, a puncturing pattern corresponding to the 3*996-tone MRU 4). When the first BSS bandwidth is 320 MHz and the first BSS bandwidth is divided into a secondary 160 MHz channel, a primary 80 MHz channel, and a secondary 80 MHz channel in ascending order of frequencies in sequence, mapping relationships between the first bitmap and the first puncturing pattern and between the first bitmap and the second puncturing pattern are as follows: The first bitmap is 0000 0110 0000 0000, the first puncturing pattern is 1111 1001 1111 1111, and the second puncturing pattern is 1111 0000 1111 1111 (namely, a puncturing pattern corresponding to the 3*996-tone MRU 2).

For still another example, in Table 7, the first bitmap is 0000 0000 0000 0001, the first puncturing pattern is 1111 1111 1111 1110, and the second puncturing pattern is 1111 1111 1111 1100 (namely, a puncturing pattern corresponding to the 3*996+484-tone MRU 8). When the first BSS bandwidth is 320 MHz and the first BSS bandwidth is divided into a secondary 160 MHz channel, a primary 80 MHz channel, and a secondary 80 MHz channel in ascending order of frequencies in sequence, mapping relationships between the first bitmap and the first puncturing pattern and between the first bitmap and the second puncturing pattern are as follows: The first bitmap is 0000 0001 0000 0000, the first puncturing pattern is 1111 1110 1111 1111, and the second puncturing pattern is 1111 1100 1111 1111 (namely, a puncturing pattern corresponding to the 3*996+484-tone MRU 4).

Optionally, in some feasible implementations, because a puncturing pattern supported by non-OFDMA transmission needs to cover the primary 20 MHz channel, selection of a position of the primary 20 MHz channel has great impact on allowed puncturing patterns for the non-OFDMA transmission. The following first describes selection of a position of a primary 80 MHz channel including the primary 20 MHz channel, and then further describes selection of the primary 20 MHz channel in the primary 80 MHz channel. For example, in a case in which the bitmap indicates 0110 0000 0000 0000, the first BSS bandwidth is 320 MHz; and if the primary 80 MHz channel is located at an 80 MHz channel with a lowest frequency, only a 20 MHz PPDU may be sent based on non-OFDMA transmission (namely, transmission of the PPDU is performed based on: PPDU BW=20 MHz, and a puncturing pattern corresponding to a value 0 of a puncturing indication field). If the primary 80 MHz channel is located at a third or fourth 80 MHz channel from left to right, a 20 MHz PPDU, a 40 MHz PPDU, an 80 MHz PPDU (all puncturing patterns supported by non-OFDMA transmission), a 160 MHz PPDU (all puncturing patterns supported by non-OFDMA transmission), or a 320 MHz PPDU of the 2*996+484-tone MRU or the 3*996-tone MRU may be sent.

For another example, in a case in which the bitmap indicates 0110 0000 1111 1111, the first BSS bandwidth is 160 MHz; and if the primary 80 MHz channel is located at an 80 MHz channel with a lowest frequency (namely, a first 80 MHz channel from left to right) in the first BSS bandwidth, only a 20 MHz PPDU may be sent based on non-OFDMA transmission. If the primary 80 MHz channel is located at an 80 MHz channel with a highest frequency (namely, a second 80 MHz channel from left to right) in the first BSS bandwidth, a 20 MHz PPDU, a 40 MHz PPDU, or an 80 MHz PPDU (all puncturing patterns supported by the non-OFDMA transmission) may be sent based on non-OFDMA transmission.

For still another example, in a case in which the bitmap indicates 0011 1100 1111 1111, the first BSS bandwidth is 160 MHz; and if the primary 80 MHz channel is located at an 80 MHz channel with a highest frequency (namely, a second 80 MHz channel from left to right) in the first BSS bandwidth, only a 20 MHz PPDU may be sent based on non-OFDMA transmission. If the primary 80 MHz channel is located at an 80 MHz channel with a lowest frequency (namely, a first 80 MHz channel from left to right) in the first BSS bandwidth, a 20 MHz PPDU, a 40 MHz PPDU, or an 80 MHz PPDU (all puncturing patterns supported by non-OFDMA transmission) may be sent based on non-OFDMA transmission.

The following further describes the selection of the primary 20 MHz channel in the primary 80 MHz channel.

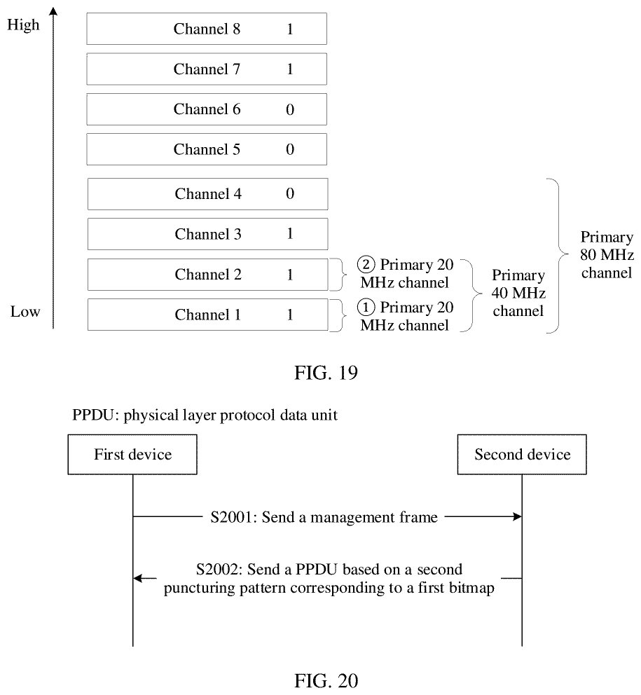

In some feasible implementations, during a further selection of the primary 20 MHz channel from a selected 80 MHz channel (namely, a preferred primary 80 MHz channel), a non-punctured 20 MHz channel in a 40 MHz channel that includes a large quantity of non-punctured 20 MHz channels may be selected as the primary channel. For example, refer to FIG. 19. FIG. 19 is a schematic diagram of a primary 20 MHz channel according to an embodiment of this application. As shown in FIG. 19, in a case in which the first bitmap indicates 0011 1100 1111 1111, the first BSS bandwidth is 160 MHz, the first puncturing pattern indicated by the first bitmap is 1110 0011, and the second puncturing pattern corresponding to the first bitmap is a puncturing pattern corresponding to the 484+242-tone MRU 4. A position of a preferred primary 80 MHz channel is a first 80 MHz channel from bottom to top, that is, the selected 80 MHz channel is an 80 MHz channel with a lowest frequency (namely, an 80 MHz channel corresponding to 1110, for example, an 80 MHz channel formed by a channel 1 to a channel 4 in FIG. 19). Further, the primary 20 MHz channel is a non-punctured sub-channel in a first 40 MHz channel (namely, a 40 MHz channel corresponding to 11 in the 80 MHz channel corresponding to 1110, for example, a 40 MHz channel formed by the channel 1 and the channel 2 in FIG. 19) from bottom to top in the preferred primary 80 MHz channel. For example, the primary 20 MHz channel may be a 20 MHz channel corresponding to the channel 1. For another example, the primary 20 MHz channel may be alternatively a 20 MHz channel corresponding to the channel 2.

It can be learned that the selection of the primary 20 MHz channel (or described as selection of a primary 80 MHz channel in which the primary 20 MHz channel is located) has great impact on puncturing patterns supported by the non-OFDMA transmission. Therefore, for various combinations in Table 3 to Table 7, there is a tendency for the position of the preferred primary 80 MHz channel. According to the standards, a preferred primary 80 MHz channel position is recommended for use, and a non-preferred primary 80 MHz channel position is not recommended for use. Specifically, for Table 3, because only one 80 MHz channel is allowed for use, Table 3 is a unique scheme, and is also a preferred scheme.

Optionally, in some feasible implementations, for Table 4, when the first BSS bandwidth is 160 MHz and the preferred primary 80 MHz channel is a lower 80 MHz channel in the 160 MHz bandwidth (that is, the primary 20 MHz channel is located in the lower 80 MHz channel in the 160 MHz bandwidth), that is, when the first BSS bandwidth is divided into a primary 8 MHz channel and a secondary 80 MHz channel in ascending order of frequencies in sequence, refer to Table 8 below for mapping relationships between the first bitmap and the first puncturing pattern and between the first bitmap and the second puncturing pattern.

TABLE 8
A table of mapping of the 160 MHz bandwidth (primary 80 MHz
channel - secondary 80 MHz channel)

| First bitmap (0 | First puncturing | | |
|---|---|---|---|
| indicates that | pattern (0 | | Other conditions |
| transmission is allowed, | indicates | Second puncturing | (than the conditions |
| and 1 indicates that | puncturing, and | pattern (0 indicates | in Note 3 to Note 5 |
| transmission is not | 1 indicates no | puncturing, and 1 | at the bottom of this |
| allowed) | puncturing) | indicates no puncturing) | table) |
| 0110 y₁y₂y₃y₄ 1111 | 1001 y₁y₂y₃y₄ | 20 MHz PPDU: | y₁y₂y₃y₄ = 0110 |
| 1111 | | 1111 (namely, 242-tone | |
| | | RU 1) | |
| 0011 y₁y₂y₃y₄ 1111 | 1100 y₁y₂y₃y₄ | 40 MHz PPDU: | y₁y₂y₃y₄ = 0110 |
| 1111 | | 1111 (namely, 484-tone | |
| | | RU 1) | |
| 1100 y₁y₂y₃y₄ 1111 | 0011 y₁y₂y₃y₄ | 40 MHz PPDU: | y₁y₂y₃y₄ = 0110 |
| 1111 | | 1111 (namely, 484-tone | |
| | | RU 1) | |
| 0001 y₁y₂y₃y₄ 1111 | 1110 y₁y₂y₃y₄ | 484 + 242-tone MRU of | y₁y₂y₃y₄ is not equal |
| 1111 | | 80 MHz PPDU: | to 1111. |
| | | 1110 (namely, 484 + 242- | |
| | | tone MRU 4) | |
| 0100 y₁y₂y₃y₄ 1111 | 1011 y₁y₂y₃y₄ | 484 + 242-tone MRU of | y₁y₂y₃y₄ is not equal |
| 1111 | | 80 MHz PPDU: | to 1111. |
| | | 1011 (namely, 484 + 242- | |
| | | tone MRU 2) | |
| 0010 y₁y₂y₃y₄ 1111 | 1101 y₁y₂y₃y₄ | 484 + 242-tone MRU of | y₁y₂y₃y₄ is not equal |
| 1111 | | 80 MHz PPDU: | to 1111. |
| | | 1101 (namely, 484 + 242- | |
| | | tone MRU 3) | |
| 1000 y₁y₂y₃y₄ 1111 | 0111 y₁y₂y₃y₄ | 484 + 242-tone MRU of | y₁y₂y₃y₄ is not equal |
| 1111 | | 80 MHz PPDU: | to 1111. |
| | | 0111 (namely, 484 + 242- | |
| | | tone MRU 1) | |
| 0000 0110 1111 1111 | 1111 1001 | 80 MHz PPDU: | None |
| | | 1111 (namely, 996-tone | |
| | | RU 1) | |

Note 1:
yᵢ indicates that the value may be 1 or 0.
Note 2:
yᵢ indicates negation of yᵢ; and when yᵢ is 0, yᵢ is 1; or when yᵢ is 1, yᵢ is 0, where i = 1, 2, 3, or 4.
Note 3:
y₁y₂y₃y₄ may not be 0000 (the secondary 80 MHz channel cannot be simultaneously punctured; otherwise, the BSS bandwidth is reduced to 80 MHz).
Note 4:
In this table, the primary 20 MHz channel is located at a non-punctured position in the primary 80 MHz channel.
Note 5:
y₁y₂y₃y₄ may be 1111, 0111, 1011, 1101, 1110, 1100, 0011 or 1001.
Note 6:
The second puncturing pattern (namely, the non-OFDMA puncturing pattern with the maximum size) is preferably used to perform non-OFDMA transmission, or the first puncturing pattern (namely, the OFDMA puncturing pattern with the maximum size) is preferably used to perform OFDMA transmission. Certainly, the non-OFDMA transmission may be alternatively performed by using a supported non-OFDMA puncturing pattern with a smaller size, or the OFDMA transmission may be performed by using a supported OFDMA puncturing pattern with a smaller size. Sizes are sorted according to a quantity of included subcarriers. A larger size indicates a larger quantity of subcarriers, and a smaller size indicates a smaller quantity of subcarriers.

Optionally, in some feasible implementations, for Table 5, when the first BSS bandwidth is 160 MHz and the preferred primary 80 MHz channel is a higher 80 MHz channel in the 160 MHz bandwidth (that is, the primary 20 MHz is located in the higher 80 MHz channel in the 160 MHz bandwidth), that is, when the first BSS bandwidth is divided into a secondary 80 MHz channel and a primary 80 MHz channel in ascending order of frequencies in sequence, refer to Table 9 below for mapping relationships between the first bitmap and the first puncturing pattern and between the first bitmap and the second puncturing pattern.

TABLE 9
A table of mapping of the 160 MHz bandwidth (secondary 80 MHz
channel - primary 80 MHz channel)

| First bitmap (0 | First puncturing | | |
|---|---|---|---|
| indicates that | pattern (0 | Second puncturing | Other conditions |
| transmission is allowed, | indicates | pattern (0 indicates | (than the conditions |
| and 1 indicates that | puncturing, and 1 | puncturing, and 1 | in Note 3 to Note 5 |
| transmission is not | indicates no | indicates no | at the bottom of this |
| allowed) | puncturing) | puncturing) | table) |
| y₁y₂y₃y₄ 0110 1111 | y₁y₂y₃y₄ 1001 | 20 MHz PPDU: | y₁y₂y₃y₄ = 1001 |
| 1111 | | 1111 (242-tone RU 1) | |
| y₁y₂y₃y₄ 0011 1111 | y₁y₂y₃y₄1100 | 40 MHz PPDU: | y₁y₂y₃y₄ is equal to |
| 1111 | | 1111 (484-tone RU 1) | 1001, or 0011, or |
| | | | 1100. |
| y₁y₂y₃y₄ 1100 1111 | y₁y₂y₃y₄ 0011 | 40 MHz PPDU: | y₁y₂y₃y₄ is equal to |
| 1111 | | 1111 (484-tone RU 1) | 1001, or 0011, or |
| | | | 1100. |
| y₁y₂y₃y₄ 0001 1111 | y₁y₂y₃y₄ 1110 | 484 + 242-tone MRU | y₁y₂y₃y₄ is not equal |
| 1111 | | of 80 MHz PPDU: | to 1111. |
| | | 1110 (484 + 242-tone | |
| | | MRU 4) | |
| y₁y₂y₃y₄ 0100 1111 | y₁y₂y₃y₄ 1011 | 484 + 242-tone MRU | y₁y₂y₃y₄ is not equal |
| 1111 | | of 80 MHz PPDU: | to 1111. |
| | | 1011 (484 + 242-tone | |
| | | MRU 2) | |
| y₁y₂y₃y₄ 0010 1111 | y₁y₂y₃y₄ 1101 | 484 + 242-tone MRU | y₁y₂y₃y₄ is not equal |
| 1111 | | of 80 MHz PPDU: | to 1111. |
| | | 1101 (484 + 242-tone | |
| | | MRU 3) | |
| y₁y₂y₃y₄ 1000 1111 | y₁y₂y₃y₄ 0111 | 484 + 242-tone MRU | y₁y₂y₃y₄ is not equal |
| 1111 | | of 80 MHz PPDU: | to 1111. |
| | | 0111 (484 + 242-tone | |
| | | MRU 1) | |
| 0110 0000 1111 1111 | 1001 1111 | 80 MHz PPDU: | None |
| | | 1111 (996-tone RU 1) | |

Note 1:
yᵢ indicates that the value may be 1 or 0.
Note 2:
yᵢ indicates negation of yᵢ; and when yᵢ is 0, yᵢ is 1; or when yᵢ is 1, yᵢ is 0, where i = 1, 2, 3, or 4.
Note 3:
y₁y₂y₃y₄ may not be 0000 (the secondary 80 MHz channel cannot be simultaneously punctured; otherwise, the BSS bandwidth is reduced to 80 MHz).
Note 4:
In this table, the primary 20 MHz channel is located at a non-punctured position in the primary 80 MHz channel.
Note 5:
y₁y₂y₃y₄ may be 1111, 0111, 1011, 1101, 1110, 1100, 0011 or 1001.
Note 6:
The second puncturing pattern (namely, the non-OFDMA puncturing pattern with the maximum size) is preferably used to perform non-OFDMA transmission, or the first puncturing pattern (namely, the OFDMA puncturing pattern with the maximum size) is preferably used to perform OFDMA transmission. Certainly, the non-OFDMA transmission may be alternatively performed by using a supported non-OFDMA puncturing pattern with a smaller size, or the OFDMA transmission may be performed by using a supported OFDMA puncturing pattern with a smaller size. Sizes are sorted according to a quantity of included subcarriers. A larger size indicates a larger quantity of subcarriers, and a smaller size indicates a smaller quantity of subcarriers.

Optionally, in some feasible implementations, for Table 6, when the first BSS bandwidth is 320 MHz and the preferred primary 80 MHz channel is an 80 MHz channel corresponding to a channel 1 to a channel 4 shown in FIG. 15, that is, when the first BSS bandwidth is divided into a primary 80 MHz channel, a secondary 80 MHz channel, and a secondary 160 MHz channel in ascending order of frequencies in sequence, refer to Table 10 below for mapping relationships between the first bitmap and the first puncturing pattern and between the first bitmap and the second puncturing pattern.

TABLE 10
A table of mapping of the 320 MHz bandwidth (primary 80 MHz
channel - secondary 80 MHz channel - secondary 160 MHz channel)

| First bitmap (0 | First puncturing | | Other conditions |
|---|---|---|---|
| indicates that | pattern (0 | | (than the |
| transmission is allowed, | indicates | | conditions in |
| and 1 indicates that | puncturing, and | Second puncturing pattern | Note 3 to Note 5 |
| transmission is not | 1 indicates no | (0 indicates puncturing, and | at the bottom of |
| allowed) | puncturing) | 1 indicates no puncturing) | this table) |
| 0110 y₁y₂y₃y₄ z₁z₂z₃z₄ | 1001 y₁y₂y₃y₄ | 20 MHz PPDU: | y₁y₂y₃y_{4,} z₁z₂z₃z_{4,} |
| k₁k₂k₃k₄ | z₁z₂z₃z₄ k₁k₂k₃k₄ | 1111 (namely, 242-tone RU 1) | and k₁k₂k₃k₄ are |
| | | | all 1001. |
| 0011 y₁y₂y₃y₄ z₁z₂z₃z₄ | 1100 y₁y₂y₃y₄ | 40 MHz PPDU: | Each of y₁y₂y₃y_{4,} |
| k₁k₂k₃k₄ | z₁z₂z₃z₄ k₁k₂k₃k₄ | 1111 (namely, 484-tone RU 1) | z₁z₂z₃z₄ and |
| | | | k₁k₂k₃k₄ does not |
| | | | contain more than |
| | | | two 1 s. |
| 1100 y₁y₂y₃y₄ z₁z₂z₃z₄ | 0011 y₁y₂y₃y₄ | 40 MHz PPDU: | Each of y₁y₂y₃y₄, |
| k₁k₂k₃k₄ | z₁z₂z₃z₄ k₁k₂k₃k₄ | 1111 (namely, 484-tone RU 1) | z₁z₂z₃z₄ and |
| | | | k₁k₂k₃k₄ does not |
| | | | contain more than |
| | | | two 1 s. |
| 0001 y₁y₂y₃y₄ z₁z₂z₃z₄ | 1110 y₁y₂y₃y₄ | 484 + 242-tone MRU of 80 | y₁y₂y₃y₄ is not |
| k₁k₂k₃k₄ | z₁z₂z₃z₄ k₁k₂k₃k₄ | MHz PPDU: | equal to 1111, and |
| | | 1110 (namely, 484 + 242- | each of z₁z₂z₃z₄ |
| | | tone MRU 4) | and k₁k₂k₃k₄ does |
| | | | not contain more |
| | | | than three 1 s. |
| 0100 y₁y₂y₃y₄ z₁z₂z₃z₄ | 1011 y₁y₂y₃y₄ | 484 + 242-tone MRU of 80 | y₁y₂y₃y₄ is not |
| k₁k₂k₃k₄ | z₁z₂z₃z₄ k₁k₂k₃k₄ | MHz PPDU: | equal to 1111, and |
| | | 1011 (namely, 484 + 242- | each of z₁z₂z₃z₄ |
| | | tone MRU 2) | and k₁k₂k₃k₄ does |
| | | | not contain more |
| | | | than three 1 s. |
| 0010 y₁y₂y₃y₄ z₁z₂z₃z₄ | 1101 y₁y₂y₃y₄ | 484 + 242-tone MRU of 80 | y₁y₂y₃y₄ is not |
| k₁k₂k₃k₄ | z₁z₂z₃z₄ k₁k₂k₃k₄ | MHz PPDU: | equal to 1111, and |
| | | 1101 (namely, 484 + 242- | each of z₁z₂z₃z₄ |
| | | tone MRU 3) | and k₁k₂k₃k₄ does |
| | | | not contain more |
| | | | than three 1 s. |
| 1000 y₁y₂y₃y₄ z₁z₂z₃z₄ | 0111 y₁y₂y₃y₄ | 484 + 242-tone MRU of 80 | y₁y₂y₃y₄ is not |
| k₁k₂k₃k₄ | z₁z₂z₃z₄ k₁k₂k₃k₄ | MHz PPDU: | equal to 1111, and |
| | | 0111 (namely, 484 + 242- | each of z₁z₂z₃z₄ |
| | | tone MRU 1) | and k₁k₂k₃k₄ does |
| | | | not contain more |
| | | | than three 1 s. |
| 0000 0110 z₁z₂z₃z₄ | 1111 1001 | 80 MHz PPDU: | k₁k₂k₃k₄ is not |
| k₁k₂k₃k₄ | z₁z₂z₃z₄ k₁k₂k₃k₄ | 1111 (namely, 996-tone RU 1) | equal to 1111. |
| | | | z₁z₂z₃z₄ is not |
| | | | equal to 1111. |
| 0000 0011 z₁z₂z₃z₄ | 1111 1100 | 996 + 484-tone MRU of 160 | z₁z₂z₃z₄ is not |
| k₁k₂k₃k₄ | z₁z₂z₃z₄ k₁k₂k₃k₄ | MHz PPDU: | equal to 1111. |
| | | 1111 1100 (namely, | k₁k₂k₃k₄ is not |
| | | 996 + 484-tone MRU 4) | equal to 1111. |
| 0000 1100 z₁z₂z₃z₄ | 1111 0011 | 996 + 484-tone MRU of 160 | z₁z₂z₃z₄ is not |
| k₁k₂k₃k₄ | z₁z₂z₃z₄ k₁k₂k₃k₄ | MHz PPDU: | equal to 1111. |
| | | 1111 0011 (namely, | k₁k₂k₃k₄ is not |
| | | 996 + 484-tone MRU 3) | equal to 1111. |
| 0000 0011 0000 | 1111 1100 1111 | 2*996 + 484-tone MRU of | k₁k₂k₃k₄ does not |
| k₁k₂k₃k₄ | k₁k₂k₃k₄ | 320 MHz PPDU: | contain more than |
| | | 1111 1100 1111 0000 | two 1 s. |
| | | (namely, 2*996 + 484-tone | |
| | | MRU 4) | |
| 0000 1100 0000 | 1111 0011 1111 | 2*996 + 484-tone MRU of | k₁k₂k₃k₄ does not |
| k₁k₂k₃k₄ | k₁k₂k₃k₄ | 320 MHz PPDU: | contain more than |
| | | 1111 0011 1111 0000 | two 1 s. |
| | | (namely, 2*996 + 484-tone | |
| | | MRU 3) | |
| 0000 0001 z₁z₂z₃z₄ | 1111 1110 | 996 + 484 + 242-tone MRU of | z₁z₂z₃z₄ is not |
| k₁k₂k₃k₄ | z₁z₂z₃z₄ k₁k₂k₃k₄ | 160 MHz PPDU: | equal to 1111. |
| | | 1111 1110 (namely, | |
| | | 996 + 484 + 242-tone MRU 8) | |
| 0000 0010 z₁z₂z₃z₄ | 1111 1101 | 996 + 484 + 242-tone MRU of | z₁z₂z₃z₄ is not |
| k₁k₂k₃k₄ | z₁z₂z₃z₄ k₁k₂k₃k₄ | 160 MHz PPDU: | equal to 1111. |
| | | 1111 1101 (namely, | |
| | | 996 + 484 + 242-tone MRU 7) | |
| 0000 0100 z₁z₂z₃z₄ | 1111 1011 | 996 + 484 + 242-tone MRU of | z₁z₂z₃z₄ is not |
| k₁k₂k₃k₄ | z₁z₂z₃z₄ k₁k₂k₃k₄ | 160 MHz PPDU: | equal to 1111. |
| | | 1111 1011 (namely, | |
| | | 996 + 484 + 242-tone MRU 6) | |
| 0000 1000 z₁z₂z₃z₄ | 1111 0111 | 996 + 484 + 242-tone MRU of | z₁z₂z₃z₄ is not |
| k₁k₂k₃k₄ | z₁z₂z₃z₄ k₁k₂k₃k₄ | 160 MHz PPDU: | equal to 1111. |
| | | 1111 0111 (namely, | |
| | | 996 + 484 + 242-tone MRU 5) | |
| 0000 0001 0000 | 1111 1110 1111 | 2*996 + 484-tone MRU of | k₁k₂k₃k₄ is not |
| k₁k₂k₃k₄ | k₁k₂k₃k₄ | 320 MHz PPDU: | equal to 1111. |
| | | 1111 1100 1111 0000 | |
| | | (namely, 2*996 + 484-tone | |
| | | MRU 4) | |
| 0000 0010 0000 | 1111 1101 1111 | 2*996 + 484-tone MRU of | k₁k₂k₃k₄ is not |
| k₁k₂k₃k₄ | k₁k₂k₃k₄ | 320 MHz PPDU: | equal to 1111. |
| | | 1111 1100 1111 0000 | |
| | | (namely, 2*996 + 484-tone | |
| | | MRU 4) | |
| 0000 0100 0000 | 1111 1011 1111 | 2*996 + 484-tone MRU of | k₁k₂k₃k₄ is not |
| k₁k₂k₃k₄ | k₁k₂k₃k₄ | 320 MHz PPDU: | equal to 1111. |
| | | 1111 0011 1111 0000 | |
| | | (namely, 2*996 + 484-tone | |
| | | MRU 3) | |
| 0000 1000 0000 | 1111 0111 1111 | 2*996 + 484-tone MRU of | k₁k₂k₃k₄ is not |
| k₁k₂k₃k₄ | k₁k₂k₃k₄ | 320 MHz PPDU: | equal to 1111. |
| | | 1111 0011 1111 0000 | |
| | | (namely, 2*996 + 484-tone | |
| | | MRU 3) | |
| 0000 0000 0110 | 1111 1111 1001 | 160 MHz PPDU: | k₁k₂k₃k₄ is not |
| k₁k₂k₃k₄ | k₁k₂k₃k₄ | 11111111 (namely, 2*996- | equal to 1111. |
| | | tone RU 1) | |
| 0000 0000 0011 | 1111 1111 1100 | 2*996 + 484-tone MRU of | k₁k₂k₃k₄ is not |
| k₁k₂k₃k₄ | k₁k₂k₃k₄ | 320 MHz PPDU: | equal to 1111. |
| | | 1111 1111 1100 0000 | |
| | | (namely, 2*996 + 484-tone | |
| | | MRU 6) | |
| 0000 0000 1100 | 1111 1111 0011 | 2*996 + 484-tone MRU of | k₁k₂k₃k₄ is not |
| k₁k₂k₃k₄ | k₁k₂k₃k₄ | 320 MHz PPDU: | equal to 1111. |
| | | 1111 1111 0011 0000 | |
| | | (namely, 2*996 + 484-tone | |
| | | MRU 5) | |
| 0000 0000 0001 | 1111 1111 1110 | 2*996 + 484-tone MRU of | k₁k₂k₃k₄ is not |
| k₁k₂k₃k₄ | k₁k₂k₃k₄ | 320 MHz PPDU: | equal to 1111. |
| | | 1111 1111 1100 0000 | |
| | | (namely, 2*996 + 484-tone | |
| | | MRU 6) | |
| 0000 0000 0010 | 1111 1111 1101 | 2*996 + 484-tone MRU of | k₁k₂k₃k₄ is not |
| k₁k₂k₃k₄ | k₁k₂k₃k₄ | 320 MHz PPDU: | equal to 1111. |
| | | 1111 1111 1100 0000 | |
| | | (namely, 2*996 + 484-tone | |
| | | MRU 6) | |
| 0000 0000 0100 | 1111 1111 1011 | 2*996 + 484-tone MRU of | k₁k₂k₃k₄ is not |
| k₁k₂k₃k₄ | k₁k₂k₃k₄ | 320 MHz PPDU: | equal to 1111. |
| | | 1111 1111 0011 0000 | |
| | | (namely, 2*996 + 484-tone | |
| | | MRU 5) | |
| 0000 0000 1000 | 1111 1111 0111 | 2*996 + 484-tone MRU of | k₁k₂k₃k₄ is not |
| k₁k₂k₃k₄ | k₁k₂k₃k₄ | 320 MHz PPDU: | equal to 1111. |
| | | 1111 1111 0011 0000 | |
| | | (namely, 2*996 + 484-tone | |
| | | MRU 5) | |
| 0000 0000 0001 0000 | 1111 1111 1110 | 3*996 + 484-tone MRU of | None |
| | 1111 | 320 MHz PPDU: | |
| | | 1111 1111 1100 1111 | |
| | | (namely, 3*996 + 484-tone | |
| | | MRU 6) | |
| 0000 0000 0010 0000 | 1111 1111 1101 | 3*996 + 484-tone MRU of | None |
| | 1111 | 320 MHz PPDU: | |
| | | 1111 1111 1100 1111 | |
| | | (namely, 3*996 + 484-tone | |
| | | MRU 6) | |
| 0000 0000 0100 0000 | 1111 1111 1011 | 3*996 + 484-tone MRU of | None |
| | 1111 | 320 MHz PPDU: | |
| | | 1111 1111 0011 1111 | |
| | | (namely, 3*996 + 484-tone | |
| | | MRU 5) | |
| 0000 0000 1000 0000 | 1111 1111 0111 | 3*996 + 484-tone MRU of | None |
| | 1111 | 320 MHz PPDU: | |
| | | 1111 1111 0011 1111 | |
| | | (namely, 3*996 + 484-tone | |
| | | MRU 5) | |
| 0000 0000 0000 0110 | 1111 1111 1111 | 3*996-tone MRU of 320 | None |
| | 1001 | MHz PPDU: | |
| | | 1111 1111 1111 0000 | |
| | | (namely, 3*996-tone MRU 4) | |
| 0000 0000 0000 0001 | 1111 1111 1111 | 3*996 + 484-tone MRU of | None |
| | 1110 | 320 MHz PPDU: | |
| | | 1111 1111 1111 1100 | |
| | | (namely, 3*996 + 484-tone | |
| | | MRU 8) | |
| 0000 0000 0000 0010 | 1111 1111 1111 | 3*996 + 484-tone MRU of | None |
| | 1101 | 320 MHz PPDU: | |
| | | 1111 1111 1111 1100 | |
| | | (namely, 3*996 + 484-tone | |
| | | MRU 8) | |
| 0000 0000 0000 0100 | 1111 1111 1111 | 3*996 + 484-tone MRU of | None |
| | 1011 | 320 MHz PPDU: | |
| | | 1111 1111 1111 0011 | |
| | | (namely, 3*996 + 484-tone | |
| | | MRU 7) | |
| 0000 0000 0000 1000 | 1111 1111 1111 | 3*996 + 484-tone MRU of | None |
| | 0111 | 320 MHz PPDU: | |
| | | 1111 1111 1111 0011 | |
| | | (namely, 3*996 + 484-tone | |
| | | MRU 7) | |

Note 1:
yᵢ, zᵢ, and kᵢ each indicate that the value may be 1 or 0.
Note 2:
yᵢ indicates negation of yᵢ; when yᵢ is 0, yᵢ is 1, or when yᵢ is 1, yᵢ is 0; and zᵢ indicates negation of zᵢ, and kᵢ indicates negation of kᵢ, where i = 1, 2, 3, or 4.
Note 3:
z₁z₂z₃z₄ k₁k₂k₃k₄ may not be 0000 0000 (Otherwise, the BSS bandwidth is reduced to 160 MHz).
Note 4:
In this table, the primary 20 MHz channel is located at a non-punctured position in the primary 80 MHz channel.
Note 5:
y₁y₂y₃y₄, z₁z₂z₃z_{4,} and k₁k₂k₃k₄ each may be 1111, 0111, 1011, 1101, 1110, 1100, 0011, 1001 or 0000.
Note 6:
The second puncturing pattern (namely, the non-OFDMA puncturing pattern with the maximum size) is preferably used to perform non-OFDMA transmission, or the first puncturing pattern (namely, the OFDMA puncturing pattern with the maximum size) is preferably used to perform OFDMA transmission. Certainly, the non-OFDMA transmission may be alternatively performed by using a supported non-OFDMA puncturing pattern with a smaller size, or the OFDMA transmission may be performed by using a supported OFDMA puncturing pattern with a smaller size. Sizes are sorted according to a quantity of included subcarriers. A larger size indicates a larger quantity of subcarriers, and a smaller size indicates a smaller quantity of subcarriers.

Optionally, in some feasible implementations, when the first BSS bandwidth is 320 MHz and the preferred primary 80 MHz channel is an 80 MHz channel corresponding to a channel 9 to a channel 12 in the 320 MHz bandwidth shown in FIG. 16, that is, when the first BSS bandwidth is divided into a secondary 160 MHz channel, a secondary 80 MHz channel, and a primary 80 MHz channel in ascending order of frequencies in sequence: For mapping relationships between the first bitmap and the first puncturing pattern and between the first bitmap and the second puncturing pattern, the four bits corresponding to the primary 80 MHz channel, the four bits corresponding to the secondary 80 MHz channel, and the eight bits corresponding to the secondary 160 MHz channel in Table 10 need to be adjusted according to a sequence of the secondary 160 MHz channel, the secondary 80 MHz channel, and the primary 80 MHz channel respectively, to obtain the mapping relationships when the first BSS bandwidth is 320 MHz and the first BSS bandwidth is divided into the secondary 160 MHz channel, the secondary 80 MHz channel, and the primary 80 MHz channel in ascending order of frequencies in sequence. It can be understood that, after the four bits corresponding to the corresponding primary 80 MHz channel, the four bits corresponding to the corresponding secondary 80 MHz channel, and the eight bits corresponding to the corresponding secondary 160 MHz channel are swapped according to the different division of the first BSS bandwidth, an index value of a resource unit corresponding to the second puncturing pattern also needs to be adaptively adjusted. This is specifically determined based on an actual scenario, and is not limited herein.

Optionally, in some feasible implementations, for Table 7, when the first BSS bandwidth is 320 MHz, and the preferred primary 80 MHz channel is an 80 MHz channel corresponding to a channel 5 to a channel 8 in the 320 MHz bandwidth shown in FIG. 17, that is, when the first BSS bandwidth is divided into a secondary 80 MHz channel, a primary 80 MHz channel, and a secondary 160 MHz channel in ascending order of frequencies in sequence, refer to Table 11 below for mapping relationships between the first bitmap and the first puncturing pattern and between the first bitmap and the second puncturing pattern.

TABLE 11
A table of mapping of the 320 MHz bandwidth (secondary 80 MHZ
channel - primary 80 MHz channel - secondary 160 MHz channel)

| First bitmap (0 | | | |
|---|---|---|---|
| indicates that | First puncturing | Second puncturing | Other conditions |
| transmission is allowed, | pattern (0 indicates | pattern (0 indicates | (than the conditions |
| and 1 indicates that | puncturing, and 1 | puncturing, and 1 | in Note 3 to Note 5 |
| transmission is not | indicates no | indicates no | at the bottom of this |
| allowed) | puncturing) | puncturing) | table) |
| y₁y₂y₃y₄ 0110 z₁z₂z₃z₄ | y₁y₂y₃y₄ 1001 | 20 MHz PPDU: | y₁y₂y₃y₄, z₁z₂z₃z_{4,} |
| k₁k₂k₃k₄ | z₁z₂z₃z₄ k₁k₂k₃k₄ | 1111 (namely, 242- | and k₁k₂k₃k₄ are all |
| | | tone RU 1) | 1001. |
| y₁y₂y₃y₄ 0011 z₁z₂z₃z₄ | y₁y₂y₃y₄ 1100 | 40 MHz PPDU: | Each of y₁y₂y₃y₄, |
| k₁k₂k₃k₄ | z₁z₂z₃z₄ k₁k₂k₃k₄ | 1111 (namely, 484- | z₁z₂z₃z₄ and |
| | | tone RU 1) | k₁k₂k₃k₄ does not |
| | | | contain more than |
| | | | two 1 s. |
| y₁y₂y₃y₄ 1100 z₁z₂z₃z₄ | y₁y₂y₃y₄ 0011 | 40 MHz PPDU: | Each of y₁y₂y₃y₄, |
| k₁k₂k₃k₄ | z₁z₂z₃z₄ k₁k₂k₃k₄ | 1111 (namely, 484- | z₁z₂z₃z₄ and |
| | | tone RU 1) | k₁k₂k₃k₄ does not |
| | | | contain more than |
| | | | two 1 s. |
| y₁y₂y₃y₄ 0001 z₁z₂z₃z₄ | y₁y₂y₃y₄ 1110 | 484 + 242-tone MRU of | Each of z₁z₂z₃z₄ |
| k₁k₂k₃k₄ | z₁z₂z₃z₄ k₁k₂k₃k₄ | 80 MHz PPDU: | and k₁k₂k₃k₄ does |
| | | 1110 (namely, | not contain more |
| | | 484 + 242-tone MRU 4) | than three 1 s. |
| y₁y₂y₃y₄ 0100 z₁z₂z₃z₄ | y₁y₂y₃y₄ 1011 | 484 + 242-tone MRU of | y₁y₂y₃y₄ is not |
| k₁k₂k₃k₄ | z₁z₂z₃z₄ k₁k₂k₃k₄ | 80 MHz PPDU: | equal to 1111, and |
| | | 1011 (namely, | each of z₁z₂z₃z₄ and |
| | | 484 + 242-tone MRU 2) | k₁k₂k₃k₄ does not |
| | | | contain more than |
| | | | three 1 s. |
| y₁y₂y₃y₄ 0010 z₁z₂z₃z₄ | y₁y₂y₃y₄ 1101 | 484 + 242-tone MRU of | y₁y₂y₃y₄ is not |
| k₁k₂k₃k₄ | z₁z₂z₃z₄ k₁k₂k₃k₄ | 80 MHz PPDU: | equal to 1111, and |
| | | 1101 (namely, | each of z₁z₂z₃z₄ and |
| | | 484 + 242-tone MRU 3) | k₁k₂k₃k₄ does not |
| | | | contain more than |
| | | | three 1 s. |
| y₁y₂y₃y₄ 1000 z₁z₂z₃z₄ | y₁y₂y₃y₄ 0111 | 484 + 242-tone MRU of | y₁y₂y₃y₄ is not |
| k₁k₂k₃k₄ | z₁z₂z₃z₄ k₁k₂k₃k₄ | 80 MHz PPDU: | equal to 1111, and |
| | | 0111 (namely, | each of z₁z₂z₃z₄ and |
| | | 484 + 242-tone MRU 1) | k₁k₂k₃k₄ does not |
| | | | contain more than |
| | | | three 1 s. |
| 0110 0000 0110 | 1001 1111 1001 | 80 MHz PPDU: | z₁z₂z₃z₄ is not equal |
| k₁k₂k₃k₄ | k₁k₂k₃k₄ | 1111 (namely, 996- | to 1111. |
| or 0110 0000 0110 | or 1001 1111 1001 | tone RU 1) | k₁k₂k₃k₄ is not |
| 0000 | 1111 | | equal to 1111. |
| or 0110 0000 1100 | or 1001 1111 0011 | | |
| k₁k₂k₃k₄ | k₁k₂k₃k₄ | | |
| or 0110 0000 0011 | or 1001 1111 1100 | | |
| k₁k₂k₃k₄ | k₁k₂k₃k₄ | | |
| or 0110 0000 1000 | or 1001 1111 0111 | | |
| k₁k₂k₃k₄ | k₁k₂k₃k₄ | | |
| or 0110 0000 0100 | or 1001 1111 1011 | | |
| k₁k₂k₃k₄ | k₁k₂k₃k₄ | | |
| or 0110 0000 0010 | or 1001 1111 1101 | | |
| k₁k₂k₃k₄ | k₁k₂k₃k₄ | | |
| or 0110 0000 0001 | or 1001 1111 1110 | | |
| k₁k₂k₃k₄ | k₁k₂k₃k₄ | | |
| or 0110 0000 z₁z₂z₃z₄ | or 1001 1111 | | |
| 0110 | z₁z₂z₃z₄ 1001 | | |
| or 0110 0000 z₁z₂z₃z₄ | or 1001 1111 | | |
| 1100 | z₁z₂z₃z₄ 0011 | | |
| or 0110 0000 z₁z₂z₃z₄ | or 1001 1111 | | |
| 0011 | z₁z₂z₃z₄ 1100 | | |
| or 0110 0000 z₁z₂z₃z₄ | or 1001 1111 | | |
| 1000 | z₁z₂z₃z₄ 0111 | | |
| or 0110 0000 z₁z₂z₃z₄ | or 1001 1111 | | |
| 0100 | z₁z₂z₃z₄ 1011 | | |
| or 0110 0000 z₁z₂z₃z₄ | or 1001 1111 | | |
| 0010 | z₁z₂z₃z₄ 1101 | | |
| or 0110 0000 z₁z₂z₃z₄ | or 1001 1111 | | |
| 0001 | z₁z₂z₃z₄ 1110 | | |
| 0011 0000 0110 | 1100 1111 1001 | 996 + 484-tone MRU of | z₁z₂z₃z₄ is not equal |
| k₁k₂k₃k₄ | k₁k₂k₃k₄ | 160 MHz PPDU: | to 1111. |
| or 0011 0000 0110 | or 1100 1111 1001 | 1100 1111 (namely, | k₁k₂k₃k₄ is not |
| 0000 | 1111 | 996 + 484-tone MRU 2) | equal to 1111. |
| or 0011 0000 1100 | or 1100 1111 0011 | | |
| k₁k₂k₃k₄ | k₁k₂k₃k₄ | | |
| or 0011 0000 0011 | or 1100 1111 1100 | | |
| k₁k₂k₃k₄ | k₁k₂k₃k₄ | | |
| or 0011 0000 1000 | or 1100 1111 0111 | | |
| k₁k₂k₃k₄ | k₁k₂k₃k₄ | | |
| or 0011 0000 0100 | or 1100 1111 1011 | | |
| k₁k₂k₃k₄ | k₁k₂k₃k₄ | | |
| or 0011 0000 0010 | or 1100 1111 1101 | | |
| k₁k₂k₃k₄ | k₁k₂k₃k₄ | | |
| or 0011 0000 0001 | or 1100 1111 1110 | | |
| k₁k₂k₃k₄ | k₁k₂k₃k₄ | | |
| or 0011 0000 z₁z₂z₃z₄ | or 1100 1111 | | |
| 0110 | z₁z₂z₃z₄ 1001 | | |
| or 0011 0000 z₁z₂z₃z₄ | or 1100 1111 | | |
| 1100 | z₁z₂z₃z₄ 0011 | | |
| or 0011 0000 z₁z₂z₃z₄ | or 1100 1111 | | |
| 0011 | z₁z₂z₃z₄ 1100 | | |
| or 0011 0000 z₁z₂z₃z₄ | or 1100 1111 | | |
| 1000 | z₁z₂z₃z₄ 0111 | | |
| or 0011 0000 z₁z₂z₃z₄ | or 1100 1111 | | |
| 0100 | z₁z₂z₃z₄ 1011 | | |
| or 0011 0000 z₁z₂z₃z₄ | or 1100 1111 | | |
| 0010 | z₁z₂z₃z₄ 1101 | | |
| or 0011 0000 z₁z₂z₃z₄ | or 1100 1111 | | |
| 0001 | z₁z₂z₃z₄ 1110 | | |
| 1100 0000 0110 | 0011 1111 1001 | 996 + 484-tone MRU of | z₁z₂z₃z₄ is not equal |
| k₁k₂k₃k₄ | k₁k₂k₃k₄ | 160 MHz PPDU: | to 1111. |
| or 1100 0000 0110 | or 0011 1111 1001 | 0011 1111 (namely, | k₁k₂k₃k₄ is not |
| 0000 | 1111 | 996 + 484-tone MRU 1) | equal to 1111. |
| or 1100 0000 1100 | or 0011 1111 0011 | | |
| k₁k₂k₃k₄ | k₁k₂k₃k₄ | | |
| or 1100 0000 0011 | or 0011 1111 1100 | | |
| k₁k₂k₃k₄ | k₁k₂k₃k₄ | | |
| or 1100 0000 1000 | or 0011 1111 0111 | | |
| k₁k₂k₃k₄ | k₁k₂k₃k₄ | | |
| or 1100 0000 0100 | or 0011 1111 1011 | | |
| k₁k₂k₃k₄ | k₁k₂k₃k₄ | | |
| or 1100 0000 0010 | or 0011 1111 1101 | | |
| k₁k₂k₃k₄ | k₁k₂k₃k₄ | | |
| or 1100 0000 0001 | or 0011 1111 1110 | | |
| k₁k₂k₃k₄ | k₁k₂k₃k₄ | | |
| or 1100 0000 z₁z₂z₃z₄ | or 0011 1111 | | |
| 0110 | z₁z₂z₃z₄ 1001 | | |
| or 1100 0000 z₁z₂z₃z₄ | or 0011 1111 | | |
| 1100 | z₁z₂z₃z₄ 0011 | | |
| or 1100 0000 z₁z₂z₃z₄ | or 0011 1111 | | |
| 0011 | z₁z₂z₃z₄ 1100 | | |
| or 1100 0000 z₁z₂z₃z₄ | or 0011 1111 | | |
| 1000 | z₁z₂z₃z₄ 0111 | | |
| or 1100 0000 z₁z₂z₃z₄ | or 0011 1111 | | |
| 0100 | z₁z₂z₃z₄ 1011 | | |
| or 1100 0000 z₁z₂z₃z₄ | or 0011 1111 | | |
| 0010 | z₁z₂z₃z₄ 1101 | | |
| or 1100 0000 z₁z₂z₃z₄ | or 0011 1111 | | |
| 0001 | z₁z₂z₃z₄ 1110 | | |
| 0011 0000 1100 0000 | 1100 1111 0011 | 2*996 + 484-tone MRU | |
| or 1100 0000 1100 | 1111 | of 320 MHz PPDU: | |
| 0000 | or 0011 1111 0011 | 0000 1111 0011 1111 | |
| | 1111 | (namely, 2*996 + 484- | |
| | | tone MRU 9) | |
| 0011 0000 0011 0000 | 1100 1111 1100 | 2*996 + 484-tone MRU | |
| or 1100 0000 0011 | 1111 | of 320 MHz PPDU: | |
| 0000 | or 0011 1111 1100 | 0000 1111 1100 1111 | |
| | 1111 | (namely, 2*996 + 484- | |
| | | tone MRU 10) | |
| 0011 0000 0000 | 1100 1111 1111 | 2*996 + 484-tone MRU | k₁k₂k₃k₄ is not |
| k₁k₂k₃k₄ | k₁k₂k₃k₄ | of 320 MHz PPDU: | equal to 1111, and |
| | | 1100 1111 1111 0000 | k₁k₂k₃k₄ does not |
| | | (namely, 2*996 + 484- | contain more than |
| | | tone MRU 2) | two 1 s. |
| 1100 0000 0000 | 0011 1111 1111 | 2*996 + 484-tone MRU | k₁k₂k₃k₄ is not |
| k₁k₂k₃k₄ | k₁k₂k₃k₄ | of 320 MHz PPDU: | equal to 1111, and |
| | | 0011 1111 1111 0000 | k₁k₂k₃k₄ does not |
| | | (namely, 2*996 + 484- | contain more than |
| | | tone MRU 1) | two 1 s. |
| 0011 0000 0000 | 1100 1111 1111 | 2*996 + 484-tone MRU | k₁k₂k₃k₄ is not |
| k₁k₂k₃k₄ | k₁k₂k₃k₄ | of 320 MHz PPDU: | equal to 1111, 1101, |
| or 1100 0000 0000 | or 0011 1111 1111 | 0000 1111 1111 0011 | 1110, 1100, 1001, |
| k₁k₂k₃k₄ | k₁k₂k₃k₄ | (namely, 2*996 + 484- | or 0000, and |
| | | tone MRU 11) | k₁k₂k₃k₄ does not |
| | | | contain more than |
| | | | two 1 s. |
| 0011 0000 0000 | 1100 1111 1111 | 2*996 + 484-tone MRU | k₁k₂k₃k₄ is not |
| k₁k₂k₃k₄ | k₁k₂k₃k₄ | of 320 MHz PPDU: | equal to 1111, 0111, |
| or 1100 0000 0000 | or 0011 1111 1111 | 0000 1111 1111 1100 | 1011, 0011, 1001, |
| k₁k₂k₃k₄ | k₁k₂k₃k₄ | (namely, 2*996 + 484- | or 0000, and |
| | | tone MRU 12) | k₁k₂k₃k₄ does not |
| | | | contain more than |
| | | | two 1 s. |
| 0001 0000 | 1110 1111 Z₁Z₂Z₃Z₄ | 996 + 484 + 242-tone | z₁z₂z₃z₄ is not equal |
| Z₁Z₂Z₃Z₄K₁K₂K₃K₄ | K₁K₂K₃K₄ | MRU of 160 MHz | to 1111. |
| where | where Z₁Z₂Z₃Z₄ | PPDU: | k₁k₂k₃k₄ is not |
| Z₁Z₂Z₃Z₄K₁K₂K₃K₄ is | K₁K₂K₃K₄ is equal | 1110 1111 | equal to 1111. |
| equal to: | to: | (996 + 484 + 242-tone | |
| 0110 k₁k₂k₃k₄ | 1001 k₁k₂k₃k₄ | MRU 4) | |
| or 0110 0000 | or 1001 1111 | | |
| or 1100 k₁k₂k₃k₄ | or 0011 k₁k₂k₃k₄ | | |
| or 0011 k₁k₂k₃k₄ | or 1100 k₁k₂k₃k₄ | | |
| or 1000 k₁k₂k₃k₄ | or 0111 k₁k₂k₃k₄ | | |
| or 0100 k₁k₂k₃k₄ | or 1011 k₁k₂k₃k₄ | | |
| or 0010 k₁k₂k₃k₄ | or 1101 k₁k₂k₃k₄ | | |
| or 0001 k₁k₂k₃k₄ | or 1110 k₁k₂k₃k₄ | | |
| or z₁z₂z₃z₄ 0110 | or z₁z₂z₃z₄ 1001 | | |
| or z₁z₂z₃z₄ 1100 | or z₁z₂z₃z₄ 0011 | | |
| or z₁z₂z₃z₄ 0011 | or z₁z₂z₃z₄ 1100 | | |
| or z₁z₂z₃z₄ 1000 | or z₁z₂z₃z₄ 0111 | | |
| or z₁z₂z₃z₄ 0100 | or z₁z₂z₃z₄ 1011 | | |
| or z₁z₂z₃z₄ 0010 | or z₁z₂z₃z₄ 1101 | | |
| or z₁z₂z₃z₄ 0001 | or z₁z₂z₃z₄ 1110 | | |
| 0010 0000 | 1101 1111 Z₁Z₂Z₃Z₄ | 996 + 484 + 242-tone | z₁z₂z₃z₄ is not equal |
| Z₁Z₂Z₃Z₄K₁K₂K₃K₄ | K₁K₂K₃K₄ | MRU of 160 MHz | to 1111. |
| where | where Z₁Z₂Z₃Z₄ | PPDU: | k₁k₂k₃k₄ is not |
| Z₁Z₂Z₃Z₄K₁K₂K₃K₄ is | K₁K₂K₃K₄ is equal | 1101 1111 (namely, | equal to 1111. |
| equal to: | to: | 996 + 484 + 242-tone | |
| 0110 k₁k₂k₃k₄ | 1001 k₁k₂k₃k₄ | MRU 3) | |
| or 0110 0000 | or 1001 1111 | | |
| or 1100 k₁k₂k₃k₄ | or 0011 k₁k₂k₃k₄ | | |
| or 0011 k₁k₂k₃k₄ | or 1100 k₁k₂k₃k₄ | | |
| or 1000 k₁k₂k₃k₄ | or 0111 k₁k₂k₃k₄ | | |
| or 0100 k₁k₂k₃k₄ | or 1011 k₁k₂k₃k₄ | | |
| or 0010 k₁k₂k₃k₄ | or 1101 k₁k₂k₃k₄ | | |
| or 0001 k₁k₂k₃k₄ | or 1110 k₁k₂k₃k₄ | | |
| or z₁z₂z₃z₄ 0110 | or z₁z₂z₃z₄ 1001 | | |
| or z₁z₂z₃z₄ 1100 | or z₁z₂z₃z₄ 0011 | | |
| or z₁z₂z₃z₄ 0011 | or z₁z₂z₃z₄ 1100 | | |
| or z₁z₂z₃z₄ 1000 | or z₁z₂z₃z₄ 0111 | | |
| or z₁z₂z₃z₄ 0100 | or z₁z₂z₃z₄ 1011 | | |
| or z₁z₂z₃z₄ 0010 | or z₁z₂z₃z₄ 1101 | | |
| or z₁z₂z₃z₄ 0001 | or z₁z₂z₃z₄ 1110 | | |
| 0100 0000 | 1011 1111 Z₁Z₂Z₃Z₄ | 996 + 484 + 242-tone | z₁z₂z₃z₄ is not equal |
| Z₁Z₂Z₃Z₄K₁K₂K₃K₄ | K₁K₂K₃K₄ | MRU of 160 MHz | to 1111. |
| where | where Z₁Z₂Z₃Z₄ | PPDU: | k₁k₂k₃k₄ is not |
| Z₁Z₂Z₃Z₄K₁K₂K₃K₄ is | K₁K₂K₃K₄ is equal | 1011 1111 (namely, | equal to 1111. |
| equal to: | to: | 996 + 484 + 242-tone | |
| 0110 k₁k₂k₃k₄ | 1001 k₁k₂k₃k₄ | MRU 2) | |
| or 0110 0000 | or 1001 1111 | | |
| or 1100 k₁k₂k₃k₄ | or 0011 k₁k₂k₃k₄ | | |
| or 0011 k₁k₂k₃k₄ | or 1100 k₁k₂k₃k₄ | | |
| or 1000 k₁k₂k₃k₄ | or 0111 k₁k₂k₃k₄ | | |
| or 0100 k₁k₂k₃k₄ | or 1011 k₁k₂k₃k₄ | | |
| or 0010 k₁k₂k₃k₄ | or 1101 k₁k₂k₃k₄ | | |
| or 0001 k₁k₂k₃k₄ | or 1110 k₁k₂k₃k₄ | | |
| or z₁z₂z₃z₄ 0110 | or z₁z₂z₃z₄ 1001 | | |
| or z₁z₂z₃z₄ 1100 | or z₁z₂z₃z₄ 0011 | | |
| or z₁z₂z₃z₄ 0011 | or z₁z₂z₃z₄ 1100 | | |
| or z₁z₂z₃z₄ 1000 | or z₁z₂z₃z₄ 0111 | | |
| or z₁z₂z₃z₄ 0100 | or z₁z₂z₃z₄ 1011 | | |
| or z₁z₂z₃z₄ 0010 | or z₁z₂z₃z₄ 1101 | | |
| or z₁z₂z₃z₄ 0001 | or z₁z₂z₃z₄ 1110 | | |
| 1000 0000 | 0111 1111 Z₁Z₂Z₃Z₄ | 996 + 484 + 242-tone | z₁z₂z₃z₄ is not equal |
| Z₁Z₂Z₃Z₄K₁K₂K₃K₄ | K₁K₂K₃K₄ | MRU of 160 MHz | to 1111. |
| where | where Z₁Z₂Z₃Z₄ | PPDU: | k₁k₂k₃k₄ is not |
| Z₁Z₂Z₃Z₄K₁K₂K₃K₄ is | K₁K₂K₃K₄ is equal | 0111 1111 (namely, | equal to 1111. |
| equal to: | to: | 996 + 484 + 242-tone | |
| 0110 k₁k₂k₃k₄ | 1001 k₁k₂k₃k₄ | MRU 1) | |
| or 0110 0000 | or 1001 1111 | | |
| or 1100 k₁k₂k₃k₄ | or 0011 k₁k₂k₃k₄ | | |
| or 0011 k₁k₂k₃k₄ | or 1100 k₁k₂k₃k₄ | | |
| or 1000 k₁k₂k₃k₄ | or 0111 k₁k₂k₃k₄ | | |
| or 0100 k₁k₂k₃k₄ | or 1011 k₁k₂k₃k₄ | | |
| or 0010 k₁k₂k₃k₄ | or 1101 k₁k₂k₃k₄ | | |
| or 0001 k₁k₂k₃k₄ | or 1110 k₁k₂k₃k₄ | | |
| or z₁z₂z₃z₄ 0110 | or z₁z₂z₃z₄ 1001 | | |
| or z₁z₂z₃z₄ 1100 | or z₁z₂z₃z₄ 0011 | | |
| or z₁z₂z₃z₄ 0011 | or z₁z₂z₃z₄ 1100 | | |
| or z₁z₂z₃z₄ 1000 | or z₁z₂z₃z₄ 0111 | | |
| or z₁z₂z₃z₄ 0100 | or z₁z₂z₃z₄ 1011 | | |
| or z₁z₂z₃z₄ 0010 | or z₁z₂z₃z₄ 1101 | | |
| or z₁z₂z₃z₄ 0001 | or z₁z₂z₃z₄ 1110 | | |
| 0001 0000 | 1110 1111 Z₁Z₂Z₃Z₄ | 2*996 + 484-tone MRU | |
| Z₁Z₂Z₃Z₄K₁K₂K₃K₄ | K₁K₂K₃K₄ | of 320 MHz PPDU: | |
| or 0010 0000 | 1101 1111 Z₁Z₂Z₃Z₄ | 0000 1111 0011 1111 | |
| Z₁Z₂Z₃Z₄K₁K₂K₃K₄ | K₁K₂K₃K₄ | (namely, 2*996 + 484- | |
| or 0100 0000 | 1011 1111 Z₁Z₂Z₃Z₄ | tone MRU 9) | |
| Z₁Z₂Z₃Z₄K₁K₂K₃K₄ | K₁K₂K₃K₄ | | |
| or 1000 0000 | 0111 1111 Z₁Z₂Z₃Z₄ | | |
| Z₁Z₂Z₃Z₄K₁K₂K₃K₄ | K₁K₂K₃K₄ | | |
| where | where Z₁Z₂Z₃Z₄ | | |
| Z₁Z₂Z₃Z₄K₁K₂K₃K₄ is | K₁K₂K₃K₄ is equal | | |
| equal to: | to: | | |
| 1100 0000 | 0011 1111 | | |
| or 1000 0000 | or 0111 1111 | | |
| or 0100 0000 | or 1011 1111 | | |
| or 0000 k₁k₂k₃k₄ | or 1111 k₁k₂k₃k₄ | | |
| 0001 0000 | 1110 1111 Z₁Z₂Z₃Z₄ | 2*996 + 484-tone MRU | |
| Z₁Z₂Z₃Z₄K₁K₂K₃K₄ | K₁K₂K₃K₄ | of 320 MHz PPDU: | |
| or 0010 0000 | 1101 1111 Z₁Z₂Z₃Z₄ | 0000 1111 1100 1111 | |
| Z₁Z₂Z₃Z₄K₁K₂K₃K₄ | K₁K₂K₃K₄ | (namely, 2*996 + 484- | |
| or 0100 0000 | 1011 1111 Z₁Z₂Z₃Z₄ | tone MRU 10) | |
| Z₁Z₂Z₃Z₄K₁K₂K₃K₄ | K₁K₂K₃K₄ | | |
| or 1000 0000 | 0111 1111 Z₁Z₂Z₃Z₄ | | |
| Z₁Z₂Z₃Z₄K₁K₂K₃K₄ | K₁K₂K₃K₄ | | |
| where | where Z₁Z₂Z₃Z₄ | | |
| Z₁Z₂Z₃Z₄K₁K₂K₃K₄ is | K₁K₂K₃K₄ is equal | | |
| equal to: | to: | | |
| 0011 0000 | 1100 1111 | | |
| or 0010 0000 | or 1101 1111 | | |
| or 0001 0000 | or 1110 1111 | | |
| 0001 0000 | | 2*996 + 484-tone MRU | k₁k₂k₃k₄ is not |
| Z₁Z₂Z₃Z₄K₁K₂K₃K₄ | | of 320 MHz PPDU: | equal to 1111. |
| where | | 1100 1111 1111 0000 | |
| Z₁Z₂Z₃Z₄K₁K₂K₃K₄ is | | (namely, 2*996 + 484- | |
| equal to: | | tone MRU 2) | |
| 0000 k₁k₂k₃k₄ | | | |
| 0010 0000 | | 2*996 + 484-tone MRU | k₁k₂k₃k₄ is not |
| Z₁Z₂Z₃Z₄K₁K₂K₃K₄ | | of 320 MHz PPDU: | equal to 1111. |
| where | | 1100 1111 1111 0000 | |
| Z₁Z₂Z₃Z₄K₁K₂K₃K₄ is | | (namely, 2*996 + 484- | |
| equal to: | | tone MRU 2) | |
| 0000 k₁k₂k₃k₄ | | | |
| 0100 0000 | | 2*996 + 484-tone MRU | k₁k₂k₃k₄ is not |
| Z₁Z₂Z₃Z₄K₁K₂K₃K₄ | | of 320 MHz PPDU: | equal to 1111. |
| where | | 0011 1111 1111 0000 | |
| Z₁Z₂Z₃Z₄K₁K₂K₃K₄ is | | (namely, 2*996 + 484- | |
| equal to: | | tone MRU 1) | |
| 0000 k₁k₂k₃k₄ | | | |
| 1000 0000 | | 2*996 + 484-tone MRU | k₁k₂k₃k₄ is not |
| Z₁Z₂Z₃Z₄K₁K₂K₃K₄ | | of 320 MHz PPDU: | equal to 1111. |
| where | | 0011 1111 1111 0000 | |
| Z₁Z₂Z₃Z₄K₁K₂K₃K₄ is | | (namely, 2*996 + 484- | |
| equal to: | | tone MRU 1) | |
| 0000 k₁k₂k₃k₄ | | | |
| 0000 0000 0110 | 1111 1111 1001 | 160 MHz PPDU: | k₁k₂k₃k₄ is not |
| k₁k₂k₃k₄ | k₁k₂k₃k₄ | 1111 1111 (namely, | equal to 1111. |
| | | 2*996-tone RU 1) | |
| 0000 0000 0011 | 1111 1111 1100 | 2*996 + 484-tone MRU | k₁k₂k₃k₄ is not |
| k₁k₂k₃k₄ | k₁k₂k₃k₄ | of 320 MHz PPDU: | equal to 1111. |
| | | 1111 1111 1100 0000 | |
| | | (namely, 2*996 + 484- | |
| | | tone MRU 6) | |
| 0000 0000 1100 | 1111 1111 0011 | 2*996 + 484-tone MRU | k₁k₂k₃k₄ is not |
| k₁k₂k₃k₄ | k₁k₂k₃k₄ | of 320 MHz PPDU: | equal to 1111. |
| | | 1111 1111 0011 0000 | |
| | | (namely, 2*996 + 484- | |
| | | tone MRU 5) | |
| 0000 0000 0001 | 1111 1111 1110 | 2*996 + 484-tone MRU | k₁k₂k₃k₄ is not |
| k₁k₂k₃k₄ | k₁k₂k₃k₄ | of 320 MHz PPDU: | equal to 1111. |
| | | 1111 1111 1100 0000 | |
| | | (namely, 2*996 + 484- | |
| | | tone MRU 6) | |
| 0000 0000 0010 | 1111 1111 1101 | 2*996 + 484-tone MRU | k₁k₂k₃k₄ is not |
| k₁k₂k₃k₄ | k₁k₂k₃k₄ | of 320 MHz PPDU: | equal to 1111. |
| | | 1111 1111 1100 0000 | |
| | | (namely, 2*996 + 484- | |
| | | tone MRU 6) | |
| 0000 0000 0100 | 1111 1111 1011 | 2*996 + 484-tone MRU | k₁k₂k₃k₄ is not |
| k₁k₂k₃k₄ | k₁k₂k₃k₄ | of 320 MHz PPDU: | equal to 1111. |
| | | 1111 1111 0011 0000 | |
| | | (namely, 2*996 + 484- | |
| | | tone MRU 5) | |
| 0000 0000 1000 | 1111 1111 0111 | 2*996 + 484-tone MRU | k₁k₂k₃k₄ is not |
| k₁k₂k₃k₄ | k₁k₂k₃k₄ | of 320 MHz PPDU: | equal to 1111. |
| | | 1111 1111 0011 0000 | |
| | | (namely, 2*996 + 484- | |
| | | tone MRU 5) | |
| 0000 0000 0001 0000 | 1111 1111 1110 | 3*996 + 484-tone MRU | |
| | 1111 | of 320 MHz PPDU: | |
| | | 1111 1111 1100 1111 | |
| | | (namely, 3*996 + 484- | |
| | | tone MRU 6) | |
| 0000 0000 0010 0000 | 1111 1111 1101 | 3*996 + 484-tone MRU | |
| | 1111 | of 320 MHz PPDU: | |
| | | 1111 1111 1100 1111 | |
| | | (namely, 3*996 + 484- | |
| | | tone MRU 6) | |
| 0000 0000 0100 0000 | 1111 1111 1011 | 3*996 + 484-tone MRU | |
| | 1111 | of 320 MHz PPDU: | |
| | | 1111 1111 0011 1111 | |
| | | (namely, 3*996 + 484- | |
| | | tone MRU 5) | |
| 0000 0000 1000 0000 | 1111 1111 0111 | 3*996 + 484-tone MRU | |
| | 1111 | of 320 MHz PPDU: | |
| | | 1111 1111 0011 1111 | |
| | | (namely, 3*996 + 484- | |
| | | tone MRU 5) | |
| 0000 0000 0000 0110 | 1111 1111 1111 | 3*996-tone MRU of | |
| | 1001 | 320 MHz PPDU: | |
| | | 1111 1111 1111 0000 | |
| | | (namely, 3*996-tone | |
| | | MRU 4) | |
| 0000 0000 0000 0001 | 1111 1111 1111 | 3*996 + 484-tone MRU | |
| | 1110 | of 320 MHz PPDU: | |
| | | 1111 1111 1111 1100 | |
| | | (namely, 3*996 + 484- | |
| | | tone MRU 8) | |
| 0000 0000 0000 0010 | 1111 1111 1111 | 3*996 + 484-tone MRU | |
| | 1101 | of 320 MHz PPDU: | |
| | | 1111 1111 1111 1100 | |
| | | (namely, 3*996 + 484- | |
| | | tone MRU 8) | |
| 0000 0000 0000 0100 | 1111 1111 1111 | 3*996 + 484-tone MRU | |
| | 1011 | of 320 MHz PPDU: | |
| | | 1111 1111 1111 0011 | |
| | | (namely, 3*996 + 484- | |
| | | tone MRU 7) | |
| 0000 0000 0000 1000 | 1111 1111 1111 | 3*996 + 484-tone MRU | |
| | 0111 | of 320 MHz PPDU: | |
| | | 1111 1111 1111 0011 | |
| | | (namely, 3*996 + 484- | |
| | | tone MRU 7) | |

Note 1:
yᵢ, zᵢ, and kᵢ each indicate that the value may be 1 or 0.
Note 2:
yᵢ indicates negation of yᵢ; when yᵢ is 0, yᵢ is 1, or when yᵢ is 1, yᵢ is 0; and zᵢ indicates negation of zᵢ, and kᵢ indicates negation of kᵢ, where i = 1, 2, 3, or 4.
Note 3:
z₁z₂z₃z₄ and k₁k₂k₃k₄ may not be both 0000 0000 (Otherwise, the BSS bandwidth is reduced to 160 MHZ).
Note 4:
In this table, the primary 20 MHz channel is located at a non-punctured position in the primary 80 MHz channel.
Note 5:
y₁y₂y₃y₄, z₁z₂z₃z_{4,} and k₁k₂k₃k₄ each may be 1111, 0111, 1011, 1101, 1110, 1100, 0011, 1001 or 0000.
Note 6:
The second puncturing pattern (namely, the non-OFDMA puncturing pattern with the maximum size) is preferably used to perform non-OFDMA transmission, or the first puncturing pattern (namely, the OFDMA puncturing pattern with the maximum size) is preferably used to perform OFDMA transmission. Certainly, the non-OFDMA transmission may be alternatively performed by using a supported non-OFDMA puncturing pattern with a smaller size, or the OFDMA transmission may be performed by using a supported OFDMA puncturing pattern with a smaller size. Sizes are sorted according to a quantity of included subcarriers. A larger size indicates a larger quantity of subcarriers, and a smaller size indicates a smaller quantity of subcarriers.

Optionally, in some feasible implementations, when the first BSS bandwidth is 320 MHz and the preferred primary 80 MHz channel is an 80 MHz channel corresponding to a channel 9 to a channel 12 in the 320 MHz bandwidth shown in FIG. 18, that is, when the first BSS bandwidth is divided into a secondary 160 MHz channel, a primary 80 MHz channel, and a secondary 80 MHz channel in ascending order of frequencies in sequence: For mapping relationships between the first bitmap and the first puncturing pattern and between the first bitmap and the second puncturing pattern, the four bits corresponding to the secondary 80 MHz channel, the four bits corresponding to the primary 80 MHz channel, and the eight bits corresponding to the secondary 160 MHz channel in Table 11 need to be adjusted according to a sequence of the secondary 160 MHz channel, the primary 80 MHz channel, and the secondary 80 MHz channel respectively, to obtain the mapping relationships when the first BSS bandwidth is 320 MHz and the first BSS bandwidth is divided into the secondary 160 MHz channel, the primary 80 MHz channel, and the secondary 80 MHz channel in ascending order of frequencies in sequence. It can be understood that, after the four bits corresponding to the corresponding primary 80 MHz channel, the four bits corresponding to the corresponding secondary 80 MHz channel, and the eight bits corresponding to the corresponding secondary 160 MHz channel are swapped according to the different division of the first BSS bandwidth, an index value of a resource unit corresponding to the second puncturing pattern also needs to be adaptively adjusted. This is specifically determined based on an actual scenario, and is not limited herein.

In this embodiment of this application, for downlink transmission, based on more flexible mapping relationships between the first bitmap (namely, a bitmap of sub-channels on which transmission is not allowed) and the first puncturing pattern and between the first bitmap and the second puncturing pattern, the first device may perform non-OFDMA transmission based on a non-OFDMA puncturing pattern (namely, the second puncturing pattern), or perform OFDMA transmission based on an OFDMA puncturing pattern (namely, the first puncturing pattern), thereby reducing implementation complexity of the non-OFDMA transmission and/or the OFDMA transmission. In addition, the mapping relationships between the first bitmap and the first puncturing pattern and between the first bitmap and the second puncturing pattern may be further optimized by selecting the primary 20 MHz channel, thereby improving spectrum utilization. In other words, in this embodiment of this application, a more flexible indication manner of the first bitmap is enabled, so that the first bitmap is no longer limited to indicating only a puncturing pattern supported by the non-OFDMA transmission, but may be further used to indicate a puncturing pattern supported by the OFDMA transmission. In addition, mapping relationships between the first bitmap and puncturing patterns supported by the non-OFDMA transmission are provided, thereby reducing complexity in implementing more flexible non-OFDMA transmission.

For example, in a 160 MHz channel, in ascending order of frequencies, transmission is allowed on 1^{st}, 4^{th}, 5^{th}, and 8^{th} 20 MHz channels, and transmission is not allowed on 2^{nd}, 3^{rd}, 6^{th}, and 7^{th} 20 MHz channels. If a puncturing pattern indicated by a bitmap is not limited (that is, a puncturing pattern is indicated based on the more flexible first bitmap in this application), a bitmap of sub-channels on which transmission is not allowed may be 0110 0110 1111 1111 (that is, a corresponding puncturing pattern allowed for transmission is 1001 1001, where 1 in the puncturing pattern indicates non-puncturing, and 0 indicates puncturing). If an AP uses OFDMA transmission, the AP may perform data transmission by using a channel that has an equivalent bandwidth of 80 MHz (namely, the 1^{st}, 4^{th}, 5^{th}, and 8^{th} 20 MHz channels in ascending order of frequencies in the 160 MHz channel). However, if the puncturing pattern indicated by the bitmap is restricted and needs to be a puncturing pattern supported by the non-OFDMA transmission (that is, according to a conventional technology, a puncturing pattern indicated by a bitmap of sub-channels on which transmission is not allowed needs to be a puncturing pattern supported by the non-OFDMA transmission), there is no corresponding puncturing pattern when the BSS bandwidth is 160 MHz, 80 MHz, or 40 MHz. Therefore, the BSS bandwidth cannot but be reduced to 20 MHz, so that an indication of the bitmap of the sub-channels on which transmission is not allowed becomes 0111 1111 1111 1111, or becomes 1110 1111 1111 1111, or becomes 1111 0111 1111 1111, or becomes 1111 1110 1111 1111, so as to implement non-OFDMA transmission based on the puncturing pattern indicated by the bitmap of the sub-channels on which transmission is not allowed. Herein, an equivalent bandwidth of the puncturing pattern supported by the non-OFDMA transmission is 20 MHz (or described as that an available bandwidth (available bandwidth) is 20 MHz), so that available bandwidths for OFDMA transmission and non-OFDMA transmission are both 20 MHz. It can be learned that, for the OFDMA transmission, compared with the conventional technology, the more flexible first bitmap provided based on this embodiment of this application can improve throughput, thereby improving applicability.

Refer to FIG. 20. FIG. 20 is another schematic flowchart of a communication method according to an embodiment of this application. As shown in FIG. 20, the communication method includes the following steps S2001 to S2002. The method shown in FIG. 20 may be performed by a station (hereinafter described as a second device), or the method shown in FIG. 20 may be performed by a chip in the second device. FIG. 20 is described by using an example in which the method is performed by the second device.

S2001: The second device receives a management frame from a first device.

In some feasible implementations, the first device may send, in a manner such as broadcast, the management frame to all stations included in a BSS in which the first device is located (for ease of description, only one station (namely, the second device) is used as an example below for description in this embodiment of this application). The management frame includes a first bitmap (or described as a bitmap of sub-channels on which transmission is not allowed), and a first puncturing pattern indicated by the first bitmap is a puncturing pattern not supported by non-OFDMA transmission. It can be understood that the first puncturing pattern may be alternatively a puncturing pattern supported by OFDMA transmission. In other words, the first puncturing pattern in this embodiment of this application may be understood as a puncturing pattern not supported by non-OFDMA transmission but supported by OFDMA transmission. Generally, the management frame may be a beacon frame or the like, which is not limited herein. Optionally, the management frame may further include a first bandwidth field, where the first bandwidth field indicates a basic service set BSS bandwidth, and the first bitmap is a bitmap corresponding to the BSS bandwidth. Correspondingly, the second device receives the management frame from the first device, and then may determine channel occupation based on information, such as the first bitmap, in the management frame.

S2002: The second device sends a physical layer protocol data unit PPDU based on a second puncturing pattern corresponding to the first bitmap.

In some feasible implementations, after the second device receives the management frame from the first device and performs parsing to obtain the first bitmap included in the management frame, the second device may send the PPDU based on the second puncturing pattern corresponding to the first bitmap to the first device. The first puncturing pattern indicated by the first bitmap is a puncturing pattern not supported by the non-orthogonal frequency division multiple access non-OFDMA transmission, and the second puncturing pattern corresponding to the first bitmap is a puncturing pattern supported by the non-OFDMA transmission. In other words, the first device may perform non-OFDMA transmission based on the second puncturing pattern. Correspondingly, the first device receives the PPDU from the second device, and decodes the PPDU. The PPDU may be an EHT MU PPDU, a non-HT duplicate PPDU, or the like, which is not limited herein.

Optionally, in some feasible implementations, if the second device needs to perform OFDMA transmission, the second device may alternatively send the PPDU based on the first puncturing pattern. In other words, in this embodiment of this application, the second device may perform non-OFDMA transmission based on the second puncturing pattern, or may perform OFDMA transmission based on the first puncturing pattern. This is specifically determined based on an actual application scenario and is not limited herein.

Optionally, in some feasible implementations, if it is specified that transmission can be further performed on another channel only when the transmission is performed on a primary 20 MHz channel (that is, to comply with a method for channel access based on a primary channel), a primary 20 MHz channel in this embodiment of this application cannot be punctured, that is, non-punctured sub-channels in the first puncturing pattern and the second puncturing pattern need to include the primary 20 MHz channel.

In this embodiment of this application, the first puncturing pattern indicated by the first bitmap may be a combination of any N puncturing patterns in the following nine puncturing patterns: 0000, 1111, 0111, 1011, 1101, 1110, 0011, 1100, and 1001, where 1 indicates that a corresponding 20 MHz sub-channel is not punctured, and 0 indicates that a corresponding 20 MHz sub-channel is punctured. Only a non-punctured 20 MHz sub-channel can be used for transmission of the PPDU, and N=First BSS bandwidth/80 MHz. For example, when the first BSS bandwidth is 160 MHz, the first bitmap may be 1000 0011 1111 1111 and the first puncturing pattern indicated by the first bitmap is 0111 1100.

The second puncturing pattern corresponding to the first bitmap includes any one of puncturing patterns corresponding to the following resource unit indexes: 242-tone RU 1, 484-tone RU 1, 484+242-tone MRU 1, 484+242-tone MRU 2, 484+242-tone MRU 3, 484+242-tone MRU 4, 996-tone RU 1, 996+484+242-tone MRU 1, 996+484+242-tone MRU 2, 996+484+242-tone MRU 3, 996+484+242-tone MRU 4, 996+484+242-tone MRU 5, 996+484+242-tone MRU 6, 996+484+242-tone MRU 7, 996+484+242-tone MRU 8, 996+484-tone MRU 1, 996+484-tone MRU 2, 996+484-tone MRU 3, 996+484-tone MRU 4, 2*996-tone RU 1, 2*996+484-tone MRU 1, 2*996+484-tone MRU 2, 2*996+484-tone MRU 3, 2*996+484-tone MRU 4, 2*996+484-tone MRU 5, 2*996+484-tone MRU 6, 2*996+484-tone MRU 7, 2*996+484-tone MRU 8, 2*996+484-tone MRU 9, 2*996+484-tone MRU 10, 2*996+484-tone MRU 11, 2*996+484-tone MRU 12, 3*996-tone MRU 1, 3*996-tone MRU 2, 3*996-tone MRU 3, 3*996-tone MRU 4, 3*996+484-tone MRU 1, 3*996+484-tone MRU 2, 3*996+484-tone MRU 3, 3*996+484-tone MRU 4, 3*996+484-tone MRU 5, 3*996+484-tone MRU 6, 3*996+484-tone MRU 7, 3*996+484-tone MRU 8, and 4*996-tone RU 1.

For mapping relationships between the first bitmap and the first puncturing pattern and between the first bitmap and the second puncturing pattern, refer to the foregoing Table 3 to Table 7. Details are not described herein again. Optionally, in consideration of impact of selection of the primary 20 MHz channel on the second puncturing pattern, this embodiment of this application further provides mapping relationships between the first bitmap and the first puncturing pattern and between the first bitmap and the second puncturing pattern, as shown in Table 8 to Table 11. Details are not described herein again.

In this embodiment of this application, for uplink transmission, based on more flexible mapping relationships between the first bitmap (namely, a bitmap of sub-channels on which transmission is not allowed) and the first puncturing pattern and between the first bitmap and the second puncturing pattern, the second device may perform non-OFDMA transmission based on a non-OFDMA puncturing pattern (namely, the second puncturing pattern), or perform OFDMA transmission based on an OFDMA puncturing pattern (namely, the first puncturing pattern), thereby reducing implementation complexity of the non-OFDMA transmission and/or the OFDMA transmission. In addition, the mapping relationships between the first bitmap and the first puncturing pattern and between the first bitmap and the second puncturing pattern may be further optimized by selecting the primary 20 MHz channel, thereby improving spectrum utilization.

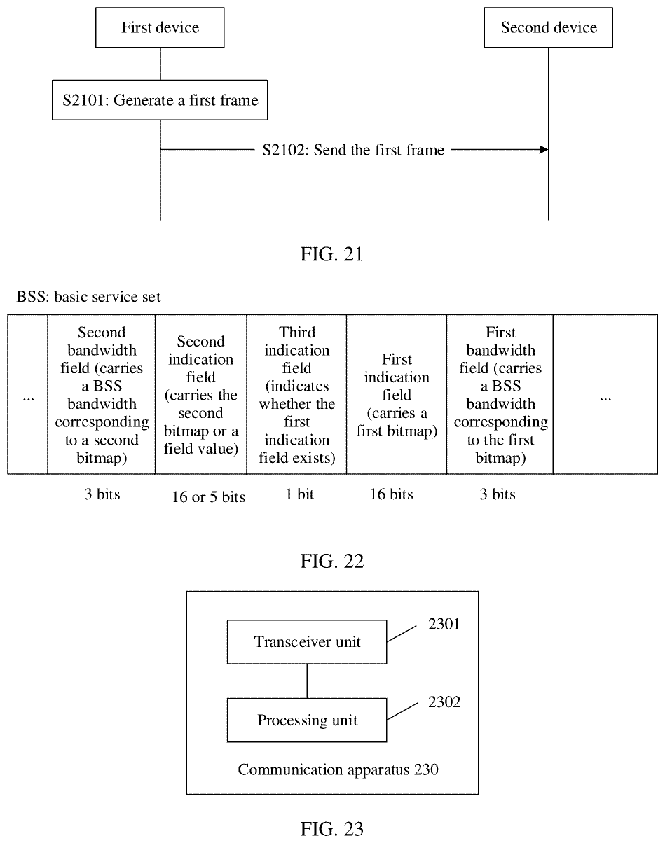

Refer to FIG. 21. FIG. 21 is still another schematic flowchart of a communication method according to an embodiment of this application. As shown in FIG. 21, the communication method includes the following steps S2101 to S2102. The method shown in FIG. 21 may be performed by a station (hereinafter described as a second device), or the method shown in FIG. 21 may be performed by a chip in the second device. FIG. 21 is described by using an example in which the method is performed by the second device.

S2101: A first device generates a first frame.

In some feasible implementations, the first device generates the first frame, where the first frame includes a first indication field, and the first indication field indicates a puncturing pattern supported by orthogonal frequency division multiple access OFDMA transmission. The first frame may be a management frame, and specifically, may be a beacon frame or the like. This is not limited herein. For example, refer to FIG. 22. FIG. 22 is a schematic diagram of a structure of a first frame according to an embodiment of this application. As shown in FIG. 22, a length of the first indication field may be 16 bits, and the first indication field may be used to carry a first bitmap.

Optionally, with reference to FIG. 22, the first frame may further include a second indication field, and the second indication field indicates a puncturing pattern supported by non-orthogonal frequency division multiple access non-OFDMA transmission. A length of the second indication field may be 16 bits. Herein, the second indication field having the length of 16 bits may be used to carry a second bitmap. Alternatively, the length of the second indication field may be 5 bits, and the second indication field having the length of 5 bits may be used to carry a field value (namely, a field value shown in the foregoing Table 2) corresponding to the puncturing pattern supported by the non-OFDMA transmission.

Optionally, the first frame further includes a third indication field, and the third indication field indicates whether the first indication field exists. In this embodiment of this application, a length of the third field may be 1 bit. It may be specified that, when a value of the third field is 1, it indicates that the first indication field exists; or when the value of the third field is 0, it indicates that the first indication field does not exist. Alternatively, it is specified that, when the value of the third field is 1, it indicates that the first indication field exists; or when the value of the third field is 0, it indicates that the first indication field exists, or the like. This is not limited herein.

Optionally, the first frame may further include a first bandwidth field. A length of the first bandwidth field may be 3 bits. The first bandwidth field indicates a first BSS bandwidth corresponding to the first bitmap. Herein, the first BSS bandwidth corresponding to the first bitmap may also be described as an enhanced BSS bandwidth or the like. This is not limited herein.

Optionally, the first frame may further include a second bandwidth field. A length of the second bandwidth field may be 3 bits. The second bandwidth field indicates a second BSS bandwidth corresponding to the second bitmap.

S2102: The first device sends the first frame to the second device.

In some feasible implementations, after generating the first frame, the first device may send the first frame to the second device. For example, the first device may send the first frame to the second device in a manner such as broadcast. Correspondingly, the second device may receive the first frame from the first device, and decode the received first frame, so as to determine channel resource occupation based on information that has been obtained through parsing. Therefore, during uplink transmission, the second device may determine a corresponding puncturing pattern based on the channel resource occupation, so as to perform transmission of a PPDU based on the corresponding puncturing pattern.

During specific implementation, in an implementation, for the second device with a relatively weak capability or the second device that has implemented a basic feature based on 802.11be, the second device of such type may read information in the second indication field only, and then perform OFDMA transmission or non-OFDMA transmission based on the puncturing pattern indicated in the second indication field. In other words, for the second device with a relatively weak capability or the second device that has implemented a basic feature based on 802.11be, the second device may implement OFDMA transmission or non-OFDMA transmission based on the existing 802.11be standard.

Optionally, in an implementation, for the second device with a relatively strong capability or the second device that has implemented a basic feature based on a non-802.11be standard (that is, the second device has implemented an advanced feature), the second device of such type may read both information in the second indication field and information in the first indication field (that is, the second device may read both information in the second indication field and information in the first indication field). Therefore, the second device may determine, based on the second bitmap (or the field value) read from the second indication field, a puncturing pattern indicated by the second bitmap (or the field value); and determine, based on the first bitmap read from the first indication field, a more flexible puncturing pattern indicated by the first bitmap. Then, non-OFDMA transmission is performed based on the puncturing pattern that is determined based on the second indication field, and OFDMA transmission is more flexibly performed based on the puncturing pattern that is determined based on the first indication field. It can be understood that, for the second device with a relatively strong capability, the second device performs, by reading both the information in the second indication field and the information in the first indication field, the non-OFDMA transmission based on the puncturing pattern indicated in the second indication field; and performs the OFDMA transmission based on the puncturing pattern indicated in the first indication field. In this way, throughput can be improved on a basis of not affecting implementation of a device with a relatively weak capability (this is because the device with a relatively weak capability may read only the information in the second indication field) and under a premise of not increasing implementation complexity.

Optionally, in an implementation, for the second device with a relatively strong capability or the second device that has implemented a basic feature based on a non-802.11be standard (that is, the second device has implemented an advanced feature), the second device of such type may read information in the first indication field only; then derive, based on the first bitmap read from the first indication field, a first puncturing pattern indicated by the first bitmap (that is, determine the first puncturing pattern based on the mapping relationships in the foregoing Table 3 to Table 1), and derive a corresponding second puncturing pattern based on the first bitmap (that is, determine the second puncturing pattern based on the mapping relationships in the foregoing Table 3 to Table 1); and further perform OFDMA transmission based on the first puncturing pattern, or perform non-OFDMA transmission based on the second puncturing pattern.

Optionally, the first indication field may be further used to indicate/carry a subsequently new puncturing pattern supported by the non-OFDMA transmission (namely, another puncturing pattern used for the non-OFDMA transmission than the puncturing patterns supported by the non-OFDMA transmission in the foregoing Table 2). The subsequently new puncturing pattern supported by the non-OFDMA transmission may be a combination of some puncturing patterns (for example, 1110 0111) in the puncturing patterns (namely, 0000, 1111, 0111, 1011, 1101, 1110, 0011, 1100 and 1001) currently supported by the OFDMA transmission; or the subsequently new puncturing pattern supported by the non-OFDMA transmission may be a puncturing pattern (namely, a newly-defined puncturing pattern) that has never appeared in the existing 802.11be standard. This is not limited herein. For the second device with a relatively strong capability or the second device that has implemented a basic feature based on a non-802.11be standard (that is, the second device has implemented an advanced feature), if the subsequently new puncturing pattern supported by the non-OFDMA transmission is a combination of some puncturing patterns in the puncturing patterns currently supported by the OFDMA transmission, the second device may directly obtain, by using the information (namely, the first bitmap) in the first indication field, the corresponding new puncturing pattern supported by the non-OFDMA transmission. If the subsequently new puncturing pattern supported by the non-OFDMA transmission is a newly-defined puncturing pattern, the second device may derive, by using the first bitmap indicated in the first indication field, a puncturing pattern corresponding to the first bitmap, and then perform non-OFDMA transmission based on the derived puncturing pattern.

This embodiment of this application provides a static puncturing indication method, which does not affect operations of an existing device and further supports an improved device. Specifically, for the second device with a relatively weak capability, the second device may read information in the second indication field only, to perform non-OFDMA transmission or OFDMA transmission based on the puncturing pattern that is indicated by the second bitmap in the second indication field. For the second device with a relatively strong capability or the second device that has implemented a basic feature based on a non-802.11be standard (that is, the second device has implemented an advanced feature), the second device may read both the first bitmap in the first indication field and the second bitmap (or the field value) in the second indication field, so as to determine, based on the read first bitmap, the puncturing pattern that is supported by OFDMA transmission and indicated by the first bitmap, and determine, based on the read second bitmap (or the field value), the puncturing pattern that is supported by non-OFDMA transmission; and then perform OFDMA transmission or non-OFDMA transmission. Optionally, the second device with a relatively strong capability or the second device that has implemented a basic feature based on a non-802.11be standard (that is, the second device has implemented an advanced feature) may read only the first bitmap in the first indication field, and then derive the first puncturing pattern and/or the second puncturing pattern based on the first bitmap, so as to perform OFDMA transmission or non-OFDMA transmission.

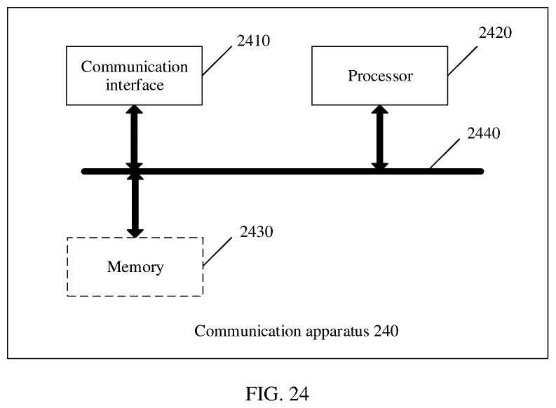

The following describes in detail communication apparatuses provided in this application with reference to FIG. 23 and FIG. 24.

Refer to FIG. 23. FIG. 23 is a schematic diagram of a structure of a communication apparatus according to an embodiment of this application. The communication apparatus 230 shown in FIG. 23 may be configured to perform some or all functions of the first device (for example, the first device may be an access point) in the method embodiments described in FIG. 12 to FIG. 21. The apparatus may be the first device, or an apparatus in the first device, or an apparatus that can be used together with the first device. The communication apparatus may be alternatively a chip system. The communication apparatus shown in FIG. 23 may include a transceiver unit 2301 and a processing unit 2302. The processing unit 2302 is configured to perform data processing. The transceiver unit 2301 integrates a receiving unit and a sending unit. The transceiver unit 2301 may also be referred to as a communication unit. Alternatively, the transceiver unit 2301 may be split into a receiving unit and a sending unit. The processing unit 2302 and the transceiver unit 2301 in subsequent descriptions are similar, and details are not described again in the subsequent descriptions.

In a possible implementation, the transceiver unit 2301 is configured to send a management frame, where the management frame includes a first bitmap, and a first puncturing pattern indicated by the first bitmap is a puncturing pattern not supported by non-orthogonal frequency division multiple access non-OFDMA transmission; and the transceiver unit 2301 is further configured to send a physical layer protocol data unit PPDU based on a second puncturing pattern corresponding to the first bitmap, where the second puncturing pattern is a puncturing pattern supported by the non-OFDMA transmission.

Optionally, in another possible implementation, the transceiver unit 2301 is configured to send a management frame, where the management frame includes a first bitmap, and a first puncturing pattern indicated by the first bitmap is a puncturing pattern not supported by non-orthogonal frequency division multiple access non-OFDMA transmission; and the transceiver unit 2301 is further configured to receive a physical layer protocol data unit PPDU, where transmission of the PPDU is performed by using a second puncturing pattern corresponding to the first bitmap, and the second puncturing pattern is a puncturing pattern supported by the non-OFDMA transmission.

For another possible implementation of the communication apparatus, refer to related descriptions of functions of the first device in the method embodiments corresponding to FIG. 12 to FIG. 21. Details are not described herein again.

Refer to FIG. 23 again. FIG. 23 is a schematic diagram of a structure of a communication apparatus according to an embodiment of this application. The communication apparatus shown in FIG. 23 may be configured to perform some or all functions of the second device (for example, the second device may be a station) in the method embodiments described in FIG. 12 to FIG. 21. The apparatus may be the second device, or an apparatus in the second device, or an apparatus that can be used together with the second device. The communication apparatus may be alternatively a chip system. The communication apparatus shown in FIG. 23 may include a transceiver unit 2301 and a processing unit 2302.

In a possible implementation, the transceiver unit is configured to receive a management frame, where the management frame includes a first bitmap, and a first puncturing pattern indicated by the first bitmap is a puncturing pattern not supported by non-orthogonal frequency division multiple access non-OFDMA transmission; and the transceiver unit is further configured to receive a physical layer protocol data unit PPDU, where transmission of the PPDU is performed by using a second puncturing pattern corresponding to the first bitmap, and the second puncturing pattern is a puncturing pattern supported by the non-OFDMA transmission.

Optionally, in another possible implementation, the transceiver unit 2301 is configured to receive a management frame, where the management frame includes a first bitmap, a first puncturing pattern indicated by the first bitmap is a puncturing pattern not supported by non-orthogonal frequency division multiple access non-OFDMA transmission, and a second puncturing pattern corresponding to the first bitmap is a puncturing pattern supported by the non-OFDMA transmission; and the transceiver unit 2301 is further configured to send a physical layer protocol data unit PPDU based on the second puncturing pattern corresponding to the first bitmap, where the second puncturing pattern is the puncturing pattern supported by the non-OFDMA transmission.

For another possible implementation of the communication apparatus, refer to related descriptions of functions of the second device in the method embodiments corresponding to FIG. 12 to FIG. 21. Details are not described herein again.

Refer to FIG. 24. FIG. 24 is a schematic diagram of a structure of another communication apparatus according to an embodiment of this application. The communication apparatus 240 is configured to implement functions of the first device (for example, the first device may be an access point) in FIG. 12 to FIG. 21. The apparatus may be the first device, or an apparatus used in the first device, where the apparatus used in the first device may be a chip system or a chip in the first device. The chip system may include a chip, or may include a chip and another discrete component.

Alternatively, the communication apparatus 240 is configured to implement functions of the second device (for example, the first device may be a station) in FIG. 12 to FIG. 21. Alternatively, the communication apparatus may be the second device, or an apparatus used in the second device, where the apparatus used in the second device may be a chip system or a chip in the second device.

The communication apparatus 240 includes at least one processor 2420, configured to implement a data processing function of the first device or the second device in the methods provided in embodiments of this application. The apparatus 240 may further include a communication interface 2410, configured to implement receiving and sending operations of the first device or the second device in the methods provided in embodiments of this application. In this embodiment of this application, the communication interface may be a transceiver, a circuit, a bus, a module, or a communication interface of another type, and is configured to communicate with another device by using a transmission medium. For example, the communication interface 2410 is used by an apparatus in the apparatus 240 to communicate with another device. The processor 2420 receives and sends data through the communication interface 2410, and is configured to implement the method in the foregoing method embodiment in FIG. 6.

The apparatus 240 may further include at least one memory 2430, configured to store program instructions and/or data. The memory 2430 is coupled to the processor 2420. In this embodiment of this application, the coupling is an indirect coupling or a communication connection between apparatuses, units, or modules; may be electrical, mechanical, or in another form; and is used for information exchange between the apparatuses, the units, or the modules. The processor 2420 may collaborate with the memory 2430. The processor 2420 may execute the program instructions stored in the memory 2430. At least one of the at least one memory may be included in the processor.

In this embodiment of this application, a specific medium for connection between the communication interface 2410, the processor 2420, and the memory 2430 is not limited. In this embodiment of this application, the memory 2430, the processor 2420, and the communication interface 2410 are connected through a bus 2440, as shown in FIG. 24. The bus is represented by using a thick line in FIG. 24. Another manner of connection between the components is merely an example for description, and imposes no limitation. The bus may be classified into an address bus, a data bus, a control bus, and the like. For ease of expression, the bus is indicated by using only a thick line in FIG. 24, which does not mean that only one bus or only one type of bus exists.

When the apparatus 240 is specifically an apparatus configured used in the first device or the second device, for example, when the apparatus 240 is specifically a chip or a chip system, the communication interface 2410 may output or receive a baseband signal. When the apparatus 240 is specifically the first device or the second device, the communication interface 2410 may output or receive a radio frequency signal. In this embodiment of this application, the processor may be a general-purpose processor, a digital signal processor, an application-specific integrated circuit, a field programmable gate array or another programmable logic device, a discrete gate or a transistor logic device, or a discrete hardware component; and may implement or perform the methods, operations, and logical block diagrams disclosed in embodiments of this application. The general-purpose processor may be a microprocessor, any conventional processor, or the like. The operations in the methods disclosed with reference to embodiments of this application may be directly performed and completed by a hardware processor, or may be performed and completed by a combination of hardware in the processor and a software module.

An embodiment of this application further provides a computer-readable storage medium. The computer-readable storage medium stores instructions. When the instructions are run on a processor, the procedures of the methods in the foregoing method embodiments are implemented.

An embodiment of this application further provides a computer program product. When the computer program product runs on a processor, the procedures of the methods in the foregoing method embodiments are implemented.

This application provides an apparatus. The apparatus is implemented in a product form of a chip, and includes an input/output interface and a processing circuit. The apparatus is a chip in the first device in FIG. 12 to FIG. 21. The input/output interface is configured to input data or a signal (for example, a PPDU) that is received by using an antenna and a radio frequency circuit. The input/output interface is further configured to output data or a signal (for example, a management frame), process the data or signal by using the radio frequency circuit, and send the data or signal by using the antenna. The processing circuit is configured to generate a management frame or the like.

This application provides an apparatus. The apparatus is implemented in a product form of a chip, and includes an input/output interface and a processing circuit. The apparatus is a chip in the second device in FIG. 12 to FIG. 21. The input/output interface is configured to input data or a signal (for example, a management frame) that is received by using an antenna and a radio frequency circuit. The input/output interface is further configured to output data or a signal (for example, a PPDU), process the data or signal by using the radio frequency circuit, and send the data or signal by using the antenna. The processing circuit is configured to generate a PPDU or the like.

It needs to be noted that, for brief description, each of the foregoing method embodiments is represented as a combination of a series of actions. However, a person skilled in the art should understand that this application is not limited to the described order of the actions, because some operations may be performed in other orders or simultaneously according to this application. In addition, a person skilled in the art should also be aware that the embodiments described in this specification are all example embodiments, and the described actions and modules are not necessarily required for this application.

Cross reference may be made to descriptions of the embodiments provided in this application, and the descriptions of the embodiments have different focuses. For a part not described in detail in an embodiment, refer to related descriptions of another embodiment. For ease of description and brevity, for functions of the apparatuses and devices provided in embodiments of this application and operations performed by the apparatuses and devices, refer to related descriptions of the method embodiments in this application. The method embodiments and the apparatus embodiments may also be mutually referenced, combined, or cited.

Finally, it should be noted that the foregoing embodiments are merely intended for describing the technical solutions of this application rather than limiting this application. Although this application is described in detail with reference to the foregoing embodiments, a person of ordinary skill in the art should understand that he or she may still make modifications to the technical solutions described in the foregoing embodiments or make equivalent replacements to some or all technical features thereof, without departing from the scope of the technical solutions of embodiments of this application.

1. A communication method, comprising:
sending, by a first device, a management frame, wherein the management frame comprises a first bitmap, and wherein a first puncturing pattern indicated by the first bitmap is a puncturing pattern that is unsupported by non-orthogonal frequency division multiple access (non-OFDMA) transmission; and
sending, by the first device based on a second puncturing pattern corresponding to the first bitmap, a physical layer protocol data unit (PPDU), wherein the second puncturing pattern is a puncturing pattern supported by the non-OFDMA transmission.

2. The method according to claim 1, wherein the management frame further comprises a first bandwidth field, wherein the first bandwidth field indicates a first basic service set (BSS) bandwidth, and wherein the first bitmap is a bitmap corresponding to the first BSS bandwidth.

3. The method according to claim 1, wherein the first puncturing pattern is a puncturing pattern supported by orthogonal frequency division multiple access (OFDMA) transmission.

4. The method according to claim 1, wherein non-punctured sub-channels in the first puncturing pattern and the second puncturing pattern comprise a primary 20 MHz channel.

5. The method according to claim 1, wherein the second puncturing pattern comprises a puncturing pattern corresponding to a resource unit index that is a 242-tone RU 1, 484-tone RU 1, 484+242-tone MRU 1, 484+242-tone MRU 2, 484+242-tone MRU 3, 484+242-tone MRU 4, 996-tone RU 1, 996+484+242-tone MRU 1, 996+484+242-tone MRU 2, 996+484+242-tone MRU 3, 996+484+242-tone MRU 4, 996+484+242-tone MRU 5, 996+484+242-tone MRU 6, 996+484+242-tone MRU 7, 996+484+242-tone MRU 8, 996+484-tone MRU 1, 996+484-tone MRU 2, 996+484-tone MRU 3, 996+484-tone MRU 4, 2*996-tone RU 1, 2*996+484-tone MRU 1, 2*996+484-tone MRU 2, 2*996+484-tone MRU 3, 2*996+484-tone MRU 4, 2*996+484-tone MRU 5, 2*996+484-tone MRU 6, 2*996+484-tone MRU 7, 2*996+484-tone MRU 8, 2*996+484-tone MRU 9, 2*996+484-tone MRU 10, 2*996+484-tone MRU 11, 2*996+484-tone MRU 12, 3*996-tone MRU 1, 3*996-tone MRU 2, 3*996-tone MRU 3, 3*996-tone MRU 4, 3*996+484-tone MRU 1, 3*996+484-tone MRU 2, 3*996+484-tone MRU 3, 3*996+484-tone MRU 4, 3*996+484-tone MRU 5, 3*996+484-tone MRU 6, 3*996+484-tone MRU 7, 3*996+484-tone MRU 8, or 4*996-tone RU 1.

6. The method according to claim 5, wherein the first BSS bandwidth is 80 MHz; and
wherein the first bitmap is 0110 1111 1111 1111, the first puncturing pattern is 1001 and the second puncturing pattern is a puncturing pattern corresponding to the 242-tone RU 1.

7. The method according to claim 5, wherein if the first BSS bandwidth is 160 MHz, and the first BSS bandwidth is divided into a primary 80 MHz channel and a secondary 80 MHz channel in ascending order of frequencies in sequence; and
wherein at least one of:
the first bitmap is 0110 y₁y₂y₃y₄ 1111 1111, the first puncturing pattern is 1001 y₁y₂y₃y₄ and the second puncturing pattern is a puncturing pattern corresponding to the 242-tone RU 1, wherein yᵢ is negation of yᵢ, i comprises 1, 2, 3, and 4, and y₁y₂y₃y₄ is any one of 1111, 0111, 1011, 1101, 1110, 1100, 0011, or 1001; or
the first bitmap is 0011 y₁y₂y₃y₄ 1111 1111, the first puncturing pattern is 1100 y₁y₂y₃y₄ and the second puncturing pattern is a puncturing pattern corresponding to the 484-tone RU 1, wherein yᵢ is negation of yᵢ, i comprises 1, 2, 3, and 4, and y₁y₂y₃y₄ is any one of 0111, 1011, 1101, 1110, 1100, 0011, or 1001; or
the first bitmap is 1100 y₁y₂y₃y₄ 1111 1111, the first puncturing pattern is 0011 y₁y₂y₃y₄ and the second puncturing pattern is a puncturing pattern corresponding to the 484-tone RU 1, wherein yᵢ is negation of yᵢ, i comprises 1, 2, 3, and 4, and y₁y₂y₃y₄ is any one of 0111, 1011, 1101, 1110, 1100, 0011, or 1001; or
the first bitmap is 0001 y₁y₂y₃y₄ 1111 1111, the first puncturing pattern is 1110 y₁y₂y₃y₄ and the second puncturing pattern is a puncturing pattern corresponding to the 484+242-tone MRU 4, wherein yᵢ is negation of yᵢ, i comprises 1, 2, 3, and 4, and y₁y₂y₃y₄ is any one of 0111, 1011, 1101, 1110, 1100, 0011, or 1001; or
the first bitmap is 0100 y₁y₂y₃y₄ 1111 1111, the first puncturing pattern is 1011 y₁y₂y₃y₄ and the second puncturing pattern is a puncturing pattern corresponding to the 484+242-tone MRU 2, wherein yᵢ is negation of yᵢ, i comprises 1, 2, 3, and 4, and y₁y₂y₃y₄ is any one of 0111, 1011, 1101, 1110, 1100, 0011, or 1001; or
the first bitmap is 0010 y₁y₂y₃y₄ 1111 1111, the first puncturing pattern is 1101 y₁y₂y₃y₄ and the second puncturing pattern is a puncturing pattern corresponding to the 484+242-tone MRU 3, wherein yᵢ is negation of yᵢ, i comprises 1, 2, 3, and 4, and y₁y₂y₃y₄ is any one of 0111, 1011, 1101, 1110, 1100, 0011, or 1001; or
the first bitmap is 1 000 y₁y₂y₃y₄ 1111 1111, the first puncturing pattern is 0111 y₁y₂y₃y₄ and the second puncturing pattern is a puncturing pattern corresponding to the 484+242-tone MRU 1, wherein yᵢ is negation of yᵢ, i comprises 1, 2, 3, and 4, and y₁y₂y₃y₄ is any one of 0111, 1011, 1101, 1110, 1100, 0011, or 1001; or
the first bitmap is 0000 0110 1111 1111, the first puncturing pattern is 1111 1001 and the second puncturing pattern is a puncturing pattern corresponding to the 996-tone RU 1.

8. The method according to claim 5, wherein the first BSS bandwidth is 160 MHz, and the first BSS bandwidth is divided into a secondary 80 MHz channel and a primary 80 MHz channel in ascending order of frequencies in sequence; and
wherein at least one of:
the first bitmap is y₁y₂y₃y₄ 0110 1111 1111, the first puncturing pattern is y₁y₂y₃y₄ 1001 and the second puncturing pattern is a puncturing pattern corresponding to the 242-tone RU 1, wherein yᵢ is negation of yᵢ, i comprises 1, 2, 3, and 4, and y₁y₂y₃y₄ is any one of 1111, 0111, 1011, 1101, 1110, 1100, 0011, or 1001; or
the first bitmap is y₁y₂y₃y₄ 0011 1111 1111, the first puncturing pattern is y₁y₂y₃y₄1100 and the second puncturing pattern is a puncturing pattern corresponding to the 484-tone RU 1, wherein yᵢ is negation of yᵢ, i comprises 1, 2, 3, and 4, and y₁y₂y₃y₄ is any one of 0111, 1011, 1101, 1110, 1100, 0011, or 1001; or
the first bitmap is y₁y₂y₃y₄ 1100 1111 1111, the first puncturing pattern is y₁y₂y₃y₄ 0011 and the second puncturing pattern is a puncturing pattern corresponding to the 484-tone RU 1, wherein yᵢ is negation of yᵢ, i comprises 1, 2, 3, and 4, and y₁y₂y₃y₄ is any one of 0111, 1011, 1101, 1110, 1100, 0011, or 1001; or
the first bitmap is y₁y₂y₃y₄ 0001 1111 1111, the first puncturing pattern is y₁y₂y₃y₄ 1110 and the second puncturing pattern is a puncturing pattern corresponding to the 484+242-tone MRU 4, wherein yᵢ is negation of yᵢ, i comprises 1, 2, 3, and 4, and y₁y₂y₃y₄ is any one of 0111, 1011, 1101, 1110, 1100, 0011, or 1001; or
the first bitmap is y₁y₂y₃y₄ 0100 1111 1111, the first puncturing pattern is y₁y₂y₃y₄ 1011 and the second puncturing pattern is a puncturing pattern corresponding to the 484+242-tone MRU 2, wherein yᵢ is negation of yᵢ, i comprises 1, 2, 3, and 4, and y₁y₂y₃y₄ is any one of 0111, 1011, 1101, 1110, 1100, 0011, or 1001; or
the first bitmap is y₁y₂y₃y₄ 0010 1111 1111, the first puncturing pattern is y₁y₂y₃y₄ 1101 and the second puncturing pattern is a puncturing pattern corresponding to the 484+242-tone MRU 3, wherein yᵢ is negation of yᵢ, i comprises 1, 2, 3, and 4, and y₁y₂y₃y₄ is any one of 0111, 1011, 1101, 1110, 1100, 0011, or 1001; or
the first bitmap is y₁y₂y₃y₄ 1000 1111 1111, the first puncturing pattern is y₁y₂y₃y₄ 0111 and the second puncturing pattern is a puncturing pattern corresponding to the 484+242-tone MRU 1, wherein yᵢ is negation of yᵢ, i comprises 1, 2, 3, and 4, and y₁y₂y₃y₄ is any one of 0111, 1011, 1101, 1110, 1100, 0011, or 1001; or
the first bitmap is 0110 0000 1111 1111, the first puncturing pattern is 1001 1111 and the second puncturing pattern is a puncturing pattern corresponding to the 996-tone RU 1.

9. The method according to claim 5, wherein the first BSS bandwidth is 320 MHz, and the first BSS bandwidth is divided into a primary 80 MHz channel, a secondary 80 MHz channel, and a secondary 160 MHz channel in ascending order of frequencies in sequence; and
wherein at least one of:
the first bitmap is 0110 y₁y₂y₃y₄ z₁z₂z₃z₄ k₁k₂k₃k₄, the first puncturing pattern is 1001 y₁y₂y₃y₄ z₁z₂z₃z₄ k₁k₂k₃k₄ and the second puncturing pattern is a puncturing pattern corresponding to the 242-tone RU 1, wherein yᵢ is negation of yᵢ, zᵢ is negation of zᵢ, kᵢ is negation of kᵢ, i comprises 1, 2, 3, and 4, y₁y₂y₃y₄ is any one of 1111, 0111, 1011, 1101, 1110, 1100, 0011, 1001, or 0000, z₁z₂z₃z₄ is any one of 1111, 0111, 1011, 1101, 1110, 1100, 0011, 1001, or 0000, k₁k₂k₃k₄ is any one of 1111, 0111, 1011, 1101, 1110, 1100, 0011, 1001, or 0000, and z₁z₂z₃z₄ and k₁k₂k₃k₄ are not both 0000; or
the first bitmap is 0011 y₁y₂y₃y₄ z₁z₂z₃z₄ k₁k₂k₃k₄, the first puncturing pattern is 1100 y₁y₂y₃y₄ z₁z₂z₃z₄ k₁k₂k₃k₄ and the second puncturing pattern is a puncturing pattern corresponding to the 484-tone RU 1, wherein yᵢ is negation of yᵢ, zᵢ is negation of zᵢ, kᵢ is negation of kᵢ, i comprises 1, 2, 3, and 4, y₁y₂y₃y₄ is any one of 0111, 1011, 1101, 1110, 1100, 0011, 1001, or 0000, z₁z₂z₃z₄ is any one of 1111, 0111, 1011, 1101, 1110, 1100, 0011, 1001, or 0000, k₁k₂k₃k₄ is any one of 1111, 0111, 1011, 1101, 1110, 1100, 0011, 1001, or 0000, and z₁z₂z₃z₄ and k₁k₂k₃k₄ are not both 0000; or
the first bitmap is 1100 y₁y₂y₃y₄ z₁z₂z₃z₄ k₁k₂k₃k₄, the first puncturing pattern is 0011 y₁y₂y₃y₄ z₁z₂z₃z₄ k₁k₂k₃k₄ and the second puncturing pattern is a puncturing pattern corresponding to the 484-tone RU 1, wherein yᵢ is negation of yᵢ, i comprises 1, 2, 3, and 4, y₁y₂y₃y₄ is any one of 0111, 1011, 1101, 1110, 1100, 0011, 1001, or 0000, z₁z₂z₃z₄ is any one of 1111, 0111, 1011, 1101, 1110, 1100, 0011, 1001, or 0000, k₁k₂k₃k₄ is any one of 1111, 0111, 1011, 1101, 1110, 1100, 0011, 1001, or 0000, and z₁z₂z₃z₄ and k₁k₂k₃k₄ are not both 0000; or
the first bitmap is 0011 0000 z₁z₂z₃z₄ k₁k₂k₃k₄, the first puncturing pattern is 1100 1111 z₁z₂z₃z₄ k₁k₂k₃k₄ and the second puncturing pattern is a puncturing pattern corresponding to the 996+484-tone MRU 2, wherein zᵢ is negation of zᵢ, kᵢ is negation of kᵢ, i comprises 1, 2, 3, and 4, z₁z₂z₃z₄ is any one of 0111, 1011, 1101, 1110, 1100, 0011, 1001, or 0000, k₁k₂k₃k₄ is any one of 1111, 0111, 1011, 1101, 1110, 1100, 0011, 1001, or 0000, and z₁z₂z₃z₄ and k₁k₂k₃k₄ are not both 0000; or
the first bitmap is 1100 0000 z₁z₂z₃z₄ k₁k₂k₃k₄, the first puncturing pattern is 0011 1111 z₁z₂z₃z₄ k₁k₂k₃k₄ and the second puncturing pattern is a puncturing pattern corresponding to the 996+484-tone MRU 1, wherein zᵢ is negation of zᵢ, kᵢ is negation of kᵢ, i comprises 1, 2, 3, and 4, z₁z₂z₃z₄ is any one of 0111, 1011, 1101, 1110, 1100, 0011, 1001, or 0000, k₁k₂k₃k₄ is any one of 1111, 0111, 1011, 1101, 1110, 1100, 0011, 1001, or 0000, and z₁z₂z₃z₄ and k₁k₂k₃k₄ are not both 0000; or
the first bitmap is 0011 0000 0000 k₁k₂k₃k₄, the first puncturing pattern is 1100 1111 1111 k₁k₂k₃k₄ and the second puncturing pattern is a puncturing pattern corresponding to the 2*996+484-tone MRU 2, wherein kᵢ is negation of kᵢ, i comprises 1, 2, 3, and 4, and k₁k₂k₃k₄ is any one of 0111, 1011, 1101, 1110, 1100, 0011, 1001, or 0000; or
the first bitmap is 1100 0000 0000 k₁k₂k₃k₄, the first puncturing pattern is 0011 1111 1111 k₁k₂k₃k₄ and the second puncturing pattern is a puncturing pattern corresponding to the 2*996+484-tone MRU 1, wherein kᵢ is negation of kᵢ, i comprises 1, 2, 3, and 4, and k₁k₂k₃k₄ is any one of 0111, 1011, 1101, 1110, 1100, 0011, 1001, or 0000; or
the first bitmap is 0001 y₁y₂y₃y₄ z₁z₂z₃z₄ k₁k₂k₃k₄, the first puncturing pattern is 1110 y₁y₂y₃y₄ z₁z₂z₃z₄ k₁k₂k₃k₄ and the second puncturing pattern is a puncturing pattern corresponding to the 484+242-tone MRU 4, wherein yᵢ is negation of yᵢ, zᵢ is negation of zᵢ, kᵢ is negation of kᵢ, i comprises 1, 2, 3, and 4, y₁y₂y₃y₄ is any one of 0111, 1011, 1101, 1110, 1100, 0011, 1001, or 0000, z₁z₂z₃z₄ is any one of 1111, 0111, 1011, 1101, 1110, 1100, 0011, 1001, or 0000, k₁k₂k₃k₄ is any one of 1111, 0111, 1011, 1101, 1110, 1100, 0011, 1001, or 0000, and z₁z₂z₃z₄ and k₁k₂k₃k₄ are not both 0000; or
the first bitmap is 0100 y₁y₂y₃y₄ z₁z₂z₃z₄ k₁k₂k₃k₄, the first puncturing pattern is 1011 y₁y₂y₃y₄ z₁z₂z₃z₄ k₁k₂k₃k₄ and the second puncturing pattern is a puncturing pattern corresponding to the 484+242-tone MRU 2, wherein yᵢ is negation of yᵢ, zᵢ is negation of zᵢ, kᵢ is negation of kᵢ, i comprises 1, 2, 3, and 4, y₁y₂y₃y₄ is any one of 0111, 1011, 1101, 1110, 1100, 0011, 1001, or 0000, z₁z₂z₃z₄ is any one of 1111, 0111, 1011, 1101, 1110, 1100, 0011, 1001, or 0000, k₁k₂k₃k₄ is any one of 1111, 0111, 1011, 1101, 1110, 1100, 0011, 1001, or 0000, and z₁z₂z₃z₄ and k₁k₂k₃k₄ are not both 0000; or
the first bitmap is 0010 y₁y₂y₃y₄ z₁z₂z₃z₄ k₁k₂k₃k₄, the first puncturing pattern is 1101 y₁y₂y₃y₄ z₁z₂z₃z₄ k₁k₂k₃k₄ and the second puncturing pattern is a puncturing pattern corresponding to the 484+242-tone MRU 3, wherein yᵢ is negation of yᵢ, zᵢ is negation of zᵢ, kᵢ is negation of kᵢ, i comprises 1, 2, 3, and 4, y₁y₂y₃y₄ is any one of 0111, 1011, 1101, 1110, 1100, 0011, 1001, or 0000, z₁z₂z₃z₄ is any one of 1111, 0111, 1011, 1101, 1110, 1100, 0011, 1001, or 0000, k₁k₂k₃k₄ is any one of 1111, 0111, 1011, 1101, 1110, 1100, 0011, 1001, or 0000, and z₁z₂z₃z₄ and k₁k₂k₃k₄ are not both 0000; or
the first bitmap is 1000 y₁y₂y₃y₄ z₁z₂z₃z₄ k₁k₂k₃k₄, the first puncturing pattern is 0111 y₁y₂y₃y₄ z₁z₂z₃z₄ k₁k₂k₃k₄ and the second puncturing pattern is a puncturing pattern corresponding to the 484+242-tone MRU 1, wherein yᵢ is negation of yᵢ, zᵢ is negation of zᵢ, kᵢ is negation of kᵢ, i comprises 1, 2, 3, and 4, y₁y₂y₃y₄ is any one of 0111, 1011, 1101, 1110, 1100, 0011, 1001, or 0000, z₁z₂z₃z₄ is any one of 1111, 0111, 1011, 1101, 1110, 1100, 0011, 1001, or 0000, k₁k₂k₃k₄ is any one of 1111, 0111, 1011, 1101, 1110, 1100, 0011, 1001, or 0000, and z₁z₂z₃z₄ and k₁k₂k₃k₄ are not both 0000; or
the first bitmap is 0001 0000 z₁z₂z₃z₄ k₁k₂k₃k₄, the first puncturing pattern is 1110 1111 z₁z₂z₃z₄ k₁k₂k₃k₄ and the second puncturing pattern is a puncturing pattern corresponding to the 996+484+242-tone MRU 4, wherein zᵢ is negation of zᵢ, kᵢ is negation of kᵢ, i comprises 1, 2, 3, and 4, z₁z₂z₃z₄ is any one of 0111, 1011, 1101, 1110, 1100, 0011, 1001, or 0000, k₁k₂k₃k₄ is any one of 1111, 0111, 1011, 1101, 1110, 1100, 0011, 1001, or 0000, and z₁z₂z₃z₄ and k₁k₂k₃k₄ are not both 0000; or
the first bitmap is 0100 0000 z₁z₂z₃z₄ k₁k₂k₃k₄, the first puncturing pattern is 101 1111 z₁z₂z₃z₄ k₁k₂k₃k₄ and the second puncturing pattern is a puncturing pattern corresponding to the 996+484+242-tone MRU 2, wherein zᵢ is negation of zᵢ, kᵢ is negation of kᵢ, i comprises 1, 2, 3, and 4, z₁z₂z₃z₄ is any one of 0111, 1011, 1101, 1110, 1100, 0011, 1001, or 0000, k₁k₂k₃k₄ is any one of 1111, 0111, 1011, 1101, 1110, 1100, 0011, 1001, or 0000, and z₁z₂z₃z₄ and k₁k₂k₃k₄ are not both 0000; or
the first bitmap is 0010 0000 z₁z₂z₃z₄ k₁k₂k₃k₄, the first puncturing pattern is 1101 1111 z₁z₂z₃z₄ k₁k₂k₃k₄ and the second puncturing pattern is a puncturing pattern corresponding to the 996+484+242-tone MRU 3, wherein zᵢ is negation of zᵢ, kᵢ is negation of kᵢ, i comprises 1, 2, 3, and 4, z₁z₂z₃z₄ is any one of 0111, 1011, 1101, 1110, 1100, 0011, 1001, or 0000, k₁k₂k₃k₄ is any one of 1111, 0111, 1011, 1101, 1110, 1100, 0011, 1001, or 0000, and z₁z₂z₃z₄ and k₁k₂k₃k₄ are not both 0000; or
the first bitmap is 1000 0000 z₁z₂z₃z₄ k₁k₂k₃k₄, the first puncturing pattern is 0111 1111 z₁z₂z₃z₄ k₁k₂k₃k₄ and the second puncturing pattern is a puncturing pattern corresponding to the 996+484+242-tone MRU 1, wherein zᵢ is negation of zᵢ, kᵢ is negation of kᵢ, i comprises 1, 2, 3, and 4, z₁z₂z₃z₄ is any one of 0111, 1011, 1101, 1110, 1100, 0011, 1001, or 0000, k₁k₂k₃k₄ is any one of 1111, 0111, 1011, 1101, 1110, 1100, 0011, 1001, or 0000, and z₁z₂z₃z₄ and k₁k₂k₃k₄ are not both 0000; or
the first bitmap is 0001 0000 0000 k₁k₂k₃k₄, the first puncturing pattern is 1110 1111 1111 k₁k₂k₃k₄ and the second puncturing pattern is a puncturing pattern corresponding to the 2*996+484-tone MRU 2, wherein kᵢ is negation of kᵢ, i comprises 1, 2, 3, and 4, and k₁k₂k₃k₄ is any one of 0111, 1011, 1101, 1110, 1100, 0011, 1001, or 0000; or
the first bitmap is 0100 0000 0000 k₁k₂k₃k₄, the first puncturing pattern is 1011 1111 1111 k₁k₂k₃k₄ and the second puncturing pattern is a puncturing pattern corresponding to the 2*996+484-tone MRU 1, wherein kᵢ is negation of kᵢ, i comprises 1, 2, 3, and 4, and k₁k₂k₃k₄ is any one of 0111, 1011, 1101, 1110, 1100, 0011, 1001, or 0000; or
the first bitmap is 0010 0000 0000 k₁k₂k₃k₄, the first puncturing pattern is 1101 1111 1111 k₁k₂k₃k₄ and the second puncturing pattern is a puncturing pattern corresponding to the 2*996+484-tone MRU 2, wherein kᵢ is negation of kᵢ, i comprises 1, 2, 3, and 4, and k₁k₂k₃k₄ is any one of 0111, 1011, 1101, 1110, 1100, 0011, 1001, or 0000; or
the first bitmap is 1000 0000 0000 k₁k₂k₃k₄, the first puncturing pattern is 0111 1111 1111 k₁k₂k₃k₄ and the second puncturing pattern is a puncturing pattern corresponding to the 2*996+484-tone MRU 1, wherein kᵢ is negation of kᵢ, i comprises 1, 2, 3, and 4, and k₁k₂k₃k₄ is any one of 0111, 1011, 1101, 1110, 1100, 0011, 1001, or 0000; or
the first bitmap is 0001 0000 0000 0000, the first puncturing pattern is 1110 1111 1111 1111 and the second puncturing pattern is a puncturing pattern corresponding to the 3*996+484-tone MRU 2; or
the first bitmap is 0100 0000 0000 0000, the first puncturing pattern is 10 1111 1111 1111 and the second puncturing pattern is a puncturing pattern corresponding to the 3*996+484-tone MRU 1; or
the first bitmap is 0010 0000 0000 0000, the first puncturing pattern is 1101 1111 1111 1111 and the second puncturing pattern is a puncturing pattern corresponding to the 3*996+484-tone MRU 2; or
the first bitmap is 1000 0000 0000 0000, the first puncturing pattern is 0111 1111 1111 1111 and the second puncturing pattern is a puncturing pattern corresponding to the 3*996+484-tone MRU 1; or
the first bitmap is 0000 0110 z₁z₂z₃z₄ k₁k₂k₃k₄, the first puncturing pattern is 1111 1101 and the second puncturing pattern is a puncturing pattern corresponding to the 996-tone RU 1, wherein zᵢ is negation of zᵢ, kᵢ is negation of kᵢ, i comprises 1, 2, 3, and 4, z₁z₂z₃z₄ is any one of 1111, 0111, 1011, 1101, 1110, 1100, 0011, 1001, or 0000, k₁k₂k₃k₄ is any one of 0111, 1011, 1101, 1110, 1100, 0011, 1001, or 0000, and z₁z₂z₃z₄ and k₁k₂k₃k₄ are not both 0000; or
the first bitmap is 0000 0110 0000 0000, the first puncturing pattern is 1111 1001 1111 1111 and the second puncturing pattern is a puncturing pattern corresponding to the 3*996-tone MRU 2; or
the first bitmap is 0000 0011 z₁z₂z₃z₄ k₁k₂k₃k₄, the first puncturing pattern is 1111 1100 z₁z₂z₃z₄ k₁k₂k₃k₄ and the second puncturing pattern is a puncturing pattern corresponding to the 996+484-tone MRU 4, wherein zᵢ is negation of zᵢ, kᵢ is negation of kᵢ, i comprises 1, 2, 3, and 4, z₁z₂z₃z₄ is any one of 0111, 1011, 1101, 1110, 1100, 0011, 1001, or 0000, k₁k₂k₃k₄ is any one of 1111, 0111, 1011, 1101, 1110, 1100, 0011, 1001, or 0000, and z₁z₂z₃z₄ and k₁k₂k₃k₄ are not both 0000; or
the first bitmap is 0000 1100 z₁z₂z₃z₄ k₁k₂k₃k₄, the first puncturing pattern is 1111 0011 z₁z₂z₃z₄ k₁k₂k₃k₄ and the second puncturing pattern is a puncturing pattern corresponding to the 996+484-tone MRU 3, wherein zᵢ is negation of zᵢ, kᵢ is negation of kᵢ, i comprises 1, 2, 3, and 4, z₁z₂z₃z₄ is any one of 0111, 1011, 1101, 1110, 1100, 0011, 1001, or 0000, k₁k₂k₃k₄ is any one of 1111, 0111, 1011, 1101, 1110, 1100, 0011, 1001, or 0000, and z₁z₂z₃z₄ and k₁k₂k₃k₄ are not both 0000; or
the first bitmap is 0000 0011 0000 k₁k₂k₃k₄, the first puncturing pattern is 1111 1100 1111 k₁k₂k₃k₄ and the second puncturing pattern is a puncturing pattern corresponding to the 2*996+484-tone MRU 4, wherein kᵢ is negation of kᵢ, i comprises 1, 2, 3, and 4, and k₁k₂k₃k₄ is any one of 0111, 1011, 1101, 1110, 1100, 0011, 1001, or 0000; or
the first bitmap is 0000 1100 0000 k₁k₂k₃k₄ k₄, the first puncturing pattern is 1111 0011 1111 k₁k₂k₃k₄ and the second puncturing pattern is a puncturing pattern corresponding to the 2*996+484-tone MRU 3, wherein kᵢ is negation of kᵢ, i comprises 1, 2, 3, and 4, and k₁k₂k₃k₄ is any one of 0111, 1011, 1101, 1110, 1100, 0011, 1001, or 0000; or
the first bitmap is 0000 0001 z₁z₂z₃z₄ k₁k₂k₃k₄, the first puncturing pattern is 1111 1110 z₁z₂z₃z₄ k₁k₂k₃k₄ and the second puncturing pattern is a puncturing pattern corresponding to the 996+484+242-tone MRU 8, wherein zᵢ is negation of zᵢ, kᵢ is negation of kᵢ, i comprises 1, 2, 3, and 4, z₁z₂z₃z₄ is any one of 0111, 1011, 1101, 1110, 1100, 0011, 1001, or 0000, k₁k₂k₃k₄ is any one of 1111, 0111, 1011, 1101, 1110, 1100, 0011, 1001, or 0000, and z₁z₂z₃z₄ and k₁k₂k₃k₄ are not both 0000; or
the first bitmap is 0000 0010 z₁z₂z₃z₄ k₁k₂k₃k₄, the first puncturing pattern is 1111 1101 z₁z₂z₃z₄ k₁k₂k₃k₄ and the second puncturing pattern is a puncturing pattern corresponding to the 996+484+242-tone MRU 7, wherein zᵢ is negation of zᵢ, kᵢ is negation of kᵢ, i comprises 1, 2, 3, and 4, z₁z₂z₃z₄ is any one of 0111, 1011, 1101, 1110, 1100, 0011, 1001, or 0000, k₁k₂k₃k₄ is any one of 1111, 0111, 1011, 1101, 1110, 1100, 0011, 1001, or 0000, and z₁z₂z₃z₄ and k₁k₂k₃k₄ are not both 0000; or
the first bitmap is 0000 0100 z₁z₂z₃z₄ k₁k₂k₃k₄, the first puncturing pattern is 1111 1011 z₁z₂z₃z₄ k₁k₂k₃k₄ and the second puncturing pattern is a puncturing pattern corresponding to the 996+484+242-tone MRU 6, wherein zᵢ is negation of zᵢ, kᵢ is negation of kᵢ, i comprises 1, 2, 3, and 4, z₁z₂z₃z₄ is any one of 0111, 1011, 1101, 1110, 1100, 0011, 1001, or 0000, k₁k₂k₃k₄ is any one of 1111, 0111, 1011, 1101, 1110, 1100, 0011, 1001, or 0000, and z₁z₂z₃z₄ and k₁k₂k₃k₄ are not both 0000; or
the first bitmap is 0000 1000 z₁z₂z₃z₄ k₁k₂k₃k₄, the first puncturing pattern is 1111 0111 z₁z₂z₃z₄ k₁k₂k₃k₄ and the second puncturing pattern is a puncturing pattern corresponding to the 996+484+242-tone MRU 5, wherein zᵢ is negation of zᵢ, kᵢ is negation of kᵢ, i comprises 1, 2, 3, and 4, z₁z₂z₃z₄ is any one of 0111, 1011, 1101, 1110, 1100, 0011, 1001, or 0000, k₁k₂k₃k₄ is any one of 1111, 0111, 1011, 1101, 1110, 1100, 0011, 1001, or 0000, and z₁z₂z₃z₄ and k₁k₂k₃k₄ are not both 0000; or
the first bitmap is 0000 0001 0000 k₁k₂k₃k₄, the first puncturing pattern is 1111 1110 1111 k₁k₂k₃k₄ and the second puncturing pattern is a puncturing pattern corresponding to the 2*996+484-tone MRU 4, wherein kᵢ is negation of kᵢ, i comprises 1, 2, 3, and 4, and k₁k₂k₃k₄ is any one of 0111, 1011, 1101, 1110, 1100, 0011, 1001, or 0000; or
the first bitmap is 0000 0010 0000 k₁k₂k₃k₄, the first puncturing pattern is 1111 1101 1111 k₁k₂k₃k₄ and the second puncturing pattern is a puncturing pattern corresponding to the 2*996+484-tone MRU 4, wherein kᵢ is negation of kᵢ, i comprises 1, 2, 3, and 4, and k₁k₂k₃k₄ is any one of 1111, 0111, 1011, 1101, 1110, 1100, 0011, 1001, or 0000; or
the first bitmap is 0000 0100 0000 k₁k₂k₃k₄, the first puncturing pattern is 1111 1011 1111 k₁k₂k₃k₄ and the second puncturing pattern is a puncturing pattern corresponding to the 2*996+484-tone MRU 3, wherein kᵢ is negation of kᵢ, i comprises 1, 2, 3, and 4, and k₁k₂k₃k₄ is any one of 1111, 0111, 1011, 1101, 1110, 1100, 0011, 1001, or 0000; or
the first bitmap is 0000 1000 0000 k₁k₂k₃k₄, the first puncturing pattern is 1111 0111 1111 k₁k₂k₃k₄ and the second puncturing pattern is a puncturing pattern corresponding to the 2*996+484-tone MRU 3, wherein kᵢ is negation of kᵢ, i comprises 1, 2, 3, and 4, and k₁k₂k₃k₄ is any one of 1111, 0111, 1011, 1101, 1110, 1100, 0011, 1001, or 0000; or
the first bitmap is 0000 0001 0000 0000, the first puncturing pattern is 1111 1110 1111 1111 and the second puncturing pattern is a puncturing pattern corresponding to the 3*996+484-tone MRU 4; or
the first bitmap is 0000 0010 0000 0000, the first puncturing pattern is 1111 1101 1111 1111 and the second puncturing pattern is a puncturing pattern corresponding to the 3*996+484-tone MRU 4; or
the first bitmap is 0000 0100 0000 0000, the first puncturing pattern is 1111 1011 1111 1111 and the second puncturing pattern is a puncturing pattern corresponding to the 3*996+484-tone MRU 3; or
the first bitmap is 0000 1000 0000 0000, the first puncturing pattern is 1111 0111 1111 1111, and the second puncturing pattern is a puncturing pattern corresponding to the 3*996+484-tone MRU 3; or
the first bitmap is 0000 0000 0110 k₁k₂k₃k₄, the first puncturing pattern is 1111 1111 1001 k₁k₂k₃k₄ and the second puncturing pattern is a puncturing pattern corresponding to the 2*996-tone RU 1, wherein kᵢ is negation of kᵢ, i comprises 1, 2, 3, and 4, and k₁k₂k₃k₄ is any one of 0111, 1011, 1101, 1110, 1100, 0011, 1001, or 0000; or
the first bitmap is 0000 0000 0011 k₁k₂k₃k₄, the first puncturing pattern is 1111 1111 1100 k₁k₂k₃k₄ and the second puncturing pattern is a puncturing pattern corresponding to the 2*996+484-tone MRU 6, wherein kᵢ is negation of kᵢ, i comprises 1, 2, 3, and 4, and k₁k₂k₃k₄ is any one of 0111, 1011, 1101, 1110, 1100, 0011, 1001, or 0000; or
the first bitmap is 0000 0000 1100 k₁k₂k₃k₄, the first puncturing pattern is 1111 1111 0011 k₁k₂k₃k₄ and the second puncturing pattern is a puncturing pattern corresponding to the 2*996+484-tone MRU 5, wherein kᵢ is negation of kᵢ, i comprises 1, 2, 3, and 4, and k₁k₂k₃k₄ is any one of 0111, 1011, 1101, 1110, 1100, 0011, 1001, or 0000; or
the first bitmap is 0000 0000 0001 k₁k₂k₃k₄, the first puncturing pattern is 1111 1111 1110 k₁k₂k₃k₄ and the second puncturing pattern is a puncturing pattern corresponding to the 2*996+484-tone MRU 6, wherein kᵢ is negation of kᵢ, i comprises 1, 2, 3, and 4, and k₁k₂k₃k₄ is any one of 0111, 1011, 1101, 1110, 1100, 0011, 1001, or 0000; or
the first bitmap is 0000 0000 0010 k₁k₂k₃k₄, the first puncturing pattern is 1111 1111 1101 k₁k₂k₃k₄ and the second puncturing pattern is a puncturing pattern corresponding to the 2*996+484-tone MRU 6, wherein kᵢ is negation of kᵢ, i comprises 1, 2, 3, and 4, and k₁k₂k₃k₄ is any one of 0111, 1011, 1101, 1110, 1100, 0011, 1001, or 0000; or
the first bitmap is 0000 0000 0100 k₁k₂k₃k₄, the first puncturing pattern is 1111 1111 1011 k₁k₂k₃k₄ and the second puncturing pattern is a puncturing pattern corresponding to the 2*996+484-tone MRU 5, wherein kᵢ is negation of kᵢ, i comprises 1, 2, 3, and 4, and k₁k₂k₃k₄ is any one of 0111, 1011, 1101, 1110, 1100, 0011, 1001, or 0000; or
the first bitmap is 0000 0000 1000 k₁k₂k₃k₄, the first puncturing pattern is 1111 1111 0111 k₁k₂k₃k₄ and the second puncturing pattern is a puncturing pattern corresponding to the 2*996+484-tone MRU 5, wherein kᵢ is negation of kᵢ, i comprises 1, 2, 3, and 4, and k₁k₂k₃k₄ is any one of 0111, 1011, 1101, 1110, 1100, 0011, 1001, or 0000; or
the first bitmap is 0000 0000 0001 0000, the first puncturing pattern is 1111 1111 1110 1111 and the second puncturing pattern is a puncturing pattern corresponding to the 2*996+484-tone MRU 6; or
the first bitmap is 0000 0000 0010 0000, the first puncturing pattern is 1111 1111 1101 1111 and the second puncturing pattern is a puncturing pattern corresponding to the 3*996+484-tone MRU 6; or
the first bitmap is 0000 0000 0100 0000, the first puncturing pattern is 1111 1111 1011 1111 and the second puncturing pattern is a puncturing pattern corresponding to the 3*996+484-tone MRU 5; or
the first bitmap is 0000 0000 1000 0000, the first puncturing pattern is 1111 1111 0111 1111, and the second puncturing pattern is a puncturing pattern corresponding to the 3*996+484-tone MRU 5; or
the first bitmap is 0000 0000 0000 0110, the first puncturing pattern is 1111 1111 1111 1001 and the second puncturing pattern is a puncturing pattern corresponding to the 3*996-tone MRU 4; or
the first bitmap is 0000 0000 0000 0001, the first puncturing pattern is 1111 1111 1111 1110 and the second puncturing pattern is a puncturing pattern corresponding to the 3*996+484-tone MRU 8; or
the first bitmap is 0000 0000 0000 0010, the first puncturing pattern is 1111 1111 1111 1101 and the second puncturing pattern is a puncturing pattern corresponding to the 3*996+484-tone MRU 8; or
the first bitmap is 0000 0000 0000 0100, the first puncturing pattern is 1111 1111 1111 1011 and the second puncturing pattern is a puncturing pattern corresponding to the 3*996+484-tone MRU 7; or
the first bitmap is 0000 0000 0000 1000, the first puncturing pattern is 1111 1111 1111 0111 and the second puncturing pattern is a puncturing pattern corresponding to the 3*996+484-tone MRU 7.

10. The method according to claim 5, wherein the first BSS bandwidth is 320 MHz, and the first BSS bandwidth is divided into a secondary 80 MHz channel, and a primary 80 MHz channel, and a secondary 160 MHz channel in ascending order of frequencies in sequence; and
wherein at least one of:
the first bitmap is y₁y₂y₃y₄ 0110 z₁z₂z₃z₄ k₁k₂k₃k₄, the first puncturing pattern is y₁y₂y₃y₄ 1001 z₁z₂z₃z₄ k₁k₂k₃k₄ and the second puncturing pattern is a puncturing pattern corresponding to the 242-tone RU 1, wherein yᵢ is negation of yᵢ, zᵢ is negation of zᵢ, k is negation of kᵢ, i comprises 1, 2, 3, and 4, each of y₁y₂y₃y₄, k₁k₂k₃k₄, and z₁z₂z₃z₄ is any one of 1111, 0111, 1011, 1101, 1110, 1100, 0011, 1001, or 0000, and z₁z₂z₃z₄ and kᵢk₂k₃k₄ are not both 0000; or
the first bitmap is y₁y₂y₃y₄ 0011 z₁z₂z₃z₄ k₁k₂k₃k₄, the first puncturing pattern is y₁y₂y₃y₄ 1100 z₁z₂z₃z₄ k₁k₂k₃k₄ and the second puncturing pattern is a puncturing pattern corresponding to the 484-tone RU 1, wherein yᵢ is negation of yᵢ, zᵢ is negation of zᵢ, k is negation of kᵢ, i comprises 1, 2, 3, and 4, y₁y₂y₃y₄ is any one of 0111, 1011, 1101, 1110, 1100, 0011, 1001, or 0000, z₁z₂z₃z₄ and k₁k₂k₃k₄ each are any one of 1111, 0111, 1011, 1101, 1110, 1100, 0011, 1001, or 0000, and z₁z₂z₃z₄ and kᵢk₂k₃k₄ are not both 1111 or not both 0000; or
the first bitmap is y₁y₂y₃y₄ 1100 z₁z₂z₃z₄ k₁k₂k₃k₄, the first puncturing pattern is y₁y₂y₃y₄ 0011 z₁z₂z₃z₄ k₁k₂k₃k₄ and the second puncturing pattern is a puncturing pattern corresponding to the 484-tone RU 1, wherein yᵢ is negation of yᵢ, zᵢ is negation of zᵢ, k is negation of kᵢ, i comprises 1, 2, 3, and 4, y₁y₂y₃y₄ is any one of 0111, 1011, 1101, 1110, 1100, 0011, 1001, or 0000, z₁z₂z₃z₄ and k₁k₂k₃k₄ each are any one of 1111, 0111, 1011, 1101, 1110, 1100, 0011, 1001, or 0000, and z₁z₂z₃z₄ and kᵢk₂k₃k₄ are not both 1111 or not both 0000; or
the first bitmap is y₁y₂y₃y₄ 0011 0000 0000, the first puncturing pattern is y₁y₂y₃y₄ 1100 1111 1111 and the second puncturing pattern is a puncturing pattern corresponding to the 2*996+484-tone MRU 8, wherein yᵢ is negation of yᵢ, i comprises 1, 2, 3, and 4, and y₁y₂y₃y₄ is any one of 0111, 1011, 1101, 1110, 1100, 0011, 1001, or 0000; or
the first bitmap is y₁y₂y₃y₄ 1100 0000 0000, the first puncturing pattern is y₁y₂y₃y₄ 0011 1111 1111 and the second puncturing pattern is a puncturing pattern corresponding to the 2*996+484-tone MRU 7, wherein yᵢ is negation of yᵢ, i comprises 1, 2, 3, and 4, and y₁y₂y₃y₄ is any one of 0111, 1011, 1101, 1110, 1100, 0011, 1001, or 0000; or
the first bitmap is 0000 0011 z₁z₂z₃z₄ k₁k₂k₃k₄, the first puncturing pattern is 1111 1100 z₁z₂z₃z₄ k₁k₂k₃k₄ and the second puncturing pattern is a puncturing pattern corresponding to the 996+484-tone MRU 4, wherein zᵢ is negation of zᵢ, kᵢ is negation of kᵢ, i comprises 1, 2, 3, and 4, z₁z₂z₃z₄ is any one of 0111, 1011, 1101, 1110, 1100, 0011, 1001, or 0000, k₁k₂k₃k₄ is any one of 1111, 0111, 1011, 1101, 1110, 1100, 0011, 1001, or 0000, and z₁z₂z₃z₄ and k₁k₂k₃k₄ are not both 0000; or
the first bitmap is 0000 1100 z₁z₂z₃z₄ k₁k₂k₃k₄, the first puncturing pattern is 1111 0011 z₁z₂z₃z₄ k₁k₂k₃k₄ and the second puncturing pattern is a puncturing pattern corresponding to the 996+484-tone MRU 3, wherein zᵢ is negation of zᵢ, kᵢ is negation of kᵢ, i comprises 1, 2, 3, and 4, z₁z₂z₃z₄ is any one of 0111, 1011, 1101, 1110, 1100, 0011, 1001, or 0000, k₁k₂k₃k₄ is any one of 1111, 0111, 1011, 1101, 1110, 1100, 0011, 1001, or 0000, and z₁z₂z₃z₄ and k₁k₂k₃k₄ are not both 0000; or
the first bitmap is 0000 0011 0000 k₁k₂k₃k₄, the first puncturing pattern is 1111 1100 1111 k₁k₂k₃k₄ and the second puncturing pattern is a puncturing pattern corresponding to the 2*996+484-tone MRU 4, wherein kᵢ is negation of kᵢ, i comprises 1, 2, 3, and 4, and k₁k₂k₃k₄ is any one of 0111, 1011, 1101, 1110, 1100, 0011, 1001, or 0000; or
the first bitmap is 0000 1100 0000 k₁k₂k₃k₄, the first puncturing pattern is 1111 0011 1111 k₁k₂k₃k₄ and the second puncturing pattern is a puncturing pattern corresponding to the 2*996+484-tone MRU 3, wherein kᵢ is negation of kᵢ, i comprises 1, 2, 3, and 4, and k₁k₂k₃k₄ is any one of 0111, 1011, 1101, 1110, 1100, 0011, 1001, or 0000; or
the first bitmap is y₁y₂y₃y₄ 0001 z₁z₂z₃z₄ k₁k₂k₃k₄, the first puncturing pattern is y₁y₂y₃y₄ 1110 z₁z₂z₃z₄ k₁k₂k₃k₄ and the second puncturing pattern is a puncturing pattern corresponding to the 484+242-tone MRU 4, wherein yᵢ is negation of yᵢ, zᵢ is negation of zᵢ, kᵢ is negation of kᵢ, i comprises 1, 2, 3, and 4, y₁y₂y₃y₄ is any one of 0111, 1011, 1101, 1110, 1100, 0011, 1001, or 0000, z₁z₂z₃z₄ and k₁k₂k₃k₄ each are any one of 1111, 0111, 1011, 1101, 1110, 1100, 0011, 1001, or 0000, and z₁z₂z₃z₄ and k₁k₂k₃k₄ are not both 1111 or not both 0000; or
the first bitmap is y₁y₂y₃y₄ 0100 z₁z₂z₃z₄ k₁k₂k₃k₄, the first puncturing pattern is y₁y₂y₃y₄ 1011 z₁z₂z₃z₄ k₁k₂k₃k₄ and the second puncturing pattern is a puncturing pattern corresponding to the 484+242-tone MRU 2, wherein yᵢ is negation of yᵢ, zᵢ is negation of zᵢ, kᵢ is negation of kᵢ, i comprises 1, 2, 3, and 4, y₁y₂y₃y₄ is any one of 0111, 1011, 1101, 1110, 1100, 0011, 1001, or 0000, z₁z₂z₃z₄ and k₁k₂k₃k₄ each are any one of 1111, 0111, 1011, 1101, 1110, 1100, 0011, 1001, or 0000, and z₁z₂z₃z₄ and k₁k₂k₃k₄ are not both 1111 or not both 0000; or
the first bitmap is y₁y₂y₃y₄ 0010 z₁z₂z₃z₄ k₁k₂k₃k₄, the first puncturing pattern is y₁y₂y₃y₄ 1101 z₁z₂z₃z₄ k₁k₂k₃k₄ and the second puncturing pattern is a puncturing pattern corresponding to the 484+242-tone MRU 3, wherein yᵢ is negation of yᵢ, zᵢ is negation of zᵢ, kᵢ is negation of kᵢ, i comprises 1, 2, 3, and 4, y₁y₂y₃y₄ is any one of 0111, 1011, 1101, 1110, 1100, 0011, 1001, or 0000, z₁z₂z₃z₄ and k₁k₂k₃k₄ each are any one of 1111, 0111, 1011, 1101, 1110, 1100, 0011, 1001, or 0000, and z₁z₂z₃z₄ and k₁k₂k₃k₄ are not both 1111 or not both 0000; or
the first bitmap is y₁y₂y₃y₄ 1000 z₁z₂z₃z₄ k₁k₂k₃k₄, the first puncturing pattern is y₁y₂y₃y₄ 0111 z₁z₂z₃z₄ k₁k₂k₃k₄ and the second puncturing pattern is a puncturing pattern corresponding to the 484+242-tone MRU 1, wherein yᵢ is negation of yᵢ, zᵢ is negation of zᵢ, kᵢ is negation of kᵢ, i comprises 1, 2, 3, and 4, y₁y₂y₃y₄ is any one of 0111, 1011, 1101, 1110, 1100, 0011, 1001, or 0000, z₁z₂z₃z₄ and k₁k₂k₃k₄ each are any one of 1111, 0111, 1011, 1101, 1110, 1100, 0011, 1001, or 0000, and z₁z₂z₃z₄ and k₁k₂k₃k₄ are not both 1111 or not both 0000; or
the first bitmap is y₁y₂y₃y₄ 0001 0000 0000, the first puncturing pattern is y₁y₂y₃y₄ 1110 1111 1111 and the second puncturing pattern is a puncturing pattern corresponding to the 2*996+484-tone MRU 8, wherein yᵢ is negation of yᵢ, i comprises 1, 2, 3, and 4, and y₁y₂y₃y₄ is any one of 0111, 1011, 1101, 1110, 1100, 0011, 1001, or 0000; or
the first bitmap is y₁y₂y₃y₄ 0100 0000 0000, the first puncturing pattern is y₁y₂y₃y₄ 0010 1111 1111 and the second puncturing pattern is a puncturing pattern corresponding to the 2*996+484-tone MRU 7, wherein yᵢ is negation of yᵢ, i comprises 1, 2, 3, and 4, and y₁y₂y₃y₄ is any one of 0111, 1011, 1101, 1110, 1100, 0011, 1001, or 0000; or
the first bitmap is y₁y₂y₃y₄ 0010 0000 0000, the first puncturing pattern is y₁y₂y₃y₄ 1101 1111 1111 and the second puncturing pattern is a puncturing pattern corresponding to the 2*996+484-tone MRU 8, wherein yᵢ is negation of yᵢ, i comprises 1, 2, 3, and 4, and y₁y₂y₃y₄ is any one of 0111, 1011, 1101, 1110, 1100, 0011, 1001, or 0000; or
the first bitmap is y₁y₂y₃y₄ 1000 0000 0000, the first puncturing pattern is y₁y₂y₃y₄ 0111 1111 1111 and the second puncturing pattern is a puncturing pattern corresponding to the 2*996+484-tone MRU 7, wherein yᵢ is negation of yᵢ, i comprises 1, 2, 3, and 4, and y₁y₂y₃y₄ is any one of 0111, 1011, 1101, 1110, 1100, 0011, 1001, or 0000; or
the first bitmap is 0000 0001 z₁z₂z₃z₄ k₁k₂k₃k₄, the first puncturing pattern is 1111 1110 z₁z₂z₃z₄ k₁k₂k₃k₄ and the second puncturing pattern is a puncturing pattern corresponding to the 996+484+242-tone MRU 8, wherein zᵢ is negation of zᵢ, kᵢ is negation of kᵢ, i comprises 1, 2, 3, and 4, z₁z₂z₃z₄ is any one of 0111, 1011, 1101, 1110, 1100, 0011, 1001, or 0000, and k₁k₂k₃k₄ is any one of 1111, 0111, 1011, 1101, 1110, 1100, 0011, 1001, or 0000; or
the first bitmap is 0000 0100 z₁z₂z₃z₄ k₁k₂k₃k₄, the first puncturing pattern is 1111 1011 z₁z₂z₃z₄ k₁k₂k₃k₄ and the second puncturing pattern is a puncturing pattern corresponding to the 996+484+242-tone MRU 6, wherein zᵢ is negation of zᵢ, kᵢ is negation of kᵢ, i comprises 1, 2, 3, and 4, z₁z₂z₃z₄ is any one of 0111, 1011, 1101, 1110, 1100, 0011, 1001, or 0000, and k₁k₂k₃k₄ is any one of 1111, 0111, 1011, 1101, 1110, 1100, 0011, 1001, or 0000; or
the first bitmap is 0000 0010 z₁z₂z₃z₄ k₁k₂k₃k₄, the first puncturing pattern is 1111 1101 z₁z₂z₃z₄ k₁k₂k₃k₄ and the second puncturing pattern is a puncturing pattern corresponding to the 996+484+242-tone MRU 7, wherein & is negation of zᵢ, kᵢ is negation of kᵢ, i comprises 1, 2, 3, and 4, z₁z₂z₃z₄ is any one of 0111, 1011, 1101, 1110, 1100, 0011, 1001, or 0000, and k₁k₂k₃k₄ is any one of 1111, 0111, 1011, 1101, 1110, 1100, 0011, 1001, or 0000; or
the first bitmap is 0000 1000 z₁z₂z₃z₄ k₁k₂k₃k₄, the first puncturing pattern is 1111 0111 z₁z₂z₃z₄ k₁k₂k₃k₄ and the second puncturing pattern is a puncturing pattern corresponding to the 996+484+242-tone MRU 5, wherein zᵢ is negation of zᵢ, kᵢ is negation of kᵢ, i comprises 1, 2, 3, and 4, z₁z₂z₃z₄ is any one of 0111, 1011, 1101, 1110, 1100, 0011, 1001, or 0000, and k₁k₂k₃k₄ is any one of 1111, 0111, 1011, 1101, 1110, 1100, 0011, 1001, or 0000; or
the first bitmap is 0000 0001 z₁z₂z₃z₄ k₁k₂k₃k₄, the first puncturing pattern is 1111 1110 1111 k₁k₂k₃k₄ and the second puncturing pattern is a puncturing pattern corresponding to the 2*996+484-tone MRU 4, wherein kᵢ is negation of kᵢ, i comprises 1, 2, 3, and 4, and k₁k₂k₃k₄ is any one of 0111, 1011, 1101, 1110, 1100, 0011, 1001, or 0000; or
the first bitmap is 0000 0100 0000 k₁k₂k₃k₄, the first puncturing pattern is 1111 1011 1111 k₁k₂k₃k₄ and the second puncturing pattern is a puncturing pattern corresponding to the 2*996+484-tone MRU 3, wherein kᵢ is negation of kᵢ, i comprises 1, 2, 3, and 4, and k₁k₂k₃k₄ is any one of 0111, 1011, 1101, 1110, 1100, 0011, 1001, or 0000; or
the first bitmap is 0000 0010 0000 k₁k₂k₃k₄, the first puncturing pattern is 1111 1101 1111 k₁k₂k₃k₄ and the second puncturing pattern is a puncturing pattern corresponding to the 2*996+484-tone MRU 4, wherein kᵢ is negation of kᵢ, i comprises 1, 2, 3, and 4, and k₁k₂k₃k₄ is any one of 0111, 1011, 1101, 1110, 1100, 0011, 1001, or 0000; or
the first bitmap is 0000 1000 0000 k₁k₂k₃k₄, the first puncturing pattern is 1111 0111 1111 k₁k₂k₃k₄ and the second puncturing pattern is a puncturing pattern corresponding to the 2*996+484-tone MRU 3, wherein kᵢ is negation of kᵢ, i comprises 1, 2, 3, and 4, and k₁k₂k₃k₄ is any one of 0111, 1011, 1101, 1110, 1100, 0011, 1001, or 0000; or
the first bitmap is 0000 0001 0000 0000, the first puncturing pattern is 1111 1110 1111 1111 and the second puncturing pattern is a puncturing pattern corresponding to the 3*996+484-tone MRU 4; or
the first bitmap is 0000 0100 0000 0000, the first puncturing pattern is 1111 1011 1111 1111 and the second puncturing pattern is a puncturing pattern corresponding to the 3*996+484-tone MRU 3; or
the first bitmap is 0000 0010 0000 0000, the first puncturing pattern is 1111 1101 1111 1111 and the second puncturing pattern is a puncturing pattern corresponding to the 3*996+484-tone MRU 4; or
the first bitmap is 0000 1000 0000 0000, the first puncturing pattern is 1111 0111 1111 1111 and the second puncturing pattern is a puncturing pattern corresponding to the 3*996+484-tone MRU 3; or
the first bitmap is 0110 0000 0110 k₁k₂k₃k₄, the first puncturing pattern is 1001 1111 1001 k₁k₂k₃k₄ and the second puncturing pattern is a puncturing pattern corresponding to the 996-tone RU 1, wherein kᵢ is negation of kᵢ, i comprises 1, 2, 3, and 4, and k₁k₂k₃k₄ is any one of 0111, 1011, 1101, 1110, 1100, 0011, 1001, or 0000; or
the first bitmap is 0110 0000 0110 0000, the first puncturing pattern is 1001 1111 1001 1111 and the second puncturing pattern is a puncturing pattern corresponding to the 996-tone RU 1; or
the first bitmap is 0110 0000 1100 k₁k₂k₃k₄, the first puncturing pattern is 1001 1111 0011 k₁k₂k₃k₄ and the second puncturing pattern is a puncturing pattern corresponding to the 996-tone RU 1, wherein kᵢ is negation of kᵢ, i comprises 1, 2, 3, and 4, and k₁k₂k₃k₄ is any one of 0111, 1011, 1101, 1110, 1100, 0011, 1001, or 0000; or
the first bitmap is 0110 0000 0011 k₁k₂k₃k₄, the first puncturing pattern is 1001 1111 1100 k₁k₂k₃k₄ and the second puncturing pattern is a puncturing pattern corresponding to the 996-tone RU 1, wherein kᵢ is negation of kᵢ, i comprises 1, 2, 3, and 4, and k₁k₂k₃k₄ is any one of 0111, 1011, 1101, 1110, 1100, 0011, 1001, or 0000; or
the first bitmap is 0110 0000 1000 k₁k₂k₃k₄, the first puncturing pattern is 1001 1111 0111 k₁k₂k₃k₄ and the second puncturing pattern is a puncturing pattern corresponding to the 996-tone RU 1, wherein kᵢ is negation of kᵢ, i comprises 1, 2, 3, and 4, and k₁k₂k₃k₄ is any one of 0111, 1011, 1101, 1110, 1100, 0011, 1001, or 0000; or
the first bitmap is 0110 0000 0100 k₁k₂k₃k₄, the first puncturing pattern is 1001 1111 1101 k₁k₂k₃k₄ and the second puncturing pattern is a puncturing pattern corresponding to the 996-tone RU 1, wherein kᵢ is negation of kᵢ, i comprises 1, 2, 3, and 4, and k₁k₂k₃k₄ is any one of 0111, 1011, 1101, 1110, 1100, 0011, 1001, or 0000; or
the first bitmap is 0110 0000 0010 k₁k₂k₃k₄, the first puncturing pattern is 1001 1111 1101 k₁k₂k₃k₄ and the second puncturing pattern is a puncturing pattern corresponding to the 996-tone RU 1, wherein kᵢ is negation of kᵢ, i comprises 1, 2, 3, and 4, and k₁k₂k₃k₄ is any one of 0111, 1011, 1101, 1110, 1100, 0011, 1001, or 0000; or
the first bitmap is 0110 0000 0001 k₁k₂k₃k₄, the first puncturing pattern is 1001 1111 1110 k₁k₂k₃k₄ and the second puncturing pattern is a puncturing pattern corresponding to the 996-tone RU 1, wherein kᵢ is negation of kᵢ, i comprises 1, 2, 3, and 4, and k₁k₂k₃k₄ is any one of 0111, 1011, 1101, 1110, 1100, 0011, 1001, or 0000; or
the first bitmap is 0110 0000 z₁z₂z₃z₄ 0110, the first puncturing pattern is 1001 1111 z₁z₂z₃z₄ 1001 and the second puncturing pattern is a puncturing pattern corresponding to the 996-tone RU 1, wherein zᵢ is negation of zᵢ, i comprises 1, 2, 3, and 4, and z₁z₂z₃z₄ is any one of 0111, 1011, 1101, 1110, 1100, 0011, 1001, or 0000; or
the first bitmap is 0110 0000 z₁z₂z₃z₄ 1100, the first puncturing pattern is 1001 1111 z₁z₂z₃z₄ 0011 and the second puncturing pattern is a puncturing pattern corresponding to the 996-tone RU 1, wherein zᵢ is negation of zᵢ, i comprises 1, 2, 3, and 4, and z₁z₂z₃z₄ is any one of 0111, 1011, 1101, 1110, 1100, 0011, 1001, or 0000; or
the first bitmap is 0110 0000 z₁z₂z₃z₄ 0011, the first puncturing pattern is 1001 1111 z₁z₂z₃z₄ 1100 and the second puncturing pattern is a puncturing pattern corresponding to the 996-tone RU 1, wherein zᵢ is negation of zᵢ, i comprises 1, 2, 3, and 4, and z₁z₂z₃z₄ is any one of 0111, 1011, 1101, 1110, 1100, 0011, 1001, or 0000; or
the first bitmap is 0110 0000 z₁z₂z₃z₄ 1000, the first puncturing pattern is 1001 1111 z₁z₂z₃z₄ 0111 and the second puncturing pattern is a puncturing pattern corresponding to the 996-tone RU 1, wherein zᵢ is negation of zᵢ, i comprises 1, 2, 3, and 4, and z₁z₂z₃z₄ is any one of 0111, 1011, 1101, 1110, 1100, 0011, 1001, or 0000; or
the first bitmap is 0110 0000 z₁z₂z₃z₄ 0100, the first puncturing pattern is 1001 1111 z₁z₂z₃z₄ 1011 and the second puncturing pattern is a puncturing pattern corresponding to the 996-tone RU 1, wherein zᵢ is negation of zᵢ, i comprises 1, 2, 3, and 4, and z₁z₂z₃z₄ is any one of 0111, 1011, 1101, 1110, 1100, 0011, 1001, or 0000; or
the first bitmap is 0110 0000 z₁z₂z₃z₄ 0010, the first puncturing pattern is 1001 1111 z₁z₂z₃z₄ 1101 and the second puncturing pattern is a puncturing pattern corresponding to the 996-tone RU 1, wherein zᵢ is negation of zᵢ, i comprises 1, 2, 3, and 4, and z₁z₂z₃z₄ is any one of 0111, 1011, 1101, 1110, 1100, 0011, 1001, or 0000; or
the first bitmap is 0110 0000 z₁z₂z₃z₄ 0001, the first puncturing pattern is 1001 1111 z₁z₂z₃z₄ 1110 and the second puncturing pattern is a puncturing pattern corresponding to the 996-tone RU 1, wherein zᵢ is negation of zᵢ, i comprises 1, 2, 3, and 4, and z₁z₂z₃z₄ is any one of 0111, 1011, 1101, 1110, 1100, 0011, 1001, or 0000; or
the first bitmap is 0110 0000 1100 0000, the first puncturing pattern is 1001 1111 0011 1111 and the second puncturing pattern is a puncturing pattern corresponding to the 2*996+484-tone MRU 9; or
the first bitmap is 0110 0000 0011 0000, the first puncturing pattern is 1001 1111 1100 1111 and the second puncturing pattern is a puncturing pattern corresponding to the 2*996+484-tone MRU 10; or
the first bitmap is 0110 0000 1000 0000, the first puncturing pattern is 1001 1111 0111 1111 and the second puncturing pattern is a puncturing pattern corresponding to the 2*996+484-tone MRU 9; or
the first bitmap is 0110 0000 0100 0000, the first puncturing pattern is 1001 1111 1011 1111 and the second puncturing pattern is a puncturing pattern corresponding to the 2*996+484-tone MRU 9; or
the first bitmap is 0110 0000 0010 0000, the first puncturing pattern is 1001 1111 1101 1111 and the second puncturing pattern is a puncturing pattern corresponding to the 2*996+484-tone MRU 10; or
the first bitmap is 0110 0000 0001 0000, the first puncturing pattern is 1001 1111 1110 1111 and the second puncturing pattern is a puncturing pattern corresponding to the 2*996+484-tone MRU 10; or
the first bitmap is 0110 0000 0000 0011, the first puncturing pattern is 1001 1111 1111 0011 and the second puncturing pattern is a puncturing pattern corresponding to the 2*996+484-tone MRU 11; or
the first bitmap is 0110 0000 0000 1100, the first puncturing pattern is 1001 1111 1111 1100 and the second puncturing pattern is a puncturing pattern corresponding to the 2*996+484-tone MRU 12; or
the first bitmap is 0110 0000 0000 1000, the first puncturing pattern is 1001 1111 1111 0111 and the second puncturing pattern is a puncturing pattern corresponding to the 2*996+484-tone MRU 11; or
the first bitmap is 0110 0000 0000 0100, the first puncturing pattern is 1001 1111 1111 1011 and the second puncturing pattern is a puncturing pattern corresponding to the 2*996+484-tone MRU 11; or
the first bitmap is 0110 0000 0000 0010, the first puncturing pattern is 1001 1111 1111 1101 and the second puncturing pattern is a puncturing pattern corresponding to the 2*996+484-tone MRU 12; or
the first bitmap is 0110 0000 0000 0001, the first puncturing pattern is 1001 1111 1111 1110 and the second puncturing pattern is a puncturing pattern corresponding to the 2*996+484-tone MRU 12; or
the first bitmap is 0110 0000 0000 0000, the first puncturing pattern is 1001 1111 1111 1111 and the second puncturing pattern is a puncturing pattern corresponding to the 3*996-tone MRU 1; or
the first bitmap is 0011 0000 0110 k₁k₂k₃k₄, the first puncturing pattern is 1100 1111 1001 k₁k₂k₃k₄ and the second puncturing pattern is a puncturing pattern corresponding to the 996+484-tone MRU 2, wherein kᵢ is negation of kᵢ, i comprises 1, 2, 3, and 4, and k₁k₂k₃k₄ is any one of 0111, 1011, 1101, 1110, 1100, 0011, 1001, or 0000; or
the first bitmap is 0011 0000 0110 0000, the first puncturing pattern is 1100 1111 1001 1111 and the second puncturing pattern is a puncturing pattern corresponding to the 996+484-tone MRU 2; or
the first bitmap is 0011 0000 1100 k₁k₂k₃k₄, the first puncturing pattern is 1100 1111 0011 k₁k₂k₃k₄ and the second puncturing pattern is a puncturing pattern corresponding to the 996+484-tone MRU 2, wherein kᵢ is negation of kᵢ, i comprises 1, 2, 3, and 4, and k₁k₂k₃k₄ is any one of 0111, 1011, 1101, 1110, 1100, 0011, 1001, or 0000; or
the first bitmap is 0011 0000 0011 k₁k₂k₃k₄, the first puncturing pattern is 1100 1111 1100 k₁k₂k₃k₄ and the second puncturing pattern is a puncturing pattern corresponding to the 996+484-tone MRU 2, wherein kᵢ is negation of kᵢ, i comprises 1, 2, 3, and 4, and k₁k₂k₃k₄ is any one of 0111, 1011, 1101, 1110, 1100, 0011, 1001, or 0000; or
the first bitmap is 0011 0000 1000 k₁k₂k₃k₄, the first puncturing pattern is 1100 1111 0111 k₁k₂k₃k₄ and the second puncturing pattern is a puncturing pattern corresponding to the 996+484-tone MRU 2, wherein kᵢ is negation of kᵢ, i comprises 1, 2, 3, and 4, and k₁k₂k₃k₄ is any one of 0111, 1011, 1101, 1110, 1100, 0011, 1001, or 0000; or
the first bitmap is 0011 0000 0100 k₁k₂k₃k₄, the first puncturing pattern is 1100 1111 1101 k₁k₂k₃k₄ and the second puncturing pattern is a puncturing pattern corresponding to the 996+484-tone MRU 2, wherein kᵢ is negation of kᵢ, i comprises 1, 2, 3, and 4, and k₁k₂k₃k₄ is any one of 0111, 1011, 1101, 1110, 1100, 0011, 1001, or 0000; or
the first bitmap is 0011 0000 0010 k₁k₂k₃k₄, the first puncturing pattern is 1100 1111 1101 k₁k₂k₃k₄ and the second puncturing pattern is a puncturing pattern corresponding to the 996+484-tone MRU 2, wherein kᵢ is negation of kᵢ, i comprises 1, 2, 3, and 4, and k₁k₂k₃k₄ is any one of 0111, 1011, 1101, 1110, 1100, 0011, 1001, or 0000; or
the first bitmap is 0011 0000 0001 k₁k₂k₃k₄, the first puncturing pattern is 1100 1111 1110 k₁k₂k₃k₄ and the second puncturing pattern is a puncturing pattern corresponding to the 996+484-tone MRU 2, wherein kᵢ is negation of kᵢ, i comprises 1, 2, 3, and 4, and k₁k₂k₃k₄ is any one of 0111, 1011, 1101, 1110, 1100, 0011, 1001, or 0000; or
the first bitmap is 0011 0000 z₁z₂z₃z₄ 0110, the first puncturing pattern is 1100 1111 z₁z₂z₃z₄ 1001 and the second puncturing pattern is a puncturing pattern corresponding to the 996+484-tone MRU 2, wherein zᵢ is negation of zᵢ, i comprises 1, 2, 3, and 4, and z₁z₂z₃z₄ is any one of 0111, 1011, 1101, 1110, 1100, 0011, 1001, or 0000; or
the first bitmap is 0011 0000 z₁z₂z₃z₄ 1100, the first puncturing pattern is 1100 1111 z₁z₂z₃z₄ 0011 and the second puncturing pattern is a puncturing pattern corresponding to the 996+484-tone MRU 2, wherein zᵢ is negation of zᵢ, i comprises 1, 2, 3, and 4, and z₁z₂z₃z₄ is any one of 0111, 1011, 1101, 1110, 1100, 0011, 1001, or 0000; or
the first bitmap is 0011 0000 z₁z₂z₃z₄ 0011, the first puncturing pattern is 1100 1111 z₁z₂z₃z₄ 1100 and the second puncturing pattern is a puncturing pattern corresponding to the 996+484-tone MRU 2, wherein zᵢ is negation of zᵢ, i comprises 1, 2, 3, and 4, and z₁z₂z₃z₄ is any one of 0111, 1011, 1101, 1110, 1100, 0011, 1001, or 0000; or
the first bitmap is 0011 0000 z₁z₂z₃z₄ 1000, the first puncturing pattern is 1100 1111 z₁z₂z₃z₄ 0111 and the second puncturing pattern is a puncturing pattern corresponding to the 996+484-tone MRU 2, wherein zᵢ is negation of zᵢ, i comprises 1, 2, 3, and 4, and z₁z₂z₃z₄ is any one of 0111, 1011, 1101, 1110, 1100, 0011, 1001, or 0000; or
the first bitmap is 0011 0000 z₁z₂z₃z₄ 0100, the first puncturing pattern is 1100 1111 z₁z₂z₃z₄ 1011 and the second puncturing pattern is a puncturing pattern corresponding to the 996+484-tone MRU 2, wherein zᵢ is negation of zᵢ, i comprises 1, 2, 3, and 4, and z₁z₂z₃z₄ is any one of 0111, 1011, 1101, 1110, 1100, 0011, 1001, or 0000; or
the first bitmap is 0011 0000 z₁z₂z₃z₄ 0010, the first puncturing pattern is 1100 1111 z₁z₂z₃z₄ 1101 and the second puncturing pattern is a puncturing pattern corresponding to the 996+484-tone MRU 2, wherein zᵢ is negation of zᵢ, i comprises 1, 2, 3, and 4, and z₁z₂z₃z₄ is any one of 0111, 1011, 1101, 1110, 1100, 0011, 1001, or 0000; or
the first bitmap is 0011 0000 z₁z₂z₃z₄ 0001, the first puncturing pattern is 1100 1111 z₁z₂z₃z₄ 1110 and the second puncturing pattern is a puncturing pattern corresponding to the 996+484-tone MRU 2, wherein zᵢ is negation of zᵢ, i comprises 1, 2, 3, and 4, and z₁z₂z₃z₄ is any one of 0111, 1011, 1101, 1110, 1100, 0011, 1001, or 0000; or
the first bitmap is 1100 0000 0110 k₁k₂k₃k₄, the first puncturing pattern is 0011 1111 1001 k₁k₂k₃k₄ and the second puncturing pattern is a puncturing pattern corresponding to the 996+484-tone MRU 1, wherein kᵢ is negation of kᵢ, i comprises 1, 2, 3, and 4, and k₁k₂k₃k₄ is any one of 0111, 1011, 1101, 1110, 1100, 0011, 1001, or 0000; or
the first bitmap is 1100 0000 0110 0000, the first puncturing pattern is 0011 1111 1001 1111 and the second puncturing pattern is a puncturing pattern corresponding to the 996+484-tone MRU 1; or
the first bitmap is 1100 0000 1100 k₁k₂k₃k₄, the first puncturing pattern is 0011 1111 0011 k₁k₂k₃k₄ and the second puncturing pattern is a puncturing pattern corresponding to the 996+484-tone MRU 1, wherein kᵢ is negation of kᵢ, i comprises 1, 2, 3, and 4, and k₁k₂k₃k₄ is any one of 0111, 1011, 1101, 1110, 1100, 0011, 1001, or 0000; or
the first bitmap is 1100 0000 0011 k₁k₂k₃k₄, the first puncturing pattern is 0011 1111 1100 k₁k₂k₃k₄ and the second puncturing pattern is a puncturing pattern corresponding to the 996+484-tone MRU 1, wherein kᵢ is negation of kᵢ, i comprises 1, 2, 3, and 4, and k₁k₂k₃k₄ is any one of 0111, 1011, 1101, 1110, 1100, 0011, 1001, or 0000; or
the first bitmap is 1100 0000 1000 k₁k₂k₃k₄, the first puncturing pattern is 0011 1111 0111 k₁k₂k₃k₄ and the second puncturing pattern is a puncturing pattern corresponding to the 996+484-tone MRU 1, wherein kᵢ is negation of kᵢ, i comprises 1, 2, 3, and 4, and k₁k₂k₃k₄ is any one of 0111, 1011, 1101, 1110, 1100, 0011, 1001, or 0000; or
the first bitmap is 1100 0000 0100 k₁k₂k₃k₄, the first puncturing pattern is 0011 1111 1011 k₁k₂k₃k₄ and the second puncturing pattern is a puncturing pattern corresponding to the 996+484-tone MRU 1, wherein kᵢ is negation of kᵢ, i comprises 1, 2, 3, and 4, and k₁k₂k₃k₄ is any one of 0111, 1011, 1101, 1110, 1100, 0011, 1001, or 0000; or
the first bitmap is 1100 0000 0010 k₁k₂k₃k₄, the first puncturing pattern is 0011 1111 1101 k₁k₂k₃k₄ and the second puncturing pattern is a puncturing pattern corresponding to the 996+484-tone MRU 1, wherein kᵢ is negation of kᵢ, i comprises 1, 2, 3, and 4, and k₁k₂k₃k₄ is any one of 0111, 1011, 1101, 1110, 1100, 0011, 1001, or 0000; or
the first bitmap is 1100 0000 0001 k₁k₂k₃k₄, the first puncturing pattern is 0011 1111 1110 k₁k₂k₃k₄ and the second puncturing pattern is a puncturing pattern corresponding to the 996+484-tone MRU 1, wherein kᵢ is negation of kᵢ, i comprises 1, 2, 3, and 4, and k₁k₂k₃k₄ is any one of 0111, 1011, 1101, 1110, 1100, 0011, 1001, or 0000; or
the first bitmap is 1100 0000 z₁z₂z₃z₄ 0110, the first puncturing pattern is 0011 1111 z₁z₂z₃z₄ 1001 and the second puncturing pattern is a puncturing pattern corresponding to the 996+484-tone MRU 1, wherein zᵢ is negation of zᵢ, i comprises 1, 2, 3, and 4, and z₁z₂z₃z₄ is any one of 0111, 1011, 1101, 1110, 1100, 0011, 1001, or 0000; or
the first bitmap is 1100 0000 z₁z₂z₃z₄ 1100, the first puncturing pattern is 0011 1111 z₁z₂z₃z₄ 0011 and the second puncturing pattern is a puncturing pattern corresponding to the 996+484-tone MRU 1, wherein zᵢ is negation of zᵢ, i comprises 1, 2, 3, and 4, and z₁z₂z₃z₄ is any one of 0111, 1011, 1101, 1110, 1100, 0011, 1001, or 0000; or
the first bitmap is 1100 0000 z₁z₂z₃z₄ 0011, the first puncturing pattern is 0011 1111 z₁z₂z₃z₄ 1100 and the second puncturing pattern is a puncturing pattern corresponding to the 996+484-tone MRU 1, wherein zᵢ is negation of zᵢ, i comprises 1, 2, 3, and 4, and z₁z₂z₃z₄ is any one of 0111, 1011, 1101, 1110, 1100, 0011, 1001, or 0000; or
the first bitmap is 1100 0000 z₁z₂z₃z₄ 1000, the first puncturing pattern is 0011 1111 z₁z₂z₃z₄ 0111 and the second puncturing pattern is a puncturing pattern corresponding to the 996+484-tone MRU 1, wherein zᵢ is negation of zᵢ, i comprises 1, 2, 3, and 4, and z₁z₂z₃z₄ is any one of 0111, 1011, 1101, 1110, 1100, 0011, 1001, or 0000; or
the first bitmap is 1100 0000 z₁z₂z₃z₄ 0100, the first puncturing pattern is 0011 1111 z₁z₂z₃z₄ 1011 and the second puncturing pattern is a puncturing pattern corresponding to the 996+484-tone MRU 1, wherein zᵢ is negation of zᵢ, i comprises 1, 2, 3, and 4, and z₁z₂z₃z₄ is any one of 0111, 1011, 1101, 1110, 1100, 0011, 1001, or 0000; or
the first bitmap is 1100 0000 z₁z₂z₃z₄ 0010, the first puncturing pattern is 0011 1111 z₁z₂z₃z₄ 1101 and the second puncturing pattern is a puncturing pattern corresponding to the 996+484-tone MRU 1, wherein zᵢ is negation of zᵢ, i comprises 1, 2, 3, and 4, and z₁z₂z₃z₄ is any one of 0111, 1011, 1101, 1110, 1100, 0011, 1001, or 0000; or
the first bitmap is 1100 0000 z₁z₂z₃z₄ 0001, the first puncturing pattern is 0011 1111 z₁z₂z₃z₄ 1110 and the second puncturing pattern is a puncturing pattern corresponding to the 996+484-tone MRU 1, wherein zᵢ is negation of zᵢ, i comprises 1, 2, 3, and 4, and z₁z₂z₃z₄ is any one of 0111, 1011, 1101, 1110, 1100, 0011, 1001, or 0000; or
the first bitmap is 0011 0000 1100 0000, the first puncturing pattern is 1100 1111 0011 1111 and the second puncturing pattern is a puncturing pattern corresponding to the 2*996+484-tone MRU 9; or
the first bitmap is 0011 0000 0011 0000, the first puncturing pattern is 1100 1111 1100 1111 and the second puncturing pattern is a puncturing pattern corresponding to the 2*996+484-tone MRU 10; or
the first bitmap is 0011 0000 1000 0000, the first puncturing pattern is 1100 1111 0111 1111 and the second puncturing pattern is a puncturing pattern corresponding to the 2*996+484-tone MRU 9; or
the first bitmap is 0011 0000 0100 0000, the first puncturing pattern is 1100 1111 1011 1111 and the second puncturing pattern is a puncturing pattern corresponding to the 2*996+484-tone MRU 9; or
the first bitmap is 0011 0000 0010 0000, the first puncturing pattern is 1100 1111 1101 1111 and the second puncturing pattern is a puncturing pattern corresponding to the 2*996+484-tone MRU 10; or
the first bitmap is 0011 0000 0001 0000, the first puncturing pattern is 1100 1111 1110 1111 and the second puncturing pattern is a puncturing pattern corresponding to the 2*996+484-tone MRU 10; or
the first bitmap is 0011 0000 0000 k₁k₂k₃k₄, the first puncturing pattern is 1100 1111 1111 k₁k₂k₃k₄, wherein k₁ is negation of kᵢ, and i comprises 1, 2, 3, and 4, and wherein at least one of:
k₁k₂k₃k₄ is any one of 0111, 1011, 1101, 1110, 1100, 0011, 1001 or 0000, the second puncturing pattern is the 2*996+484-tone MRU 2; or
k₁k₂k₃k₄ is any one of 0111, 1011, or 0011, the second puncturing pattern is the 2*996+484-tone MRU 11; or
k₁k₂k₃k₄ is any one of 1101, 1110, or 1100, the second puncturing pattern is the 2*996+484-tone MRU 12; or
the first bitmap is 1100 0000 1100 0000, the first puncturing pattern is 0011 1111 0011 1111 and the second puncturing pattern is a puncturing pattern corresponding to the 2*996+484-tone MRU 9; or
the first bitmap is 1100 0000 0011 0000, the first puncturing pattern is 0011 1111 1100 1111 and the second puncturing pattern is a puncturing pattern corresponding to the 2*996+484-tone MRU 10; or
the first bitmap is 1100 0000 1000 0000, the first puncturing pattern is 0011 1111 0111 1111 and the second puncturing pattern is a puncturing pattern corresponding to the 2*996+484-tone MRU 9; or
the first bitmap is 1100 0000 0100 0000, the first puncturing pattern is 0011 1111 1011 1111 and the second puncturing pattern is a puncturing pattern corresponding to the 2*996+484-tone MRU 9; or
the first bitmap is 1100 0000 0010 0000, the first puncturing pattern is 0011 1111 1101 1111 and the second puncturing pattern is a puncturing pattern corresponding to the 2*996+484-tone MRU 10; or
the first bitmap is 1100 0000 0001 0000, the first puncturing pattern is 0011 1111 1110 1111 and the second puncturing pattern is a puncturing pattern corresponding to the 2*996+484-tone MRU 10; or
the first bitmap is 1100 0000 0000 k₁k₂k₃k₄, the first puncturing pattern is 0011 1111 1111 k₁k₂k₃k₄, wherein kᵢ is negation of kᵢ, and i comprises 1, 2, 3, and 4, and wherein at least one of:
k₁k₂k₃k₄ is any one of 0111, 1011, 1101, 1110, 1100, 0011, 1001 or 0000, the second puncturing pattern is the 2*996+484-tone MRU 1; or
k₁k₂k₃k₄ is any one of 0111, 1011, or 0011, the second puncturing pattern is the 2*996+484-tone MRU 11; or
k₁k₂k₃k₄ is any one of 1101, 1110, or 1100, the second puncturing pattern is the 2*996+484-tone MRU 12; or
wherein at least one of:
the first bitmap is 0001 0 000 Z₁Z₂Z₃Z₄ K₁K₂K₂K₄, the first puncturing pattern is 1110 1111 Z₁Z₂Z₃Z₄ K₁K₂K₃K₄ and the second puncturing pattern is a puncturing pattern corresponding to the 996+484+242-tone MRU 4; or
the first bitmap is 0010 0000 Z₁Z₂Z₃Z₄ K₁K₂K₂K₄, the first puncturing pattern is 1101 1111 Z₁Z₂Z₃Z₄ K₁K₂K₃K₄ and the second puncturing pattern is a puncturing pattern corresponding to the 996+484+242-tone MRU 3; or
the first bitmap is 0100 000 0 Z₁Z₂Z₃Z₄ K₁K₂K₂K₄, the first puncturing pattern is 1011 1111 Z₁Z₂Z₃Z₄ K₁K₂K₃K₄ and the second puncturing pattern is a puncturing pattern corresponding to the 996+484+242-tone MRU 2; or
the first bitmap is 1000 0000 Z₁Z₂Z₃Z₄ K₁K₂K₂K₄, the first puncturing pattern is 0111 1111 Z₁Z₂Z₃Z₄ K₁K₂K₃K₄ and the second puncturing pattern is a puncturing pattern corresponding to the 996+484+242-tone MRU 1;
wherein at least one of:
Z₁Z₂Z₃Z₄ and K₁K₂K₂K₄ are 0110 and k₁k₂k₂k₄ respectively, Z₁Z₂Z₃Z₄ and K₁K₂K₃K₄ are 1001 and k₁k₂k₃k₄ respectively; or
Z₁Z₂Z₃Z₄ and K₁K₂K₂K₄ are 0110 and 0000 respectively, Z₁Z₂Z₃Z₄ and K₁K₂K₃K₄ are 1001 and 1111 respectively; or
Z₁Z₂Z₃Z₄ and K₁K₂K₂K₄ are 1100 and k₁k₂k₃k₄ respectively, Z₁Z₂Z₃Z₄ and K₁K₂K₃K₄ are 0011 and k₁k₂k₃k₄ respectively; or
Z₁Z₂Z₃Z₄ and K₁K₂K₂K₄ are 0011 and k₁k₂k₃k₄ respectively, Z₁Z₂Z₃Z₄ and K₁K₂K₃K₄ are 1100 and k₁k₂k₃k₄ respectively; or
Z₁Z₂Z₃Z₄ and K₁K₂K₂K₄ are 1000 and k₁k₂k₃k₄ respectively, Z₁Z₂Z₃Z₄ and K₁K₂K₃K₄ are 0111 and k₁k₂k₃k₄ respectively; or
Z₁Z₂Z₃Z₄ and K₁K₂K₂K₄ are 0100 and k₁k₂k₃k₄ respectively, Z₁Z₂Z₃Z₄ and K₁K₂K₃K₄ are 1011 and k₁k₂k₃k₄ respectively; or
Z₁Z₂Z₃Z₄ and K₁K₂K₂K₄ are 0010 and k₁k₂k₃k₄ respectively, Z₁Z₂Z₃Z₄ and K₁K₂K₃K₄ are 1101 and k₁k₂k₃k₄ respectively; or
Z₁Z₂Z₃Z₄ and K₁K₂K₂K₄ are 0001 and k₁k₂k₃k₄ respectively, Z₁Z₂Z₃Z₄ and K₁K₂K₃K₄ are 1110 and k₁k₂k₃k₄ respectively; or
Z₁Z₂Z₃Z₄ and K₁K₂K₂K₄ are z₁z₂z₃z₄ and 0110 respectively, Z₁Z₂Z₃Z₄ and K₁K₂K₃K₄ are z₁z₂z₃z₄ and 1001 respectively; or
Z₁Z₂Z₃Z₄ and K₁K₂K₂K₄ are z₁z₂z₃z₄ and 1100 respectively, Z₁Z₂Z₃Z₄ and K₁K₂K₃K₄ are z₁z₂z₃z₄ and 0011 respectively; or
Z₁Z₂Z₃Z₄ and K₁K₂K₂K₄ are z₁z₂z₃z₄ and 0011 respectively, Z₁Z₂Z₃Z₄ and K₁K₂K₃K₄ are z₁z₂z₃z₄ and 1100 respectively; or
Z₁Z₂Z₃Z₄ and K₁K₂K₂K₄ are z₁z₂z₃z₄ and 1000 respectively, Z₁Z₂Z₃Z₄ and K₁K₂K₃K₄ are z₁z₂z₃z₄ and 0111 respectively; or
z₁z₂z₂z₄ and K₁K₂K₂K₄ are z₁z₂z₃z₄ and 0100 respectively, Z₁Z₂Z₃Z₄ and K₁K₂K₃K₄ are z₁z₂z₃z₄ and 1011 respectively; or
z₁z₂z₂z₄ and K₁K₂K₂K₄ are z₁z₂z₃z₄ and 0010 respectively, Z₁Z₂Z₃Z₄ and K₁K₂K₃K₄ are z₁z₂z₃z₄ and 1101 respectively; or
Z₁Z₂Z₃Z₄ and K₁K₂K₂K₄ are z₁z₂z₃z₄ and 0001 respectively, Z₁Z₂Z₃Z₄ and K₁K₂K₃K₄ are z₁z₂z₃z₄ and 1110 respectively; and
wherein kᵢ is negation of kᵢ, zᵢ is negation of zᵢ, i comprises 1, 2, 3, and 4, k₁k₂k₃k₄ is any one of 0111, 1011, 1101, 1110, 1100, 0011, 1001 or 0000, and z₁z₂z₃z₄ is any one of 0111, 1011, 1101, 1110, 1100, 0011, 1001 or 0000; or
the first bitmap is 0001 0000 Z₁Z₂Z₃Z₄ K₁K₂K₂K₄, the first puncturing pattern is 1110 1111 Z₁Z₂Z₃Z₄ K₁K₂K₃K₄, wherein at least one of:
Z₁Z₂Z₃Z₄ and K₁K₂K₂K₄ are respectively 1100 and 0000, Z₁Z₂Z₃Z₄ and K₁K₂K₃K₄ are respectively 0011 and 1111, and the second puncturing pattern is a puncturing pattern corresponding to the 2*996+484-tone MRU 9; or
Z₁Z₂Z₃Z₄ and K₁K₂K₂K₄ are respectively 0011 and 0000, Z₁Z₂Z₃Z₄ and K₁K₂K₃K₄ are respectively 1100 and 1111, and the second puncturing pattern is a puncturing pattern corresponding to the 2*996+484-tone MRU 10; or
Z₁Z₂Z₃Z₄ and K₁K₂K₂K₄ are respectively 1000 and 0000, Z₁Z₂Z₃Z₄ and K₁K₂K₃K₄ are respectively 0111 and 1111, and the second puncturing pattern is a puncturing pattern corresponding to the 2*996+484-tone MRU 9; or
Z₁Z₂Z₃Z₄ and K₁K₂K₂K₄ are respectively 0100 and 0000, Z₁Z₂Z₃Z₄ and K₁K₂K₃K₄ are respectively 1011 and 1111, and the second puncturing pattern is a puncturing pattern corresponding to the 2*996+484-tone MRU 9; or
Z₁Z₂Z₃Z₄ and K₁K₂K₂K₄ are respectively 0010 and 0000, Z₁Z₂Z₃Z₄ and K₁K₂K₃K₄ are respectively 1101 and 1111, and the second puncturing pattern is a puncturing pattern corresponding to the 2*996+484-tone MRU 10; or
Z₁Z₂Z₃Z₄ and K₁K₂K₂K₄ are respectively 0001 and 0000, Z₁Z₂Z₃Z₄ and K₁K₂K₃K₄ are respectively 1110 and 1111, and the second puncturing pattern is a puncturing pattern corresponding to the 2*996+484-tone MRU 10; or
Z₁Z₂Z₃Z₄ and K₁K₂K₂K₄ are respectively 0000 and k₁k₂k₃k₄, Z₁Z₂Z₃Z₄ and K₁K₂K₃K₄ are respectively 1111 and k₁k₂k₃k₄, and the second puncturing pattern is a puncturing pattern corresponding to the 2*996+484-tone MRU 2, wherein kᵢ is negation of kᵢ, i comprises 1, 2, 3, and 4, and k₁k₂k₃k₄ is any one of 0111, 1011, 1101, 1110, 1100, 0011, 1001 or 0000; or
the first bitmap is 0010 0000 Z₁Z₂Z₃Z₄ and K₁K₂K₂K₄, the first puncturing pattern is 1101 1111 Z₁Z₂Z₃Z₄ K₁K₂K₃K₄, wherein at least one of:
Z₁Z₂Z₃Z₄ and K₁K₂K₂K₄ are respectively 1100 and 0000, Z₁Z₂Z₃Z₄ and K₁K₂K₃K₄ are respectively 0011 and 1111, and the second puncturing pattern is a puncturing pattern corresponding to the 2*996+484-tone MRU 9; or
Z₁Z₂Z₃Z₄ and K₁K₂K₂K₄ are respectively 0011 and 0000, Z₁Z₂Z₃Z₄ and K₁K₂K₃K₄ are respectively 1100 and 1111, and the second puncturing pattern is a puncturing pattern corresponding to the 2*996+484-tone MRU 10; or
Z₁Z₂Z₃Z₄ and K₁K₂K₂K₄ are respectively 1000 and 0000, Z₁Z₂Z₃Z₄ and K₁K₂K₃K₄ are respectively 0111 and 1111, and the second puncturing pattern is a puncturing pattern corresponding to the 2*996+484-tone MRU 9; or
Z₁Z₂Z₃Z₄ and K₁K₂K₂K₄ are respectively 0100 and 0000, Z₁Z₂Z₃Z₄ and K₁K₂K₃K₄ are respectively 1011 and 1111, and the second puncturing pattern is a puncturing pattern corresponding to the 2*996+484-tone MRU 9; or
Z₁Z₂Z₃Z₄ and K₁K₂K₂K₄ are respectively 0010 and 0000, Z₁Z₂Z₃Z₄ and K₁K₂K₃K₄ are respectively 1101 and 1111, and the second puncturing pattern is a puncturing pattern corresponding to the 2*996+484-tone MRU 10; or
Z₁Z₂Z₃Z₄ and K₁K₂K₂K₄ are respectively 0001 and 0000, Z₁Z₂Z₃Z₄ and K₁K₂K₃K₄ are respectively 1110 and 1111, and the second puncturing pattern is a puncturing pattern corresponding to the 2*996+484-tone MRU 10; or
Z₁Z₂Z₃Z₄ and K₁K₂K₂K₄ are respectively 0000 and k₁k₂k₃k₄, Z₁Z₂Z₃Z₄ and K₁K₂K₃K₄ are respectively 1111 and k₁k₂k₃k₄, and the second puncturing pattern is a puncturing pattern corresponding to the 2*996+484-tone MRU 2, wherein kᵢ is negation of kᵢ, i comprises 1, 2, 3, and 4, and k₁k₂k₃k₄ is any one of 0111, 1011, 1101, 1110, 1100, 0011, 1001 or 0000; or
the first bitmap is 0100 0000 Z₁Z₂Z₃Z₄ and K₁K₂K₂K₄, the first puncturing pattern is 1011 1111 Z₁Z₂Z₃Z₄ K₁K₂K₃K₄, wherein at least one of:
Z₁Z₂Z₃Z₄ and K₁K₂K₂K₄ are respectively 1100 and 0000, Z₁Z₂Z₃Z₄ and K₁K₂K₃K₄ are respectively 0011 and 1111, and the second puncturing pattern is a puncturing pattern corresponding to the 2*996+484-tone MRU 9; or
Z₁Z₂Z₃Z₄ and K₁K₂K₂K₄ are respectively 0011 and 0000, Z₁Z₂Z₃Z₄ and K₁K₂K₃K₄ are respectively 1100 and 1111, and the second puncturing pattern is a puncturing pattern corresponding to the 2*996+484-tone MRU 10; or
Z₁Z₂Z₃Z₄ and K₁K₂K₂K₄ are respectively 1000 and 0000, z₁z₂z₃z₄ and K₁K₂K₃K₄ are respectively 0111 and 1111, and the second puncturing pattern is a puncturing pattern corresponding to the 2*996+484-tone MRU 9; or
Z₁Z₂Z₃Z₄ and K₁K₂K₂K₄ are respectively 0100 and 0000, Z₁Z₂Z₃Z₄ and K₁K₂K₃K₄ are respectively 1011 and 1111, and the second puncturing pattern is a puncturing pattern corresponding to the 2*996+484-tone MRU 9; or
Z₁Z₂Z₃Z₄ and K₁K₂K₂K₄ are respectively 0010 and 0000, Z₁Z₂Z₃Z₄ and K₁K₂K₃K₄ are respectively 1101 and 1111, and the second puncturing pattern is a puncturing pattern corresponding to the 2*996+484-tone MRU 10; or
Z₁Z₂Z₃Z₄ and K₁K₂K₂K₄ are respectively 0001 and 0000, Z₁Z₂Z₃Z₄ and K₁K₂K₃K₄ are respectively 1110 and 1111, and the second puncturing pattern is a puncturing pattern corresponding to the 2*996+484-tone MRU 10; or
Z₁Z₂Z₃Z₄ and K₁K₂K₂K₄ are respectively 0000 and k₁k₂k₃k₄, Z₁Z₂Z₃Z₄ and K₁K₂K₃K₄ are respectively 1111 and k₁k₂k₃k₄, and the second puncturing pattern is a puncturing pattern corresponding to the 2*996+484-tone MRU 1, wherein kᵢ is negation of kᵢ, i comprises 1, 2, 3, and 4, and k₁k₂k₃k₄ is any one of 0111, 1011, 1101, 1110, 1100, 0011, 1001 or 0000; or
the first bitmap is 1000 0000 Z₁Z₂Z₃Z₄ K₁K₂K₂K₄, the first puncturing pattern is 0111 1111 Z₁Z₂Z₃Z₄ K₁K₂K₃K₄, wherein at least one of:
Z₁Z₂Z₃Z₄ and K₁K₂K₂K₄ are respectively 1100 and 0000, Z₁Z₂Z₃Z₄ and K₁K₂K₃K₄ are respectively 0011 and 1111, and the second puncturing pattern is a puncturing pattern corresponding to the 2*996+484-tone MRU 9; or
Z₁Z₂Z₃Z₄ and K₁K₂K₂K₄ are respectively 0011 and 0000, Z₁Z₂Z₃Z₄ and K₁K₂K₃K₄ are respectively 1100 and 1111, and the second puncturing pattern is a puncturing pattern corresponding to the 2*996+484-tone MRU 10; or
Z₁Z₂Z₃Z₄ and K₁K₂K₂K₄ are respectively 1000 and 0000, Z₁Z₂Z₃Z₄ and K₁K₂K₃K₄ are respectively 0111 and 1111, and the second puncturing pattern is a puncturing pattern corresponding to the 2*996+484-tone MRU 9; or
Z₁Z₂Z₃Z₄ and K₁K₂K₂K₄ are respectively 0100 and 0000, Z₁Z₂Z₃Z₄ and K₁K₂K₃K₄ are respectively 1011 and 1111, and the second puncturing pattern is a puncturing pattern corresponding to the 2*996+484-tone MRU 9; or
Z₁Z₂Z₃Z₄ and K₁K₂K₂K₄ are respectively 0010 and 0000, Z₁Z₂Z₃Z₄ and K₁K₂K₃K₄ are respectively 1101 and 1111, and the second puncturing pattern is a puncturing pattern corresponding to the 2*996+484-tone MRU 10; or
Z₁Z₂Z₃Z₄ and K₁K₂K₂K₄ are respectively 0001 and 0000, z₁z₂z₃z₄ and K₁K₂K₃K₄ are respectively 1110 and 1111, and the second puncturing pattern is a puncturing pattern corresponding to the 2*996+484-tone MRU 10; or
Z₁Z₂Z₃Z₄ and K₁K₂K₂K₄ are respectively 0000 and k₁k₂k₃k₄, Z₁Z₂Z₃Z₄ and K₁K₂K₃K₄ are respectively 1111 and k₁k₂k₃k₄, and the second puncturing pattern is a puncturing pattern corresponding to the 2*996+484-tone MRU 1, wherein kᵢ is negation of kᵢ, i comprises 1, 2, 3, and 4, and k₁k₂k₃k₄ is any one of 0111, 1011, 1101, 1110, 1100, 0011, 1001 or 0000; or
the first bitmap is 0001 0000 0000 0000, the first puncturing pattern is 1110 1111 1111 1111 and the second puncturing pattern is a puncturing pattern corresponding to the 3*996+484-tone MRU 2; or
the first bitmap is 0010 0000 0000 0000, the first puncturing pattern is 1101 1111 1111 1111 and the second puncturing pattern is a puncturing pattern corresponding to the 3*996+484-tone MRU 2; or
the first bitmap is 0100 0000 0000 0000, the first puncturing pattern is 10 1111 1111 1111 and the second puncturing pattern is a puncturing pattern corresponding to the 3*996+484-tone MRU 1; or
the first bitmap is 0100 0000 0000 0000, the first puncturing pattern is 0111 1111 1111 1111 and the second puncturing pattern is a puncturing pattern corresponding to the 3*996+484-tone MRU 1; or
the first bitmap is 0000 0000 0110 k₁k₂k₃k₄, the first puncturing pattern is 1111 1111 1001 k₁k₂k₃k₄ and the second puncturing pattern is a puncturing pattern corresponding to the 2*996-tone RU 1, wherein kᵢ is negation of kᵢ, i comprises 1, 2, 3, and 4, and k₁k₂k₃k₄ is any one of 0111, 1011, 1101, 1110, 1100, 0011, 1001, or 0000; or
the first bitmap is 0000 0000 0011 k₁k₂k₃k₄, the first puncturing pattern is 1111 1111 1100 k₁k₂k₃k₄ and the second puncturing pattern is a puncturing pattern corresponding to the 2*996+484-tone MRU 6, wherein kᵢ is negation of kᵢ, i comprises 1, 2, 3, and 4, and k₁k₂k₃k₄ is any one of 0111, 1011, 1101, 1110, 1100, 0011, 1001, or 0000; or
the first bitmap is 0000 0000 1100 k₁k₂k₃k₄, the first puncturing pattern is 1111 1111 0011 k₁k₂k₃k₄ and the second puncturing pattern is a puncturing pattern corresponding to the 2*996+484-tone MRU 5, wherein h; is negation of kᵢ, i comprises 1, 2, 3, and 4, and k₁k₂k₃k₄ is any one of 0111, 1011, 1101, 1110, 1100, 0011, 1001, or 0000; or
the first bitmap is 0000 0000 0001 k₁, the first puncturing pattern is 1111 1111 1110 k₁k₂k₃k₄ and the second puncturing pattern is a puncturing pattern corresponding to the 2*996+484-tone MRU 6, wherein h; is negation of kᵢ, i comprises 1, 2, 3, and 4, and k₁k₂k₃k₄ is any one of 0111, 1011, 1101, 1110, 1100, 0011, 1001, or 0000; or
the first bitmap is 0000 0000 0010 k₁k₂k₃k₄, the first puncturing pattern is 1111 1111 1101 k₁k₂k₃k₄ and the second puncturing pattern is a puncturing pattern corresponding to the 2*996+484-tone MRU 6, wherein kᵢ is negation of kᵢ, i comprises 1, 2, 3, and 4, and k₁k₂k₃k₄ is any one of 0111, 1011, 1101, 1110, 1100, 0011, 1001, or 0000; or
the first bitmap is 0000 0000 0100 k₁k₂k₃k₄, the first puncturing pattern is 1111 1111 1011 k₁k₂k₃k₄ and the second puncturing pattern is a puncturing pattern corresponding to the 2*996+484-tone MRU 5, wherein kᵢ is negation of kᵢ, i comprises 1, 2, 3, and 4, and k₁k₂k₃k₄ is any one of 0111, 1011, 1101, 1110, 1100, 0011, 1001, or 0000; or
the first bitmap is 0000 0000 1000 k₁k₂k₃k₄, the first puncturing pattern is 1111 1111 0111 k₁k₂k₃k₄ and the second puncturing pattern is a puncturing pattern corresponding to the 2*996+484-tone MRU 5, wherein kᵢ h is negation of kᵢ, i comprises 1, 2, 3, and 4, and k₁k₂k₃k₄ is any one of 0111, 1011, 1101, 1110, 1100, 0011, 1001, or 0000; or
the first bitmap is 0000 0000 0001 0000, the first puncturing pattern is 1111 1111 1110 1111 and the second puncturing pattern is a puncturing pattern corresponding to the 3*996+484-tone MRU 6; or
the first bitmap is 0000 0000 0010 0000, the first puncturing pattern is 1111 1111 1101 1111 and the second puncturing pattern is a puncturing pattern corresponding to the 3*996+484-tone MRU 6; or
the first bitmap is 0000 0000 0100 0000, the first puncturing pattern is 1111 1111 1011 1111 and the second puncturing pattern is a puncturing pattern corresponding to the 3*996+484-tone MRU 5; or
the first bitmap is 0000 0000 1000 0000, the first puncturing pattern is 1111 1111 0111 1111 and the second puncturing pattern is a puncturing pattern corresponding to the 3*996+484-tone MRU 5; or
the first bitmap is 0000 0000 0000 0110, the first puncturing pattern is 1111 1111 1111 1001 and the second puncturing pattern is a puncturing pattern corresponding to the 3*996-tone MRU 4; or
the first bitmap is 0000 0000 0000 0001, the first puncturing pattern is 1111 1111 1111 1110 and the second puncturing pattern is a puncturing pattern corresponding to the 3*996+484-tone MRU 8; or
the first bitmap is 0000 0000 0000 0010, the first puncturing pattern is 1111 1111 1111 1101 and the second puncturing pattern is a puncturing pattern corresponding to the 3*996+484-tone MRU 8; or
the first bitmap is 0000 0000 0000 0100, the first puncturing pattern is 1111 1111 1111 1011 and the second puncturing pattern is a puncturing pattern corresponding to the 3*996+484-tone MRU 7; or
the first bitmap is 0000 0000 0000 1000, the first puncturing pattern is 1111 1111 1111 0111 and the second puncturing pattern is a puncturing pattern corresponding to the 3*996+484-tone MRU 7.

11. The method according to claim 1, wherein the PPDU comprises at least one of an extremely high throughput multiple-user physical layer protocol data unit (EHT MU PPDU) and a non-high throughput duplicate physical layer protocol data unit (non-HT duplicate PPDU).

12. A communication method, comprising:
receiving, by a second device, a management frame, wherein the management frame comprises a first bitmap, and wherein a first puncturing pattern indicated by the first bitmap is a puncturing pattern unsupported by non-orthogonal frequency division multiple access (non-OFDMA) transmission; and
receiving, by the second device, a physical layer protocol data unit (PPDU), wherein transmission of the PPDU is performed using a second puncturing pattern corresponding to the first bitmap, and wherein the second puncturing pattern is a puncturing pattern supported by the non-OFDMA transmission.

13. The method according to claim 12, wherein the management frame further comprises a first bandwidth field, wherein the first bandwidth field indicates a first basic service set (BSS) bandwidth, and wherein the first bitmap is a bitmap corresponding to the first BSS bandwidth.

14. The method according to claim 12, wherein the first puncturing pattern is a puncturing pattern supported by orthogonal frequency division multiple access (OFDMA) transmission.

15. The method according to claim 12, wherein
the second puncturing pattern comprises a puncturing pattern corresponding a resource unit index that is a 242-tone RU 1, 484-tone RU 1, 484+242-tone MRU 1, 484+242-tone MRU 2, 484+242-tone MRU 3, 484+242-tone MRU 4, 996-tone RU 1, 996+484+242-tone MRU 1, 996+484+242-tone MRU 2, 996+484+242-tone MRU 3, 996+484+242-tone MRU 4, 996+484+242-tone MRU 5, 996+484+242-tone MRU 6, 996+484+242-tone MRU 7, 996+484+242-tone MRU 8, 996+484-tone MRU 1, 996+484-tone MRU 2, 996+484-tone MRU 3, 996+484-tone MRU 4, 2*996-tone RU 1, 2*996+484-tone MRU 1, 2*996+484-tone MRU 2, 2*996+484-tone MRU 3, 2*996+484-tone MRU 4, 2*996+484-tone MRU 5, 2*996+484-tone MRU 6, 2*996+484-tone MRU 7, 2*996+484-tone MRU 8, 2*996+484-tone MRU 9, 2*996+484-tone MRU 10, 2*996+484-tone MRU 11, 2*996+484-tone MRU 12, 3*996-tone MRU 1, 3*996-tone MRU 2, 3*996-tone MRU 3, 3*996-tone MRU 4, 3*996+484-tone MRU 1, 3*996+484-tone MRU 2, 3*996+484-tone MRU 3, 3*996+484-tone MRU 4, 3*996+484-tone MRU 5, 3*996+484-tone MRU 6, 3*996+484-tone MRU 7, 3*996+484-tone MRU 8, or 4*996-tone RU 1.

16. The method according to claim 15, wherein the first BSS bandwidth is 160 MHz, and the first BSS bandwidth is divided into a primary 80 MHz channel and a secondary 80 MHz channel in ascending order of frequencies in sequence; and
wherein at least one of:
the first bitmap is 0110 y₁y₂y₃y₄ 1111 1111, the first puncturing pattern is 1001 y₁y₂y₃y₄ and the second puncturing pattern is a puncturing pattern corresponding to the 242-tone RU 1, wherein yᵢ is negation of yᵢ, i comprises 1, 2, 3, and 4, and y₁y₂y₃y₄ is any one of 1111, 0111, 1011, 1101, 1110, 1100, 0011, or 1001; or
the first bitmap is 0011 y₁y₂y₃y₄ 1111 1111, the first puncturing pattern is 1100 y₁y₂y₃y₄ and the second puncturing pattern is a puncturing pattern corresponding to the 484-tone RU 1, wherein yᵢ is negation of yᵢ, i comprises 1, 2, 3, and 4, and y₁y₂y₃y₄ is any one of 0111, 1011, 1101, 1110, 1100, 0011, or 1001; or
the first bitmap is 1100 y₁y₂y₃y₄ 1111 1111, the first puncturing pattern is 0011 y₁y₂y₃y₄ and the second puncturing pattern is a puncturing pattern corresponding to the 484-tone RU 1, wherein yᵢ is negation of yᵢ, i comprises 1, 2, 3, and 4, and y₁y₂y₃y₄ is any one of 0111, 1011, 1101, 1110, 1100, 0011, or 1001; or
the first bitmap is 0001 y₁y₂y₃y₄ 1111 1111, the first puncturing pattern is 1110 y₁y₂y₃y₄ and the second puncturing pattern is a puncturing pattern corresponding to the 484+242-tone MRU 4, wherein yᵢ is negation of yᵢ, i comprises 1, 2, 3, and 4, and y₁y₂y₃y₄ is any one of 0111, 1011, 1101, 1110, 1100, 0011, or 1001; or
the first bitmap is 0100 y₁y₂y₃y₄ 1111 1111, the first puncturing pattern is 1011 y₁y₂y₃y₄ and the second puncturing pattern is a puncturing pattern corresponding to the 484+242-tone MRU 2, wherein yᵢ is negation of yᵢ, i comprises 1, 2, 3, and 4, and y₁y₂y₃y₄ is any one of 0111, 1011, 1101, 1110, 1100, 0011, or 1001; or
the first bitmap is 0010 y₁y₂y₃y₄ 1111 1111, the first puncturing pattern is 1101 y₁y₂y₃y₄ and the second puncturing pattern is a puncturing pattern corresponding to the 484+242-tone MRU 3, wherein yᵢ is negation of yᵢ, i comprises 1, 2, 3, and 4, and y₁y₂y₃y₄ is any one of 0111, 1011, 1101, 1110, 1100, 0011, or 1001; or
the first bitmap is 1 000 y₁y₂y₃y₄ 1111 1111, the first puncturing pattern is 0111 y₁y₂y₃y₄ and the second puncturing pattern is a puncturing pattern corresponding to the 484+242-tone MRU 1, wherein yᵢ is negation of yᵢ, i comprises 1, 2, 3, and 4, and y₁y₂y₃y₄ is any one of 0111, 1011, 1101, 1110, 1100, 0011, or 1001; or
the first bitmap is 0000 0110 1111 1111, the first puncturing pattern is 1111 1001 and the second puncturing pattern is a puncturing pattern corresponding to the 996-tone RU 1.

17. The method according to claim 15, wherein if the first BSS bandwidth is 160 MHz, and the first BSS bandwidth is divided into a secondary 80 MHz channel and a primary 80 MHz channel in ascending order of frequencies in sequence; and
wherein at least one of
the first bitmap is y₁y₂y₃y₄ 0110 1111 1111, the first puncturing pattern is y₁y₂y₃y₄ 1001 and the second puncturing pattern is a puncturing pattern corresponding to the 242-tone RU 1, wherein yᵢ is negation of yᵢ, i comprises 1, 2, 3, and 4, and y₁y₂y₃y₄ is any one of 1111, 0111, 1011, 1101, 1110, 1100, 0011, or 1001; or
the first bitmap is y₁y₂y₃y₄ 0011 1111 1111, the first puncturing pattern is y₁y₂y₃y₄ 1100 and the second puncturing pattern is a puncturing pattern corresponding to the 484-tone RU 1, wherein yᵢ is negation of yᵢ, i comprises 1, 2, 3, and 4, and y₁y₂y₃y₄ is any one of 0111, 1011, 1101, 1110, 1100, 0011, or 1001; or
the first bitmap is y₁y₂y₃y₄ 1100 1111 1111, the first puncturing pattern is y₁y₂y₃y₄ 0011 and the second puncturing pattern is a puncturing pattern corresponding to the 484-tone RU 1, wherein yᵢ is negation of yᵢ, i comprises 1, 2, 3, and 4, and y₁y₂y₃y₄ is any one of 0111, 1011, 1101, 1110, 1100, 0011, or 1001; or
the first bitmap is y₁y₂y₃y₄ 0001 1111 1111, the first puncturing pattern is y₁y₂y₃y₄ 1110 and the second puncturing pattern is a puncturing pattern corresponding to the 484+242-tone MRU 4, wherein yᵢ is negation of yᵢ, i comprises 1, 2, 3, and 4, and y₁y₂y₃y₄ is any one of 0111, 1011, 1101, 1110, 1100, 0011, or 1001; or
the first bitmap is y₁y₂y₃y₄ 0100 1111 1111, the first puncturing pattern is y₁y₂y₃y₄ 1011 and the second puncturing pattern is a puncturing pattern corresponding to the 484+242-tone MRU 2, wherein yᵢ is negation of yᵢ, i comprises 1, 2, 3, and 4, and y₁y₂y₃y₄ is any one of 0111, 1011, 1101, 1110, 1100, 0011, or 1001; or
the first bitmap is y₁y₂y₃y₄ 0010 1111 1111, the first puncturing pattern is y₁y₂y₃y₄ 1101 and the second puncturing pattern is a puncturing pattern corresponding to the 484+242-tone MRU 3, wherein yᵢ is negation of yᵢ, i comprises 1, 2, 3, and 4, and y₁y₂y₃y₄ is any one of 0111, 1011, 1101, 1110, 1100, 0011, or 1001; or
the first bitmap is y₁y₂y₃y₄ 1000 1111 1111, the first puncturing pattern is y₁y₂y₃y₄ 0111 and the second puncturing pattern is a puncturing pattern corresponding to the 484+242-tone MRU 1, wherein yᵢ is negation of yᵢ, i comprises 1, 2, 3, and 4, and y₁y₂y₃y₄ is any one of 0111, 1011, 1101, 1110, 1100, 0011, or 1001; or
the first bitmap is 0110 0000 1111 1111, the first puncturing pattern is 1001 1111 and the second puncturing pattern is a puncturing pattern corresponding to the 996-tone RU 1.

18. The method according to claim 15, wherein the first BSS bandwidth is 320 MHz, and the first BSS bandwidth is divided into a primary 80 MHz channel, a secondary 80 MHz channel, and a secondary 160 MHz channel in ascending order of frequencies in sequence; and
wherein at least one of
the first bitmap is 0110 y₁y₂y₃y₄ z₁z₂z₃z₄ k₁k₂k₃k₄, the first puncturing pattern is 1001 y₁y₂y₃y₄ z₁z₂z₃z₄ k₁k₂k₃k₄ and the second puncturing pattern is a puncturing pattern corresponding to the 242-tone RU 1, wherein yᵢ is negation of yᵢ, zᵢ is negation of zᵢ, kᵢ is negation of kᵢ, i comprises 1, 2, 3, and 4, y₁y₂y₃y₄ is any one of 1111, 0111, 1011, 1101, 1110, 1100, 0011, 1001, or 0000, z₁z₂z₃z₄ is any one of 1111, 0111, 1011, 1101, 1110, 1100, 0011, 1001, or 0000, k₁k₂k₃k₄ is any one of 1111, 0111, 1011, 1101, 1110, 1100, 0011, 1001, or 0000, and z₁z₂z₃z₄ and k₁k₂k₃k₄ are not both 0000; or
the first bitmap is 0011 y₁y₂y₃y₄ z₁z₂z₃z₄ k₁k₂k₃k₄, the first puncturing pattern is 1100 y₁y₂y₃y₄ z₁z₂z₃z₄ k₁k₂k₃k₄ and the second puncturing pattern is a puncturing pattern corresponding to the 484-tone RU 1, wherein yᵢ is negation of yᵢ, zᵢ is negation of zᵢ, kᵢ is negation of kᵢ, i comprises 1, 2, 3, and 4, y₁y₂y₃y₄ is any one of 0111, 1011, 1101, 1110, 1100, 0011, 1001, or 0000, z₁z₂z₃z₄ is any one of 1111, 0111, 1011, 1101, 1110, 1100, 0011, 1001, or 0000, k₁k₂k₃k₄ is any one of 1111, 0111, 1011, 1101, 1110, 1100, 0011, 1001, or 0000, and z₁z₂z₃z₄ and k₁k₂k₃k₄ are not both 0000; or
the first bitmap is 1100 y₁y₂y₃y₄ z₁z₂z₃z₄ k₁k₂k₃k₄, the first puncturing pattern is 0011 y₁y₂y₃y₄ z₁z₂z₃z₄ k₁k₂k₃k₄ and the second puncturing pattern is a puncturing pattern corresponding to the 484-tone RU 1, wherein yᵢ is negation of yᵢ, i comprises 1, 2, 3, and 4, y₁y₂y₃y₄ is any one of 0111, 1011, 1101, 1110, 1100, 0011, 1001, or 0000, z₁z₂z₃z₄ is any one of 1111, 0111, 1011, 1101, 1110, 1100, 0011, 1001, or 0000, k₁k₂k₃k₄ is any one of 1111, 0111, 1011, 1101, 1110, 1100, 0011, 1001, or 0000, and z₁z₂z₃z₄ and k₁k₂k₃k₄ are not both 0000; or
the first bitmap is 0011 0000 z₁z₂z₃z₄ k₁k₂k₃k₄, the first puncturing pattern is 1100 1111 z₁z₂z₃z₄ k₁k₂k₃k₄ and the second puncturing pattern is a puncturing pattern corresponding to the 996+484-tone MRU 2, wherein zᵢ is negation of zᵢ, kᵢ is negation of kᵢ, i comprises 1, 2, 3, and 4, z₁z₂z₃z₄ is any one of 0111, 1011, 1101, 1110, 1100, 0011, 1001, or 0000, k₁k₂k₃k₄ is any one of 1111, 0111, 1011, 1101, 1110, 1100, 0011, 1001, or 0000, and z₁z₂z₃z₄ and k₁k₂k₃k₄ are not both 0000; or
the first bitmap is 1100 0000 z₁z₂z₃z₄ k₁k₂k₃k₄, the first puncturing pattern is 0011 1111 z₁z₂z₃z₄ k₁k₂k₃k₄ and the second puncturing pattern is a puncturing pattern corresponding to the 996+484-tone MRU 1, wherein zᵢ is negation of zᵢ, kᵢ is negation of kᵢ, i comprises 1, 2, 3, and 4, z₁z₂z₃z₄ is any one of 0111, 1011, 1101, 1110, 1100, 0011, 1001, or 0000, k₁k₂k₃k₄ is any one of 1111, 0111, 1011, 1101, 1110, 1100, 0011, 1001, or 0000, and z₁z₂z₃z₄ and k₁k₂k₃k₄ are not both 0000; or
the first bitmap is 0011 0000 0000 k₁k₂k₃k₄, the first puncturing pattern is 1100 1111 1111 k₁k₂k₃k₄ and the second puncturing pattern is a puncturing pattern corresponding to the 2*996+484-tone MRU 2, wherein kᵢ is negation of kᵢ, i comprises 1, 2, 3, and 4, and k₁k₂k₃k₄ is any one of 0111, 1011, 1101, 1110, 1100, 0011, 1001, or 0000; or
the first bitmap is 1100 0000 0000 k₁k₂k₃k₄, the first puncturing pattern is 0011 1111 1111 k₁k₂k₃k₄ and the second puncturing pattern is a puncturing pattern corresponding to the 2*996+484-tone MRU 1, wherein kᵢ is negation of kᵢ, i comprises 1, 2, 3, and 4, and k₁k₂k₃k₄ is any one of 0111, 1011, 1101, 1110, 1100, 0011, 1001, or 0000; or
the first bitmap is 0001 y₁y₂y₃y₄ z₁z₂z₃z₄ k₁k₂k₃k₄, the first puncturing pattern is 1110 y₁y₂y₃y₄ z₁z₂z₃z₄ k₁k₂k₃k₄ and the second puncturing pattern is a puncturing pattern corresponding to the 484+242-tone MRU 4, wherein yᵢ is negation of yᵢ, zᵢ is negation of zᵢ, kᵢ is negation of kᵢ, i comprises 1, 2, 3, and 4, y₁y₂y₃y₄ is any one of 0111, 1011, 1101, 1110, 1100, 0011, 1001, or 0000, z₁z₂z₃z₄ is any one of 1111, 0111, 1011, 1101, 1110, 1100, 0011, 1001, or 0000, k₁k₂k₃k₄ is any one of 1111, 0111, 1011, 1101, 1110, 1100, 0011, 1001, or 0000, and z₁z₂z₃z₄ and k₁k₂k₃k₄ are not both 0000; or
the first bitmap is 0100 y₁y₂y₃y₄ z₁z₂z₃z₄ k₁k₂k₃k₄, the first puncturing pattern is 1011 y₁y₂y₃y₄ z₁z₂z₃z₄ k₁k₂k₃k₄ and the second puncturing pattern is a puncturing pattern corresponding to the 484+242-tone MRU 2, wherein yᵢ is negation of yᵢ, zᵢ is negation of zᵢ, kᵢ is negation of kᵢ, i comprises 1, 2, 3, and 4, y₁y₂y₃y₄ is any one of 0111, 1011, 1101, 1110, 1100, 0011, 1001, or 0000, z₁z₂z₃z₄ is any one of 1111, 0111, 1011, 1101, 1110, 1100, 0011, 1001, or 0000, k₁k₂k₃k₄ is any one of 1111, 0111, 1011, 1101, 1110, 1100, 0011, 1001, or 0000, and z₁z₂z₃z₄ and k₁k₂k₃k₄ are not both 0000; or
the first bitmap is 0010 y₁y₂y₃y₄ z₁z₂z₃z₄ k₁k₂k₃k₄, the first puncturing pattern is 1101 y₁y₂y₃y₄ z₁z₂z₃z₄ k₁k₂k₃k₄ and the second puncturing pattern is a puncturing pattern corresponding to the 484+242-tone MRU 3, wherein yᵢ is negation of yᵢ, zᵢ is negation of zᵢ, kᵢ is negation of kᵢ, i comprises 1, 2, 3, and 4, y₁y₂y₃y₄ is any one of 0111, 1011, 1101, 1110, 1100, 0011, 1001, or 0000, z₁z₂z₃z₄ is any one of 1111, 0111, 1011, 1101, 1110, 1100, 0011, 1001, or 0000, k₁k₂k₃k₄ is any one of 1111, 0111, 1011, 1101, 1110, 1100, 0011, 1001, or 0000, and z₁z₂z₃z₄ and k₁k₂k₃k₄ are not both 0000; or
the first bitmap is 1000 y₁y₂y₃y₄ z₁z₂z₃z₄ k₁k₂k₃k₄, the first puncturing pattern is 0111 y₁y₂y₃y₄ z₁z₂z₃z₄ k₁k₂k₃k₄ and the second puncturing pattern is a puncturing pattern corresponding to the 484+242-tone MRU 1, wherein yᵢ is negation of yᵢ, zᵢ is negation of zᵢ, kᵢ is negation of kᵢ, i comprises 1, 2, 3, and 4, y₁y₂y₃y₄ is any one of 0111, 1011, 1101, 1110, 1100, 0011, 1001, or 0000, z₁z₂z₃z₄ is any one of 1111, 0111, 1011, 1101, 1110, 1100, 0011, 1001, or 0000, k₁k₂k₃k₄ is any one of 1111, 0111, 1011, 1101, 1110, 1100, 0011, 1001, or 0000, and z₁z₂z₃z₄ and k₁k₂k₃k₄ are not both 0000; or
the first bitmap is 0001 0000 z₁z₂z₃z₄ k₁k₂k₃k₄, the first puncturing pattern is 1110 1111 z₁z₂z₃z₄ k₁k₂k₃k₄ and the second puncturing pattern is a puncturing pattern corresponding to the 996+484+242-tone MRU 4, wherein zᵢ is negation of zᵢ, kᵢ is negation of kᵢ, i comprises 1, 2, 3, and 4, z₁z₂z₃z₄ is any one of 0111, 1011, 1101, 1110, 1100, 0011, 1001, or 0000, k₁k₂k₃k₄ is any one of 1111, 0111, 1011, 1101, 1110, 1100, 0011, 1001, or 0000, and z₁z₂z₃z₄ and k₁k₂k₃k₄ are not both 0000; or
the first bitmap is 0100 0000 z₁z₂z₃z₄ k₁k₂k₃k₄, the first puncturing pattern is 1011 1111 z₁z₂z₃z₄ k₁k₂k₃k₄ and the second puncturing pattern is a puncturing pattern corresponding to the 996+484+242-tone MRU 2, wherein zᵢ is negation of zᵢ, kᵢ is negation of kᵢ, i comprises 1, 2, 3, and 4, z₁z₂z₃z₄ is any one of 0111, 1011, 1101, 1110, 1100, 0011, 1001, or 0000, k₁k₂k₃k₄ is any one of 1111, 0111, 1011, 1101, 1110, 1100, 0011, 1001, or 0000, and z₁z₂z₃z₄ and k₁k₂k₃k₄ are not both 0000; or
the first bitmap is 0010 0000 z₁z₂z₃z₄ k₁k₂k₃k₄, the first puncturing pattern is 1101 1111 z₁z₂z₃z₄ k₁k₂k₃k₄ and the second puncturing pattern is a puncturing pattern corresponding to the 996+484+242-tone MRU 3, wherein & is negation of zᵢ, kᵢ is negation of kᵢ, i comprises 1, 2, 3, and 4, z₁z₂z₃z₄ is any one of 0111, 1011, 1101, 1110, 1100, 0011, 1001, or 0000, k₁k₂k₃k₄ is any one of 1111, 0111, 1011, 1101, 1110, 1100, 0011, 1001, or 0000, and z₁z₂z₃z₄ and k₁k₂k₃k₄ are not both 0000; or
the first bitmap is 1000 0000 z₁z₂z₃z₄ k₁k₂k₃k₄, the first puncturing pattern is 0111 1111 z₁z₂z₃z₄ k₁k₂k₃k₄ and the second puncturing pattern is a puncturing pattern corresponding to the 996+484+242-tone MRU 1, wherein zᵢ is negation of zᵢ, kᵢ is negation of kᵢ, i comprises 1, 2, 3, and 4, z₁z₂z₃z₄ is any one of 0111, 1011, 1101, 1110, 1100, 0011, 1001, or 0000, k₁k₂k₃k₄ is any one of 1111, 0111, 1011, 1101, 1110, 1100, 0011, 1001, or 0000, and z₁z₂z₃z₄ and k₁k₂k₃k₄ are not both 0000; or
the first bitmap is 0001 0000 0000 k₁k₂k₃k₄, the first puncturing pattern is 1110 1111 1111 k₁k₂k₃k₄ and the second puncturing pattern is a puncturing pattern corresponding to the 2*996+484-tone MRU 2, wherein kᵢ is negation of kᵢ, i comprises 1, 2, 3, and 4, and k₁k₂k₃k₄ is any one of 0111, 1011, 1101, 1110, 1100, 0011, 1001, or 0000; or
the first bitmap is 0100 0000 0000 k₁k₂k₃k₄, the first puncturing pattern is 1011 1111 1111 k₁k₂k₃k₄ and the second puncturing pattern is a puncturing pattern corresponding to the 2*996+484-tone MRU 1, wherein kᵢ is negation of kᵢ, i comprises 1, 2, 3, and 4, and k₁k₂k₃k₄ is any one of 0111, 1011, 1101, 1110, 1100, 0011, 1001, or 0000; or
the first bitmap is 0010 0000 0000 k₁k₂k₃k₄, the first puncturing pattern is 1101 1111 1111 k₁k₂k₃k₄ and the second puncturing pattern is a puncturing pattern corresponding to the 2*996+484-tone MRU 2, wherein kᵢ is negation of kᵢ, i comprises 1, 2, 3, and 4, and k₁k₂k₃k₄ is any one of 0111, 1011, 1101, 1110, 1100, 0011, 1001, or 0000; or
the first bitmap is 1000 0000 0000 k₁k₂k₃k₄, the first puncturing pattern is 0111 1111 1111 k₁k₂k₃k₄ and the second puncturing pattern is a puncturing pattern corresponding to the 2*996+484-tone MRU 1, wherein kᵢ is negation of kᵢ, i comprises 1, 2, 3, and 4, and k₁k₂k₃k₄ is any one of 0111, 1011, 1101, 1110, 1100, 0011, 1001, or 0000; or
the first bitmap is 0001 0000 0000 0000, the first puncturing pattern is 1110 1111 1111 1111 and the second puncturing pattern is a puncturing pattern corresponding to the 3*996+484-tone MRU 2; or
the first bitmap is 0100 0000 0000 0000, the first puncturing pattern is 10 1111 1111 1111 and the second puncturing pattern is a puncturing pattern corresponding to the 3*996+484-tone MRU 1; or
the first bitmap is 0010 0000 0000 0000, the first puncturing pattern is 1101 1111 1111 1111 and the second puncturing pattern is a puncturing pattern corresponding to the 3*996+484-tone MRU 2; or
the first bitmap is 1000 0000 0000 0000, the first puncturing pattern is 0111 1111 1111 1111 and the second puncturing pattern is a puncturing pattern corresponding to the 3*996+484-tone MRU 1; or
the first bitmap is 0000 0110 z₁z₂z₃z₄ k₁k₂k₃k₄, the first puncturing pattern is 1111 1101 and the second puncturing pattern is a puncturing pattern corresponding to the 996-tone RU 1, wherein zᵢ is negation of zᵢ, kᵢ is negation of kᵢ, i comprises 1, 2, 3, and 4, z₁z₂z₃z₄ is any one of 1111, 0111, 1011, 1101, 1110, 1100, 0011, 1001, or 0000, k₁k₂k₃k₄ is any one of 0111, 1011, 1101, 1110, 1100, 0011, 1001, or 0000, and z₁z₂z₃z₄ and k₁k₂k₃k₄ are not both 0000; or
the first bitmap is 0000 0110 0000 0000, the first puncturing pattern is 1111 1001 1111 1111 and the second puncturing pattern is a puncturing pattern corresponding to the 3*996-tone MRU 2; or
the first bitmap is 0000 0011 z₁z₂z₃z₄ k₁k₂k₃k₄, the first puncturing pattern is 1111 1100 z₁z₂z₃z₄ k₁k₂k₃k₄ and the second puncturing pattern is a puncturing pattern corresponding to the 996+484-tone MRU 4, wherein zᵢ is negation of zᵢ, kᵢ is negation of kᵢ, i comprises 1, 2, 3, and 4, z₁z₂z₃z₄ is any one of 0111, 1011, 1101, 1110, 1100, 0011, 1001, or 0000, k₁k₂k₃k₄ is any one of 1111, 0111, 1011, 1101, 1110, 1100, 0011, 1001, or 0000, and z₁z₂z₃z₄ and k₁k₂k₃k₄ are not both 0000; or
the first bitmap is 0000 1100 z₁z₂z₃z₄ k₁k₂k₃k₄, the first puncturing pattern is 1111 0011 z₁z₂z₃z₄ k₁k₂k₃k₄ and the second puncturing pattern is a puncturing pattern corresponding to the 996+484-tone MRU 3, wherein zᵢ is negation of zᵢ, kᵢ is negation of kᵢ, i comprises 1, 2, 3, and 4, z₁z₂z₃z₄ is any one of 0111, 1011, 1101, 1110, 1100, 0011, 1001, or 0000, k₁k₂k₃k₄ is any one of 1111, 0111, 1011, 1101, 1110, 1100, 0011, 1001, or 0000, and z₁z₂z₃z₄ and k₁k₂k₃k₄ are not both 0000; or
the first bitmap is 0000 0011 0000 k₁k₂k₃k₄, the first puncturing pattern is 1111 1100 1111 k₁k₂k₃k₄ and the second puncturing pattern is a puncturing pattern corresponding to the 2*996+484-tone MRU 4, wherein kᵢ is negation of kᵢ, i comprises 1, 2, 3, and 4, and k₁k₂k₃k₄ is any one of 0111, 1011, 1101, 1110, 1100, 0011, 1001, or 0000; or
the first bitmap is 0000 1100 0000 k₁k₂k₃k₄, the first puncturing pattern is 1111 0011 1111 k₁k₂k₃k₄ and the second puncturing pattern is a puncturing pattern corresponding to the 2*996+484-tone MRU 3, wherein kᵢ is negation of kᵢ, i comprises 1, 2, 3, and 4, and k₁k₂k₃k₄ is any one of 0111, 1011, 1101, 1110, 1100, 0011, 1001, or 0000; or
the first bitmap is 0000 0001 z₁z₂z₃z₄ k₁k₂k₃k₄, the first puncturing pattern is 1111 1110 z₁z₂z₃z₄ k₁k₂k₃k₄ and the second puncturing pattern is a puncturing pattern corresponding to the 996+484+242-tone MRU 8, wherein zᵢ is negation of zᵢ, kᵢ is negation of kᵢ, i comprises 1, 2, 3, and 4, z₁z₂z₃z₄ is any one of 0111, 1011, 1101, 1110, 1100, 0011, 1001, or 0000, k₁k₂k₃k₄ is any one of 1111, 0111, 1011, 1101, 1110, 1100, 0011, 1001, or 0000, and z₁z₂z₃z₄ and k₁k₂k₃k₄ are not both 0000; or
the first bitmap is 0000 0010 z₁z₂z₃z₄ k₁k₂k₃k₄, the first puncturing pattern is 1111 1101 z₁z₂z₃z₄ k₁k₂k₃k₄ and the second puncturing pattern is a puncturing pattern corresponding to the 996+484+242-tone MRU 7, wherein zᵢ is negation of zᵢ, kᵢ is negation of kᵢ, i comprises 1, 2, 3, and 4, z₁z₂z₃z₄ is any one of 0111, 1011, 1101, 1110, 1100, 0011, 1001, or 0000, k₁k₂k₃k₄ is any one of 1111, 0111, 1011, 1101, 1110, 1100, 0011, 1001, or 0000, and z₁z₂z₃z₄ and k₁k₂k₃k₄ are not both 0000; or
the first bitmap is 0000 0100 z₁z₂z₃z₄ k₁k₂k₃k₄, the first puncturing pattern is 1111 1011 z₁z₂z₃z₄ k₁k₂k₃k₄ and the second puncturing pattern is a puncturing pattern corresponding to the 996+484+242-tone MRU 6, wherein zᵢ is negation of zᵢ, kᵢ is negation of kᵢ, i comprises 1, 2, 3, and 4, z₁z₂z₃z₄ is any one of 0111, 1011, 1101, 1110, 1100, 0011, 1001, or 0000, k₁k₂k₃k₄ is any one of 1111, 0111, 1011, 1101, 1110, 1100, 0011, 1001, or 0000, and z₁z₂z₃z₄ and k₁k₂k₃k₄ are not both 0000; or
the first bitmap is 0000 1000 z₁z₂z₃z₄ k₁k₂k₃k₄, the first puncturing pattern is 1111 0111 z₁z₂z₃z₄ k₁k₂k₃k₄ and the second puncturing pattern is a puncturing pattern corresponding to the 996+484+242-tone MRU 5, wherein zᵢ is negation of zᵢ, kᵢ is negation of kᵢ, i comprises 1, 2, 3, and 4, z₁z₂z₃z₄ is any one of 0111, 1011, 1101, 1110, 1100, 0011, 1001, or 0000, k₁k₂k₃k₄ is any one of 1111, 0111, 1011, 1101, 1110, 1100, 0011, 1001, or 0000, and z₁z₂z₃z₄ and k₁k₂k₃k₄ are not both 0000; or
the first bitmap is 0000 0001 0000 k₁k₂k₃k₄, the first puncturing pattern is 1111 1110 1111 k₁k₂k₃k₄ and the second puncturing pattern is a puncturing pattern corresponding to the 2*996+484-tone MRU 4, wherein kᵢ is negation of kᵢ, i comprises 1, 2, 3, and 4, and k₁k₂k₃k₄ is any one of 0111, 1011, 1101, 1110, 1100, 0011, 1001, or 0000; or
the first bitmap is 0000 0010 0000 k₁k₂k₃k₄, the first puncturing pattern is 1111 1101 1111 k₁k₂k₃k₄ and the second puncturing pattern is a puncturing pattern corresponding to the 2*996+484-tone MRU 4, wherein kᵢ is negation of kᵢ, i comprises 1, 2, 3, and 4, and k₁k₂k₃k₄ is any one of 1111, 0111, 1011, 1101, 1110, 1100, 0011, 1001, or 0000; or
the first bitmap is 0000 0100 0000 k₁k₂k₃k₄, the first puncturing pattern is 1111 1011 1111 k₁k₂k₃k₄ and the second puncturing pattern is a puncturing pattern corresponding to the 2*996+484-tone MRU 3, wherein kᵢ is negation of kᵢ, i comprises 1, 2, 3, and 4, and k₁k₂k₃k₄ is any one of 1111, 0111, 1011, 1101, 1110, 1100, 0011, 1001, or 0000; or
the first bitmap is 0000 1000 0000 k₁k₂k₃k₄, the first puncturing pattern is 1111 0111 1111 k₁k₂k₃k₄ and the second puncturing pattern is a puncturing pattern corresponding to the 2*996+484-tone MRU 3, wherein kᵢ is negation of kᵢ, i comprises 1, 2, 3, and 4, and k₁k₂k₃k₄ is any one of 1111, 0111, 1011, 1101, 1110, 1100, 0011, 1001, or 0000; or
the first bitmap is 0000 0001 0000 0000, the first puncturing pattern is 1111 1110 1111 1111 and the second puncturing pattern is a puncturing pattern corresponding to the 3*996+484-tone MRU 4; or
the first bitmap is 0000 0010 0000 0000, the first puncturing pattern is 1111 1101 1111 1111 and the second puncturing pattern is a puncturing pattern corresponding to the 3*996+484-tone MRU 4; or
the first bitmap is 0000 0100 0000 0000, the first puncturing pattern is 1111 1011 1111 1111 and the second puncturing pattern is a puncturing pattern corresponding to the 3*996+484-tone MRU 3; or
the first bitmap is 0000 1000 0000 0000, the first puncturing pattern is 1111 0111 1111 1111, and the second puncturing pattern is a puncturing pattern corresponding to the 3*996+484-tone MRU 3; or
the first bitmap is 0000 0000 0110 k₁k₂k₃k₄, the first puncturing pattern is 1111 1111 1001 k₁k₂k₃k₄ and the second puncturing pattern is a puncturing pattern corresponding to the 2*996-tone RU 1, wherein kᵢ is negation of kᵢ, i comprises 1, 2, 3, and 4, and k₁k₂k₃k₄ is any one of 0111, 1011, 1101, 1110, 1100, 0011, 1001, or 0000; or
the first bitmap is 0000 0000 0011 k₁k₂k₃k₄, the first puncturing pattern is 1111 1111 1100 k₁k₂k₃k₄ and the second puncturing pattern is a puncturing pattern corresponding to the 2*996+484-tone MRU 6, wherein kᵢ is negation of kᵢ, i comprises 1, 2, 3, and 4, and k₁k₂k₃k₄ is any one of 0111, 1011, 1101, 1110, 1100, 0011, 1001, or 0000; or
the first bitmap is 0000 0000 1100 k₁k₂k₃k₄, the first puncturing pattern is 1111 1111 0011 k₁k₂k₃k₄ and the second puncturing pattern is a puncturing pattern corresponding to the 2*996+484-tone MRU 5, wherein kᵢ is negation of kᵢ, i comprises 1, 2, 3, and 4, and k₁k₂k₃k₄ is any one of 0111, 1011, 1101, 1110, 1100, 0011, 1001, or 0000; or
the first bitmap is 0000 0000 0001 k₁k₁k₂k₃k₄, the first puncturing pattern is 1111 1111 1110 k₁k₂k₃k₄ and the second puncturing pattern is a puncturing pattern corresponding to the 2*996+484-tone MRU 6, wherein kᵢ is negation of kᵢ, i comprises 1, 2, 3, and 4, and k₁k₂k₃k₄ is any one of 0111, 1011, 1101, 1110, 1100, 0011, 1001, or 0000; or
the first bitmap is 0000 0000 0010 k₁k₂k₃k₄, the first puncturing pattern is 1111 1111 1101 k₁k₂k₃k₄ and the second puncturing pattern is a puncturing pattern corresponding to the 2*996+484-tone MRU 6, wherein kᵢ is negation of kᵢ, i comprises 1, 2, 3, and 4, and k₁k₂k₃k₄ is any one of 0111, 1011, 1101, 1110, 1100, 0011, 1001, or 0000; or
the first bitmap is 0000 0000 0100 k₁k₂k₃k₄, the first puncturing pattern is 1111 1111 1011 k₁k₂k₃k₄ and the second puncturing pattern is a puncturing pattern corresponding to the 2*996+484-tone MRU 5, wherein kᵢ is negation of kᵢ, i comprises 1, 2, 3, and 4, and k₁k₂k₃k₄ is any one of 0111, 1011, 1101, 1110, 1100, 0011, 1001, or 0000; or
the first bitmap is 0000 0000 1000 k₁k₂k₃k₄, the first puncturing pattern is 1111 1111 0111 k₁k₂k₃k₄ and the second puncturing pattern is a puncturing pattern corresponding to the 2*996+484-tone MRU 5, wherein kᵢ is negation of kᵢ, i comprises 1, 2, 3, and 4, and k₁k₂k₃k₄ is any one of 0111, 1011, 1101, 1110, 1100, 0011, 1001, or 0000; or
the first bitmap is 0000 0000 0001 0000, the first puncturing pattern is 1111 1111 1110 1111 and the second puncturing pattern is a puncturing pattern corresponding to the 2*996+484-tone MRU 6; or
the first bitmap is 0000 0000 0010 0000, the first puncturing pattern is 1111 1111 1101 1111 and the second puncturing pattern is a puncturing pattern corresponding to the 3*996+484-tone MRU 6; or
the first bitmap is 0000 0000 0100 0000, the first puncturing pattern is 1111 1111 1011 1111 and the second puncturing pattern is a puncturing pattern corresponding to the 3*996+484-tone MRU 5; or
the first bitmap is 0000 0000 1000 0000, the first puncturing pattern is 1111 1111 0111 1111, and the second puncturing pattern is a puncturing pattern corresponding to the 3*996+484-tone MRU 5; or
the first bitmap is 0000 0000 0000 0110, the first puncturing pattern is 1111 1111 1111 1001 and the second puncturing pattern is a puncturing pattern corresponding to the 3*996-tone MRU 4; or
the first bitmap is 0000 0000 0000 0001, the first puncturing pattern is 1111 1111 1111 1110 and the second puncturing pattern is a puncturing pattern corresponding to the 3*996+484-tone MRU 8; or
the first bitmap is 0000 0000 0000 0010, the first puncturing pattern is 1111 1111 1111 1101 and the second puncturing pattern is a puncturing pattern corresponding to the 3*996+484-tone MRU 8; or
the first bitmap is 0000 0000 0000 0100, the first puncturing pattern is 1111 1111 1111 1011 and the second puncturing pattern is a puncturing pattern corresponding to the 3*996+484-tone MRU 7; or
the first bitmap is 0000 0000 0000 1000, the first puncturing pattern is 1111 1111 1111 0111 and the second puncturing pattern is a puncturing pattern corresponding to the 3*996+484-tone MRU 7.

19. The method according to claim 15, wherein the first BSS bandwidth is 320 MHz, and the first BSS bandwidth is divided into a secondary 80 MHz channel, and a primary 80 MHz channel, and a secondary 160 MHz channel in ascending order of frequencies in sequence,
the first bitmap is y₁y₂y₃y₄ 0110 z₁z₂z₃z₄ k₁k₂k₃k₄, the first puncturing pattern is y₁y₂y₃y₄ 1001 z₁z₂z₃z₄ k₁k₂k₃k₄ and the second puncturing pattern is a puncturing pattern corresponding to the 242-tone RU 1, wherein yᵢ is negation of yᵢ, zᵢ is negation of zᵢ, kᵢ is negation of kᵢ, i comprises 1, 2, 3, and 4, each of y₁y₂y₃y₄, k₁k₂k₃k₄, and z₁z₂z₃z₄ is any one of 1111, 0111, 1011, 1101, 1110, 1100, 0011, 1001, or 0000, and z₁z₂z₃z₄ and k₁k₂k₃k₄ are not both 0000; or
the first bitmap is y₁y₂y₃y₄ 0011 z₁z₂z₃z₄ k₁k₂k₃k₄, the first puncturing pattern is y₁y₂y₃y₄ 1100 z₁z₂z₃z₄ k₁k₂k₃k₄ and the second puncturing pattern is a puncturing pattern corresponding to the 484-tone RU 1, wherein yᵢ is negation of yᵢ, zᵢ is negation of zᵢ, kᵢ is negation of kᵢ, i comprises 1, 2, 3, and 4, y₁y₂y₃y₄ is any one of 0111, 1011, 1101, 1110, 1100, 0011, 1001, or 0000, z₁z₂z₃z₄ and k₁k₂k₃k₄ each are any one of 1111, 0111, 1011, 1101, 1110, 1100, 0011, 1001, or 0000, and z₁z₂z₃z₄ and k₁k₂k₃k₄ are not both 1111 or not both 0000; or
the first bitmap is y₁y₂y₃y₄ 1100 z₁z₂z₃z₄ k₁k₂k₃k₄, the first puncturing pattern is y₁y₂y₃y₄ 0011 z₁z₂z₃z₄ k₁k₂k₃k₄ and the second puncturing pattern is a puncturing pattern corresponding to the 484-tone RU 1, wherein yᵢ is negation of yᵢ, zᵢ is negation of zᵢ, kᵢ is negation of kᵢ, i comprises 1, 2, 3, and 4, y₁y₂y₃y₄ is any one of 0111, 1011, 1101, 1110, 1100, 0011, 1001, or 0000, z₁z₂z₃z₄ and k₁k₂k₃k₄ each are any one of 1111, 0111, 1011, 1101, 1110, 1100, 0011, 1001, or 0000, and z₁z₂z₃z₄ and k₁k₂k₃k₄ are not both 1111 or not both 0000; or
the first bitmap is y₁y₂y₃y₄ 0011 0000 0000, the first puncturing pattern is y₁y₂y₃y₄ 1100 1111 1111 and the second puncturing pattern is a puncturing pattern corresponding to the 2*996+484-tone MRU 8, wherein yᵢ is negation of yᵢ, i comprises 1, 2, 3, and 4, and y₁y₂y₃y₄ is any one of 0111, 1011, 1101, 1110, 1100, 0011, 1001, or 0000; or
the first bitmap is y₁y₂y₃y₄ 1100 0000 0000, the first puncturing pattern is y₁y₂y₃y₄ 0011 1111 1111 and the second puncturing pattern is a puncturing pattern corresponding to the 2*996+484-tone MRU 7, wherein yᵢ is negation of yᵢ, i comprises 1, 2, 3, and 4, and y₁y₂y₃y₄ is any one of 0111, 1011, 1101, 1110, 1100, 0011, 1001, or 0000; or
the first bitmap is 0000 0011 z₁z₂z₃z₄ k₁k₂k₃k₄, the first puncturing pattern is 1111 1100 z₁z₂z₃z₄ k₁k₂k₃k₄ and the second puncturing pattern is a puncturing pattern corresponding to the 996+484-tone MRU 4, wherein zᵢ is negation of zᵢ, kᵢ is negation of kᵢ, i comprises 1, 2, 3, and 4, z₁z₂z₃z₄ is any one of 0111, 1011, 1101, 1110, 1100, 0011, 1001, or 0000, k₁k₂k₃k₄ is any one of 1111, 0111, 1011, 1101, 1110, 1100, 0011, 1001, or 0000, and z₁z₂z₃z₄ and k₁k₂k₃k₄ are not both 0000; or
the first bitmap is 0000 1100 z₁z₂z₃z₄ k₁k₂k₃k₄, the first puncturing pattern is 1111 0011 z₁z₂z₃z₄ k₁k₂k₃k₄ and the second puncturing pattern is a puncturing pattern corresponding to the 996+484-tone MRU 3, wherein zᵢ is negation of zᵢ, kᵢ is negation of kᵢ, i comprises 1, 2, 3, and 4, z₁z₂z₃z₄ is any one of 0111, 1011, 1101, 1110, 1100, 0011, 1001, or 0000, k₁k₂k₃k₄ is any one of 1111, 0111, 1011, 1101, 1110, 1100, 0011, 1001, or 0000, and z₁z₂z₃z₄ and k₁k₂k₃k₄ are not both 0000; or
the first bitmap is 0000 0011 0000 k₁k₂k₃k₄, the first puncturing pattern is 1111 1100 1111 k₁k₂k₃k₄ and the second puncturing pattern is a puncturing pattern corresponding to the 2*996+484-tone MRU 4, wherein kᵢ is negation of kᵢ, i comprises 1, 2, 3, and 4, and k₁k₂k₃k₄ is any one of 0111, 1011, 1101, 1110, 1100, 0011, 1001, or 0000; or
the first bitmap is 0000 1100 0000 k₁k₂k₃k₄, the first puncturing pattern is 1111 0011 1111 k₁k₂k₃k₄ and the second puncturing pattern is a puncturing pattern corresponding to the 2*996+484-tone MRU 3, wherein kᵢ is negation of kᵢ, i comprises 1, 2, 3, and 4, and k₁k₂k₃k₄ is any one of 0111, 1011, 1101, 1110, 1100, 0011, 1001, or 0000; or
the first bitmap is y₁y₂y₃y₄ 0001 z₁z₂z₃z₄ k₁k₂k₃k₄, the first puncturing pattern is y₁y₂y₃y₄ 1110 z₁z₂z₃z₄ k₁k₂k₃k₄ and the second puncturing pattern is a puncturing pattern corresponding to the 484+242-tone MRU 4, wherein yᵢ is negation of yᵢ, zᵢ is negation of zᵢ, kᵢ is negation of kᵢ, i comprises 1, 2, 3, and 4, y₁y₂y₃y₄ is any one of 0111, 1011, 1101, 1110, 1100, 0011, 1001, or 0000, z₁z₂z₃z₄ and k₁k₂k₃k₄ each are any one of 1111, 0111, 1011, 1101, 1110, 1100, 0011, 1001, or 0000, and z₁z₂z₃z₄ and k₁k₂k₃k₄ are not both 1111 or not both 0000; or
the first bitmap is y₁y₂y₃y₄ 0100 z₁z₂z₃z₄ k₁k₂k₃k₄, the first puncturing pattern is y₁y₂y₃y₄ 1011 z₁z₂z₃z₄ k₁k₂k₃k₄ and the second puncturing pattern is a puncturing pattern corresponding to the 484+242-tone MRU 2, wherein yᵢ is negation of yᵢ, zᵢ is negation of zᵢ, kᵢ is negation of kᵢ, i comprises 1, 2, 3, and 4, y₁y₂y₃y₄ is any one of 0111, 1011, 1101, 1110, 1100, 0011, 1001, or 0000, z₁z₂z₃z₄ and k₁k₂k₃k₄ each are any one of 1111, 0111, 1011, 1101, 1110, 1100, 0011, 1001, or 0000, and z₁z₂z₃z₄ and k₁k₂k₃k₄ are not both 1111 or not both 0000; or
the first bitmap is y₁y₂y₃y₄ 0010 z₁z₂z₃z₄ k₁k₂k₃k₄, the first puncturing pattern is y₁y₂y₃y₄ 1101 z₁z₂z₃z₄ k₁k₂k₃k₄ and the second puncturing pattern is a puncturing pattern corresponding to the 484+242-tone MRU 3, wherein yᵢ is negation of yᵢ, zᵢ is negation of zᵢ, kᵢ is negation of kᵢ, i comprises 1, 2, 3, and 4, y₁y₂y₃y₄ is any one of 0111, 1011, 1101, 1110, 1100, 0011, 1001, or 0000, z₁z₂z₃z₄ and k₁k₂k₃k₄ each are any one of 1111, 0111, 1011, 1101, 1110, 1100, 0011, 1001, or 0000, and z₁z₂z₃z₄ and k₁k₂k₃k₄ are not both 1111 or not both 0000; or
the first bitmap is y₁y₂y₃y₄ 1000 z₁z₂z₃z₄ k₁k₂k₃k₄, the first puncturing pattern is y₁y₂y₃y₄ 0111 z₁z₂z₃z₄ k₁k₂k₃k₄ and the second puncturing pattern is a puncturing pattern corresponding to the 484+242-tone MRU 1, wherein yᵢ is negation of yᵢ, zᵢ is negation of zᵢ, kᵢ is negation of kᵢ, i comprises 1, 2, 3, and 4, y₁y₂y₃y₄ is any one of 0111, 1011, 1101, 1110, 1100, 0011, 1001, or 0000, z₁z₂z₃z₄ and k₁k₂k₃k₄ each are any one of 1111, 0111, 1011, 1101, 1110, 1100, 0011, 1001, or 0000, and z₁z₂z₃z₄ and k₁k₂k₃k₄ are not both 1111 or not both 0000; or
the first bitmap is y₁y₂y₃y₄ 0001 0000 0000, the first puncturing pattern is y₁y₂y₃y₄ 1110 1111 1111 and the second puncturing pattern is a puncturing pattern corresponding to the 2*996+484-tone MRU 8, wherein yᵢ is negation of yᵢ, i comprises 1, 2, 3, and 4, and y₁y₂y₃y₄ is any one of 0111, 1011, 1101, 1110, 1100, 0011, 1001, or 0000; or
the first bitmap is y₁y₂y₃y₄ 0100 0000 0000, the first puncturing pattern is y₁y₂y₃y₄ 1011 1111 1111 and the second puncturing pattern is a puncturing pattern corresponding to the 2*996+484-tone MRU 7, wherein yᵢ is negation of yᵢ, i comprises 1, 2, 3, and 4, and y₁y₂y₃y₄ is any one of 0111, 1011, 1101, 1110, 1100, 0011, 1001, or 0000; or
the first bitmap is y₁y₂y₃y₄ 0010 0000 0000, the first puncturing pattern is y₁y₂y₃y₄ 1101 1111 1111 and the second puncturing pattern is a puncturing pattern corresponding to the 2*996+484-tone MRU 8, wherein yᵢ is negation of yᵢ, i comprises 1, 2, 3, and 4, and y₁y₂y₃y₄ is any one of 0111, 1011, 1101, 1110, 1100, 0011, 1001, or 0000; or
the first bitmap is y₁y₂y₃y₄ 1000 0000 0000, the first puncturing pattern is y₁y₂y₃y₄ 0111 1111 1111 and the second puncturing pattern is a puncturing pattern corresponding to the 2*996+484-tone MRU 7, wherein yᵢ is negation of yᵢ, i comprises 1, 2, 3, and 4, and y₁y₂y₃y₄ is any one of 0111, 1011, 1101, 1110, 1100, 0011, 1001, or 0000; or
the first bitmap is 0000 0001 z₁z₂z₃z₄ k₁k₂k₃k₄, the first puncturing pattern is 1111 1110 z₁z₂z₃z₄ k₁k₂k₃k₄ and the second puncturing pattern is a puncturing pattern corresponding to the 996+484+242-tone MRU 8, wherein zᵢ is negation of zᵢ, kᵢ is negation of kᵢ, i comprises 1, 2, 3, and 4, z₁z₂z₃z₄ is any one of 0111, 1011, 1101, 1110, 1100, 0011, 1001, or 0000, and k₁k₂k₃k₄ is any one of 1111, 0111, 1011, 1101, 1110, 1100, 0011, 1001, or 0000; or
the first bitmap is 0000 0100 z₁z₂z₃z₄ k₁k₂k₃k₄, the first puncturing pattern is 1111 1011 z₁z₂z₃z₄ k₁k₂k₃k₄ and the second puncturing pattern is a puncturing pattern corresponding to the 996+484+242-tone MRU 6, wherein zᵢ is negation of zᵢ, kᵢ is negation of kᵢ, i comprises 1, 2, 3, and 4, z₁z₂z₃z₄ is any one of 0111, 1011, 1101, 1110, 1100, 0011, 1001, or 0000, and k₁k₂k₃k₄ is any one of 1111, 0111, 1011, 1101, 1110, 1100, 0011, 1001, or 0000; or
the first bitmap is 0000 0010 z₁z₂z₃z₄ k₁k₂k₃k₄, the first puncturing pattern is 1111 1101 z₁z₂z₃z₄ k₁k₂k₃k₄ and the second puncturing pattern is a puncturing pattern corresponding to the 996+484+242-tone MRU 7, wherein & is negation of zᵢ, kᵢ is negation of kᵢ, i comprises 1, 2, 3, and 4, z₁z₂z₃z₄ is any one of 0111, 1011, 1101, 1110, 1100, 0011, 1001, or 0000, and k₁k₂k₃k₄ is any one of 1111, 0111, 1011, 1101, 1110, 1100, 0011, 1001, or 0000; or
the first bitmap is 0000 1000 z₁z₂z₃z₄ k₁k₂k₃k₄, the first puncturing pattern is 1111 0111 z₁z₂z₃z₄ k₁k₂k₃k₄ and the second puncturing pattern is a puncturing pattern corresponding to the 996+484+242-tone MRU 5, wherein zᵢ is negation of zᵢ, kᵢ is negation of kᵢ, i comprises 1, 2, 3, and 4, z₁z₂z₃z₄ is any one of 0111, 1011, 1101, 1110, 1100, 0011, 1001, or 0000, and k₁k₂k₃k₄ is any one of 1111, 0111, 1011, 1101, 1110, 1100, 0011, 1001, or 0000; or
the first bitmap is 0000 0001 z₁z₂z₃z₄ k₁k₂k₃k₄, the first puncturing pattern is 1111 1110 1111 k₁k₂k₃k₄ and the second puncturing pattern is a puncturing pattern corresponding to the 2*996+484-tone MRU 4, wherein kᵢ is negation of kᵢ, i comprises 1, 2, 3, and 4, and k₁k₂k₃k₄ is any one of 0111, 1011, 1101, 1110, 1100, 0011, 1001, or 0000; or
the first bitmap is 0000 0100 0000 k₁k₂k₃k₄, the first puncturing pattern is 1111 1011 1111 k₁k₂k₃k₄ and the second puncturing pattern is a puncturing pattern corresponding to the 2*996+484-tone MRU 3, wherein kᵢ is negation of kᵢ, i comprises 1, 2, 3, and 4, and k₁k₂k₃k₄ is any one of 0111, 1011, 1101, 1110, 1100, 0011, 1001, or 0000; or
the first bitmap is 0000 0010 0000 k₁, the first puncturing pattern is 1111 1101 1111 k₁k₂k₃k₄ and the second puncturing pattern is a puncturing pattern corresponding to the 2*996+484-tone MRU 4, wherein kᵢ is negation of kᵢ, i comprises 1, 2, 3, and 4, and k₁k₂k₃k₄ is any one of 0111, 1011, 1101, 1110, 1100, 0011, 1001, or 0000; or
the first bitmap is 0000 1000 0000 k₁k₂k₃k₄, the first puncturing pattern is 1111 0111 1111 k₁k₂k₃k₄ and the second puncturing pattern is a puncturing pattern corresponding to the 2*996+484-tone MRU 3, wherein kᵢ is negation of kᵢ, i comprises 1, 2, 3, and 4, and k₁k₂k₃k₄ is any one of 0111, 1011, 1101, 1110, 1100, 0011, 1001, or 0000; or
the first bitmap is 0000 0001 0000 0000, the first puncturing pattern is 1111 1110 1111 1111 and the second puncturing pattern is a puncturing pattern corresponding to the 3*996+484-tone MRU 4; or
the first bitmap is 0000 0100 0000 0000, the first puncturing pattern is 1111 1101 1111 1111 and the second puncturing pattern is a puncturing pattern corresponding to the 3*996+484-tone MRU 3; or
the first bitmap is 0000 0010 0000 0000, the first puncturing pattern is 1111 1101 1111 1111 and the second puncturing pattern is a puncturing pattern corresponding to the 3*996+484-tone MRU 4; or
the first bitmap is 0000 1000 0000 0000, the first puncturing pattern is 1111 0111 1111 1111 and the second puncturing pattern is a puncturing pattern corresponding to the 3*996+484-tone MRU 3; or
the first bitmap is 0110 0000 0110 k₁k₂k₃k₄, the first puncturing pattern is 1001 1111 1001 k₁k₂k₃k₄ and the second puncturing pattern is a puncturing pattern corresponding to the 996-tone RU 1, wherein kᵢ is negation of kᵢ, i comprises 1, 2, 3, and 4, and k₁k₂k₃k₄ is any one of 0111, 1011, 1101, 1110, 1100, 0011, 1001, or 0000; or
the first bitmap is 0110 0000 0110 0000, the first puncturing pattern is 1001 1111 1001 1111 and the second puncturing pattern is a puncturing pattern corresponding to the 996-tone RU 1; or
the first bitmap is 0110 0000 1100 k₁k₂k₃k₄, the first puncturing pattern is 1001 1111 0011 k₁k₂k₃k₄ and the second puncturing pattern is a puncturing pattern corresponding to the 996-tone RU 1, wherein kᵢ is negation of kᵢ, i comprises 1, 2, 3, and 4, and k₁k₂k₃k₄ is any one of 0111, 1011, 1101, 1110, 1100, 0011, 1001, or 0000; or
the first bitmap is 0110 0000 0011 k₁k₂k₃k₄, the first puncturing pattern is 1001 1111 1100 k₁k₂k₃k₄ and the second puncturing pattern is a puncturing pattern corresponding to the 996-tone RU 1, wherein kᵢ is negation of kᵢ, i comprises 1, 2, 3, and 4, and k₁k₂k₃k₄ is any one of 0111, 1011, 1101, 1110, 1100, 0011, 1001, or 0000; or
the first bitmap is 0110 0000 1000 k₁k₂k₃k₄, the first puncturing pattern is 1001 1111 0111 k₁k₂k₃k₄ and the second puncturing pattern is a puncturing pattern corresponding to the 996-tone RU 1, wherein kᵢ is negation of kᵢ, i comprises 1, 2, 3, and 4, and k₁k₂k₃k₄ is any one of 0111, 1011, 1101, 1110, 1100, 0011, 1001, or 0000; or
the first bitmap is 0110 0000 0100 k₁k₂k₃k₄, the first puncturing pattern is 1001 1111 1101 k₁k₂k₃k₄ and the second puncturing pattern is a puncturing pattern corresponding to the 996-tone RU 1, wherein kᵢ is negation of kᵢ, i comprises 1, 2, 3, and 4, and k₁k₂k₃k₄ is any one of 0111, 1011, 1101, 1110, 1100, 0011, 1001, or 0000; or
the first bitmap is 0110 0000 0010 k₁k₂k₃k₄, the first puncturing pattern is 1001 1111 1101 k₁k₂k₃k₄ and the second puncturing pattern is a puncturing pattern corresponding to the 996-tone RU 1, wherein kᵢ is negation of kᵢ, i comprises 1, 2, 3, and 4, and k₁k₂k₃k₄ is any one of 0111, 1011, 1101, 1110, 1100, 0011, 1001, or 0000; or
the first bitmap is 0110 0000 0001 k₁k₂k₃k₄, the first puncturing pattern is 1001 1111 1110 k₁k₂k₃k₄ and the second puncturing pattern is a puncturing pattern corresponding to the 996-tone RU 1, wherein kᵢ is negation of kᵢ, i comprises 1, 2, 3, and 4, and k₁k₂k₃k₄ is any one of 0111, 1011, 1101, 1110, 1100, 0011, 1001, or 0000; or
the first bitmap is 0110 0000 z₁z₂z₃z₄ 0110, the first puncturing pattern is 1001 1111 z₁z₂z₃z₄ 1001 and the second puncturing pattern is a puncturing pattern corresponding to the 996-tone RU 1, wherein zᵢ is negation of zᵢ, i comprises 1, 2, 3, and 4, and z₁z₂z₃z₄ is any one of 0111, 1011, 1101, 1110, 1100, 0011, 1001, or 0000; or
the first bitmap is 0110 0000 z₁z₂z₃z₄ 1100, the first puncturing pattern is 1001 1111 z₁z₂z₃z₄ 0011 and the second puncturing pattern is a puncturing pattern corresponding to the 996-tone RU 1, wherein zᵢ is negation of zᵢ, i comprises 1, 2, 3, and 4, and z₁z₂z₃z₄ is any one of 0111, 1011, 1101, 1110, 1100, 0011, 1001, or 0000; or
the first bitmap is 0110 0000 z₁z₂z₃z₄ 0011, the first puncturing pattern is 1001 1111 z₁z₂z₃z₄ 1100 and the second puncturing pattern is a puncturing pattern corresponding to the 996-tone RU 1, wherein zᵢ is negation of zᵢ, i comprises 1, 2, 3, and 4, and z₁z₂z₃z₄ is any one of 0111, 1011, 1101, 1110, 1100, 0011, 1001, or 0000; or
the first bitmap is 0110 0000 z₁z₂z₃z₄ 1000, the first puncturing pattern is 1001 1111 z₁z₂z₃z₄ 0111 and the second puncturing pattern is a puncturing pattern corresponding to the 996-tone RU 1, wherein zᵢ is negation of zᵢ, i comprises 1, 2, 3, and 4, and z₁z₂z₃z₄ is any one of 0111, 1011, 1101, 1110, 1100, 0011, 1001, or 0000; or
the first bitmap is 0110 0000 z₁z₂z₃z₄ 0100, the first puncturing pattern is 1001 1111 z₁z₂z₃z₄ 1011 and the second puncturing pattern is a puncturing pattern corresponding to the 996-tone RU 1, wherein zᵢ is negation of zᵢ, i comprises 1, 2, 3, and 4, and z₁z₂z₃z₄ is any one of 0111, 1011, 1101, 1110, 1100, 0011, 1001, or 0000; or
the first bitmap is 0110 0000 z₁z₂z₃z₄ 0010, the first puncturing pattern is 1001 1111 z₁z₂z₃z₄ 1101 and the second puncturing pattern is a puncturing pattern corresponding to the 996-tone RU 1, wherein zᵢ is negation of zᵢ, i comprises 1, 2, 3, and 4, and z₁z₂z₃z₄ is any one of 0111, 1011, 1101, 1110, 1100, 0011, 1001, or 0000; or
the first bitmap is 0110 0000 z₁z₂z₃z₄ 0001, the first puncturing pattern is 1001 1111 z₁z₂z₃z₄ 1110 and the second puncturing pattern is a puncturing pattern corresponding to the 996-tone RU 1, wherein zᵢ is negation of zᵢ, i comprises 1, 2, 3, and 4, and z₁z₂z₃z₄ is any one of 0111, 1011, 1101, 1110, 1100, 0011, 1001, or 0000; or
the first bitmap is 0110 0000 1100 0000, the first puncturing pattern is 1001 1111 0011 1111 and the second puncturing pattern is a puncturing pattern corresponding to the 2*996+484-tone MRU 9; or
the first bitmap is 0110 0000 0011 0000, the first puncturing pattern is 1001 1111 1100 1111 and the second puncturing pattern is a puncturing pattern corresponding to the 2*996+484-tone MRU 10; or
the first bitmap is 0110 0000 1000 0000, the first puncturing pattern is 1001 1111 0111 1111 and the second puncturing pattern is a puncturing pattern corresponding to the 2*996+484-tone MRU 9; or
the first bitmap is 0110 0000 0100 0000, the first puncturing pattern is 1001 1111 1011 1111 and the second puncturing pattern is a puncturing pattern corresponding to the 2*996+484-tone MRU 9; or
the first bitmap is 0110 0000 0010 0000, the first puncturing pattern is 1001 1111 1101 1111 and the second puncturing pattern is a puncturing pattern corresponding to the 2*996+484-tone MRU 10; or
the first bitmap is 0110 0000 0001 0000, the first puncturing pattern is 1001 1111 1110 1111 and the second puncturing pattern is a puncturing pattern corresponding to the 2*996+484-tone MRU 10; or
the first bitmap is 0110 0000 0000 0011, the first puncturing pattern is 1001 1111 1111 0011 and the second puncturing pattern is a puncturing pattern corresponding to the 2*996+484-tone MRU 11; or
the first bitmap is 0110 0000 0000 1100, the first puncturing pattern is 1001 1111 1111 1100 and the second puncturing pattern is a puncturing pattern corresponding to the 2*996+484-tone MRU 12; or
the first bitmap is 0110 0000 0000 1000, the first puncturing pattern is 1001 1111 1111 0111 and the second puncturing pattern is a puncturing pattern corresponding to the 2*996+484-tone MRU 11; or
the first bitmap is 0110 0000 0000 0100, the first puncturing pattern is 1001 1111 1111 1011 and the second puncturing pattern is a puncturing pattern corresponding to the 2*996+484-tone MRU 11; or
the first bitmap is 0110 0000 0000 0010, the first puncturing pattern is 1001 1111 1111 1101 and the second puncturing pattern is a puncturing pattern corresponding to the 2*996+484-tone MRU 12; or
the first bitmap is 0110 0000 0000 0001, the first puncturing pattern is 1001 1111 1111 1110 and the second puncturing pattern is a puncturing pattern corresponding to the 2*996+484-tone MRU 12; or
the first bitmap is 0110 0000 0000 0000, the first puncturing pattern is 1001 1111 1111 1111 and the second puncturing pattern is a puncturing pattern corresponding to the 3*996-tone MRU 1; or
the first bitmap is 0011 0000 0110 k₁k₂k₃k₄, the first puncturing pattern is 1100 1111 1001 k₁k₂k₃k₄ and the second puncturing pattern is a puncturing pattern corresponding to the 996+484-tone MRU 2, wherein kᵢ is negation of kᵢ, i comprises 1, 2, 3, and 4, and k₁k₂k₃k₄ is any one of 0111, 1011, 1101, 1110, 1100, 0011, 1001, or 0000; or
the first bitmap is 0011 0000 0110 0000, the first puncturing pattern is 1100 1111 1001 1111 and the second puncturing pattern is a puncturing pattern corresponding to the 996+484-tone MRU 2; or
the first bitmap is 0011 0000 1100 k₁k₂k₃k₄, the first puncturing pattern is 1100 1111 0011 k₁k₂k₃k₄ and the second puncturing pattern is a puncturing pattern corresponding to the 996+484-tone MRU 2, wherein kᵢ is negation of kᵢ, i comprises 1, 2, 3, and 4, and k₁k₂k₃k₄ is any one of 0111, 1011, 1101, 1110, 1100, 0011, 1001, or 0000; or
the first bitmap is 0011 0000 0011 k₁k₂k₃k₄, the first puncturing pattern is 1100 1111 1100 k₁k₂k₃k₄ and the second puncturing pattern is a puncturing pattern corresponding to the 996+484-tone MRU 2, wherein kᵢ is negation of kᵢ, i comprises 1, 2, 3, and 4, and k₁k₂k₃k₄ is any one of 0111, 1011, 1101, 1110, 1100, 0011, 1001, or 0000; or
the first bitmap is 0011 0000 1000 k₁k₂k₃k₄, the first puncturing pattern is 1100 1111 0111 k₁k₂k₃k₄ and the second puncturing pattern is a puncturing pattern corresponding to the 996+484-tone MRU 2, wherein kᵢ is negation of kᵢ, i comprises 1, 2, 3, and 4, and k₁k₂k₃k₄ is any one of 0111, 1011, 1101, 1110, 1100, 0011, 1001, or 0000; or
the first bitmap is 0011 0000 0100 k₁k₂k₃k₄, the first puncturing pattern is 1100 1111 1101 k₁k₂k₃k₄ and the second puncturing pattern is a puncturing pattern corresponding to the 996+484-tone MRU 2, wherein kᵢ is negation of kᵢ, i comprises 1, 2, 3, and 4, and k₁k₂k₃k₄ is any one of 0111, 1011, 1101, 1110, 1100, 0011, 1001, or 0000; or
the first bitmap is 0011 0000 0010 k₁k₂k₃k₄, the first puncturing pattern is 1100 1111 1101 k₁k₂k₃k₄ and the second puncturing pattern is a puncturing pattern corresponding to the 996+484-tone MRU 2, wherein kᵢ is negation of kᵢ, i comprises 1, 2, 3, and 4, and k₁k₂k₃k₄ is any one of 0111, 1011, 1101, 1110, 1100, 0011, 1001, or 0000; or
the first bitmap is 0011 0000 0001 k₁k₂k₃k₄, the first puncturing pattern is 1100 1111 1110 k₁k₂k₃k₄ and the second puncturing pattern is a puncturing pattern corresponding to the 996+484-tone MRU 2, wherein kᵢ is negation of kᵢ, i comprises 1, 2, 3, and 4, and k₁k₂k₃k₄ is any one of 0111, 1011, 1101, 1110, 1100, 0011, 1001, or 0000; or
the first bitmap is 0011 0000 z₁z₂z₃z₄ 0110, the first puncturing pattern is 1100 1111 z₁z₂z₃z₄ 1001 and the second puncturing pattern is a puncturing pattern corresponding to the 996+484-tone MRU 2, wherein zᵢ is negation of zᵢ, i comprises 1, 2, 3, and 4, and z₁z₂z₃z₄ is any one of 0111, 1011, 1101, 1110, 1100, 0011, 1001, or 0000; or
the first bitmap is 0011 0000 z₁z₂z₃z₄ 1100, the first puncturing pattern is 1100 1111 z₁z₂z₃z₄ 0011 and the second puncturing pattern is a puncturing pattern corresponding to the 996+484-tone MRU 2, wherein zᵢ is negation of zᵢ, i comprises 1, 2, 3, and 4, and z₁z₂z₃z₄ is any one of 0111, 1011, 1101, 1110, 1100, 0011, 1001, or 0000; or
the first bitmap is 0011 0000 z₁z₂z₃z₄ 0011, the first puncturing pattern is 1100 1111 z₁z₂z₃z₄ 1100 and the second puncturing pattern is a puncturing pattern corresponding to the 996+484-tone MRU 2, wherein zᵢ is negation of zᵢ, i comprises 1, 2, 3, and 4, and z₁z₂z₃z₄ is any one of 0111, 1011, 1101, 1110, 1100, 0011, 1001, or 0000; or
the first bitmap is 0011 0000 z₁z₂z₃z₄ 1000, the first puncturing pattern is 1100 1111 z₁z₂z₃z₄ 0111 and the second puncturing pattern is a puncturing pattern corresponding to the 996+484-tone MRU 2, wherein zᵢ is negation of zᵢ, i comprises 1, 2, 3, and 4, and z₁z₂z₃z₄ is any one of 0111, 1011, 1101, 1110, 1100, 0011, 1001, or 0000; or
the first bitmap is 0011 0000 z₁z₂z₃z₄ 0100, the first puncturing pattern is 1100 1111 z₁z₂z₃z₄ 1011 and the second puncturing pattern is a puncturing pattern corresponding to the 996+484-tone MRU 2, wherein zᵢ is negation of zᵢ, i comprises 1, 2, 3, and 4, and z₁z₂z₃z₄ is any one of 0111, 1011, 1101, 1110, 1100, 0011, 1001, or 0000; or
the first bitmap is 0011 0000 z₁z₂z₃z₄ 0010, the first puncturing pattern is 1100 1111 z₁z₂z₃z₄ 1101 and the second puncturing pattern is a puncturing pattern corresponding to the 996+484-tone MRU 2, wherein zᵢ is negation of zᵢ, i comprises 1, 2, 3, and 4, and z₁z₂z₃z₄ is any one of 0111, 1011, 1101, 1110, 1100, 0011, 1001, or 0000; or
the first bitmap is 0011 0000 z₁z₂z₃z₄ 0001, the first puncturing pattern is 1100 1111 z₁z₂z₃z₄ 1110 and the second puncturing pattern is a puncturing pattern corresponding to the 996+484-tone MRU 2, wherein zᵢ is negation of zᵢ, i comprises 1, 2, 3, and 4, and z₁z₂z₃z₄ is any one of 0111, 1011, 1101, 1110, 1100, 0011, 1001, or 0000; or
the first bitmap is 1100 0000 0110 k₁k₂k₃k₄, the first puncturing pattern is 0011 1111 1001 k₁k₂k₃k₄ and the second puncturing pattern is a puncturing pattern corresponding to the 996+484-tone MRU 1, wherein kᵢ is negation of kᵢ, i comprises 1, 2, 3, and 4, and k₁k₂k₃k₄ is any one of 0111, 1011, 1101, 1110, 1100, 0011, 1001, or 0000; or
the first bitmap is 1100 0000 0110 0000, the first puncturing pattern is 0011 1111 1001 1111 and the second puncturing pattern is a puncturing pattern corresponding to the 996+484-tone MRU 1; or
the first bitmap is 1100 0000 1100 k₁k₂k₃k₄, the first puncturing pattern is 0011 1111 0011 k₁k₂k₃k₄ and the second puncturing pattern is a puncturing pattern corresponding to the 996+484-tone MRU 1, wherein kᵢ is negation of kᵢ, i comprises 1, 2, 3, and 4, and k₁k₂k₃k₄ is any one of 0111, 1011, 1101, 1110, 1100, 0011, 1001, or 0000; or
the first bitmap is 1100 0000 0011 k₁k₂k₃k₄, the first puncturing pattern is 0011 1111 1100 k₁k₂k₃k₄ and the second puncturing pattern is a puncturing pattern corresponding to the 996+484-tone MRU 1, wherein kᵢ is negation of kᵢ, i comprises 1, 2, 3, and 4, and k₁k₂k₃k₄ is any one of 0111, 1011, 1101, 1110, 1100, 0011, 1001, or 0000; or
the first bitmap is 1100 0000 1000 k₁k₂k₃k₄, the first puncturing pattern is 0011 1111 0111 k₁k₂k₃k₄ and the second puncturing pattern is a puncturing pattern corresponding to the 996+484-tone MRU 1, wherein kᵢ is negation of kᵢ, i comprises 1, 2, 3, and 4, and k₁k₂k₃k₄ is any one of 0111, 1011, 1101, 1110, 1100, 0011, 1001, or 0000; or
the first bitmap is 1100 0000 0100 k₁k₂k₃k₄, the first puncturing pattern is 0011 1111 1011 k₁k₂k₃k₄ and the second puncturing pattern is a puncturing pattern corresponding to the 996+484-tone MRU 1, wherein kᵢ is negation of kᵢ, i comprises 1, 2, 3, and 4, and k₁k₂k₃k₄ is any one of 0111, 1011, 1101, 1110, 1100, 0011, 1001, or 0000; or
the first bitmap is 1100 0000 0010 k₁k₂k₃k₄, the first puncturing pattern is 0011 1111 1101 k₁k₂k₃k₄ and the second puncturing pattern is a puncturing pattern corresponding to the 996+484-tone MRU 1, wherein kᵢ is negation of kᵢ, i comprises 1, 2, 3, and 4, and k₁k₂k₃k₄ is any one of 0111, 1011, 1101, 1110, 1100, 0011, 1001, or 0000; or
the first bitmap is 1100 0000 0001 k₁k₂k₃k₄, the first puncturing pattern is 0011 1111 1110 k₁k₂k₃k₄ and the second puncturing pattern is a puncturing pattern corresponding to the 996+484-tone MRU 1, wherein kᵢ is negation of kᵢ, i comprises 1, 2, 3, and 4, and k₁k₂k₃k₄ is any one of 0111, 1011, 1101, 1110, 1100, 0011, 1001, or 0000; or
the first bitmap is 1100 0000 z₁z₂z₃z₄ 0110, the first puncturing pattern is 0011 1111 z₁z₂z₃z₄ 1001 and the second puncturing pattern is a puncturing pattern corresponding to the 996+484-tone MRU 1, wherein zᵢ is negation of zᵢ, i comprises 1, 2, 3, and 4, and z₁z₂z₃z₄ is any one of 0111, 1011, 1101, 1110, 1100, 0011, 1001, or 0000; or
the first bitmap is 1100 0000 z₁z₂z₃z₄ 1100, the first puncturing pattern is 0011 1111 z₁z₂z₃z₄ 0011 and the second puncturing pattern is a puncturing pattern corresponding to the 996+484-tone MRU 1, wherein zᵢ is negation of zᵢ, i comprises 1, 2, 3, and 4, and z₁z₂z₃z₄ is any one of 0111, 1011, 1101, 1110, 1100, 0011, 1001, or 0000; or
the first bitmap is 1100 0000 z₁z₂z₃z₄ 0011, the first puncturing pattern is 0011 1111 z₁z₂z₃z₄ 1100 and the second puncturing pattern is a puncturing pattern corresponding to the 996+484-tone MRU 1, wherein zᵢ is negation of zᵢ, i comprises 1, 2, 3, and 4, and z₁z₂z₃z₄ is any one of 0111, 1011, 1101, 1110, 1100, 0011, 1001, or 0000; or
the first bitmap is 1100 0000 z₁z₂z₃z₄ 1000, the first puncturing pattern is 0011 1111 z₁z₂z₃z₄ 0111 and the second puncturing pattern is a puncturing pattern corresponding to the 996+484-tone MRU 1, wherein zᵢ is negation of zᵢ, i comprises 1, 2, 3, and 4, and z₁z₂z₃z₄ is any one of 0111, 1011, 1101, 1110, 1100, 0011, 1001, or 0000; or
the first bitmap is 1100 0000 z₁z₂z₃z₄ 0100, the first puncturing pattern is 0011 1111 z₁z₂z₃z₄ 1011 and the second puncturing pattern is a puncturing pattern corresponding to the 996+484-tone MRU 1, wherein zᵢ is negation of zᵢ, i comprises 1, 2, 3, and 4, and z₁z₂z₃z₄ is any one of 0111, 1011, 1101, 1110, 1100, 0011, 1001, or 0000; or
the first bitmap is 1100 0000 z₁z₂z₃z₄ 0010, the first puncturing pattern is 0011 1111 z₁z₂z₃z₄ 1101 and the second puncturing pattern is a puncturing pattern corresponding to the 996+484-tone MRU 1, wherein zᵢ is negation of zᵢ, i comprises 1, 2, 3, and 4, and z₁z₂z₃z₄ is any one of 0111, 1011, 1101, 1110, 1100, 0011, 1001, or 0000; or
the first bitmap is 1100 0000 z₁z₂z₃z₄ 0001, the first puncturing pattern is 0011 1111 z₁z₂z₃z₄ 1110 and the second puncturing pattern is a puncturing pattern corresponding to the 996+484-tone MRU 1, wherein zᵢ is negation of zᵢ, i comprises 1, 2, 3, and 4, and z₁z₂z₃z₄ is any one of 0111, 1011, 1101, 1110, 1100, 0011, 1001, or 0000; or
the first bitmap is 0011 0000 1100 0000, the first puncturing pattern is 1100 1111 0011 1111 and the second puncturing pattern is a puncturing pattern corresponding to the 2*996+484-tone MRU 9; or
the first bitmap is 0011 0000 0011 0000, the first puncturing pattern is 1100 1111 1100 1111 and the second puncturing pattern is a puncturing pattern corresponding to the 2*996+484-tone MRU 10; or
the first bitmap is 0011 0000 1000 0000, the first puncturing pattern is 1100 1111 0111 1111 and the second puncturing pattern is a puncturing pattern corresponding to the 2*996+484-tone MRU 9; or
the first bitmap is 0011 0000 0100 0000, the first puncturing pattern is 1100 1111 1011 1111 and the second puncturing pattern is a puncturing pattern corresponding to the 2*996+484-tone MRU 9; or
the first bitmap is 0011 0000 0010 0000, the first puncturing pattern is 1100 1111 1101 1111 and the second puncturing pattern is a puncturing pattern corresponding to the 2*996+484-tone MRU 10; or
the first bitmap is 0011 0000 0001 0000, the first puncturing pattern is 1100 1111 1110 1111 and the second puncturing pattern is a puncturing pattern corresponding to the 2*996+484-tone MRU 10; or
the first bitmap is 0011 0000 0000 k₁k₂k₃k₄, the first puncturing pattern is 1100 1111 1111 k₁k₂k₃k₄, wherein kᵢ is negation of kᵢ, and i comprises 1, 2, 3, and 4, and wherein at least one of:
k₁k₂k₃k₄ is any one of 0111, 1011, 1101, 1110, 1100, 0011, 1001 or 0000, the second puncturing pattern is the 2*996+484-tone MRU 2; or
k₁k₂k₃k₄ is any one of 0111, 1011, or 0011, the second puncturing pattern is the 2*996+484-tone MRU 11; or
k₁k₂k₃k₄ is any one of 1101, 1110, or 1100, the second puncturing pattern is the 2*996+484-tone MRU 12; or
the first bitmap is 1100 0000 1100 0000, the first puncturing pattern is 0011 1111 0011 1111 and the second puncturing pattern is a puncturing pattern corresponding to the 2*996+484-tone MRU 9; or
the first bitmap is 1100 0000 0011 0000, the first puncturing pattern is 0011 1111 1100 1111 and the second puncturing pattern is a puncturing pattern corresponding to the 2*996+484-tone MRU 10; or
the first bitmap is 1100 0000 1000 0000, the first puncturing pattern is 0011 1111 0111 1111 and the second puncturing pattern is a puncturing pattern corresponding to the 2*996+484-tone MRU 9; or
the first bitmap is 1100 0000 0100 0000, the first puncturing pattern is 0011 1111 1011 1111 and the second puncturing pattern is a puncturing pattern corresponding to the 2*996+484-tone MRU 9; or
the first bitmap is 1100 0000 0010 0000, the first puncturing pattern is 0011 1111 1101 1111 and the second puncturing pattern is a puncturing pattern corresponding to the 2*996+484-tone MRU 10; or
the first bitmap is 1100 0000 0001 0000, the first puncturing pattern is 0011 1111 1110 1111 and the second puncturing pattern is a puncturing pattern corresponding to the 2*996+484-tone MRU 10; or
the first bitmap is 1100 0000 0000 k₁k₂k₃k₄, the first puncturing pattern is 0011 1111 1111 k₁k₂k₃k₄, wherein kᵢ is negation of kᵢ, and i comprises 1, 2, 3, and 4, and wherein at least one of:
k₁k₂k₃k₄ is any one of 0111, 1011, 1101, 1110, 1100, 0011, 1001 or 0000, the second puncturing pattern is the 2*996+484-tone MRU 1; or
k₁k₂k₃k₄ is any one of 0111, 1011, or 0011, the second puncturing pattern is the 2*996+484-tone MRU 11; or
k₁k₂k₃k₄ is any one of 1101, 1110, or 1100, the second puncturing pattern is the 2*996+484-tone MRU 12; or
wherein at least one of:
the first bitmap is 0001 0 000 Z₁Z₂Z₃Z₄ K₁K₂K₂K₄, the first puncturing pattern is 1110 1111 Z₁Z₂Z₃Z₄ K₁K₂K₃K₄ and the second puncturing pattern is a puncturing pattern corresponding to the 996+484+242-tone MRU 4; or
the first bitmap is 0010 0000 Z₁Z₂Z₃Z₄ K₁K₂K₂K₄, the first puncturing pattern is 1101 1111 Z₁Z₂Z₃Z₄ K₁K₂K₃K₄ and the second puncturing pattern is a puncturing pattern corresponding to the 996+484+242-tone MRU 3; or
the first bitmap is 0100 000 0 Z₁Z₂Z₃Z₄ K₁K₂K₂K₄, the first puncturing pattern is 1011 1111 Z₁Z₂Z₃Z₄ K₁K₂K₃K₄ and the second puncturing pattern is a puncturing pattern corresponding to the 996+484+242-tone MRU 2; or
the first bitmap is 1000 0000 Z₁Z₂Z₃Z₄ K₁K₂K₂K₄, the first puncturing pattern is 0111 1111 Z₁Z₂Z₃Z₄ K₁K₂K₃K₄ and the second puncturing pattern is a puncturing pattern corresponding to the 996+484+242-tone MRU 1;
wherein at least one of:
Z₁Z₂Z₃Z₄ and K₁K₂K₂K₄ are 0110 and k₁k₂k₃k₄ respectively, Z₁Z₂Z₃Z₄ and K₁K₂K₃K₄ are 1001 and k₁k₂k₃k₄ respectively; or
Z₁Z₂Z₃Z₄ and K₁K₂K₂K₄ are 0110 and 0000 respectively, Z₁Z₂Z₃Z₄ and K₁K₂K₃K₄ are 1001 and 1111 respectively; or
Z₁Z₂Z₃Z₄ and K₁K₂K₂K₄ are 1100 and k₁k₂k₃k₄ respectively, Z₁Z₂Z₃Z₄ and K₁K₂K₃K₄ are 0011 and k₁k₂k₃k₄ respectively; or
Z₁Z₂Z₃Z₄ and K₁K₂K₂K₄ are 0011 and k₁k₂k₃k₄ respectively, Z₁Z₂Z₃Z₄ and K₁K₂K₃K₄ are 1100 and k₁k₂k₃k₄ respectively; or
Z₁Z₂Z₃Z₄ and K₁K₂K₂K₄ are 1000 and k₁k₂k₃k₄ respectively, Z₁Z₂Z₃Z₄ and K₁K₂K₃K₄ are 0111 and k₁k₂k₃k₄ respectively; or
Z₁Z₂Z₃Z₄ and K₁K₂K₂K₄ are 0100 and k₁k₂k₃k₄ respectively, Z₁Z₂Z₃Z₄ and K₁K₂K₃K₄ are 1011 and k₁k₂k₃k₄ respectively; or
Z₁Z₂Z₃Z₄ and K₁K₂K₂K₄ are 0010 and k₁k₂k₃k₄ respectively, Z₁Z₂Z₃Z₄ and K₁K₂K₃K₄ are 1101 and k₁k₂k₃k₄ respectively; or
Z₁Z₂Z₃Z₄ and K₁K₂K₂K₄ are 0001 and k₁k₂k₃k₄ respectively, Z₁Z₂Z₃Z₄ and K₁K₂K₃K₄ are 1110 and k₁k₂k₃k₄ respectively; or
Z₁Z₂Z₃Z₄ and K₁K₂K₂K₄ are z₁z₂z₃z₄ and 0110 respectively, Z₁Z₂Z₃Z₄ and K₁K₂K₃K₄ are z₁z₂z₃z₄ and 1001 respectively; or
Z₁Z₂Z₃Z₄ and K₁K₂K₂K₄ are z₁z₂z₃z₄ and 1100 respectively, Z₁Z₂Z₃Z₄ and K₁K₂K₃K₄ are z₁z₂z₃z₄ and 0011 respectively; or
Z₁Z₂Z₃Z₄ and K₁K₂K₂K₄ are z₁z₂z₃z₄ and 0011 respectively, Z₁Z₂Z₃Z₄ and K₁K₂K₃K₄ are z₁z₂z₃z₄ and 1100 respectively; or
Z₁Z₂Z₃Z₄ and K₁K₂K₂K₄ are z₁z₂z₃z₄ and 1000 respectively, Z₁Z₂Z₃Z₄ and K₁K₂K₃K₄ are z₁z₂z₃z₄ and 0111 respectively; or
z₁z₂z₂z₄ and K₁K₂K₂K₄ are z₁z₂z₃z₄ and 0100 respectively, Z₁Z₂Z₃Z₄ and K₁K₂K₃K₄ are z₁z₂z₃z₄ and 1011 respectively; or
Z₁Z₂Z₃Z₄ and K₁K₂K₂K₄ are z₁z₂z₃z₄ and 0010 respectively, Z₁Z₂Z₃Z₄ and K₁K₂K₃K₄ are z₁z₂z₃z₄ and 1101 respectively; or
Z₁Z₂Z₃Z₄ and K₁K₂K₂K₄ are z₁z₂z₃z₄ and 0001 respectively, Z₁Z₂Z₃Z₄ and K₁K₂K₃K₄ are z₁z₂z₃z₄ and 1110 respectively and
wherein kᵢ is negation of kᵢ, zᵢ is negation of zᵢ, i comprises 1, 2, 3, and 4, k₁k₂k₃k₄ is any one of 0111, 1011, 1101, 1110, 1100, 0011, 1001 or 0000, and z₁z₂z₃z₄ is any one of 0111, 1011, 1101, 1110, 1100, 0011, 1001 or 0000; or
the first bitmap is 0001 0000 Z₁Z₂Z₃Z₄ K₁K₂K₂K₄, the first puncturing pattern is 1110 1111 Z₁Z₂Z₃Z₄ K₁K₂K₃K₄, wherein at least one of:
Z₁Z₂Z₃Z₄ and K₁K₂K₂K₄ are respectively 1100 and 0000, Z₁Z₂Z₃Z₄ and K₁K₂K₃K₄ are respectively 0011 and 1111, and the second puncturing pattern is a puncturing pattern corresponding to the 2*996+484-tone MRU 9; or
Z₁Z₂Z₃Z₄ and K₁K₂K₂K₄ are respectively 0011 and 0000, Z₁Z₂Z₃Z₄ and K₁K₂K₃K₄ are respectively 1100 and 1111, and the second puncturing pattern is a puncturing pattern corresponding to the 2*996+484-tone MRU 10; or
Z₁Z₂Z₃Z₄ and K₁K₂K₂K₄ are respectively 1000 and 0000, Z₁Z₂Z₃Z₄ and K₁K₂K₃K₄ are respectively 0111 and 1111, and the second puncturing pattern is a puncturing pattern corresponding to the 2*996+484-tone MRU 9; or
Z₁Z₂Z₃Z₄ and K₁K₂K₂K₄ are respectively 0100 and 0000, Z₁Z₂Z₃Z₄ and K₁K₂K₃K₄ are respectively 1011 and 1111, and the second puncturing pattern is a puncturing pattern corresponding to the 2*996+484-tone MRU 9; or
Z₁Z₂Z₃Z₄ and K₁K₂K₂K₄ are respectively 0010 and 0000, Z₁Z₂Z₃Z₄ and K₁K₂K₃K₄ are respectively 1101 and 1111, and the second puncturing pattern is a puncturing pattern corresponding to the 2*996+484-tone MRU 10; or
Z₁Z₂Z₃Z₄ and K₁K₂K₂K₄ are respectively 0001 and 0000, Z₁Z₂Z₃Z₄ and K₁K₂K₃K₄ are respectively 1110 and 1111, and the second puncturing pattern is a puncturing pattern corresponding to the 2*996+484-tone MRU 10; or
Z₁Z₂Z₃Z₄ and K₁K₂K₂K₄ are respectively 0000 and k₁k₂k₃k₄, Z₁Z₂Z₃Z₄ and K₁K₂K₃K₄ are respectively 1111 and k₁k₂k₃k₄, and the second puncturing pattern is a puncturing pattern corresponding to the 2*996+484-tone MRU 2, wherein kᵢ is negation of kᵢ, i comprises 1, 2, 3, and 4, and k₁k₂k₃k₄ is any one of 0111, 1011, 1101, 1110, 1100, 0011, 1001 or 0000; or
the first bitmap is 0010 0000 Z₁Z₂Z₃Z₄ K₁K₂K₂K₄, the first puncturing pattern is 1101 1111 Z₁Z₂Z₃Z₄ K₁K₂K₃K₄, wherein at least one of:
Z₁Z₂Z₃Z₄ and K₁K₂K₂K₄ are respectively 1100 and 0000, Z₁Z₂Z₃Z₄ and K₁K₂K₃K₄ are respectively 0011 and 1111, and the second puncturing pattern is a puncturing pattern corresponding to the 2*996+484-tone MRU 9; or
Z₁Z₂Z₃Z₄ and K₁K₂K₂K₄ are respectively 0011 and 0000, Z₁Z₂Z₃Z₄ and K₁K₂K₃K₄ are respectively 1100 and 1111, and the second puncturing pattern is a puncturing pattern corresponding to the 2*996+484-tone MRU 10; or
Z₁Z₂Z₃Z₄ and K₁K₂K₂K₄ are respectively 1000 and 0000, Z₁Z₂Z₃Z₄ and K₁K₂K₃K₄ are respectively 0111 and 1111, and the second puncturing pattern is a puncturing pattern corresponding to the 2*996+484-tone MRU 9; or
Z₁Z₂Z₃Z₄ and K₁K₂K₂K₄ are respectively 0100 and 0000, Z₁Z₂Z₃Z₄ and K₁K₂K₃K₄ are respectively 1011 and 1111, and the second puncturing pattern is a puncturing pattern corresponding to the 2*996+484-tone MRU 9; or
Z₁Z₂Z₃Z₄ and K₁K₂K₂K₄ are respectively 0010 and 0000, Z₁Z₂Z₃Z₄ and K₁K₂K₃K₄ are respectively 1101 and 1111, and the second puncturing pattern is a puncturing pattern corresponding to the 2*996+484-tone MRU 10; or
Z₁Z₂Z₃Z₄ and K₁K₂K₂K₄ are respectively 0001 and 0000, Z₁Z₂Z₃Z₄ and K₁K₂K₃K₄ are respectively 1110 and 1111, and the second puncturing pattern is a puncturing pattern corresponding to the 2*996+484-tone MRU 10; or
Z₁Z₂Z₃Z₄ and K₁K₂K₂K₄ are respectively 0000 and k₁k₂k₃k₄, Z₁Z₂Z₃Z₄ and K₁K₂K₃K₄ are respectively 1111 and k₁k₂k₃k₄, and the second puncturing pattern is a puncturing pattern corresponding to the 2*996+484-tone MRU 2, wherein kᵢ is negation of kᵢ, i comprises 1, 2, 3, and 4, and k₁k₂k₃k₄ is any one of 0111, 1011, 1101, 1110, 1100, 0011, 1001 or 0000; or
the first bitmap is 0100 0000 Z₁Z₂Z₃Z₄ K₁K₂K₂K₄, the first puncturing pattern is 1011 1111 Z₁Z₂Z₃Z₄ K₁K₂K₃K₄, wherein at least one of:
Z₁Z₂Z₃Z₄ and K₁K₂K₂K₄ are respectively 1100 and 0000, Z₁Z₂Z₃Z₄ and K₁K₂K₃K₄ are respectively 0011 and 1111, and the second puncturing pattern is a puncturing pattern corresponding to the 2*996+484-tone MRU 9; or
Z₁Z₂Z₃Z₄ and K₁K₂K₂K₄ are respectively 0011 and 0000, Z₁Z₂Z₃Z₄ and K₁K₂K₃K₄ are respectively 1100 and 1111, and the second puncturing pattern is a puncturing pattern corresponding to the 2*996+484-tone MRU 10; or
z₁z₂z₂z₄ and K₁K₂K₂K₄ are respectively 1000 and 0000, Z₁Z₂Z₃Z₄ and K₁K₂K₃K₄ are respectively 0111 and 1111, and the second puncturing pattern is a puncturing pattern corresponding to the 2*996+484-tone MRU 9; or
Z₁Z₂Z₃Z₄ and K₁K₂K₂K₄ are respectively 0100 and 0000, Z₁Z₂Z₃Z₄ and K₁K₂K₃K₄ are respectively 1011 and 1111, and the second puncturing pattern is a puncturing pattern corresponding to the 2*996+484-tone MRU 9; or
Z₁Z₂Z₃Z₄ and K₁K₂K₂K₄ are respectively 0010 and 0000, Z₁Z₂Z₃Z₄ and K₁K₂K₃K₄ are respectively 1101 and 1111, and the second puncturing pattern is a puncturing pattern corresponding to the 2*996+484-tone MRU 10; or
Z₁Z₂Z₃Z₄ and K₁K₂K₂K₄ are respectively 0001 and 0000, Z₁Z₂Z₃Z₄ and K₁K₂K₃K₄ are respectively 1110 and 1111, and the second puncturing pattern is a puncturing pattern corresponding to the 2*996+484-tone MRU 10; or
Z₁Z₂Z₃Z₄ and K₁K₂K₂K₄ are respectively 0000 and k₁k₂k₃k₄, Z₁Z₂Z₃Z₄ and K₁K₂K₃K₄ are respectively 1111 and k₁k₂k₃k₄, and the second puncturing pattern is a puncturing pattern corresponding to the 2*996+484-tone MRU 1, wherein kᵢ is negation of kᵢ, i comprises 1, 2, 3, and 4, and k₁k₂k₃k₄ is any one of 0111, 1011, 1101, 1110, 1100, 0011, 1001 or 0000; or
the first bitmap is 1000 0000 Z₁Z₂Z₃Z₄ K₁K₂K₂K₄, the first puncturing pattern is 0111 1111 Z₁Z₂Z₃Z₄ K₁K₂K₃K₄, wherein at least one of:
Z₁Z₂Z₃Z₄ and K₁K₂K₂K₄ are respectively 1100 and 0000, Z₁Z₂Z₃Z₄ and K₁K₂K₃K₄ are respectively 0011 and 1111, and the second puncturing pattern is a puncturing pattern corresponding to the 2*996+484-tone MRU 9; or
Z₁Z₂Z₃Z₄ and K₁K₂K₂K₄ are respectively 0011 and 0000, Z₁Z₂Z₃Z₄ and K₁K₂K₃K₄ are respectively 1100 and 1111, and the second puncturing pattern is a puncturing pattern corresponding to the 2*996+484-tone MRU 10; or
Z₁Z₂Z₃Z₄ and K₁K₂K₂K₄ are respectively 1000 and 0000, Z₁Z₂Z₃Z₄ and K₁K₂K₃K₄ are respectively 0111 and 1111, and the second puncturing pattern is a puncturing pattern corresponding to the 2*996+484-tone MRU 9; or
Z₁Z₂Z₃Z₄ and K₁K₂K₂K₄ are respectively 0100 and 0000, Z₁Z₂Z₃Z₄ and K₁K₂K₃K₄ are respectively 1011 and 1111, and the second puncturing pattern is a puncturing pattern corresponding to the 2*996+484-tone MRU 9; or
Z₁Z₂Z₃Z₄ and K₁K₂K₂K₄ are respectively 0010 and 0000, Z₁Z₂Z₃Z₄ and K₁K₂K₃K₄ are respectively 1101 and 1111, and the second puncturing pattern is a puncturing pattern corresponding to the 2*996+484-tone MRU 10; or
z₁z₂z₂z₄ and K₁K₂K₂K₄ are respectively 0001 and 0000, Z₁Z₂Z₃Z₄ and K₁K₂K₃K₄ are respectively 1110 and 1111, and the second puncturing pattern is a puncturing pattern corresponding to the 2*996+484-tone MRU 10; or
Z₁Z₂Z₃Z₄ and K₁K₂K₂K₄ are respectively 0000 and k₁k₂k₃k₄, Z₁Z₂Z₃Z₄ and K₁K₂K₃K₄ are respectively 1111 and k₁k₂k₃k₄, and the second puncturing pattern is a puncturing pattern corresponding to the 2*996+484-tone MRU 1, wherein kᵢ is negation of kᵢ, i comprises 1, 2, 3, and 4, and k₁k₂k₃k₄ is any one of 0111, 1011, 1101, 1110, 1100, 0011, 1001 or 0000; or
the first bitmap is 0001 0000 0000 0000, the first puncturing pattern is 1110 1111 1111 1111 and the second puncturing pattern is a puncturing pattern corresponding to the 3*996+484-tone MRU 2; or
the first bitmap is 0010 0000 0000 0000, the first puncturing pattern is 1101 1111 1111 1111 and the second puncturing pattern is a puncturing pattern corresponding to the 3*996+484-tone MRU 2; or
the first bitmap is 0100 0000 0000 0000, the first puncturing pattern is 10 1111 1111 1111 and the second puncturing pattern is a puncturing pattern corresponding to the 3*996+484-tone MRU 1; or
the first bitmap is 0100 0000 0000 0000, the first puncturing pattern is 0111 1111 1111 1111 and the second puncturing pattern is a puncturing pattern corresponding to the 3*996+484-tone MRU 1; or
the first bitmap is 0000 0000 0110 k₁k₂k₃k₄, the first puncturing pattern is 1111 1111 1001 k₁k₂k₃k₄ and the second puncturing pattern is a puncturing pattern corresponding to the 2*996-tone RU 1, wherein kᵢ is negation of kᵢ, i comprises 1, 2, 3, and 4, and k₁k₂k₃k₄ is any one of 0111, 1011, 1101, 1110, 1100, 0011, 1001, or 0000; or
the first bitmap is 0000 0000 0011 k₁k₂k₃k₄, the first puncturing pattern is 1111 1111 1100 k₁k₂k₃k₄ and the second puncturing pattern is a puncturing pattern corresponding to the 2*996+484-tone MRU 6, wherein kᵢ is negation of kᵢ, i comprises 1, 2, 3, and 4, and k₁k₂k₃k₄ is any one of 0111, 1011, 1101, 1110, 1100, 0011, 1001, or 0000; or
the first bitmap is 0000 0000 1100 k₁k₂k₃k₄, the first puncturing pattern is 1111 1111 0011 k₁k₂k₃k₄ and the second puncturing pattern is a puncturing pattern corresponding to the 2*996+484-tone MRU 5, wherein kᵢ h is negation of kᵢ, i comprises 1, 2, 3, and 4, and k₁k₂k₃k₄ is any one of 0111, 1011, 1101, 1110, 1100, 0011, 1001, or 0000; or
the first bitmap is 0000 0000 0001 k₁k₂k₃k₄, the first puncturing pattern is 1111 1111 1110 k₁k₂k₃k₄ and the second puncturing pattern is a puncturing pattern corresponding to the 2*996+484-tone MRU 6, wherein kᵢ is negation of kᵢ, i comprises 1, 2, 3, and 4, and k₁k₂k₃k₄ is any one of 0111, 1011, 1101, 1110, 1100, 0011, 1001, or 0000; or
the first bitmap is 0000 0000 0010 k₁k₂k₃k₄, the first puncturing pattern is 1111 1111 1101 k₁k₂k₃k₄ and the second puncturing pattern is a puncturing pattern corresponding to the 2*996+484-tone MRU 6, wherein kᵢ is negation of kᵢ, i comprises 1, 2, 3, and 4, and k₁k₂k₃k₄ is any one of 0111, 1011, 1101, 1110, 1100, 0011, 1001, or 0000; or
the first bitmap is 0000 0000 0100 k₁k₂k₃k₄, the first puncturing pattern is 1111 1111 1011 k₁k₂k₃k₄ and the second puncturing pattern is a puncturing pattern corresponding to the 2*996+484-tone MRU 5, wherein kᵢ is negation of kᵢ, i comprises 1, 2, 3, and 4, and k₁k₂k₃k₄ is any one of 0111, 1011, 1101, 1110, 1100, 0011, 1001, or 0000; or
the first bitmap is 0000 0000 1000 k₁k₂k₃k₄, the first puncturing pattern is 1111 1111 0111 k₁k₂k₃k₄ and the second puncturing pattern is a puncturing pattern corresponding to the 2*996+484-tone MRU 5, wherein kᵢ is negation of kᵢ, i comprises 1, 2, 3, and 4, and k₁k₂k₃k₄ is any one of 0111, 1011, 1101, 1110, 1100, 0011, 1001, or 0000; or
the first bitmap is 0000 0000 0001 0000, the first puncturing pattern is 1111 1111 1110 1111 and the second puncturing pattern is a puncturing pattern corresponding to the 3*996+484-tone MRU 6; or
the first bitmap is 0000 0000 0010 0000, the first puncturing pattern is 1111 1111 1101 1111 and the second puncturing pattern is a puncturing pattern corresponding to the 3*996+484-tone MRU 6; or
the first bitmap is 0000 0000 0100 0000, the first puncturing pattern is 1111 1111 1011 1111 and the second puncturing pattern is a puncturing pattern corresponding to the 3*996+484-tone MRU 5; or
the first bitmap is 0000 0000 1000 0000, the first puncturing pattern is 1111 1111 0111 1111 and the second puncturing pattern is a puncturing pattern corresponding to the 3*996+484-tone MRU 5; or
the first bitmap is 0000 0000 0000 0110, the first puncturing pattern is 1111 1111 1111 1001 and the second puncturing pattern is a puncturing pattern corresponding to the 3*996-tone MRU 4; or
the first bitmap is 0000 0000 0000 0001, the first puncturing pattern is 1111 1111 1111 1110 and the second puncturing pattern is a puncturing pattern corresponding to the 3*996+484-tone MRU 8; or
the first bitmap is 0000 0000 0000 0010, the first puncturing pattern is 1111 1111 1111 1101 and the second puncturing pattern is a puncturing pattern corresponding to the 3*996+484-tone MRU 8; or
the first bitmap is 0000 0000 0000 0100, the first puncturing pattern is 1111 1111 1111 1011 and the second puncturing pattern is a puncturing pattern corresponding to the 3*996+484-tone MRU 7; or
the first bitmap is 0000 0000 0000 1000, the first puncturing pattern is 1111 1111 1111 0111 and the second puncturing pattern is a puncturing pattern corresponding to the 3*996+484-tone MRU 7.

20. A communication apparatus, comprising:
at least one processor; and
at least one non-transitory computer readable memory connected to the at least one processor and including computer program code, wherein the at least one non-transitory computer readable memory and the computer program code are configured, with the at least one processor, to cause the communications apparatus to perform at least:
sending a management frame, wherein the management frame comprises a first bitmap, and wherein a first puncturing pattern indicated by the first bitmap is a puncturing pattern unsupported by non-orthogonal frequency division multiple access (non-OFDMA) transmission; and
sending, based on a second puncturing pattern corresponding to the first bitmap, a physical layer protocol data unit (PPDU), wherein the second puncturing pattern is a puncturing pattern supported by the non-OFDMA transmission.
